(19) United States
(12) Patent Application Publication
(10) Pub. No.: US 2015/0087055 A1
(43) Pub. Date: Mar. 26, 2015

(54) ANALOG AND MIXED-SIGNAL COMPUTATION AND CIRCUITS IN LIVING CELLS

(71) Applicant: MASSACHUSETTS INSTITUTE OF TECHNOLOGY, Cambridge, MA (US)

(72) Inventors: Rahul Sarpeshkar, Arlington, MA (US); Timothy Kuan-Ta Lu, Charlestown, MA (US); Ramez Danial, Cambridge, MA (US); Jacob Rosenblum Rubens, Cambridge, MA (US)

(73) Assignee: MASSACHUSETTS INSTITUTE OF TECHNOLOGY, Cambridge, MA (US)

(21) Appl. No.: 14/391,817

(22) PCT Filed: Apr. 12, 2013
(86) PCT No.: PCT/US2013/036411

§ 371 Date: Oct. 10, 2014

Related U.S. Application Data
(60) Provisional application No. 61/623,936, filed on Apr. 13, 2012.

(51) Int. Cl. G06N 3/00

(52) U.S. Cl. CPC G06N 3/002
USPC 435/320.1

(57) ABSTRACT

Provided herein are molecular analog gene circuits that exploit positive and negative feedback to implement logarithmically linear sensing, addition, subtraction, and scaling thus enabling multiplicative, ratiometric, and power-law computations. The circuits exhibit Weber's Law behavior as in natural biological systems, operate over a wide dynamic range of up to four orders of magnitude, and can be architected to have tunable transfer functions. The molecular circuits described herein can be composed together to implement higher-order functions that are well-described by both intricate biochemical models and by simple mathematical functions. The molecular circuits described herein enable logarithmically linear analog computation within in-vitro and in-vivo systems with a broad class of molecules, all of which obey the Boltzmann exponential equations of thermodynamics that govern molecular association, attenuation, transformation, and degradation.

### CROSS REFERENCE TO RELATED APPLICATIONS

This application claims benefit under 35 U.S.C. §119(e) of U.S. Provisional Patent Application Ser. No. 61/623,936 filed on Apr. 13, 2012, the contents of which are incorporated herein in their entirety by reference.

### GOVERNMENT SUPPORT PARAGRAPH

This invention was made with Government support under Grant No. CCF-1124247 awarded by the National Science Foundation, under Grant No. N00014-11-1-0725 awarded by the Office of Naval Research, and under Grant No. FA8721-05-C-0002 awarded by the U.S. Air Force. The Government has certain rights in this invention.

### BACKGROUND

A central goal of synthetic biology is to achieve multi-signal integration and processing in living cells for diagnostic, therapeutic, and biotechnology applications. Digital logic has been used to build small-scale circuits but other paradigms are needed for efficient computation in resource-limited cellular environments. Using fundamental properties of the scaling laws of thermodynamic noise with temperature and molecular count, which are true in both biological and in electronic systems, the pros and cons of analog versus digital computation have been analyzed for neurobiological systems²¹ and for systems in cell biology²⁰. These results show that analog computation is more efficient than digital computation in part count, speed, and energy consumption below a certain crossover computational precision.^{20,21}. For the limited computational precision seen in biological cells, analog computation therefore has benefits over digital computation.

### SUMMARY OF THE INVENTION

Herein we demonstrate that synthetic analog gene circuits can be engineered to execute sophisticated computational functions in living cells using only a few interacting components, such as less than three transcription factors. Such synthetic analog gene circuits exploit positive and negative feedback to implement logarithmically linear sensing, addition, subtraction, and scaling thus enabling multiplicative, ratiometric, and power-law computations. The circuits exhibit Weber's Law behavior as in natural biological systems, operate over a wide dynamic range of up to four orders of magnitude, and can be architected to have tunable transfer functions. The molecular circuits described herein can be composed together to implement higher-order functions that are well-described by both intricate biochemical models and by simple mathematical functions. By exploiting analog building-block functions that are already naturally present in cells^{20,21}, this paradigm efficiently implements arithmetic operations and complex functions in the logarithmic domain. Such circuits can open up new applications for synthetic biology and biotechnology that require complex computations with limited parts, that need wide-dynamic-range bio-sensing, or that would benefit from the fine control of gene expression. The molecular circuits described herein enable logarithmically linear analog computation within in-vitro and in-vivo systems with a broad class of molecules, all of which obey the Boltzmann exponential equations of thermodynamics that govern molecular association, attenuation, transformation, and degradation.

Examples of embodiments are provided herein and throughout the present application.

Accordingly, provided herein in some aspects are graded positive-feedback molecular circuits comprising
a. an input association block, or component comprising molecular species Mᵢₙ and Mₒᵤₜ′ as inputs and that outputs molecular species C, wherein the input association block may have an adjustable input association strength; and
b. a control block, or component comprising one or more of an association, attenuation, transformation, or degradation block, wherein the output C of the input block is converted to a molecular species C′ as an output, wherein the association, attenuation, transformation and degradation strengths of the respective association, attenuation, transformation or degradation blocks may have adjustable strengths; and
c. an output transformation block, or component comprising molecular species C′ of the control block as an input that is converted to Mₒᵤₜ as an output, wherein the output transformation strength may be adjusted; and
d. a feedback block, or component comprising one or more of an association, attenuation, transformation, or degradation block, wherein the molecular species Mₒᵤₜ of the output transformation block is converted to Mₒᵤₜ′ as an output, and wherein the association, attenuation, transformation, and degradation strengths of the respective association, attenuation, transformation, and degradation blocks may be adjusted;
and wherein signs of the functional derivatives of the blocks in the feedback circuit are configured such that small changes in at least one molecular species in the feedback loop, for example, C, return as further changes in C that increase the initial change in C, thus creating a positive-feedback loop.

In some embodiments of these aspects, the circuit is executable in a cell, a cellular system, or an in vitro system.

In some embodiments of these aspects, the molecular species are selected from DNA, RNA, peptides, proteins, and small molecule inducers.

In some embodiments of these aspects, the proteins are one or more of transcription factors, nucleic acid binding proteins, enzymes, and hormones.

In some embodiments of these aspects, the RNA is one or more of a microRNA, a short-hairpin RNA, and antisense RNA.

In some embodiments of these aspects, strength of the graded positive feedback of the circuit is adjusted by altering any of the association, attenuation, transformation, or degradation strengths of any of the blocks or components in the feedback loop.

In some embodiments of these aspects, the K_{d} of binding of one molecular species to another is used to adjust the association, attenuation, transformation, or degradation strength of any of the blocks in the feedback circuit.

In some embodiments of these aspects, decoy or sequestration binding molecules or fragments of molecules serve to change the attenuation strength of any of any of the blocks/components in the feedback circuit.

In some embodiments of these aspects, degradation strength of any block is altered by adding one or more ssrA tags, antisense RNAs, microRNAs, proteases, degrons, PEST tags, or anti-sigma factors, in any block.

In some embodiments of these aspects, the circuit comprises low-copy plasmids and high-copy plasmids, each plasmid expressing one or more components of the association block, the control block, the transformation block, and the feedback block.

In some embodiments of these aspects, the attenuation strength of any block is altered by increasing a ratio of a high-copy plasmid number to a low-copy plasmid number.

In some embodiments of these aspects, graded positive feedback is used to widen a logarithmically linear range of transduction from an input molecular species to an output molecule.

Also provided herein, in some aspects, are molecular circuits for performing addition or weighted addition, wherein any of two outputs of an association, attenuation, transformation, or degradation block of any of the graded positive-feedback molecular circuits described herein is a common molecule.

In some aspects, provided herein are molecular circuits comprising at least two of any of the molecular circuits described herein, wherein the output slopes from any of these circuits with a common output molecule are adjusted by weighting to create a logarithmically linear function of the concentrations of the input molecular species.

In some aspects, provided herein are molecular circuits for performing subtraction or weighted subtraction wherein any of two outputs of an association, attenuation, transformation, or degradation block is a common molecule, and wherein the subtraction input to the block whose output is subtracted is a repressory input.

In some embodiments of these aspects, at least two of the inputs to the circuit arises from the output of logarithmically linear circuits, such that logarithmic subtraction, weighted logarithmic subtraction, division, or ratioing of these inputs is enabled.

A “block” referred to herein and throughout the specification can be understood to comprise one or more components that executed the function, e.g., the biological function, as described.

Provided herein, in some aspects, are graded negative-feedback molecular circuits comprising
a. an input association block comprising molecular species Mᵢₙ and Mₒᵤₜ′ as inputs and that outputs molecular species C, wherein the input association block may have an adjustable input association strength; and
b. a control block comprising one or more of an association, attenuation, transformation, or degradation block, wherein the output C of the input block is converted to a molecular species C′ as an output, wherein the association, attenuation, transformation and degradation strengths of the respective association, attenuation, transformation or degradation blocks may have adjustable strengths; and
c. an output transformation block comprising molecular species C′ of the control block as an input that is converted to Mₒᵤₜ as an output, wherein the output transformation strength may be adjusted; and
d. a feedback block comprising one or more of an association, attenuation, transformation, or degradation block, wherein the molecular species Mₒᵤₜ of the output transformation block is converted to Mₒᵤₜ′ as an output, wherein the association, attenuation, transformation, and degradation strengths of the respective association, attenuation, transformation, and degradation blocks may be adjusted;
   and wherein signs of the functional derivatives of the blocks in the feedback circuit are configured such that small changes in at least one molecule in the feedback loop, for example, C, return as further changes in C that decrease the initial change in C, thus creating a negative-feedback loop.

In some embodiments of these aspects, the circuit is executable in a cell, a cellular system, or an in vitro system.

In some embodiments of these aspects, the molecular species are selected from DNA, RNA, peptides, proteins, and small molecule inducers.

In some embodiments of these aspects, the input-output molecular transfer function is a power law or equivalently creates a molecular output whose logarithmic concentration is a scaled version of the logarithmic concentration of the input.

Also provided herein are molecular circuits for use in performing fine control of gene, protein, or other molecular expression.

Also provided herein are logarithmically linear molecular circuits for use in performing logarithmically linear analog computation.

### BRIEF DESCRIPTION OF THE DRAWINGS

FIG. 1A shows synthetic analog gene circuits utilize inherent continuous behavior of biochemical reactions to perform computations and implement mathematical functions over a wide dynamic range whereas digital circuits abstract this behavior into discrete ‘0s’ and ‘1s’. FIG. 1B shows open loop (OL) control comprising AraC-GFP expression from a P_{lacO}. FIG. 1C shows an AraC-based positive-logarithm circuit that logarithmically transforms input inducer concentrations into output protein levels over a wide dynamic range. This topology involves a transcriptional positive-feedback (PF) loop on a low-copy-number plasmid (LCP) that alleviates saturated binding of inducer to transcription-factor (TF) along with a “shunt” high-copy-number plasmid (HCP) containing TF binding sites that alleviates saturation of DNA binding sites. The HCP also affects the effective strength of the positive feedback on the LCP. FIG. 1D shows arabinose-to-mCherry transfer functions: The PF LCP with a HCP shunt (triangles) implements a wide-dynamic-range positive-slope logarithm circuit with an input dynamic range greater than three orders of magnitude. It is well fit by a mathematical function of the form ln(1+x), where x is a scaled version of the input inducer concentration. In contrast, the OL LCP with a HCP shunt (squares) has a narrow dynamic range and is well fit by a Hill function. FIG. 1E compares the PF LCP with a medium copy plasmid (MCP) shunt (diamonds) and the PF LCP with a HCP shunt (triangles, data from FIG. 1D shown here) demonstrates the importance of the shunt plasmid in providing wide-dynamic-range operation. Solid lines indicate modeling results of a detailed biochemical model.

FIG. 2A depicts a LuxR-based wide-dynamic-range positive-logarithm circuit. FIG. 2B shows the AHL-to-GFP transfer function for PF on a LCP (circles), PF LCP with a MCP shunt (diamonds), and PF LCP with a HCP shunt (triangles). The PF LCP with a HCP shunt implements a wide-dynamic-range positive-slope logarithm circuit with an input dynamic range that extends over three orders of magnitude. Solid lines indicate modeling results of a detailed biochemical model; the top figure shows the fit of a mathematical function of the form ln(1+x). FIG. 2C. The bottom figure shows the AHL-to-mCherry transfer function for PF LCP with a MCP shunt (diamonds) and a PF LCP with a HCP shunt (triangles). The PF LCP with a HCP shunt implements a wide-dynamic-range positive-slope logarithm circuit with an input dynamic range greater than three orders of magnitude. Solid lines indicate modeling results of a detailed biochemical model; the top figure shows the fit of a mathematical function of the form ln(1+x). FIG. 2D demonstrates that placing the PF loop on a variable-copy-number plasmid (VCP) enables dynamic adjustment of AHL-to-mCherry transfer functions between analog and digital behaviors using a CopyControl (CC) induction solution. The VCP is normally maintained at low copy numbers and can be induced to higher copy numbers via CopyControl-mediated expression of replication protein TrfA from a promoter integrated into the genome of EPI300 cells²⁴. FIG. 2E demonstrates that when a VCP PF loop is induced to high copy numbers (CC ON, diamonds), the circuit behaves in a digital-like fashion, with an input dynamic range that spans ˜2 orders of magnitude. The dotted red line is a Hill function fit to the digital-like curve. The dashed black line reveals that the digital-like curve is not well fit by a ln(1+x) function. When the VCP PF loop remains in the low copy state (CC OFF, circles), the circuit behaves in an analog fashion with a wide dynamic range that is greater than three orders of magnitude. The dashed line indicates that the PF-shunt positive logarithm is well fit by a ln(1+x) function.

FIGS. 3A-3H depict a synthetic two-stage analog cascade implementing a wide-dynamic-range negative-slope logarithm computation. FIG. 3A shows a LuxR-based PF-shunt positive-logarithm circuit modified to include an additional output on the LCP, which is quantified by expression of mCherry. FIG. 3B shows the AHL-to-mCherry transfer function: The solid line indicates modeling results of a detailed biochemical model whereas the dashed line shows the fit of a mathematical function of the form ln(1+x). FIG. 3C shows an inversion module with input protein LacI, expressed from a LCP, and output protein mCherry, under the control of a HCP P_{lacO} promoter. FIG. 3D shows LacI-to-mCherry transfer function for different IPTG concentrations. Lad was expressed by replacing mCherry in FIG. 3A with the lad gene and thus, the mCherry fluorescence at a given AHL concentration was used as a surrogate for quantifying Lad concentration for a given AHL concentration. The solid line indicates modeling results of a detailed biochemical model whereas the dashed line shows the fit of a mathematical function of the form −ln(1+x). FIG. 3E shows that a negative-slope logarithm circuit combines the wide-dynamic-range (WDR) PF-shunt positive-logarithm circuit with the LacI-to-mCherry circuit. FIG. 3F shows that by varying the amount of Lad produced using AHL, we achieve tunable IPTG-to-mCherry transfer functions. Solid lines indicate modeling results of a detailed biochemical model. Even at very high IPTG concentrations, increasing the amount of Lad reduced mCherry output. FIG. 3G shows that the negative-slope logarithm circuit with AHL as its input, yields an mCherry output, over more than four orders of magnitude. The slope of the negative logarithm can be tuned with different IPTG concentrations. Solid lines indicate modeling results of a detailed biochemical model. FIG. 3H shows that by simply cascading the ln(1+x) function that describes the PF-shunt positive-logarithm in FIG. 3B with the −ln(1+x) function that describes the LacI-to-mCherry module in FIG. 3D, the behavior of a wide-dynamic-range negative-logarithm circuit can be described.

FIGS. 4A-4F demonstrate complex analog computation implemented by composing synthetic gene circuits together. FIG. 4A shows that an adder is built by engineering two circuits, e.g., two wide-dynamic-range positive logarithmic circuits, to produce a common output, which is then effectively summed. FIG. 4B shows the adder circuit of FIG. 4A sums the logarithms of two inputs, AHL and arabinose, over ˜2 orders of magnitude, to an output, mCherry. FIG. 4C shows that a division circuit or ratiometer is implemented when the slopes of a wide-dynamic-range positive and negative logarithm circuit are closely matched by tuning their output RBSs. FIG. 4D shows that the ratiometer circuit of FIG. 4C performs a logarithmic transformation on the ratio between two inputs, arabinose and AHL, over more than 3 orders of magnitude. IPTG was held constant at 1.5 mM. The dotted blue line indicates a log-linear fit. FIG. 4E shows that a negative-feedback loop with tunable feedback strength implements power-law functions. This circuit motif uses LacI-mCherry produced on a HCP to suppress the production of AraC-GFP on a LCP. When induced by arabinose, AraC-GFP enhances the production of LacI-mCherry. The bottom figure in FIG. 4F shows that power-law behavior from the circuit of FIG. 4E can be observed in the IPTG-to-mCherry transfer function. The solid line indicates modeling results of a detailed biochemical model; the figure at the top of FIG. 4F shows the fit to a power law of the form x^{0.7}.

FIG. 5 shows a schematic diagram of the binding reaction for an inducer and transcription factor.

FIGS. 6A-6B show schematic diagram models of “analogic” promoter activity for (FIG. 6A) LuxR and (FIG. 6B) AraC.

FIGS. 7A-7D show positive-feedback circuits. FIG. 7A shows a genetic circuit for LuxR, FIG. 7B shows an analog schematic diagram for the LuxR system, FIG. 7C shows a genetic circuit for AraC, and FIG. 7D shows an analog schematic diagram for the AraC system.

FIG. 8 shows simulation results of our positive-feedback circuit versus inducer concentration for different values of K_{d}.

FIG. 9 depicts that transcription factors search for their promoter by sliding and jumping.

FIGS. 10A-10H depict a positive-feedback-and-shunt (PF-shunt) circuit. FIG. 10A shows a PF-shunt genetic circuit for LuxR; FIG. 10B shows an analog schematic diagram for LuxR, FIG. 10C shows experimental and modeling results for the GFP signal of the LuxR circuit; FIG. 10D shows experimental and modeling results for the mCherry signal of the LuxR circuit; FIG. 10E shows a PF-shunt genetic circuit for AraC; FIG. 10F shows a schematic diagram model for AraC; FIG. 10G shows experimental and modeling results for the GFP signal of the AraC circuit; FIG. 10H shows experimental and modeling results for the mCherry signal of the AraC circuit.

FIG. 11 depicts a schematic diagram model of the binding reaction of IPTG and the LacI repressor.

FIG. 12 depicts a schematic diagram of the P_{lacO} promoter.

FIG. 13 depicts a wide-dynamic-range negative-slope genetic circuit.

FIGS. 14A-14C depict a wide-dynamic-range PF-shunt subcircuit. FIG. 14A shows a genetic circuit; FIG. 14B shows an analog schematic diagram; FIG. 14C shows experimental and modeling results. This data also appears in FIG. 3B and is reproduced here for clarity.

FIGS. 15A-15D shows characterization of the PlacO promoter. FIG. 15A shows a genetic circuit; FIG. 15B shows an analog schematic diagram; FIG. 15C shows experimental and modeling results as a function of IPTG; FIG. 15D shows experimental and modeling results as a function of Lad.

FIG. 16 shows experimental and modeling results for a wide-dynamic-range negative-slope circuit.

FIGS. 17A-17C depict a power law circuit. FIG. 17A shows a genetic circuit, FIG. 17B shows an analog schematic diagram model, FIG. 17C shows experimental and model results.

FIGS. 18A-18E depict different topologies for open-loop (OL) circuits with a Pₗᵤₓ promoter. In FIG. 18A, both the transcription factor LuxR, under the control of the P_{lacO} promoter, and the output signal GFP, under the control of the Pₗᵤₓ promoter, are expressed from the same low-copy plasmid (LCP). In FIG. 18B, the transcription factor LuxR, under the control of the P_{lacO} promoter, is expressed from a LCP and the output signal mCherry, under the control of the Pₗᵤₓ promoter, is expressed from a HCP. In FIG. 18C, both the transcription factor LuxR fused to GFP, under the control of the P_{lacO} promoter, and the output signal mCherry, under the control of the Pₗᵤₓ promoter, are expressed from the same plasmid (LCP). In FIG. 18D, the transcription factor LuxR fused to GFP, under the control of the P_{lacO} promoter, is expressed from a LCP and the output signal mCherry, under the control of the P_{lacO} promoter, is expressed from a HCP. In FIG. 18E, to demonstrate that LuxR does not exhibit repression at the Pₗᵤₓ promoter in the absence of AHL, we placed LuxR under the control of the P_{lacO} promoter and GFP under the control of the Pₗᵤₓ promoter. Both of these components were located on the same low-copy plasmid. Testing of this circuit was performed in MG1655 Pro cells, where the Lad repressor is constitutively expressed and represses the P_{lacO} promoter. Expression from the P_{lacO} promoter can be induced by the addition of IPTG.

FIGS. 19A-19C depict transfer functions for open-loop LuxR circuits in different topologies. FIG. 19A shows a OL: LuxR circuit (circles, schematic in FIG. 18A) and a OL+Shunt: LuxR circuit (diamonds, schematic in FIG. 18C). FIG. 19B shows a OL: LuxR-GFP circuit (circles, schematic in FIG. 18B) and the OL+Shunt: LuxR-GFP circuit (diamonds, schematic in FIG. 18D). Model fits are shown as solid lines. FIG. 19C demonstrated that LuxR does not repress the Plux promoter in the absence of AHL for the circuit shown in FIG. 18E. When LuxR is expressed at high levels from an inducible PlacO promoter (IPTG=10 mM), the GFP output from the Plux promoter is higher than when LuxR is expressed at low levels (IPTG=0 mM).

FIGS. 20A-20C depict experimental data and schematics for AraC-based open-loop circuits with shunts. FIG. 20A shows the transcription factor AraC, under the control of the P_{lacO} promoter, is expressed from a LCP and, in the presence of arabinose, activates transcription of mCherry from the P_{BAD} promoter on a HCP. FIG. 20B shows the transcription factor AraC-GFP, under the control of the P_{lacO} promoter, is expressed from a LCP and, in the presence of arabinose, activates transcription of mCherry from the P_{BAD} promoter on a HCP. In FIG. 20C, mCherry output of the OL+Shunt: AraC circuit is shown in circles and the mCherry output of the OL+Shunt: AraC-GFP circuit is shown in diamonds. Model results are shown in solid lines.

FIG. 21A depicts a schematic of AraC-GFP positive feedback with a dummy shunt. FIG. 21B shows AraC-GFP positive feedback plus dummy shunt in diamonds and AraC-GFP positive feedback alone in circles.

FIGS. 22A-22F depict logarithmic approximations to a PF-shunt circuit. In FIG. 22A, the GFP signal for LuxR is fit to ln(1+x), in FIG. 22B, the GFP signal for LuxR is fit to ln(x), In FIG. 22C, the mCherry signal for LuxR is fit to ln(1+x), in FIG. 22D, the mCherry signal for LuxR is fit to ln(x), in FIG. 22E, the mCherry Signal for AraC is fit to ln(1+x), in FIG. 22F, the mCherry Signal for the AraC is fit to ln(x).

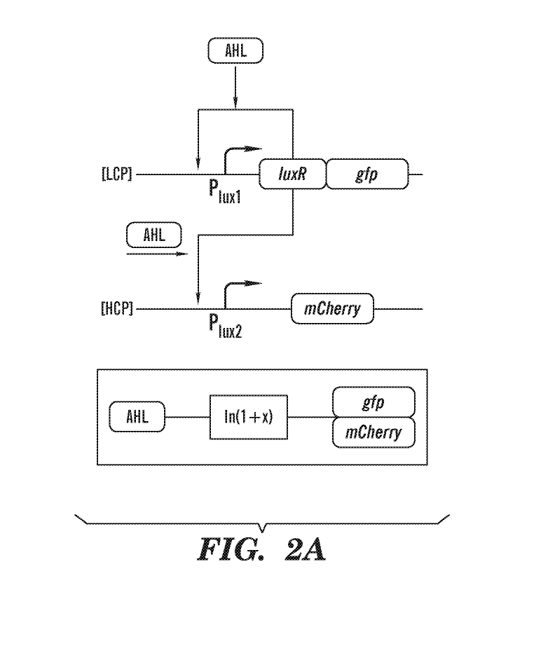

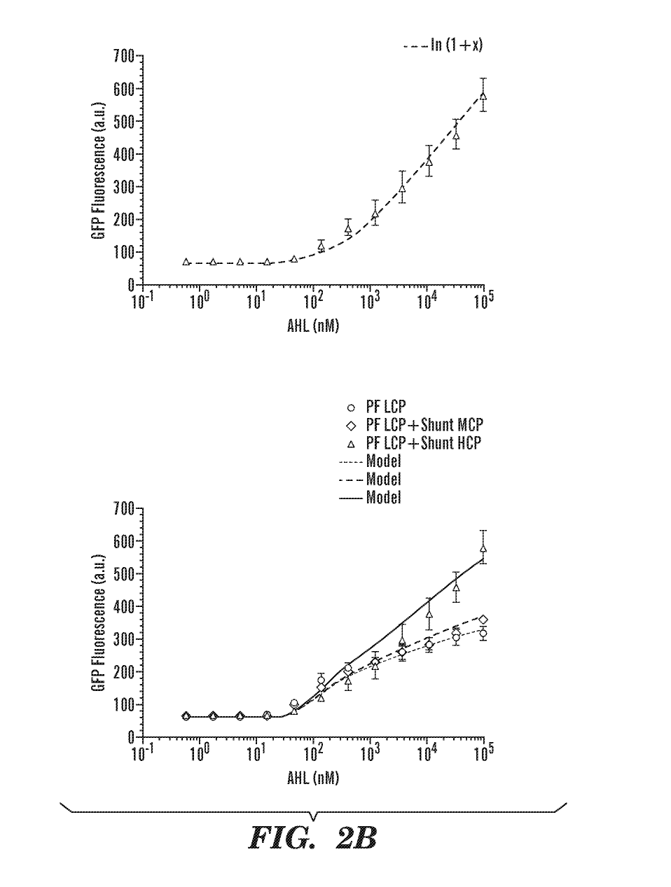

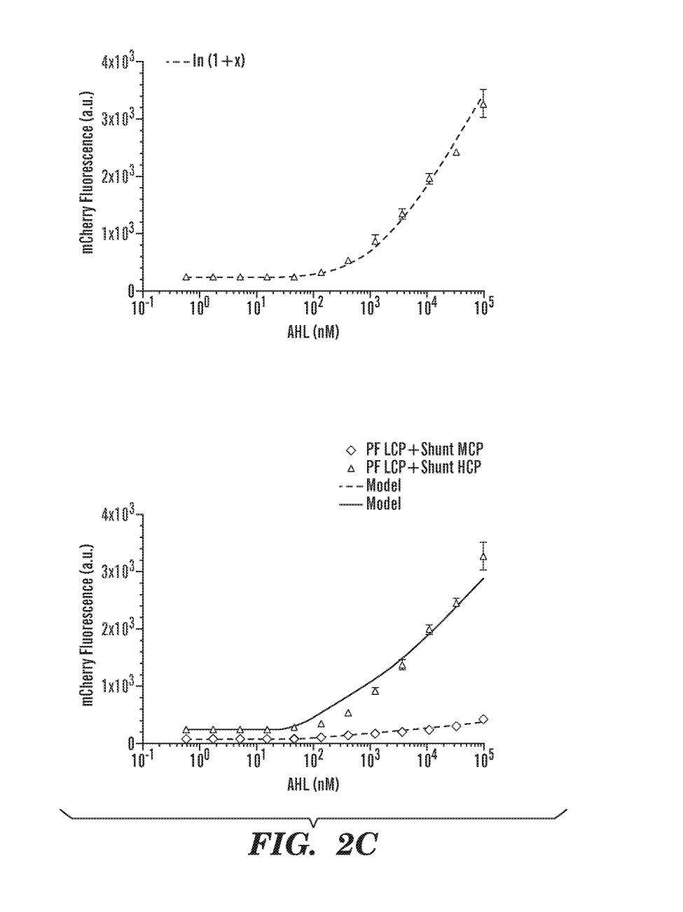

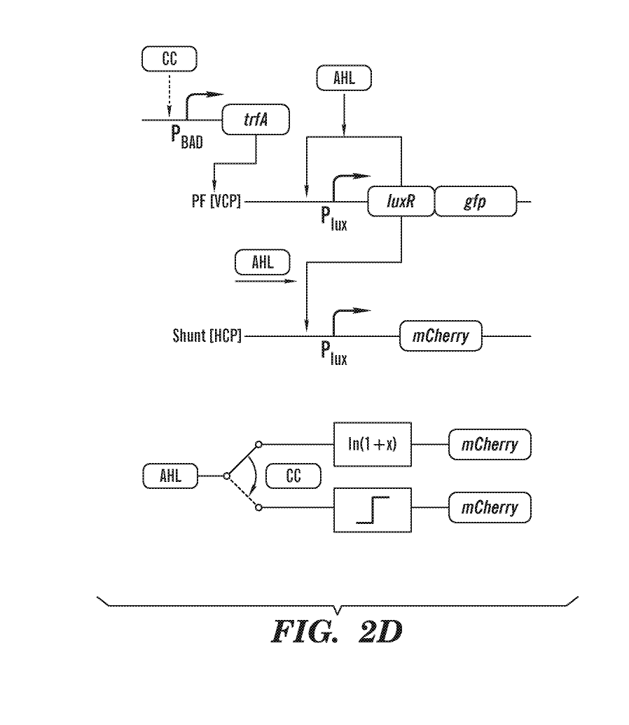

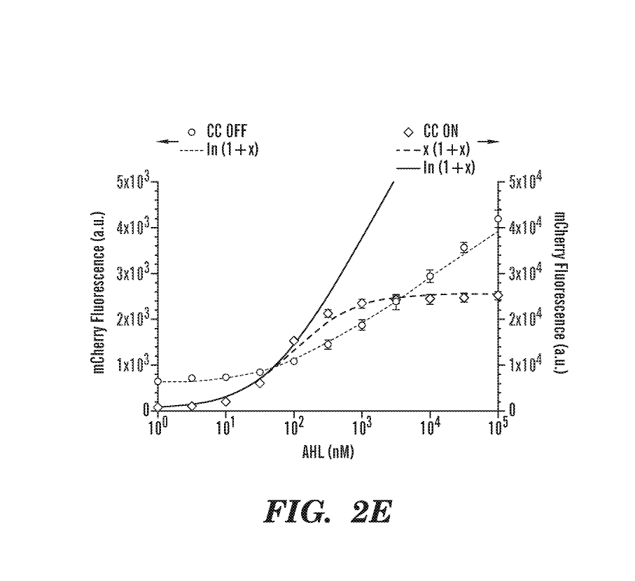

In FIG. 23A, the mCherry signal is fit to ln(1+x) when the copy-control induction, CC, is OFF (PF is LCP and Shunt is HCP); this model function provides a good fit over the entire input range. In FIG. 23B, Dotted line: the mCherry signal is fit to the Hill function x/(1+x) when CC is ON (PF is HCP and the Shunt is HCP); this model function provides a good fit over the entire input range. Dashed line: the mCherry signal is fit to ln(1+x) when CC is ON (PF is HCP and the Shunt is HCP); this model function provides a good fit over only a limited range of low AHL concentrations. This data appears in FIG. 2E and is reproduced here for clarity.

In FIG. 24A, the mCherry output signal is fit to ln(1+x). In FIG. 24B, the P_{lacO} output signal is fit by −ln(1+x). In FIG. 24C, the mCherry signal, which represents the output of a cascade of two stages is fit by Eq. 60. In FIG. 24D, the mCherry signal is fit to a log-linear negative slope. FIG. 24E shows a wide-dynamic-range negative-logarithm circuit that does not require an inducer (IPTG) for tuning Lad expression. FIG. 24F shows experimental data showing the AHL-to-mCherry transfer function for the circuit of FIG. 24E. The dashed line is a fit to the −ln(1+x) function.

FIG. 25 shows Matlab surface fits to adder circuit data.

FIG. 26 shows Matlab surface fits to ratiometer circuit data.

FIG. 27 shows that the IPTG-to-mCherry transfer function is a mathematical power law function.

FIGS. 28A-28C show mixed-signal control and log-linear functions constructed with synthetic gene circuits. FIG. 28A shows hybrid promoters, such as P_{lacO/ara}, that enable digital toggling of analog input-output transfer functions, such as the WDR logarithm. FIG. 28B shows that when IPTG is low (0 mM), the arabinose-to-mCherry transfer function is correspondingly OFF. When IPTG is high (0.7 mM), the transfer function implements a positive-logarithm transformation on arabinose as an input that spans almost three orders of magnitude. AHL was held constant at 5 μM. The dashed line is the fit of the ln(1+x) function. FIG. 28C shows that when AraC is OFF (arabinose=0 mM), the AHL-to-mCherry transfer function is correspondingly OFF. When AraC is ON (arabinose=66 mM), the transfer function implements a negative-logarithm transformation on AHL as an input that spans almost three orders of magnitude. The dashed line is the fit of the −ln(x) function.

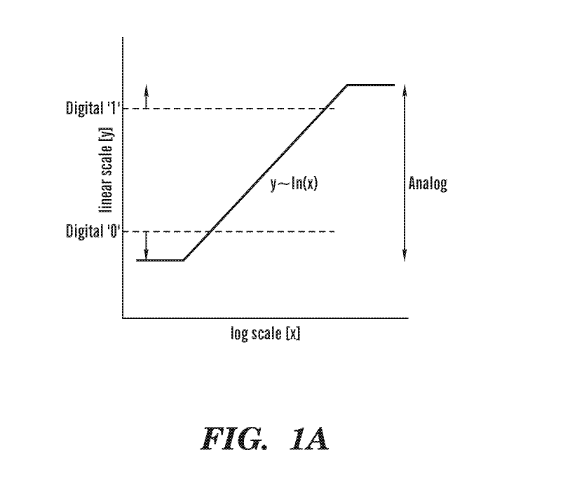

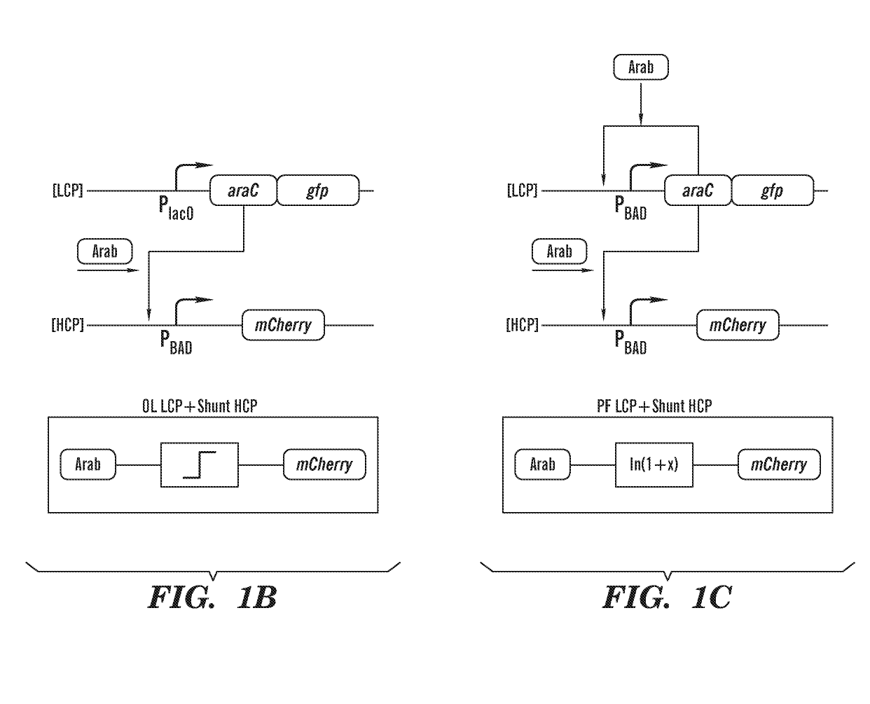

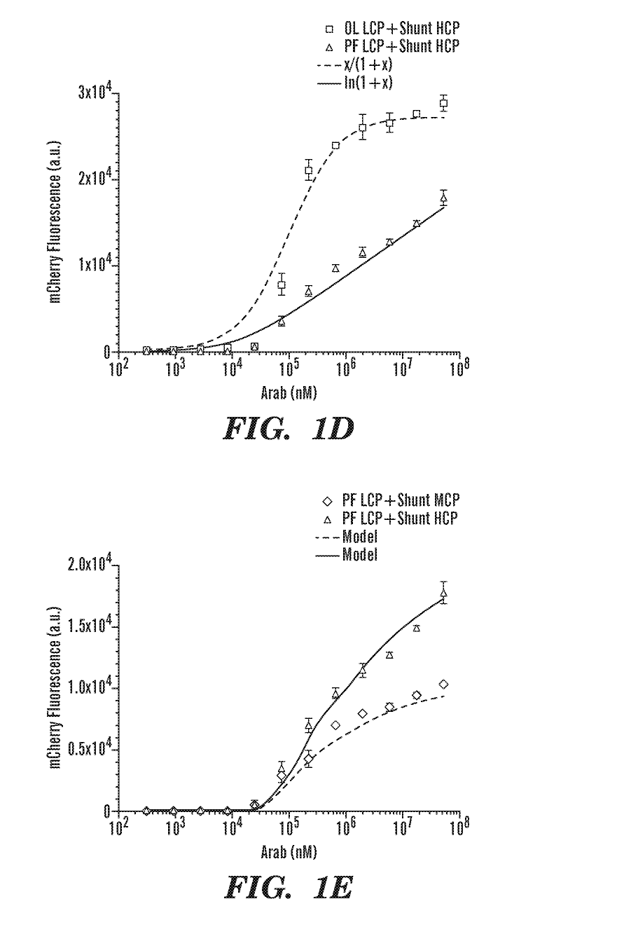

FIGS. 29A-29B show a wide-dynamic-range PF-shunt circuit with two tandem promoters on the HCP. In FIG. 29A, the circuit includes a single P_{BAD} promoter on the LCP and two P_{BAD} promoters on the shunt HCP. FIG. 29B shows experimental measurements from the double-promoter PF-shunt circuit (squares) are contrasted with those from an equivalent PF-shunt circuit with a single promoter on the HCP (triangles). The fits correspond to in (1+x) functions. The data for the PF LCP+Shunt HCP (black triangles) are reproduced from FIG. 1D for comparison.

FIG. 30 shows time-course experiments (5 hours, 7.5 hours, and 10 hours) of the LuxR-based PF-shunt circuit. The dotted line corresponds to a ln(1+x) function.

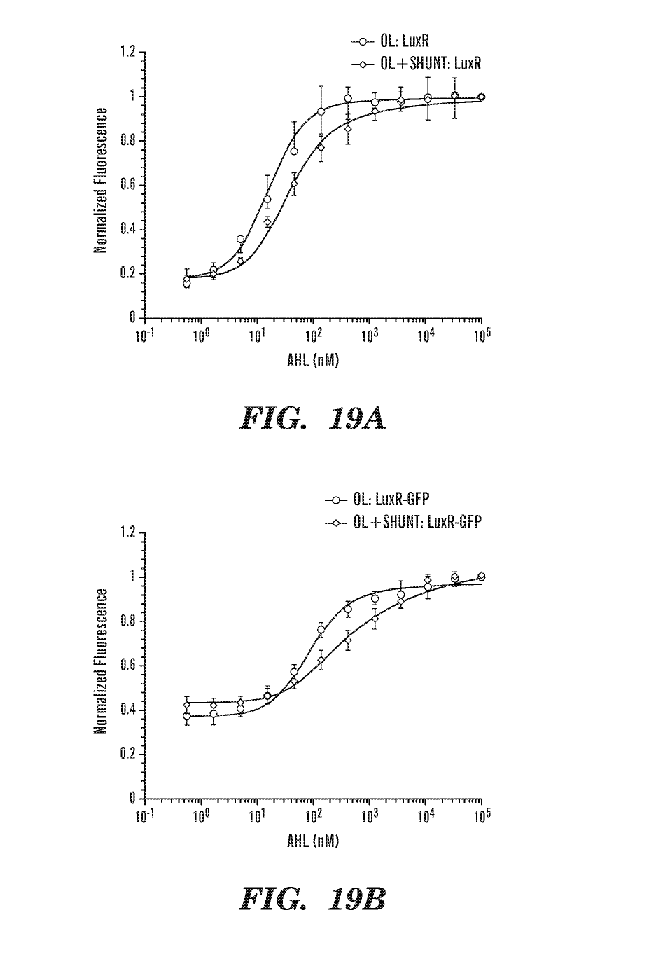

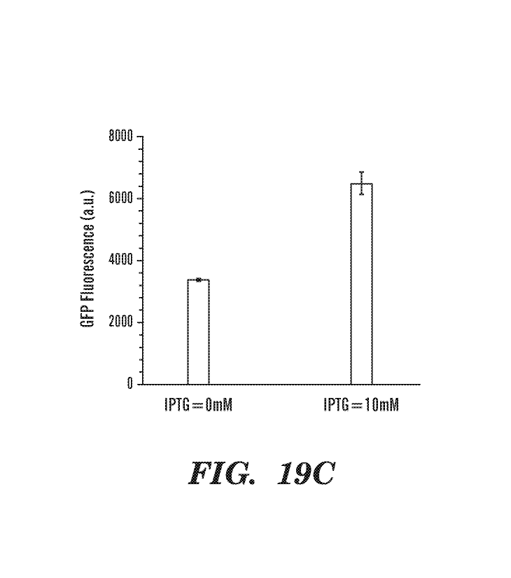

FIGS. 31A-31E show sensitivity values for various circuit motifs. FIG. 31A shows sensitivities for arabinose-to-GFP transfer functions for PF LCP versus PF LCP with a HCP shunt. FIG. 31B shows sensitivities forarabinose-to-mCherry transfer functions for OL LCP with a HCP shunt (FIG. 1D), PF LCP with a HCP shunt (FIG. 1D), and PF LCP with a double promoter HCP shunt (FIGS. 29A-29B). FIG. 31C shows sensitivities for AHL-to-GFP transfer functions for PF LCP and PF with a HCP shunt (FIG. 2B). FIG. 31D shows sensitivities for AHL-to-mCherry transfer functions for the PF VCP with a HCP shunt and CC OFF (FIG. 2E), PF VCP with a HCP shunt and CC ON (FIG. 2E), and PF LCP with a HCP shunt (FIG. 2B). FIG. 31E shows sensitivities for AHL-to-mCherry transfer functions for LuxR-GFP expressed in an open-loop fashion with a HCP shunt (OL+Shunt: LuxR-GFP, FIG. 19B) and PF LCP with a HCP shunt (FIG. 2B).

FIG. 32 depicts definition of Input Dynamic Range (IDR=I_{n90%}/I_{n10%}) and Output Dynamic Range (ODR=0.8·α).

FIGS. 33A-33B show tradeoffs between sensitivity and IDR as a function of the basal level and the maximum output of analog transfer functions.

FIGS. 34A-34G demonstrate simulation results for the input dynamic range (IDR) of the minimal model of our positive-feedback circuit without and with a shunt plasmid. FIG. 34A shows graded positive feedback without a shunt (Eqs. 79.1-79.4). FIG. 34A shows graded positive feedback with a shunt (Eqs. 80.1-80.7). FIG. 34C shows IDR obtained for Eqs. 79.1-79.4 as a function of K_{d} for the transcription-factor-promoter binding. FIG. 34D shows IDR obtained for Eqs. 80.1-80.7 as a function of the ratio between the shunt HCP and the PF LCP. FIG. 34E shows a heat map that shows IDR as a function of K_{d} and the ratio between the copy numbers of the shunt HCP and the PF LCP. FIG. 34F shows a heat map of the PF signal. FIG. 34G shows a heat map of the shunt HCP signal. (Parameters: Kₘ=100, K_{d0}=540, Aₘₐₓ=1800 e.g., the ratio between the maximum production rate in Eqs. 79.3, 80.4, and 80.5 and the degradation rate in Eqs. 79.4, 80.6, and 80.7, A_{Basal}=10 e.g., the ratio between the basal production rate and the degradation rate).

FIG. 35 shows GFP flow cytometry data for a population of cells containing the LuxR-GFP-based positive-feedback circuit on a LCP under the control of the Plux promoter (FIG. 2A).

FIGS. 36A-36B show flow cytometry data for a population of cells containing the wide-dynamic-range positive-slope circuit with the Pₗᵤₓ promoter driving expression of LuxR-GFP from a LCP and a different Pₗᵤₓ promoter driving expression of mCherry from a MCP shunt (FIG. 2A). FIG. 36A shows GFP fluorescence. FIG. 36B shows mCherry fluorescence.

FIGS. 37A-36B show flow cytometry data for a population of cells containing the wide-dynamic-range positive-slope circuit with the Pₗᵤₓ promoter driving expression of LuxR-GFP from a LCP and a different Pₗᵤₓ promoter driving expression of mCherry from a HCP shunt (FIG. 2A). FIG. 37A shows GFP fluorescence. FIG. 37B shows mCherry fluorescence.

FIG. 38 shows GFP flow cytometry data for a population of cells containing the AraC-GFP-based positive-feedback circuit on a LCP under the control of the PBAD promoter (FIG. 1B).

FIGS. 39A-39B show flow cytometry data for a population of cells containing the wide-dynamic-range positive-slope circuit with the PBAD promoter driving expression of AraC-GFP from a LCP and a different PBAD promoter driving expression of mCherry from a MCP shunt (FIG. 1B). FIG. 39A shows GFP fluorescence. FIG. 39B shows mCherry fluorescence.

FIGS. 40A-40B show flow cytometry data for a population of cells containing the wide-dynamic-range positive-slope circuit with the P_{BAD} promoter driving expression of AraC-GFP from a LCP and a different P_{BAD} promoter driving expression of mCherry from a HCP shunt (FIG. 1B). FIG. 40A shows GFP fluorescence. FIG. 40B shows mCherry fluorescence.

FIGS. 41A-41B show mCherry flow cytometry data for a population of cells containing the variable plasmid-copy-number system enabling the dynamic switching of transfer functions between analog and digital behaviors. The LuxR-GFP-based positive-feedback circuit is on a VCP and the shunt HCP contains a Pₗᵤₓ promoter (FIG. 2D). FIG. 41A shows no CC (CopyControl). FIG. 41B shows 1×CC.

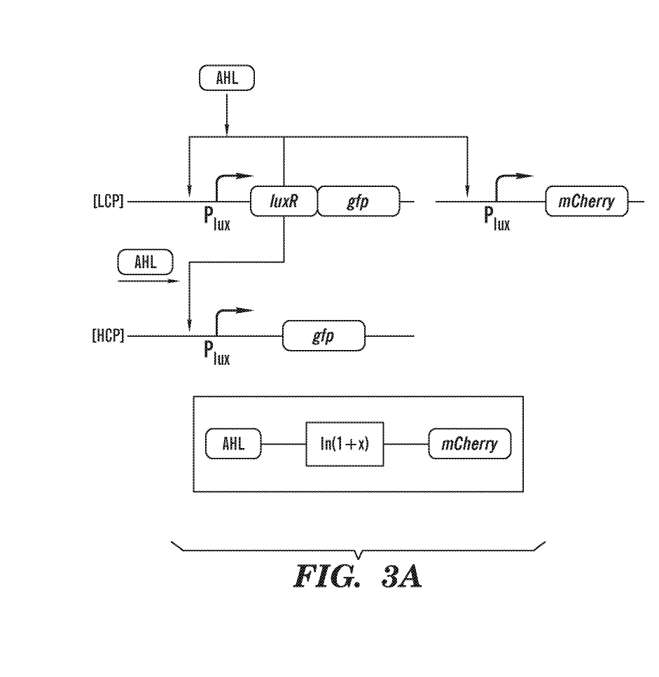

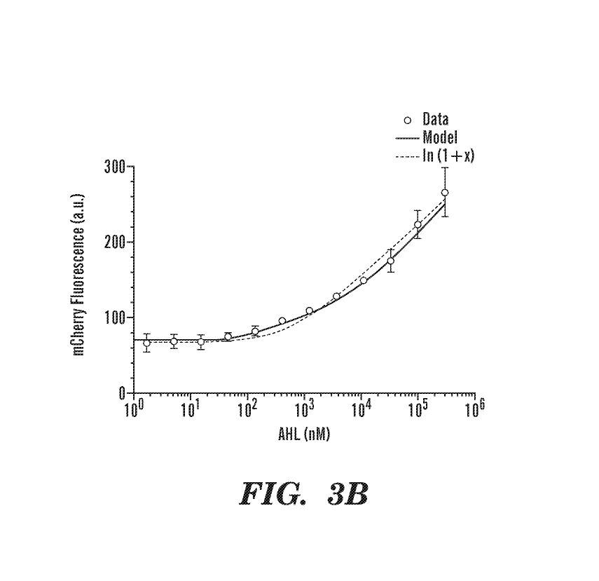

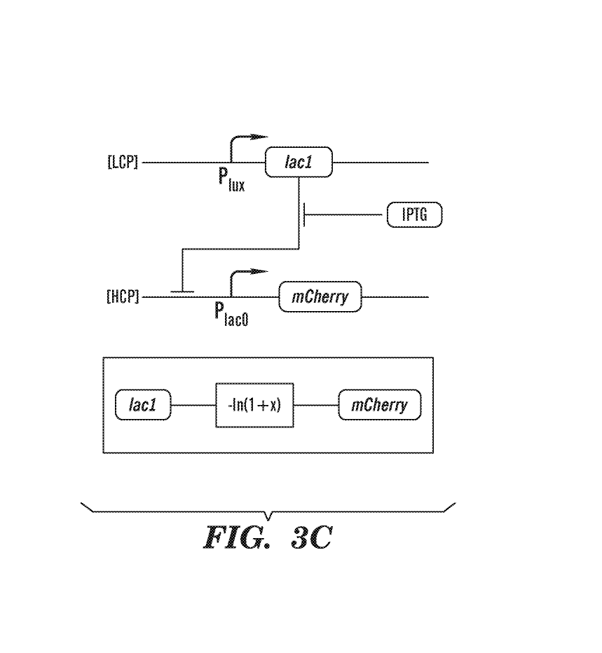

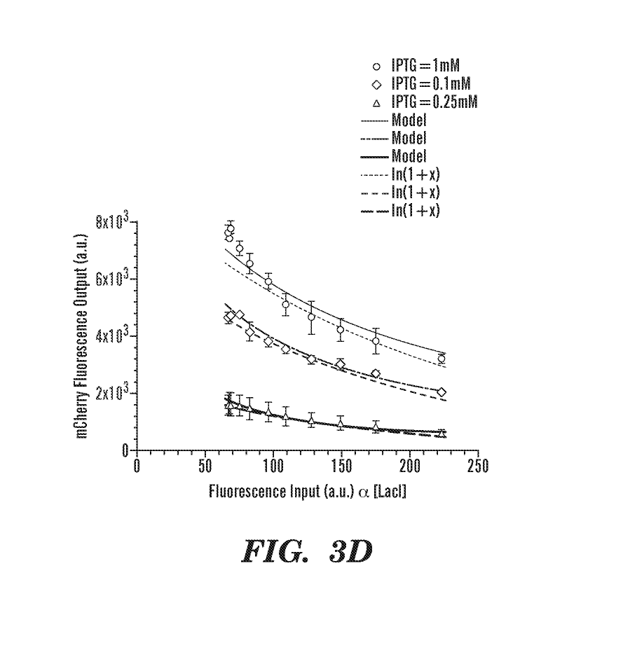

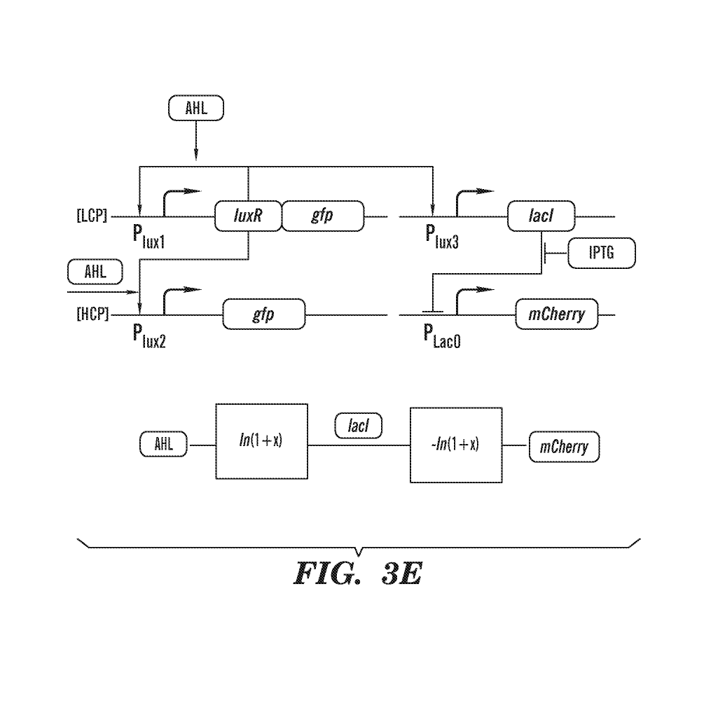

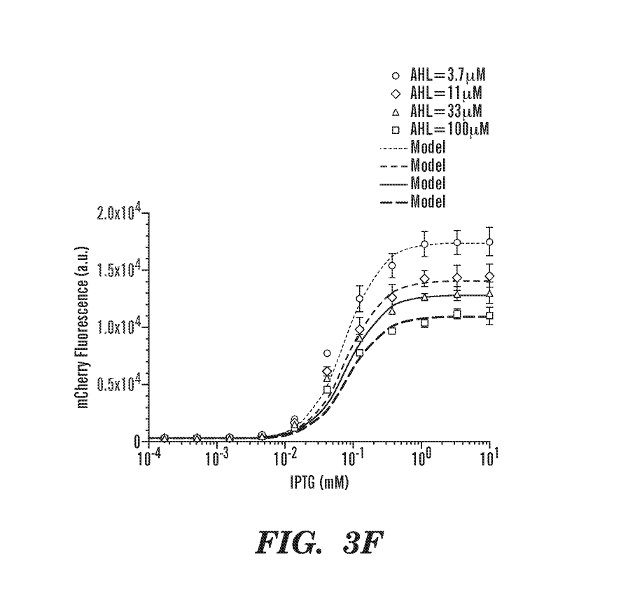

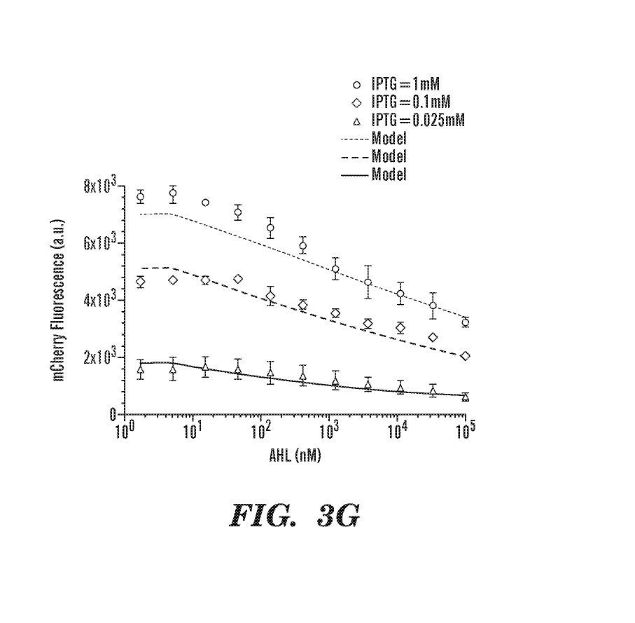

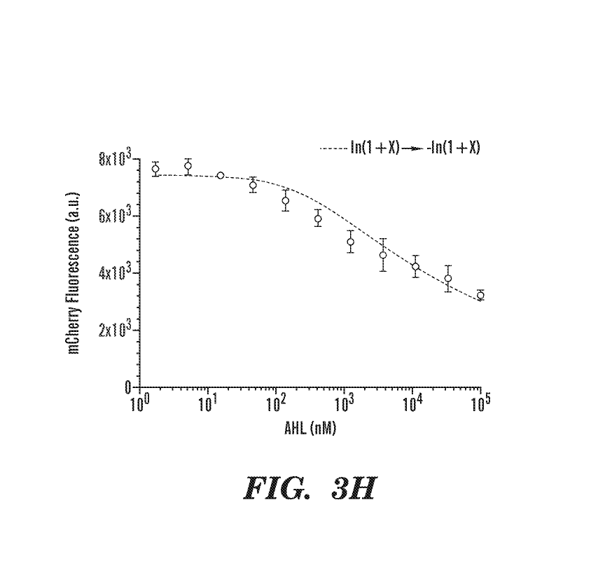

FIG. 42 shows mCherry flow cytometry data for a population of cells containing the wide-dynamic-range positive-slope circuit with the two Pₗᵤₓ promoters driving expression of LuxR-GFP and mCherry from a LCP and a different Pₗᵤₓ promoter driving expression of GFP from a HCP shunt (FIG. 3A).

FIGS. 43A-43B show mCherry flow cytometry data for a population of cells containing the P_{lacO} promoter driving expression of mCherry in the wide-dynamic-range negative-slope circuit (FIG. 3E). FIG. 43A shows AHL=100 μM. FIG. 43B shows AHL=3.4 μM.

FIG. 44 shows mCherry flow cytometry data for a population of cells containing the P_{lacO} promoter driving expression of mCherry in the wide-dynamic-range negative-slope circuit (FIG. 3E), where IPTG=1 mM.

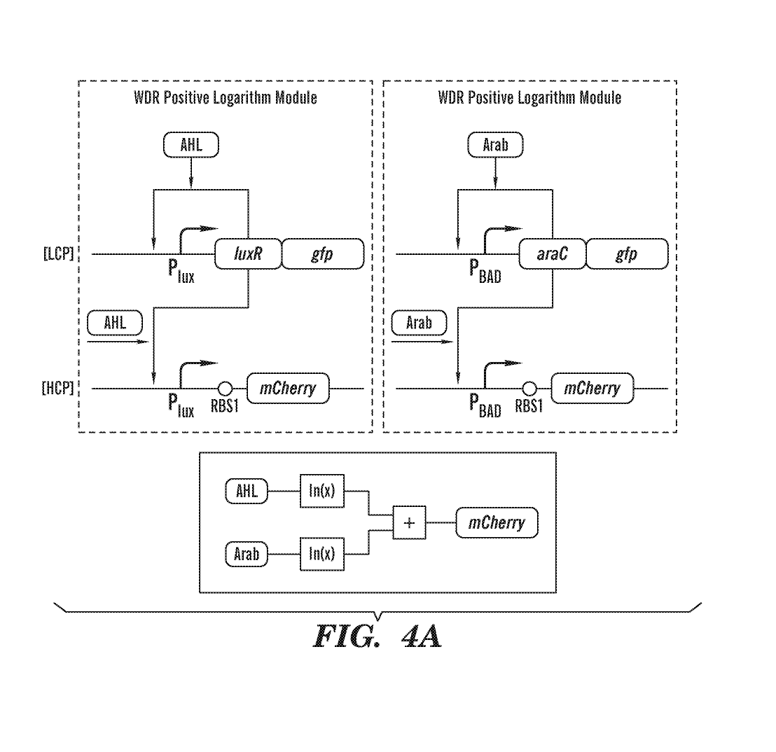

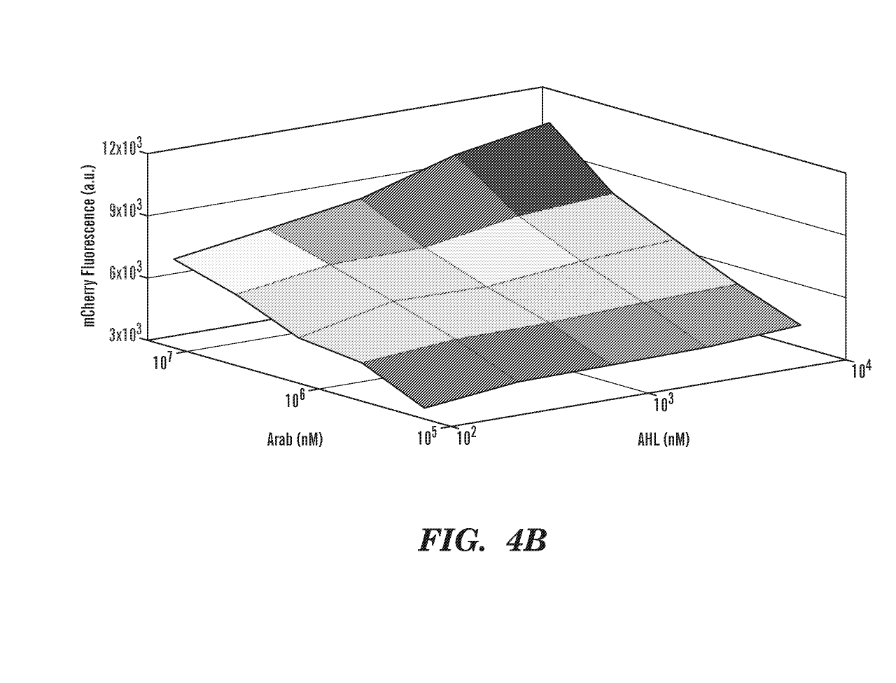

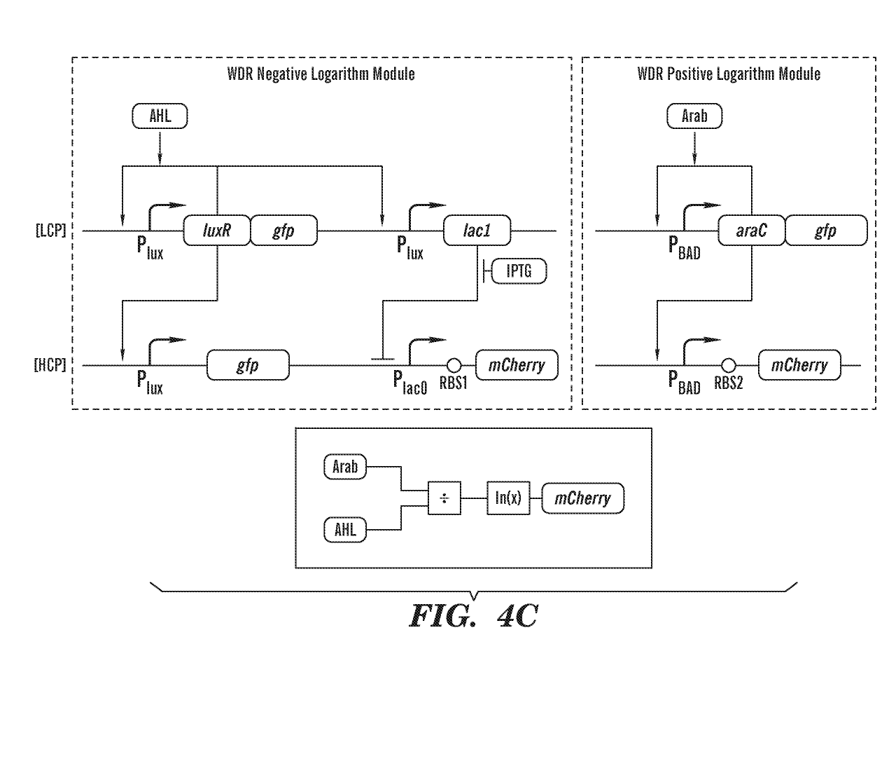

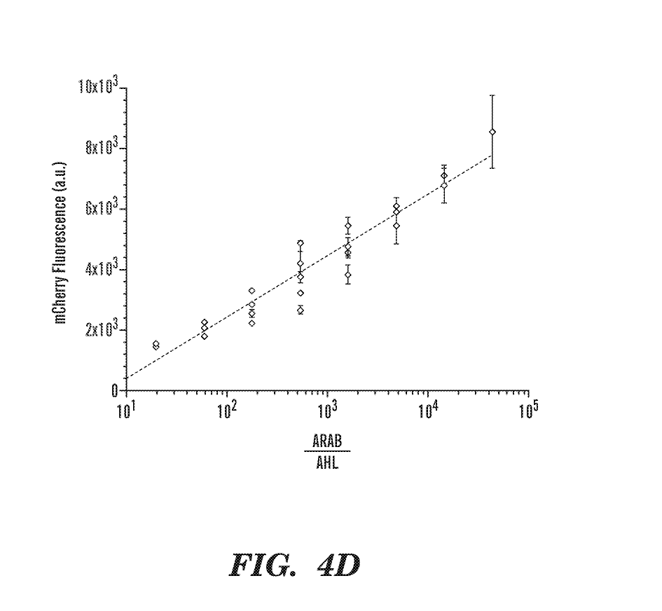

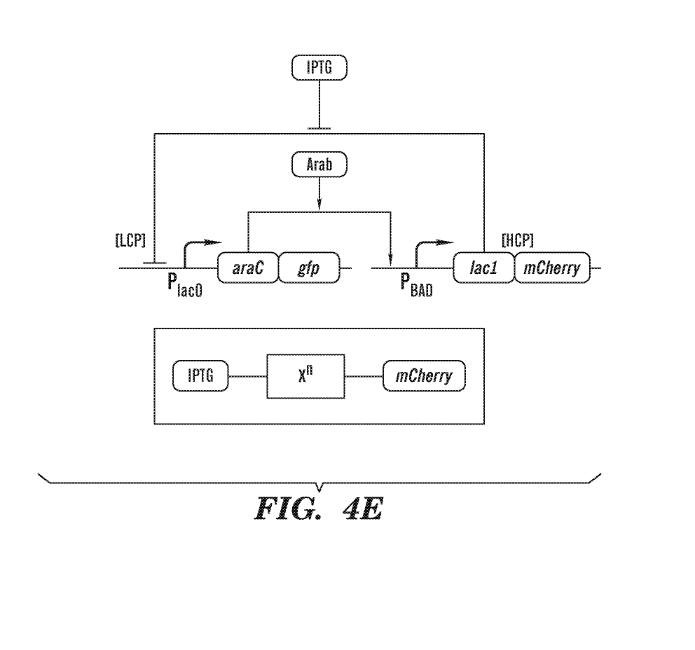

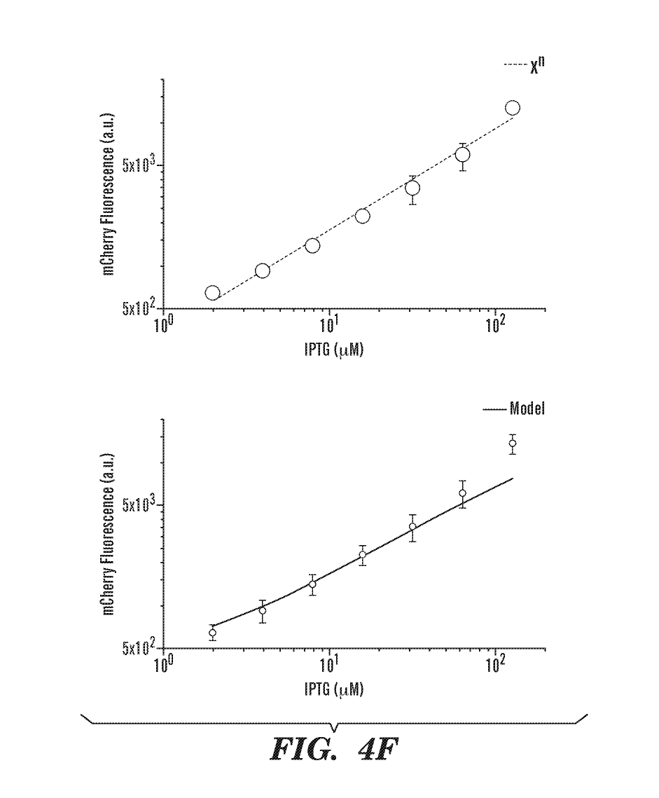

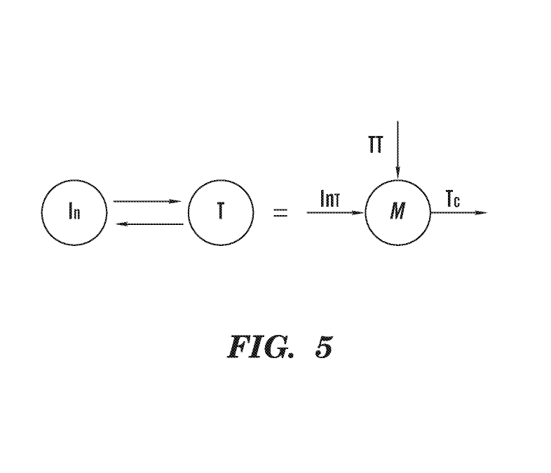

FIGS. 45A-45B show mCherry flow cytometry data for a population cells containing the adder circuit (FIG. 4A). FIG. 45A shows AHL was held constant at 10 μM and arabinose was varied. FIG. 45A shows arabinose was held constant at 17.7 mM and AHL was varied.

FIGS. 46A-46B show mCherry flow cytometry data for a population of cells containing the divider (i.e., ratiometer) circuit (FIG. 4C). FIG. 46A shows IPTG was held constant at 1 mM, AHL was held constant at 33 μM, and arabinose was varied. FIG. 46B shows IPTG was held constant at 1 mM, arabinose was held constant at 0.66 mM, and AHL was varied.

FIG. 47 shows mCherry flow cytometry data for populations of cells containing power-law circuits (FIG. 4E). Arabinose was held constant at 4.6 μM and IPTG was varied. This circuit contains pRD43 (LCP) and pRD114 (HCP).

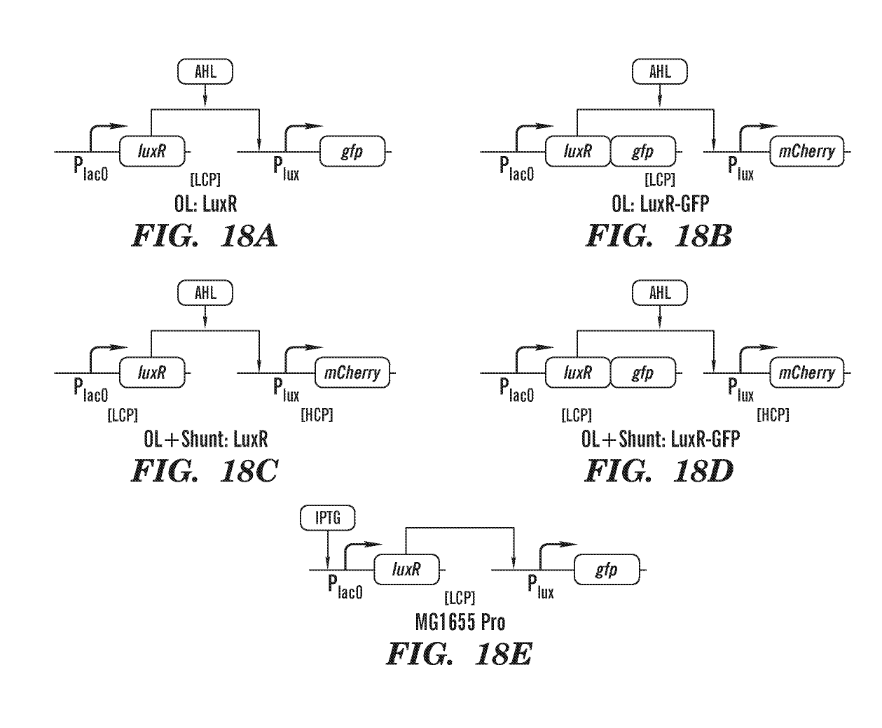

FIG. 48 shows GFP flow cytometry data for a population of cells expressing GFP under the control of the Pₗᵤₓ promoter on a LCP (FIG. 18A, OL: LuxR). The transcription factor LuxR is under the control of the P_{lacO} promoter and is expressed from the same LCP as GFP.

FIG. 49 shows mCherry flow cytometry data for a population of cells expressing mCherry under the control of the Pₗᵤₓ promoter on a HCP shunt (FIG. 18B, OL+Shunt: LuxR). The transcription factor LuxR is under the control of the P_{lacO} promoter and is expressed from a separate LCP.

FIG. 50 shows mCherry flow cytometry data for a population of cells expressing mCherry under the control of the Pₗᵤₓ promoter on a LCP (FIG. 18C, OL: LuxR-GFP). The transcription factor LuxR is fused to GFP, is under the control of the P_{lacO} promoter, and is expressed from the same LCP as mCherry.

FIG. 51 shows mCherry flow cytometry data for a population of cells expressing mCherry under the control of the Pₗᵤₓ promoter on a HCP shunt (FIG. 18D, OL+Shunt: LuxR-GFP). The transcription factor LuxR is fused to GFP, is under the control of the P_{lacO} promoter, and is expressed from a separate LCP.

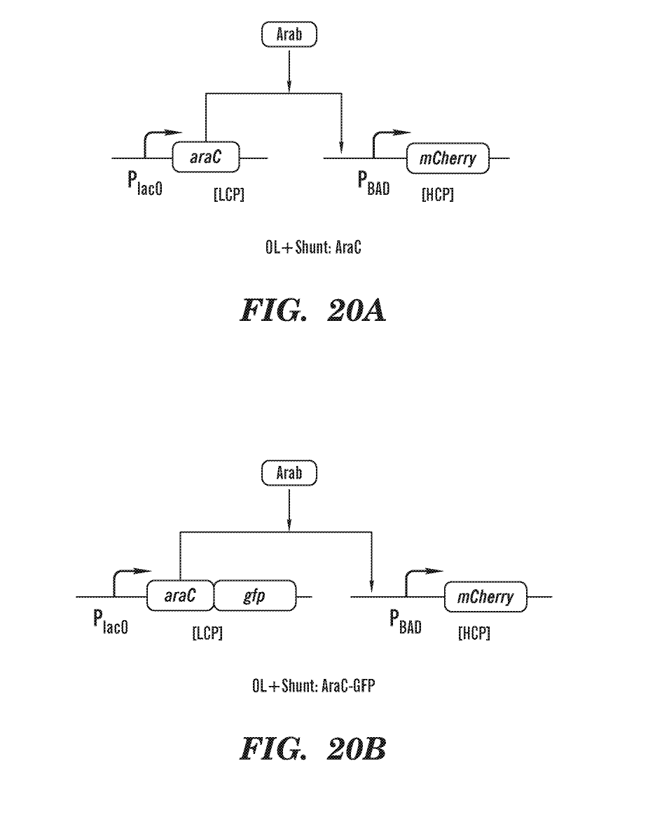

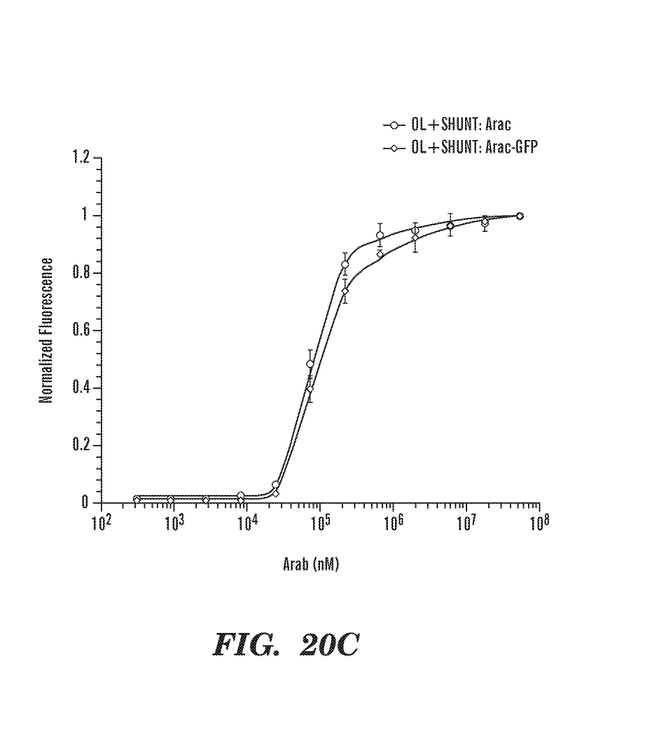

FIG. 52 shows mCherry flow cytometry data for a population of cells expressing mCherry under the control of the P_{BAD} promoter on a HCP shunt (FIG. 20A, OL+Shunt: AraC). The transcription factor AraC is under the control of the P_{lacO} promoter, and is expressed from a separate LCP.

FIG. 53 shows mCherry flow cytometry data for a population of cells expressing mCherry under the control of the P_{BAD} promoter on a HCP shunt (FIG. 1C, FIG. 20B, OL+Shunt: AraC-GFP). The transcription factor AraC is fused to GFP, is under the control of the P_{lacO} promoter, and is expressed from a separate LCP.

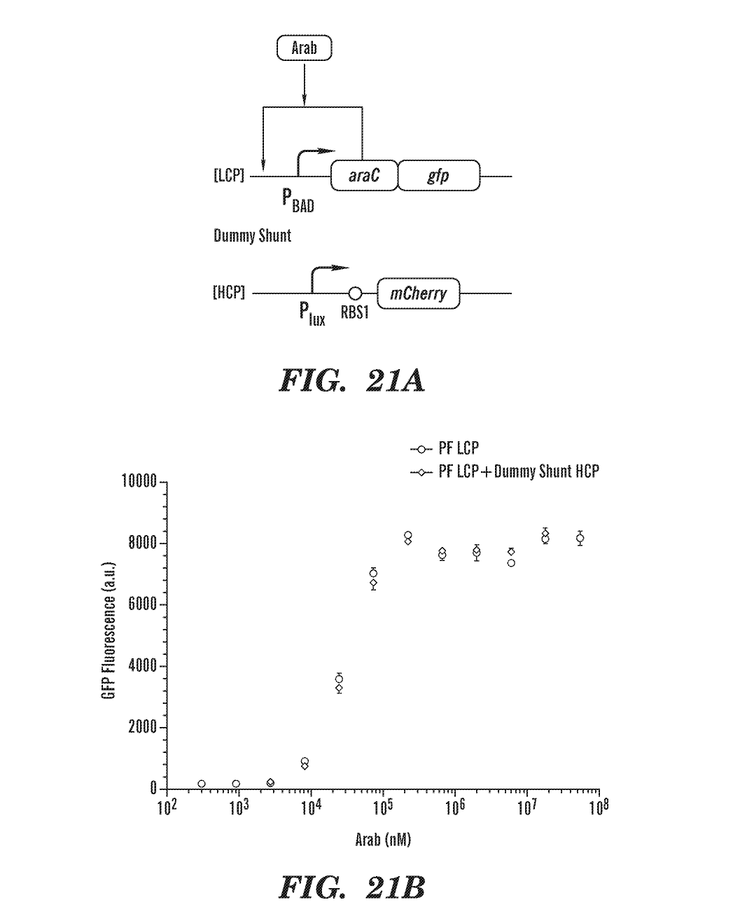

FIG. 54 shows GFP flow cytometry data for a population of cells containing the AraC-GFP-based positive feedback circuit on a LCP and a dummy shunt HCP containing the Pₗᵤₓ promoter (FIG. 21A).

FIGS. 55A-55B show mCherry flow cytometry data for a population of cells containing the positive-logarithm circuit that can be digitally toggled by leveraging the hybrid promoter P_{lacO/ara} as an output (FIG. 28). In FIG. 55A, AHL was held constant at 5 μM, IPTG was held at 0 mM, and arabinose was varied. In FIG. 55B, AHL was held constant at 5 μM, IPTG was held at 0.7 mM, and arabinose was varied.

FIG. 56 shows mCherry flow cytometry data for a population of cells containing the wide-dynamic-range positive-slope circuit with the P_{BAD} promoter driving expression of AraC-GFP from a LCP and a double P_{BAD} promoter driving expression of mCherry from a HCP shunt (FIG. 29A).

FIG. 57 shows a pRD43 plasmid map of 5209 base pairs.

FIG. 58 shows a pRD58 plasmid map of 2875 base pairs.

FIG. 59 shows a pRD89 plasmid map of 4493 base pairs.

FIG. 60 shows a pRD114 plasmid map of 4189 base pairs.

FIG. 61 shows a pRD123 plasmid map of 5339 base pairs.

FIG. 62 shows a pRD131 plasmid map of 3106 base pairs.

FIG. 63 shows a pRD152 plasmid map of 4982 base pairs.

FIG. 64 shows a pRD171 plasmid map of 4366 base pairs.

FIG. 65 shows a pRD215 plasmid map of 2872 base pairs.

FIG. 66 shows a pRD238 plasmid map of 4068 base pairs.

FIG. 67 shows a pRD258 plasmid map of 7056 base pairs.

FIG. 68 shows a pRD276 plasmid map of 3103 base pairs.

FIG. 69 shows a pRD289 plasmid map of 8432 base pairs.

FIG. 70 shows a pRD293 plasmid map of 3798 base pairs.

FIG. 71 shows a pRD302 plasmid map of 5252 base pairs.

FIG. 72 shows a pRD316 plasmid map of 4178 base pairs.

FIG. 73 shows a pRD318 plasmid map of 2864 base pairs.

FIG. 74 shows a pRD328 plasmid map of 4969 base pairs.

FIG. 75 shows a pRD331 plasmid map of 5084 base pairs.

FIG. 76 shows a pRD357 plasmid map of 3089 base pairs.

FIG. 77 shows a pRD362 plasmid map of 4966 base pairs.

FIG. 78 shows a pRD392 plasmid map of 4186 base pairs.

FIG. 79 shows a pRD397 plasmid map of 5929 base pairs.

FIG. 80 shows a pRD408 plasmid map of 5378 base pairs.

FIG. 81 shows a pJR378 plasmid map of 8418 base pairs.

FIG. 82 shows a pJR570 plasmid map of 5997 base pairs.

FIG. 83 shows a pRD10 plasmid map of 3392 base pairs.

FIG. 84 reveals a general positive or negative feedback architecture for analog computation with molecules.

FIG. 85 reveals an embodiment that illustrates how strong positive-feedback causes quickly saturating operation while weaker positive feedback causes analog (more linear) operation. Mutations in promoter sequences at association control regions (quickly saturating operation) or at attenuation decoy regions (analog operation) serve to change the strength of the positive feedback loop operation by changing an association or attenuation weight in blocks of the positive feedback loop.

### DETAILED DESCRIPTION

A central goal of synthetic biology is to achieve multi-signal integration and processing in living cells for diagnostic, therapeutic, and biotechnology applications. Digital logic has been used to build small-scale circuits but other paradigms are needed for efficient computation in resource-limited cellular environments. We demonstrate herein that synthetic gene circuits can be engineered to encode sophisticated computational functions in living cells, using, for example, just three transcription factors. We demonstrate herein that such synthetic analog gene circuits can exploit feedback to implement logarithmically linear sensing, addition, ratiometric, and power-law computations. The circuits described herein can exhibit Weber's Law behavior as in natural biological systems, operate over a wide dynamic range of up to four orders of magnitude, and can be architected to have tunable transfer functions. The circuits described herein can be composed together to implement higher-order functions that are well-described by both intricate biochemical models and by simple mathematical functions. By exploiting analog building-block functions that are already naturally present in cells, the paradigms and circuit structures described herein efficiently implement arithmetic operations and complex functions in the logarithmic domain. Such circuits open up new applications for synthetic biology and biotechnology that require complex computations with limited parts, which need wide-dynamic-range bio-sensing, and/or that benefit from fine control of gene expression.

In natural biological systems, digital behavior is appropriate for settings where decision making is necessary, such as in developmental circuits (1). The digital paradigm is an abstraction of graded analog functions where values above a threshold are classified as ‘1’ and values below this threshold as ‘0’ (FIG. 1A). Digital computation in living cells using synthetic gene circuits has included switches (2-4), counters (5), logic gates (6-11), classifiers (12, 13), and edge detectors (14). However, given low numbers of orthogonal synthetic devices and cellular resource limitations (15, 16), it can be challenging to scale digital logic for complex computations in living cells. Analog functions can be found in natural biological systems, where they enable graded and complex responses to environmental signals (17, 18). For example, neurons can implement both digital and analog computation (19). Furthermore, electronic circuits which perform analog computation on logarithmically transformed signals have been used in commercially valuable electronic chips for several decades. The thermodynamic Boltzmann exponential equations that describe electron flow in electronic transistors and the thermodynamic Boltzmann exponential equations that describe molecular flux in chemical reactions have strikingly detailed similarity (20). These similarities indicate that log-domain analog computation in electronics can be mapped to log-domain analog computation in chemistry and vice versa (20). Since analog computation exploits powerful biochemical mathematical basis functions that are naturally present (FIG. 1A), they are an advantageous alternative to digital logic when resources of device count, space, time, or energy are constrained (16,21).

As demonstrated herein, analog synthetic circuit motifs were created that perform positive wide-dynamic-range logarithmic transformations of inducer concentration inputs to fluorescent protein outputs (FIG. 1B). The resulting transfer functions thus exhibit a region of linearity on a semi-log plot (log-linear). Logarithmic functions permit intensity-independent responses and can compress a large input dynamic range into a smaller, manageable output dynamic range. A logarithmic function naturally implements Weber's Law behavior, which states that the ratio between the perceptual change in a signal divided by its background level is a constant, resulting in the detection of fold-changes rather than absolute levels (22). Weber's Law is approximately true within molecular signaling networks and the human perception of sound intensity, light intensity, and weight (20).

Provided in the various aspects described herein are molecular circuits and circuit configurations comprising two or more modular functional blocks, each such modular functional block comprising one or more molecular or biological component parts for executing the circuit function, such as positive logarithmic feedback, negative logarithmic feedback, power law functions, division function, addition function, subtraction function etc. As understood by one of ordinary skill in the art, the various modular blocks described herein in the various molecular/biological circuit configurations are governed and defined by their functional properties, but need not be physically distinct or physically separate in all embodiments. For example, two or more such modular blocks can be incorporated in one physical structure or component, such as a plasmid or vector; a single given modular block can be incorporated in more than one physical structure or component, such as multiple plasmids or vectors; or a single physical structure or component can comprise two or more modular functional blocks, as described herein. For example, a high copy-number plasmid is a physical structure or component part that can comprise two or more modular functional blocks, or part of two or more functional blocks, as described herein.

In some embodiments, the molecular circuits described herein incorporate the effects of biochemical interactions, such as the binding of inducer molecules to transcription factors, the binding of transcription factors to promoters, the degradation of free and bound transcription factors to DNA, the effective variation of transcription-factor diffusion-limited binding rates inside the cell with variation in plasmid copy number, microRNA binding to microRNA target sequences, etc. and the integration of all these effects. As used herein, transcription factors are called “free transcription factors” if they are not interacting with inducers or DNA. When inducers complex with transcription factors, the resulting product is referred to herein as an “inducer-transcription-factor complex.” When free transcription factors bind to DNA, it is referred to herein as “bound transcription factors.” When inducer-transcription factor complexes bind to DNA, it is referred to herein as “bound inducer-transcription-factor complex.”

Accordingly, provided herein, in some aspects, are graded or analog feedback molecular circuits comprising two or more modular functional blocks configured for performing positive wide-dynamic range logarithmic transduction of molecular inputs or configured for performing computations with input molecular species to generate output molecular species, wherein the molecular/biological circuit is implementable or executable in a cell, cellular system, or in vitro system comprising molecular or biological machinery or components, such as transcriptional or translational machinery or components.

In some embodiments of these aspects and all such aspects described herein, the two or more modular functional blocks comprise an association block, a control block, a transformation block, and a feedback block. These graded molecular circuits can use, for example, transcriptional and translational regulation mechanisms via component parts to implement logarithmic mathematical functions, as described herein.

As used herein, an “association block” or “association module” or “association component” refers to a modular functional component of a biological circuit in which two or more input molecular species associate to create one or more associated output molecular species via a chemical/molecular reaction by the association block. Such molecular species include nucleic acids, such as RNA and DNA; proteins, such as transcription factors, enzymes, and protein hormones; small molecule inducers and small-molecule hormones; or any other molecular species that undergoes chemical reactions as defined by the input-output block combination(s). The “association strength” of the block is a monotonically increasing or monotonically decreasing function of the ability of the two species to associate or bind with each other. It is often represented by the parameter K_{d} (20), with 1/K_{d} signifying a high association strength.

Input and output molecular species in an association block can include nucleic acids, such as RNA and DNA; proteins, such as transcription factors, enzymes, and protein hormones; small molecule inducers or small-molecule hormones; or any other molecular species that undergoes chemical reactions as defined and controlled by the association block. Examples of means to alter association strengths include mutating the binding sequence on a fragment of a DNA molecule such that a transcription-factor molecule associates with the DNA more strongly or weakly (FIG. 85), altering the amino-acid content of the transcription-factor molecule such that it binds the DNA more strongly or weakly, altering the structure of an inducer molecule such that it binds a transcription-factor molecule more strongly or weakly, or altering the RNA content of one or both of two RNA molecules that have an affinity for one another. For example, targeted mutations can be used to alter affinity of RNA molecules to another RNA, DNA or a protein or a protein complex.

As used herein, a molecular input species is transformed to a different molecular output species via a chemical reaction in a “transformation block.” The “transformation strength” of the transformation block is a monotonically increasing function of the ratio of the concentration of the output species with respect to the input species. Examples of means to alter transformation strengths include mutating the sequences of promoter and/or transcription-factor binding strengths to DNA such that the output mRNA to input transcription factor ratio is increased, altering the ribosome binding sequence on the mRNA such that the output protein to input mRNA ratio is increased, or having the output of transcription itself be an RNA polymerase, e.g., the T7 RNA polymerase, such that this polymerase amplifies the gain of transcription through two stages of amplification rather than one.

As used herein, a molecular input species is degraded via a “degradation block” if the action of the degradation block serves to decrease the concentration of the input molecular species by degrading or destroying it in an irreversible fashion. The “degradation strength” of the degradation block is a monotonically increasing function of its ability to decrease the concentration of the species that it degrades. Examples of means to alter the degradation strength include means of tagging protein molecules with recognition sequences such as ‘ssrA tags’ that enable proteases (protein destroying enzymes) to speed their destruction or by altering the terminal sequences of mRNA molecules such that RNAase enzymes speed their destruction.

As used herein, a molecular input species is attenuated via an “attenuation block” if the species is reduced in number by virtue of its binding with another molecular species that sequesters it or that attenuates the species without destroying it irreversibly (FIG. 85). Examples of means to alter the attenuation strength include the use of high-copy plasmids to sequester or shunt away transcription-factor molecules from low-copy plasmids (FIG. 2A or 3A), or the use of decoy binding sites on a plasmid that decoy a transcription factor away from its binding site on DNA that activates transcription (FIG. 85).

As used herein, a molecular species Mᵢₙ is converted to an output molecular species C in an “input block”, “input module”, or “input component” if the input block comprises at least one association block with an association strength that may (or may not) be altered by design.

As used herein, a molecular species C is converted to C′ in a “control block”, “control module”, or “control component” when that block is itself composed of one or more of an association, transformation, attenuation, or degradation block with respective association, transformation, attenuation, and degradation strengths that may (or may not) be altered by design. The control block can also serve to just be an identity function with no net transformation as a special case, i.e., C=C′ and [C]=[C′] such that the identity and concentration of the molecular input and output species are identical, or with the identity being the same (C=C′ as a molecular species) but the concentration of the input and output species differing from one another ([C]≠[C′]).

As used herein, an “output block” or “output module” or “output component” refers to a modular functional component of a biological circuit in which the molecular species C′ generated by the control block is converted to a molecular species termed herein as “Mₒᵤₜ” via a transformation block with a transformation strength that may (or may not) be altered by design. The output block can also serve to just be an identity function with no net transformation as a special case, i.e., Mₒᵤₜ=C′ and [Mₒᵤₜ]=[C′] such that the identity and concentration of the molecular input and output species are identical, or with the identity being the same (Mₒᵤₜ=C′ as a molecular species) but the concentration of the input and output species differing from one another ([Mₒᵤₜ]#[C′]).

As used herein, a “feedback block” or “feedback module” or “feedback component” refers to a modular functional component of a biological circuit that takes one or more output molecular species M, of the circuit as its input and produces at its output one or more molecular species at its output via the composition of one or more of an association, transformation, attenuation, or degradation block with respective association, transformation, attenuation, and degradation strengths that may (or may not) be altered by design. The feedback block can also serve to just be an identity function, in some embodiments, with no net transformation as a special case, i.e., Mₒᵤₜ=Mₒᵤₜ′ and [Mₒᵤₜ]=[Mₒᵤₜ′] such that the identity and concentration of the molecular input and output species of the feedback block are identical or with the same identity but differing concentration (Mₒᵤₜ=Mₒᵤₜ′; [Mₒᵤₜ]≠[Mₒᵤₜ′]).

In some aspects, provided herein are graded positive-feedback molecular circuits, also referred to as a “wide-dynamic-range positive-logarithm circuit” comprising a “positive-feedback (PF) component” located on a low-copy plasmid (LCP) and a “shunt component” located on a high-copy plasmid (HCP).

As demonstrated herein, the positive-feedback (PF) component cascades the successive outputs of an input block, control block, output block, and feedback block in a positive feedback loop (FIG. 84) to achieve wide-dynamic-range logarithmically linear transduction of an input Mᵢₙ molecule as described herein. The signs of the functional derivatives of the blocks in the feedback loop are configured such that small changes in C (or in any other variable in the feedback loop such as C′, Mₒᵤₜ, or Mₒᵤₜ′) propagate around the loop and return as further changes in C that increase the initial change in C, thus creating a positive-feedback loop (20).

The shunt component (shunt) of the molecular circuit provides a means for controlling the attenuation and/or degradation strength of the feedback block and the control block thus affecting the overall strength of the positive feedback to enable optimally wide-dynamic-range graded analog operation. The shunt component binds and sequesters molecules away from the LCP, thus providing control of the attenuation strength of the LCP PF component (for example in FIG. 1C), and, in some embodiments, also protects these molecules from degradation, thus providing control of the degradation strength of the LCP PF component (for example in FIG. 2A). The shunt component also provides a proportional copy of the output of the PF component Mₒᵤₜ so it can be easily measured (both FIGS. 1C and 2A). The input and output strength depicted in FIG. 84 are the association strength of the input block and the transformation strength of the output block respectively.

In some embodiments of the aspects described herein, the PF component on the LCP comprises one or more inducible promoters operably linked to sequences encoding transcription factors (TFs) that bind to these same promoters, i.e., TFs that are “specific for the inducible promoter.” Thus, the TFs generated by the PF component increase their own generation via a positive-feedback loop and alleviate saturation of the inducer-TF interaction. In some embodiments, the one or more inducible promoters of the PF component is/are also operably linked to sequences encoding a protein output, such as a detectable output, for example, a reporter protein.

In some embodiments of the aspects described herein, the shunt component on the HCP is comprised of one or more inducible promoters that are bound by and shunt away the same TFs generated by the LCP, thus reducing saturation of the TF-DNA interaction on the LCP.

In addition, in some embodiments of the aspects described herein, the shunt component on the HCP, also generates a protein output, such as a reporter protein, that is different from the TF output of the LCP (FIG. 1B or FIG. 1C, for example). As such, the one or more inducible promoters of the shunt component, that bind or shunt away the TFs generated by PF component, is/are operably linked to sequences encoding a protein output, such as a detectable output, for example, a reporter protein, in some embodiments.

In addition, in some embodiments, the feedback loop can comprise any other molecular species acting on another molecular species, such as any other protein acting on a promoter, or other genetic regulatory element, a microRNA (miRNA) or any other RNA species acting on an RNA-based genetic regulatory element, or a microRNA (miRNA) or any other RNA species bound to a protein acting on a promoter, or other genetic regulatory element.

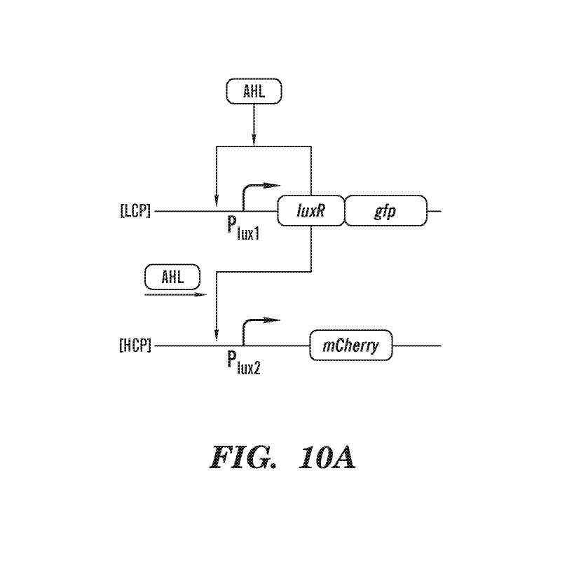

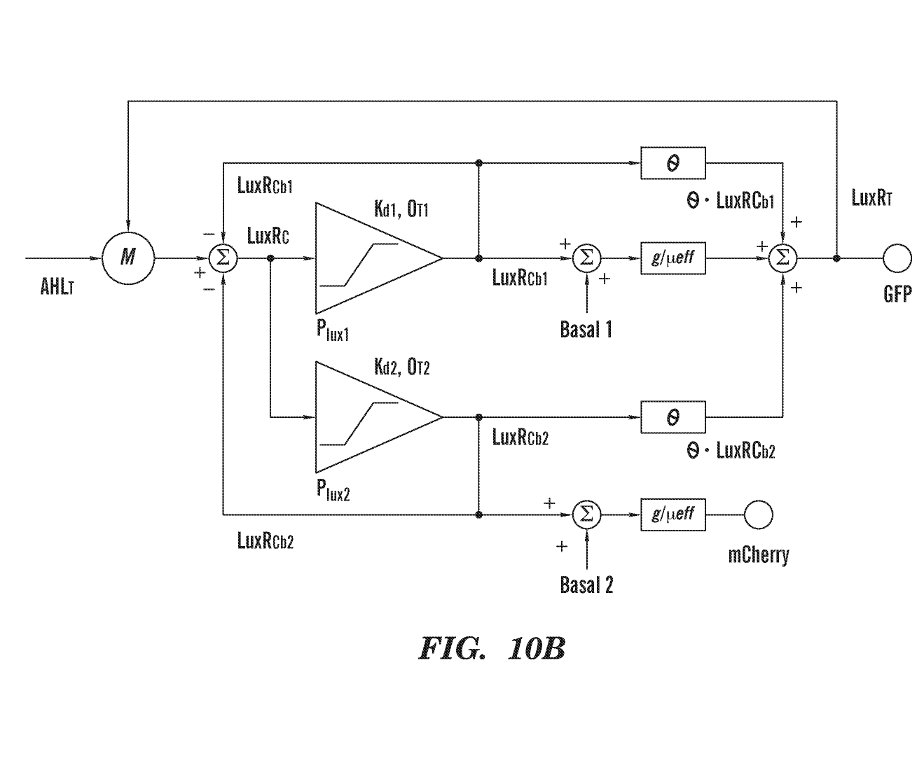

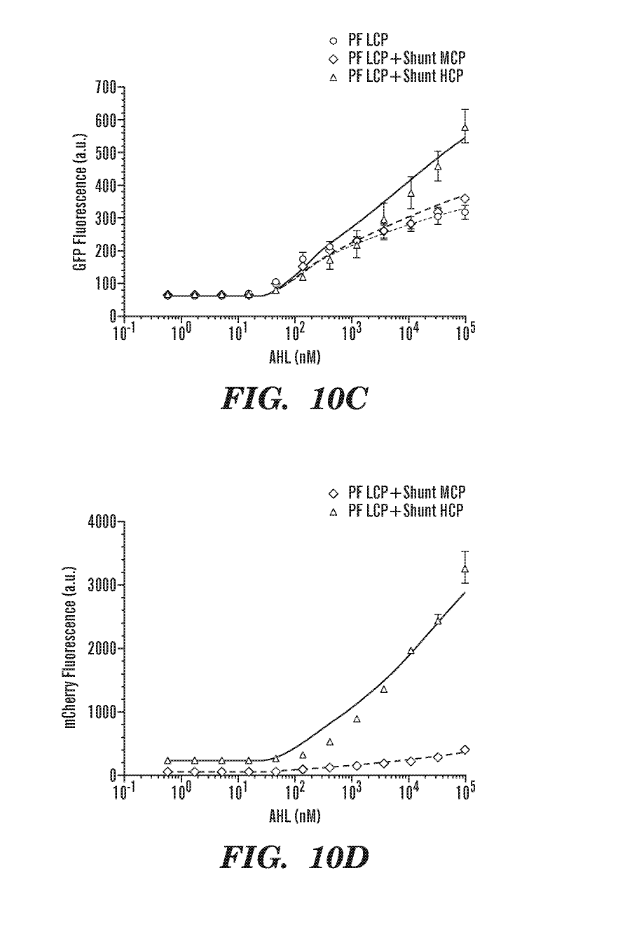

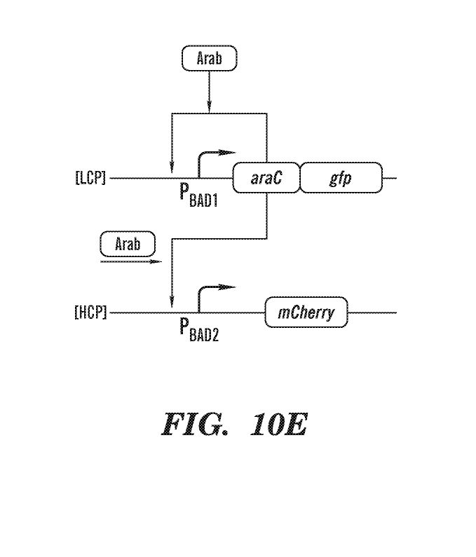

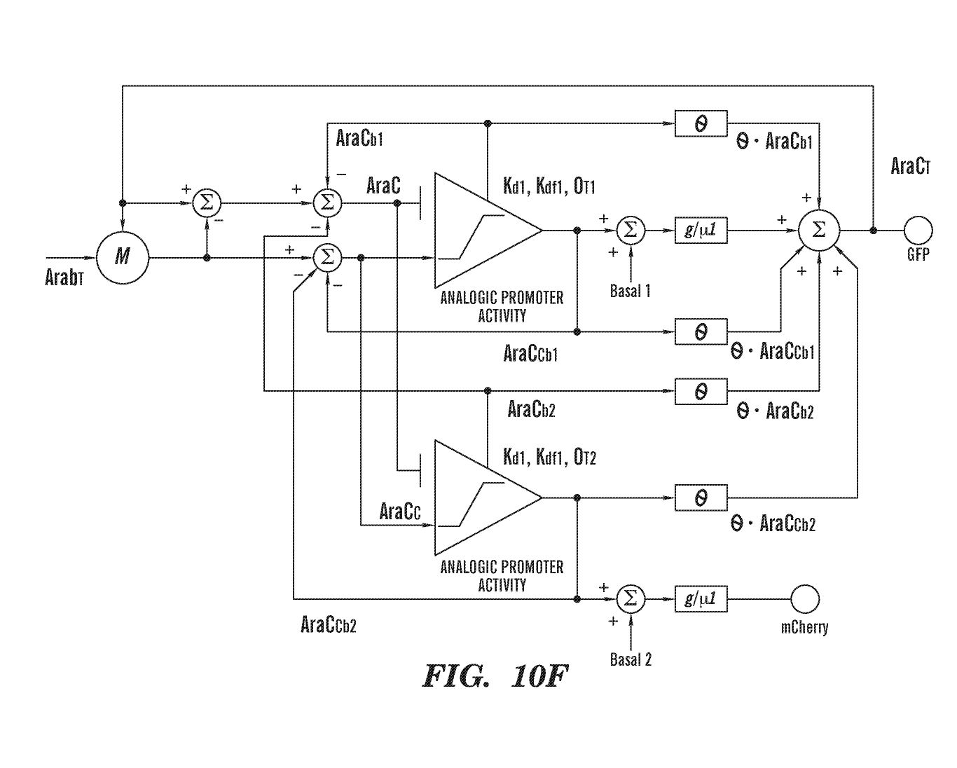

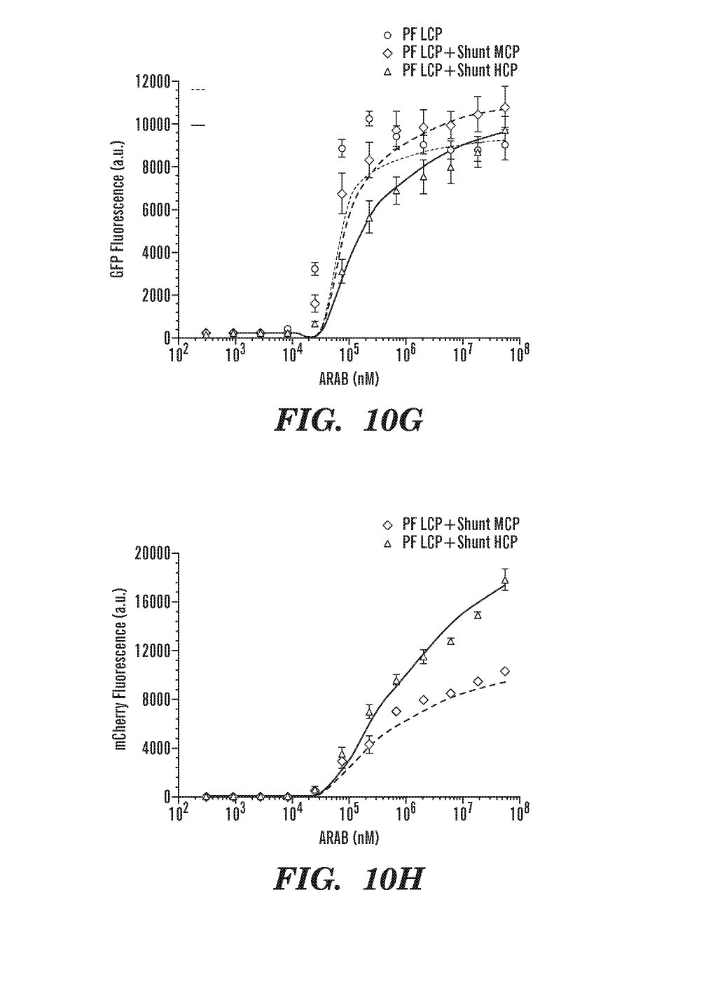

Accordingly, as demonstrated herein, in some exemplary embodiments of these aspects (FIG. 1C), a graded positive-feedback molecular circuit uses “Mᵢₙ=Arabinose” as the molecular input species bound to “Mₒᵤₜ′=AraC” in the input association block, “C=AraC_{c}” as the output molecular species produced by the input association block, “C′=AraC_{cb}” bound to DNA, i.e., the P_{BAD} promoter as the control block output, and “Mₒᵤₜ=AraC” as the transformation output of the DNA promoter. The shunt component also comprises a P_{BAD} promoter operably linked to a sequence encoding an output product, such as a reporter protein, e.g., mCherry. In such embodiments, Mₒᵤₜ=Mₒᵤₜ′=AraC in terms of molecular species, but not in terms of concentration due to the attenuation and/or degradation strength modulation of the shunt component (see, for example, FIG. 1C and FIGS. 10A-10H). Other similarly functioning biological components can be used instead of arabinose, P_{BAD} promoter, and mCherry which were used to illustrate that the components work as an analog circuit.

In some embodiments of the graded positive-feedback molecular circuits described herein, where a configuration involving a “positive-feedback (PF) component” located on a low-copy plasmid (LCP) and a “shunt component” located on a high-copy plasmid (HCP) is used, the attenuation and degradation strength of the control block and/or the feedback block of the circuits is determined by the relative copy numbers or ratio of the number of high-copy plasmids versus the low-copy plasmids. For example, the ratio of the number of high-copy plasmids versus the low-copy plasmids is at least 2:1, at least 3:1, at least 4:1, at least 5:1, at least 6:1, at least 7:1, at least 8:1, at least 9:1, at least 10:1, at least 11:1, at least 12:1, at least 13:1, at least 14:1, at least 15:1, at least 16:1, at least 17:1, at least 18:1, at least 19:1, at least 20:1, at least 25:1, at least 30:1, at least 40:1, at least 50:1, at least 60:1, at least 70:1, at least 80:1, at least 90:1, at least 100:1, or more, or any ratio in between, e.g., 27:5 and the like. For the embodiments described herein in the examples ratios of 63:1, as determined by modeling and experiments, were found to provide optimally wide-dynamic-range operation both other embodiments with other transcription factors will have different values.

In some embodiments of the graded positive-feedback molecular circuits described herein, where a configuration involving a “positive-feedback (PF) component” located on a low-copy plasmid (LCP) and a “shunt component” located on a high-copy plasmid (HCP) is used, the transformation strength of the circuits is determined by the K_{d} of the molecular binding of Mₒᵤₜ′ to the input component, for example, the binding of AraC to P_{BAD} in the control block of the exemplary circuit described above. In addition, the degradation strength can be set by dilution and protein degradation of the molecular species C′, such as dilution and protein degradation of AraC_{cb} in the control block of the exemplary circuit described above. Similarly, the attenuation strength of the feedback blocks of the circuits can be determined by dilution and protein degradation of the molecular species Mₒᵤₜ or Mₒᵤₜ′, for example, AraC or AraC_{c} in the feedback block of the exemplary circuit described above

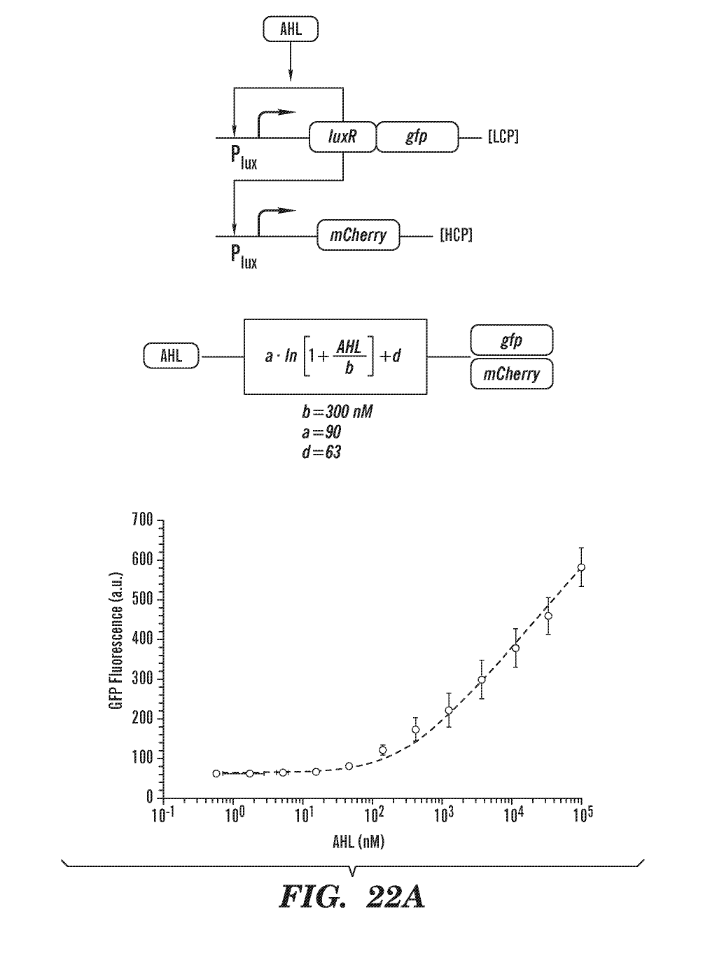

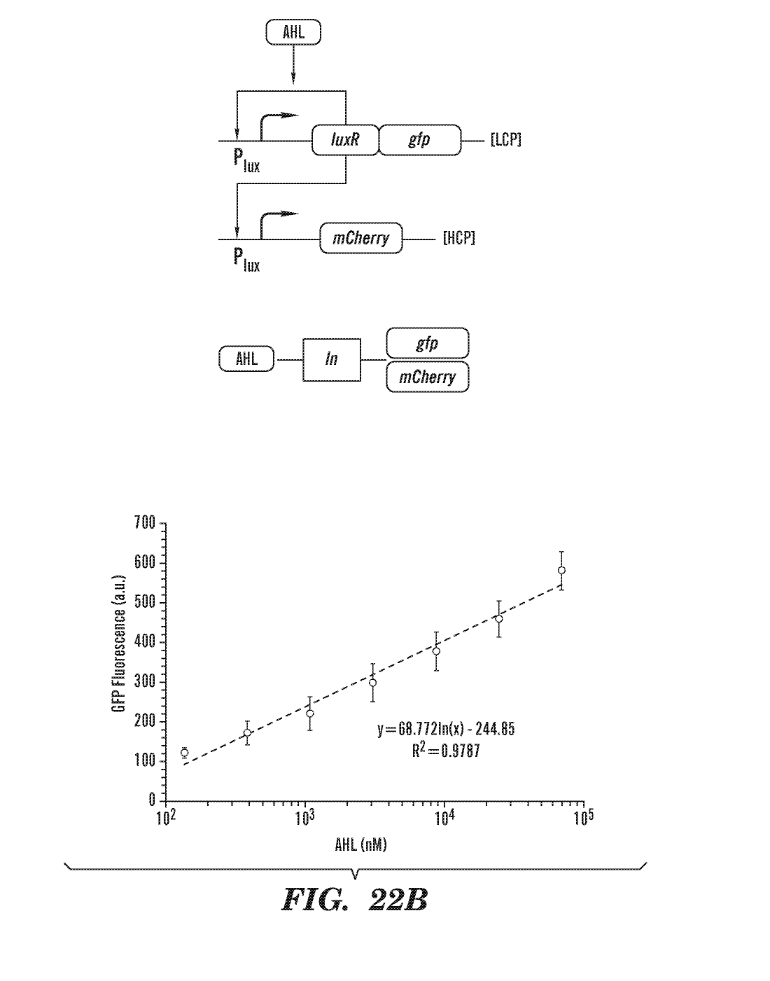

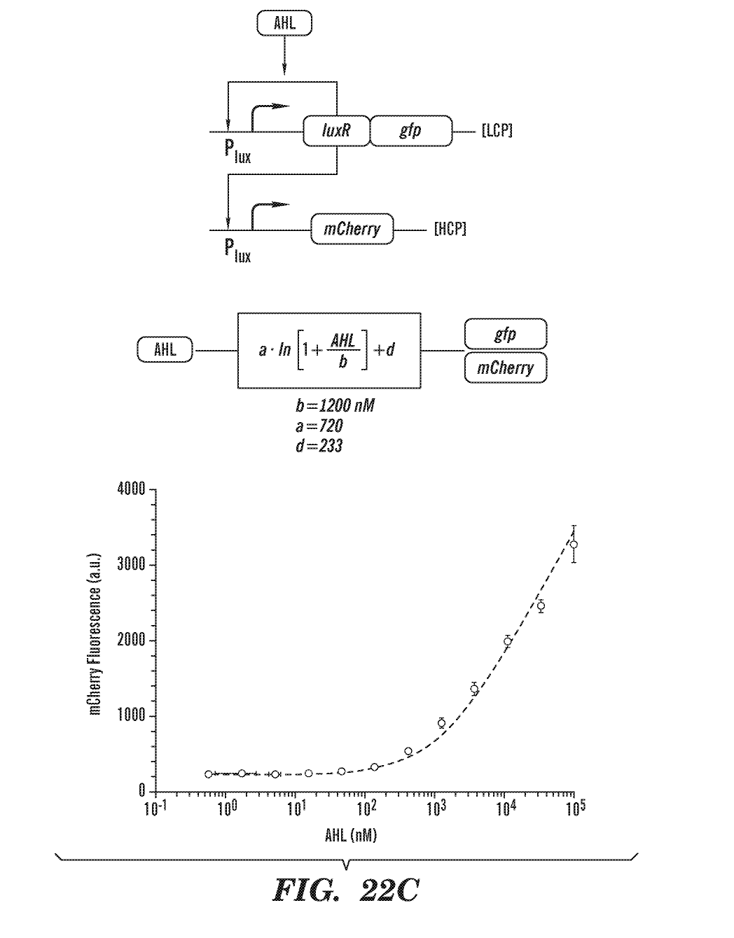

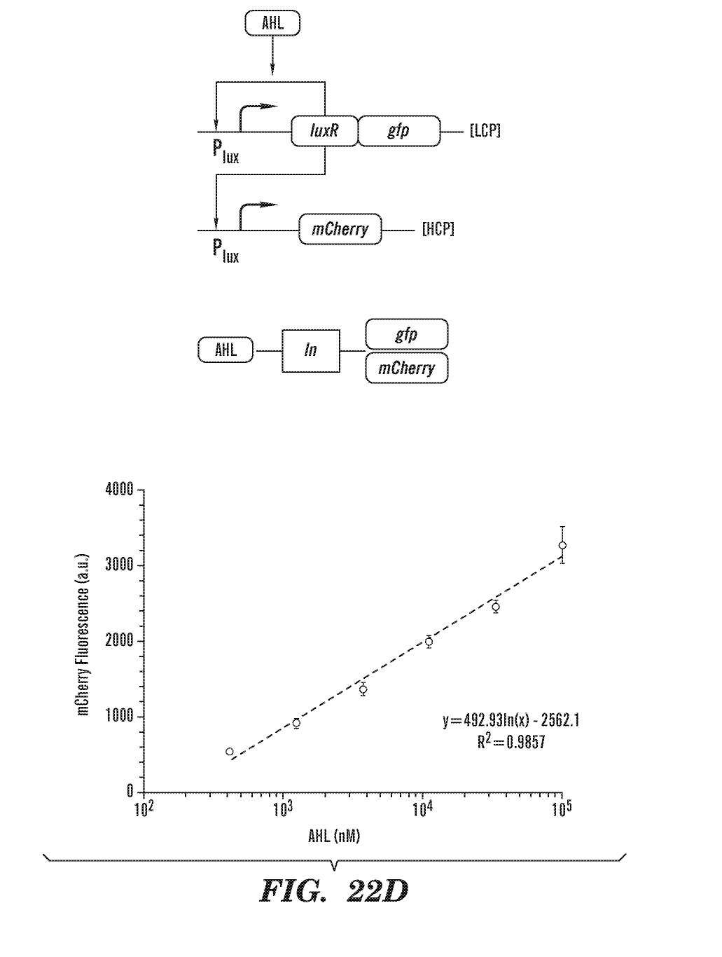

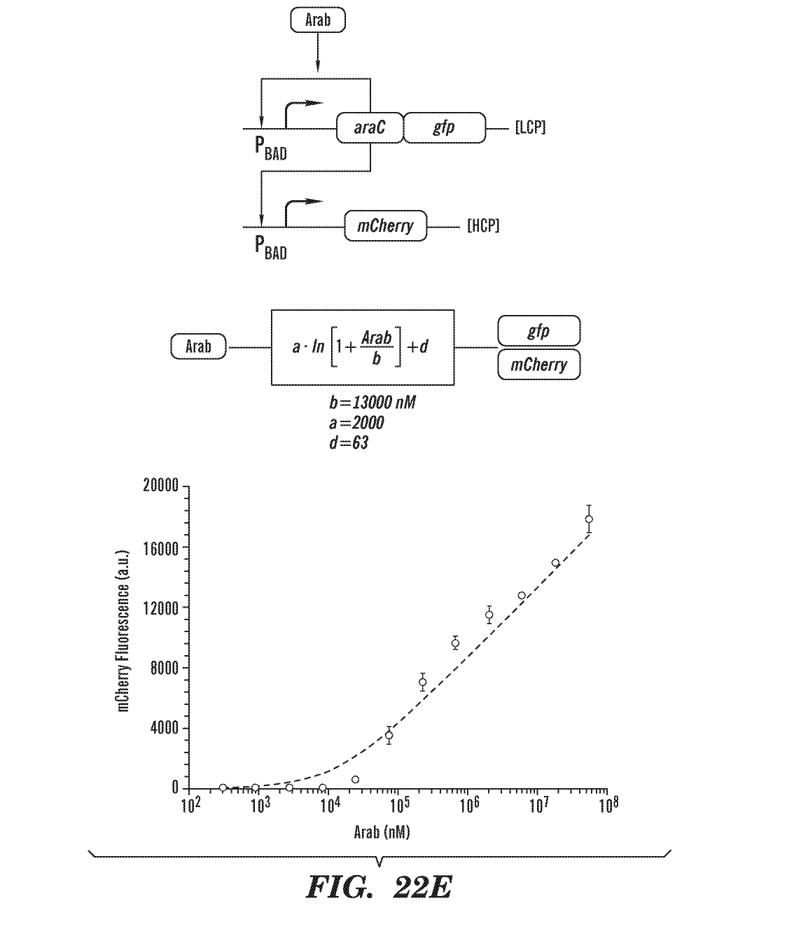

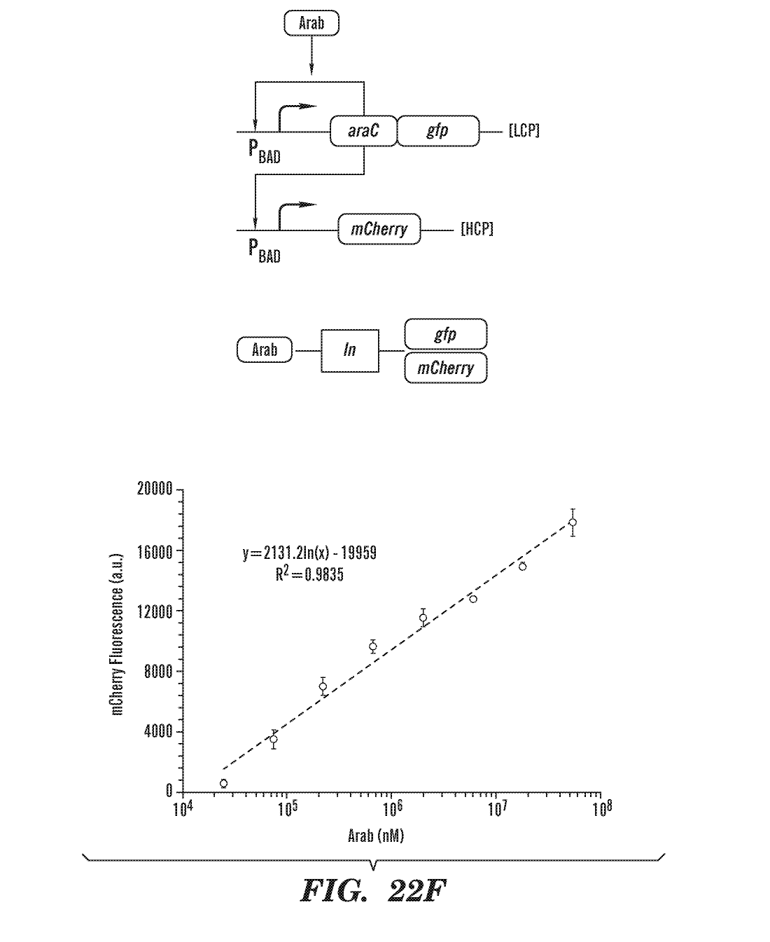

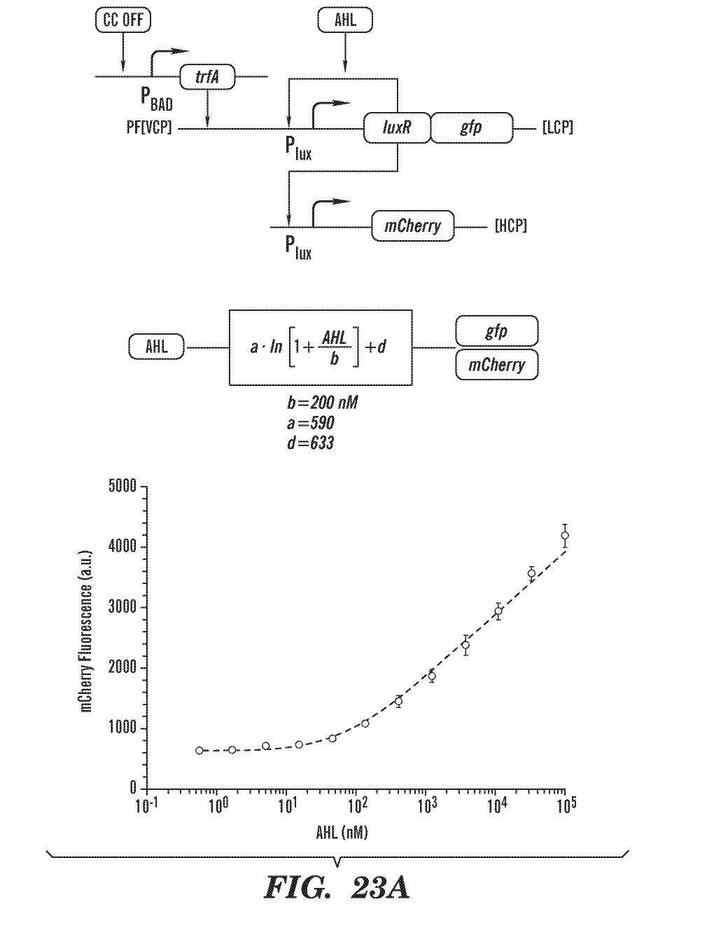

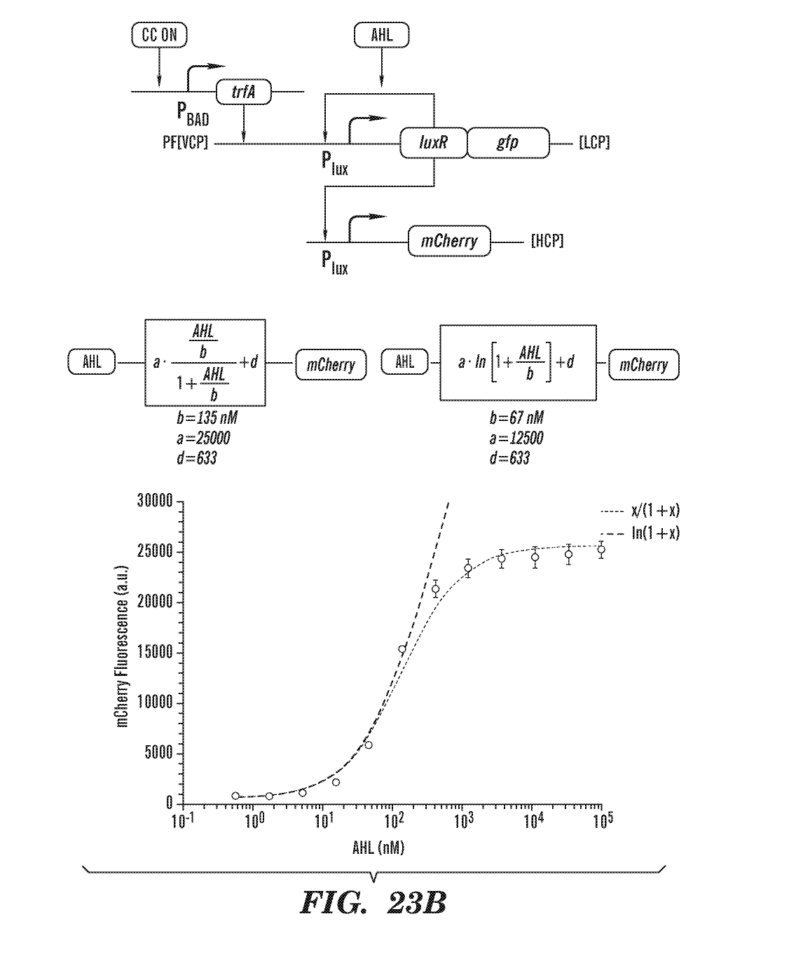

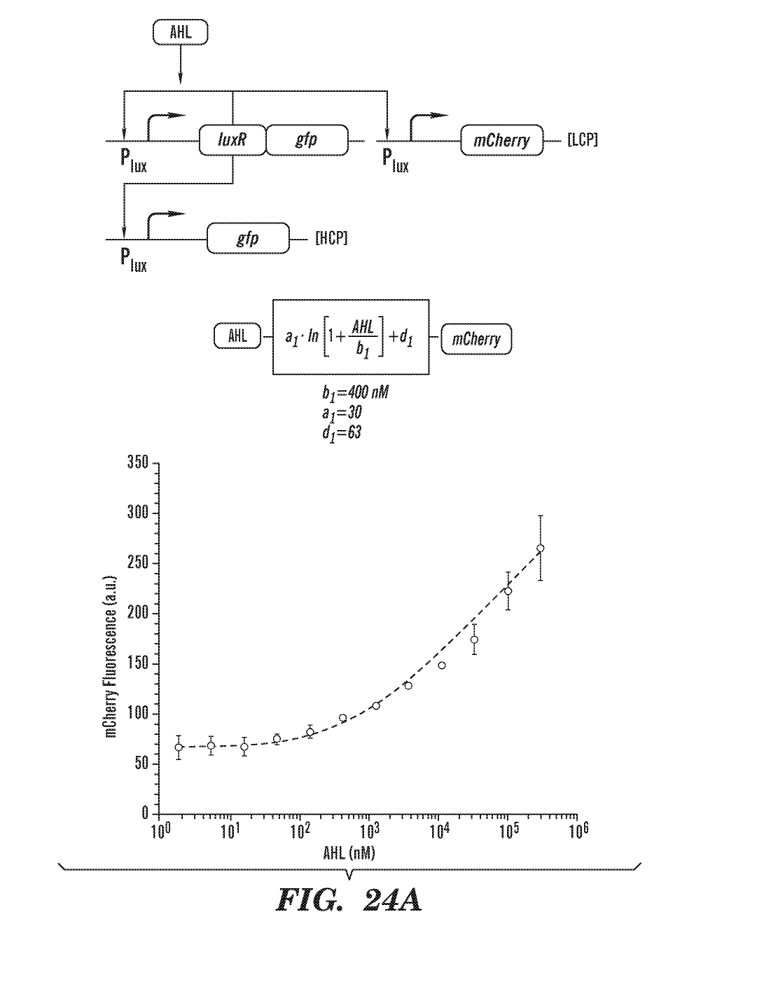

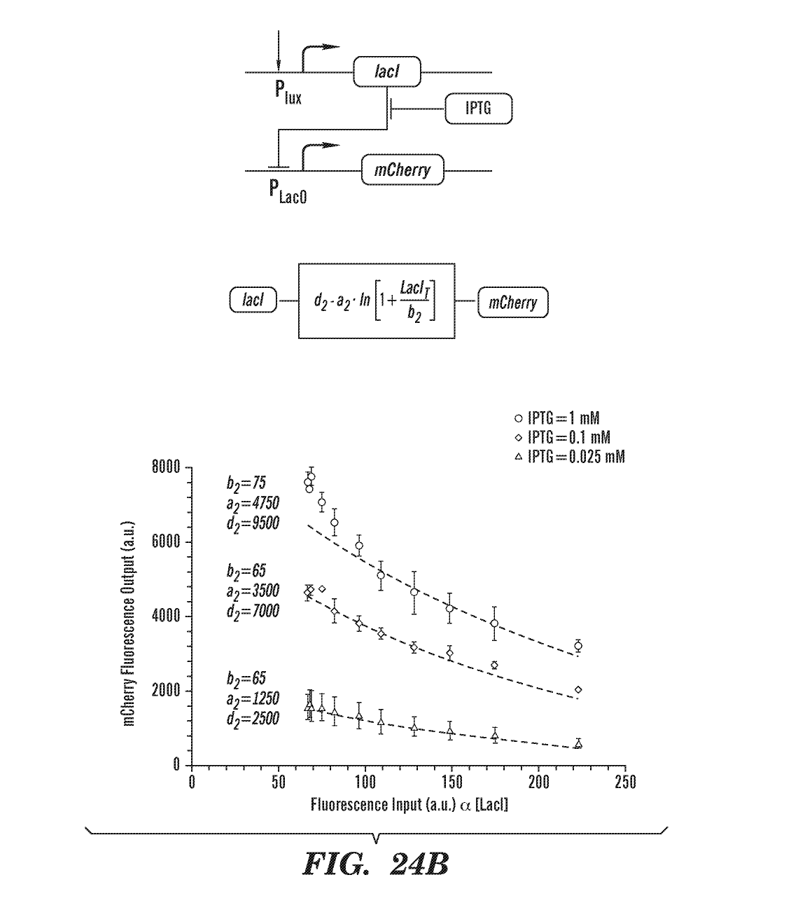

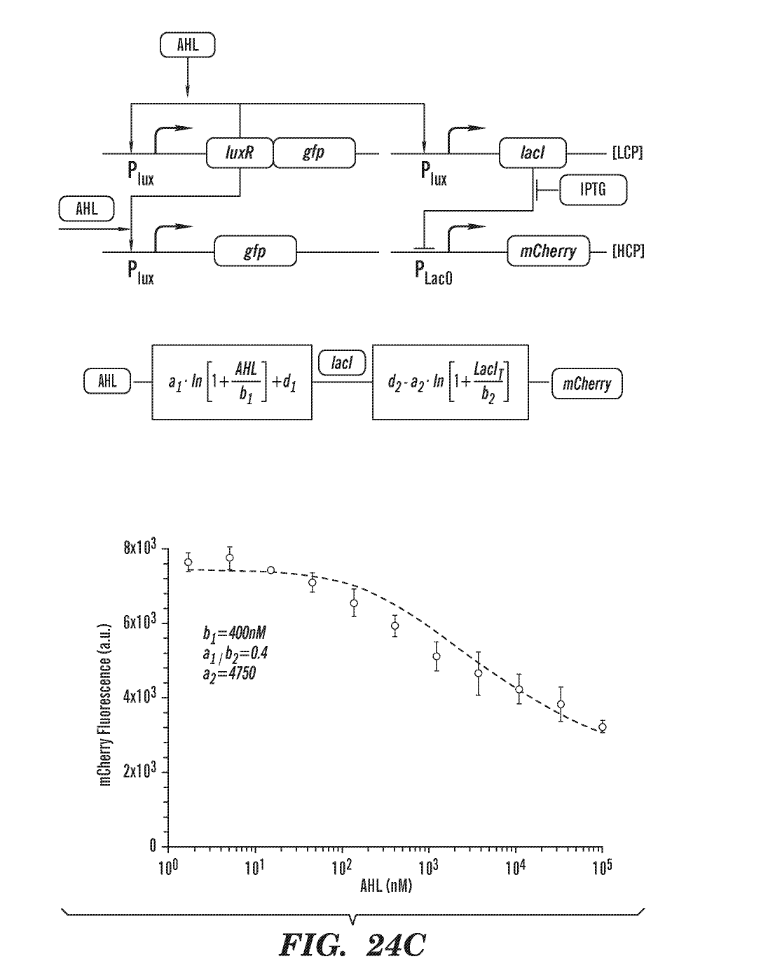

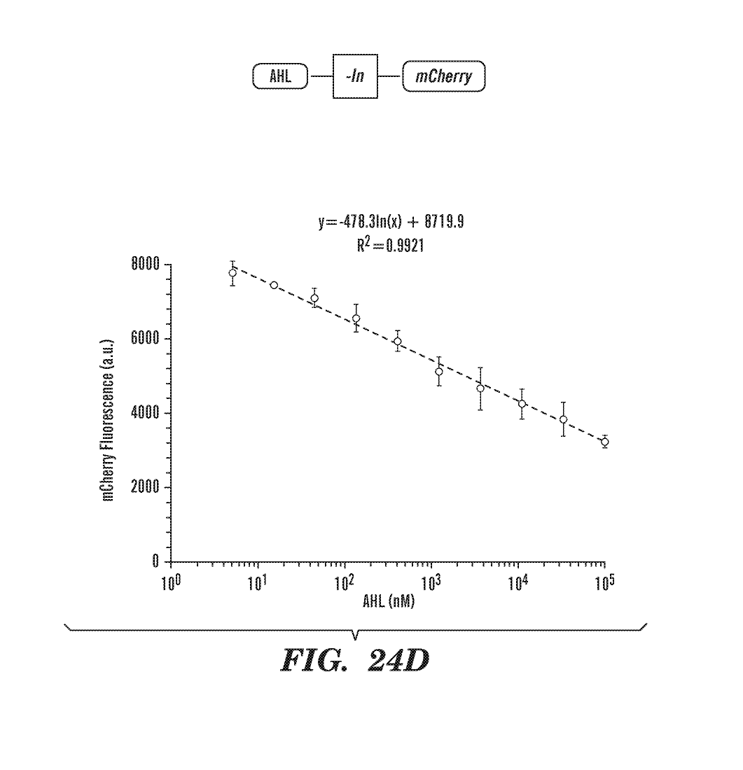

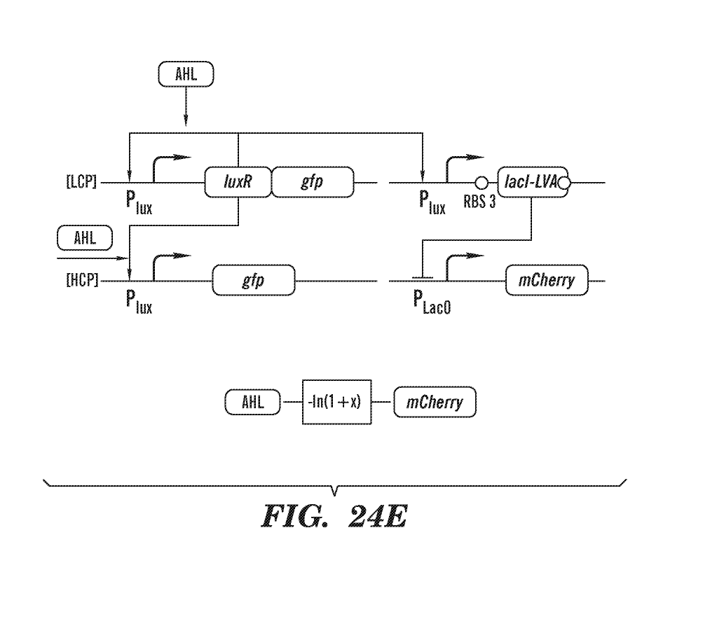

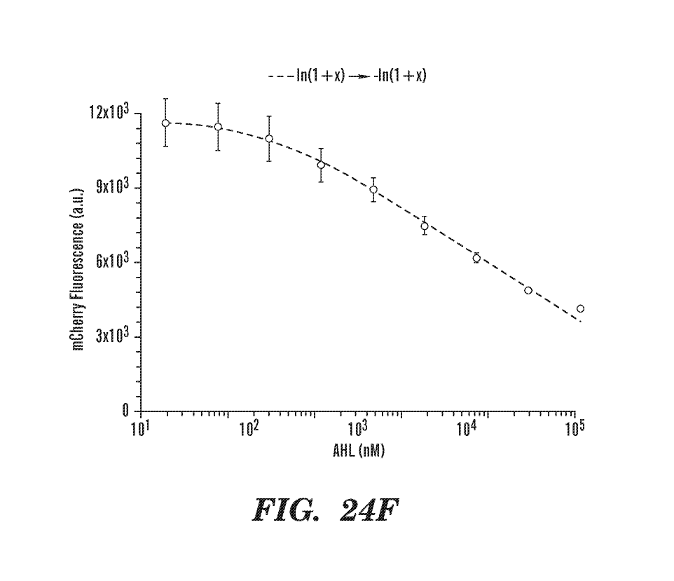

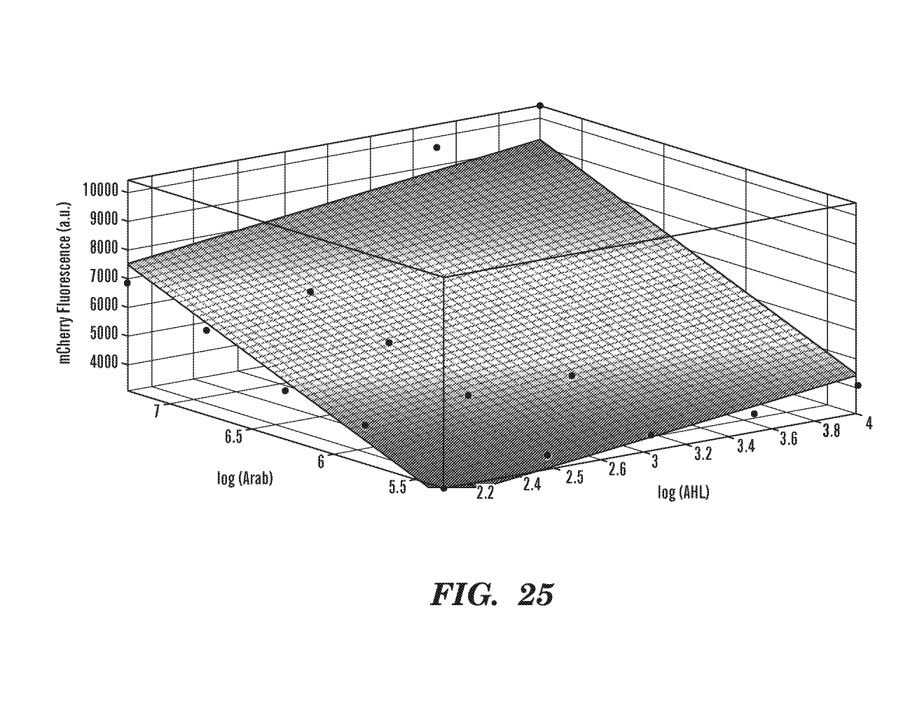

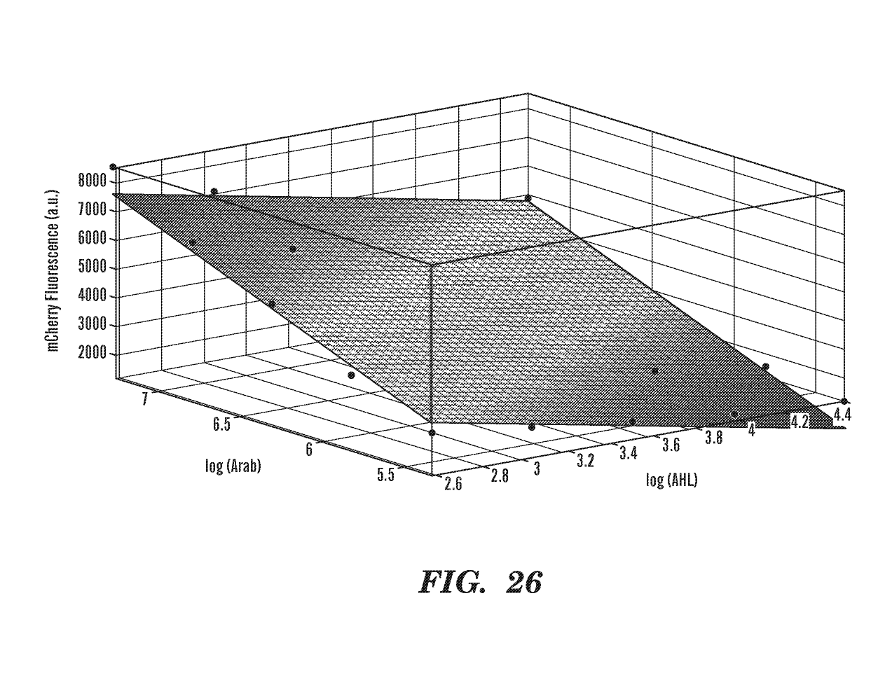

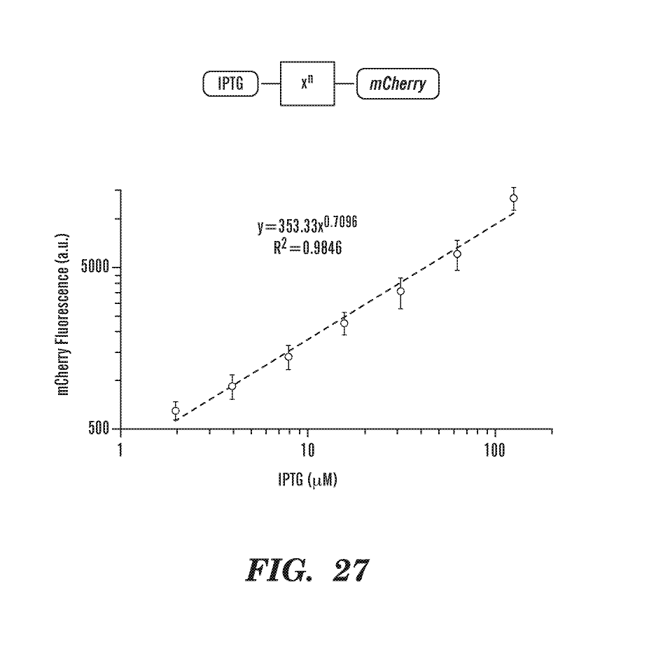

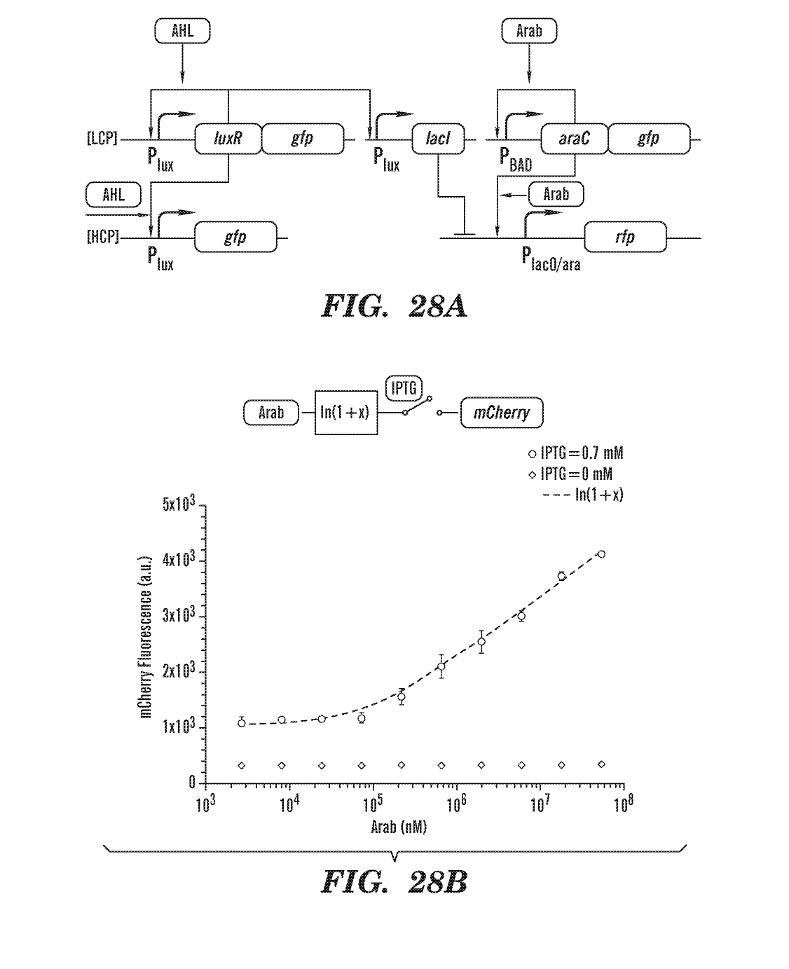

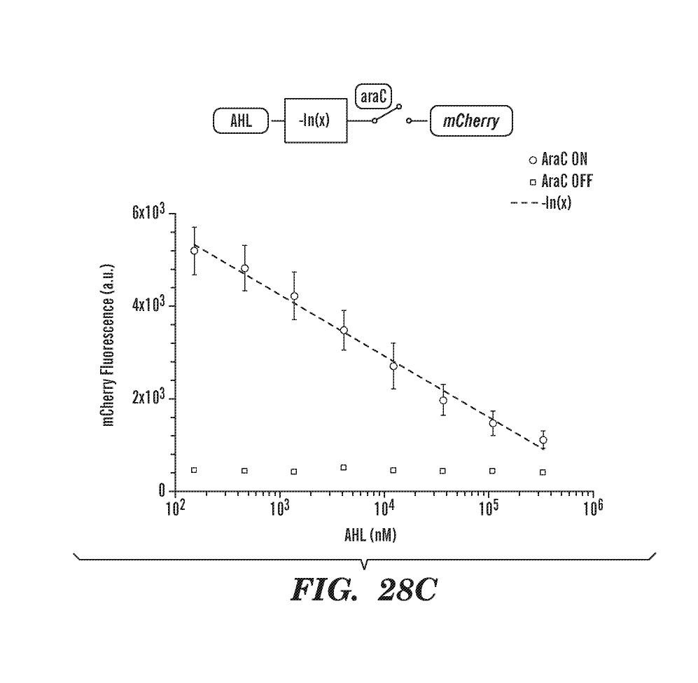

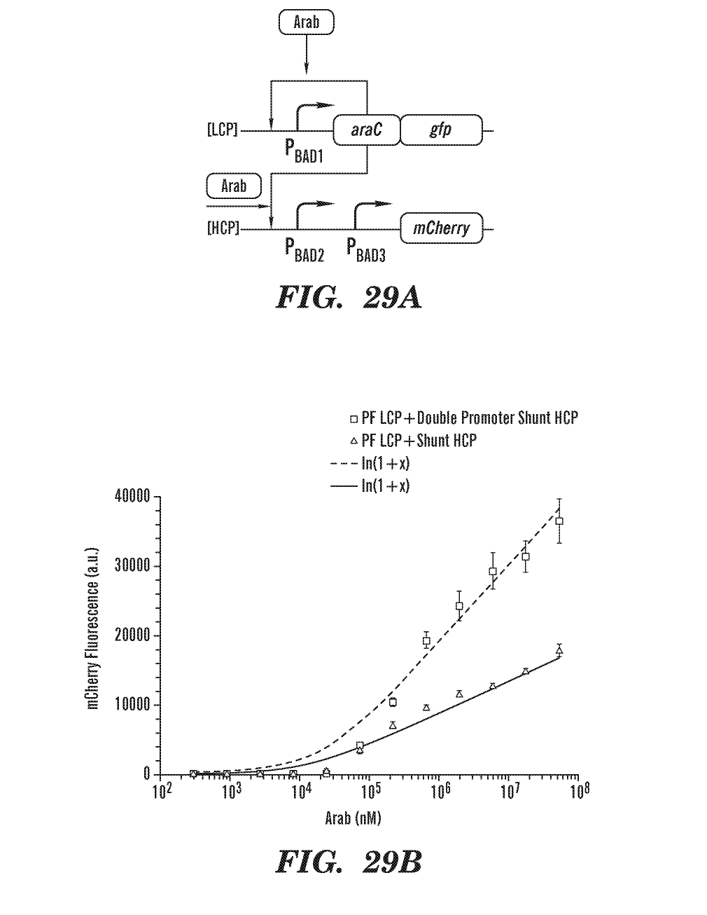

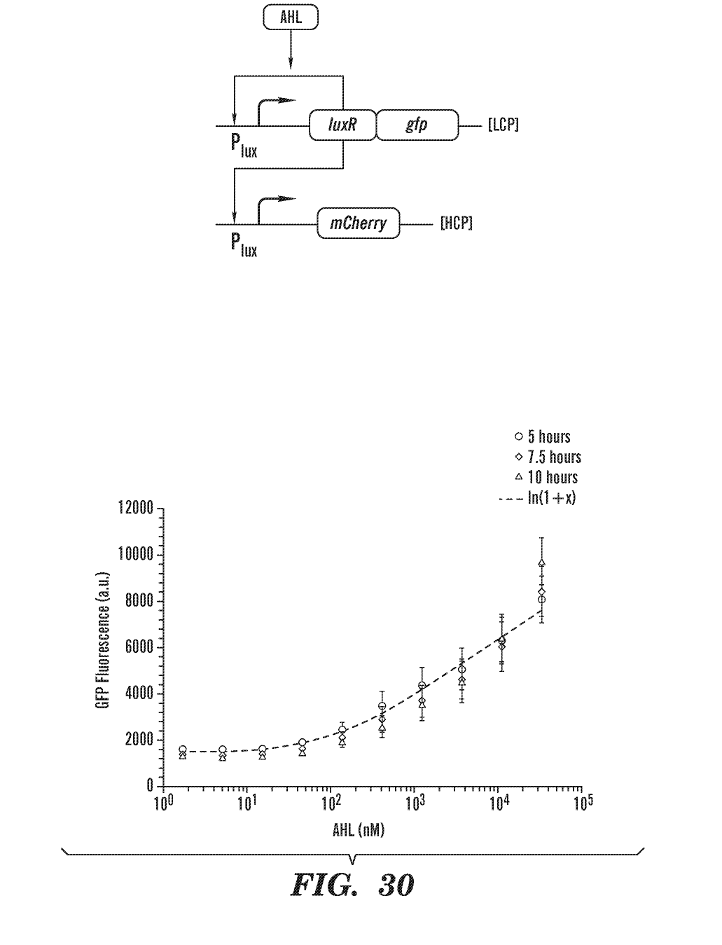

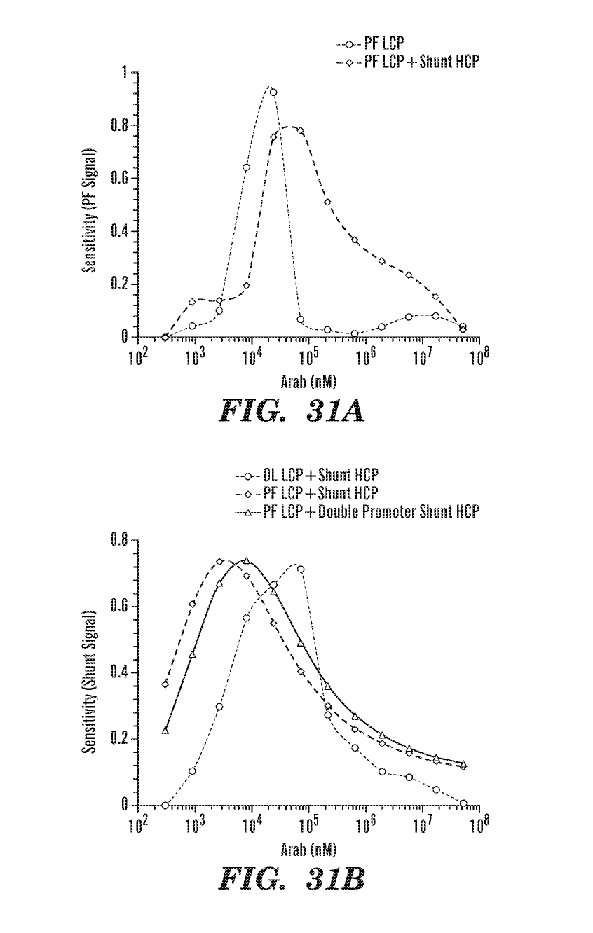

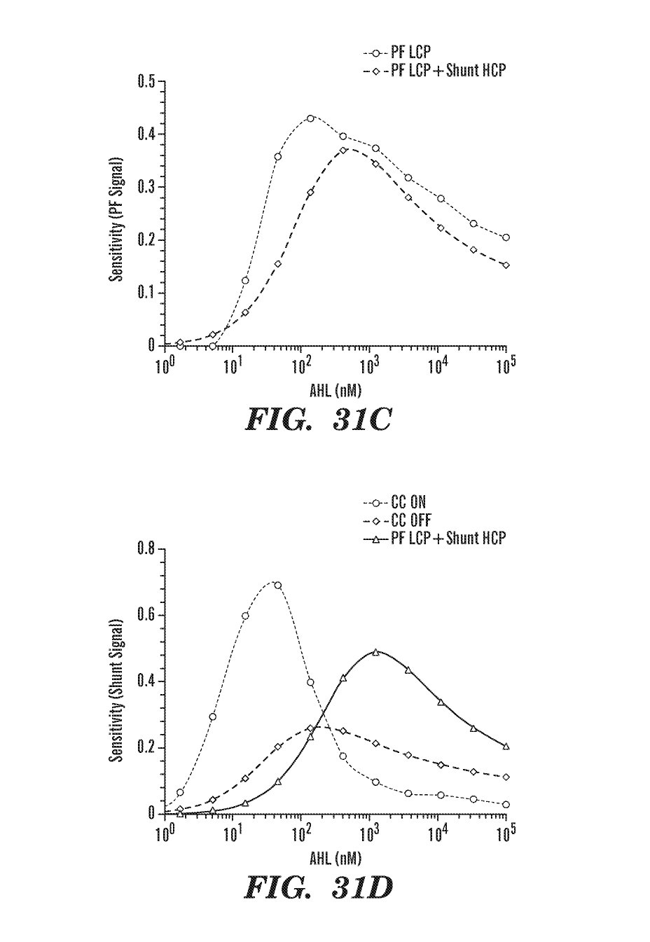

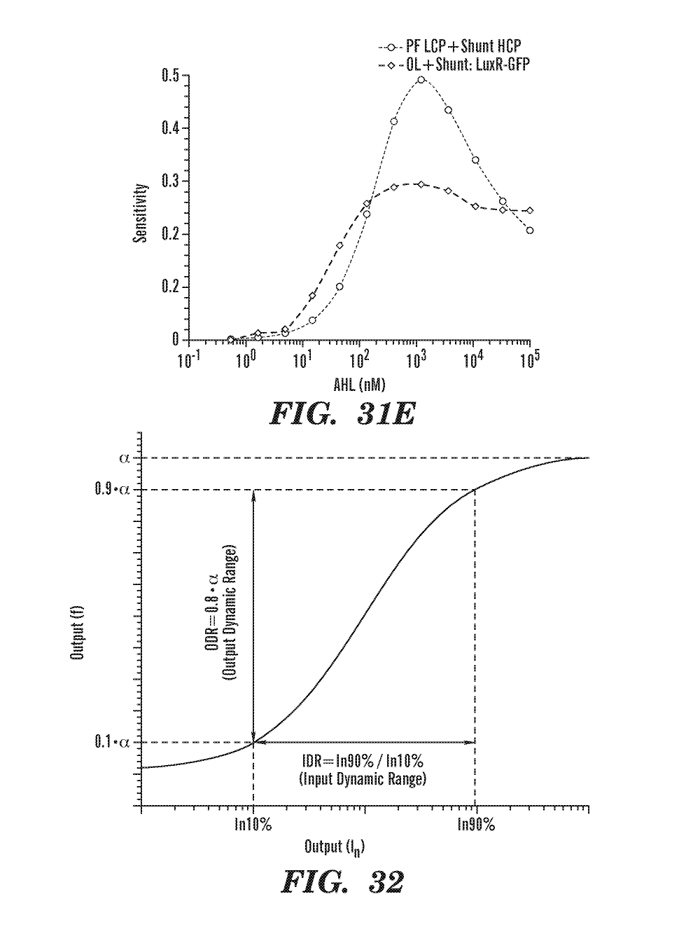

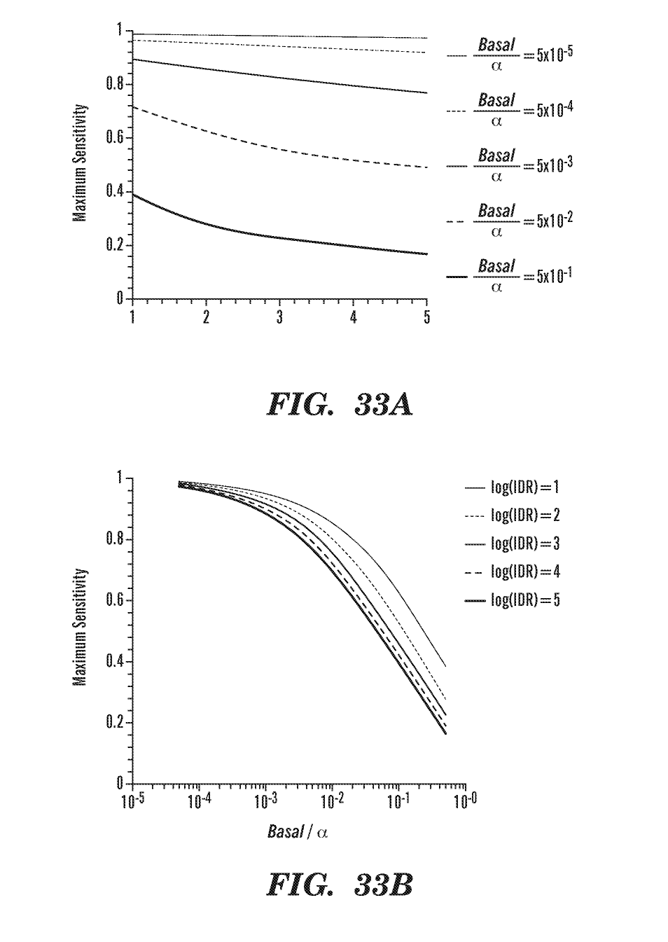

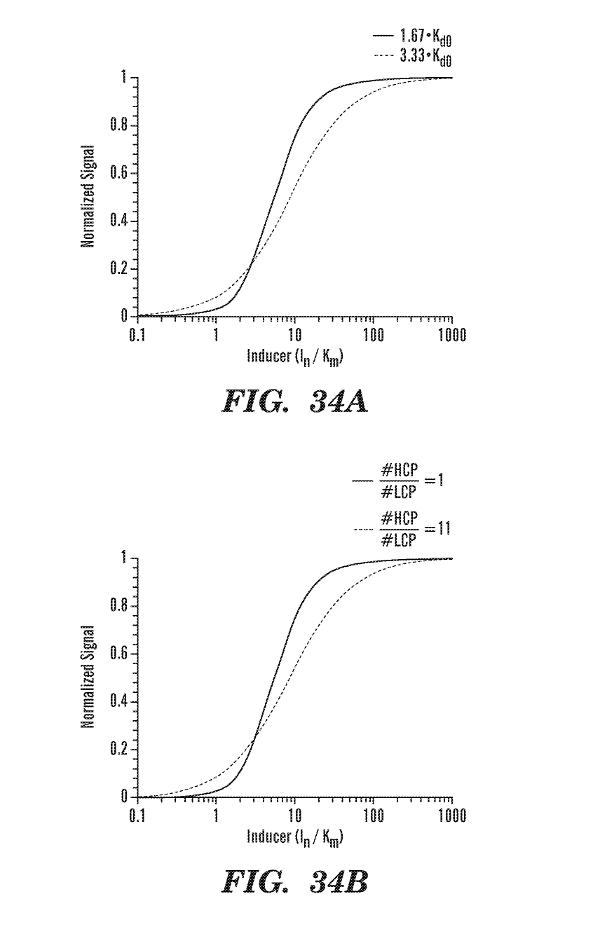

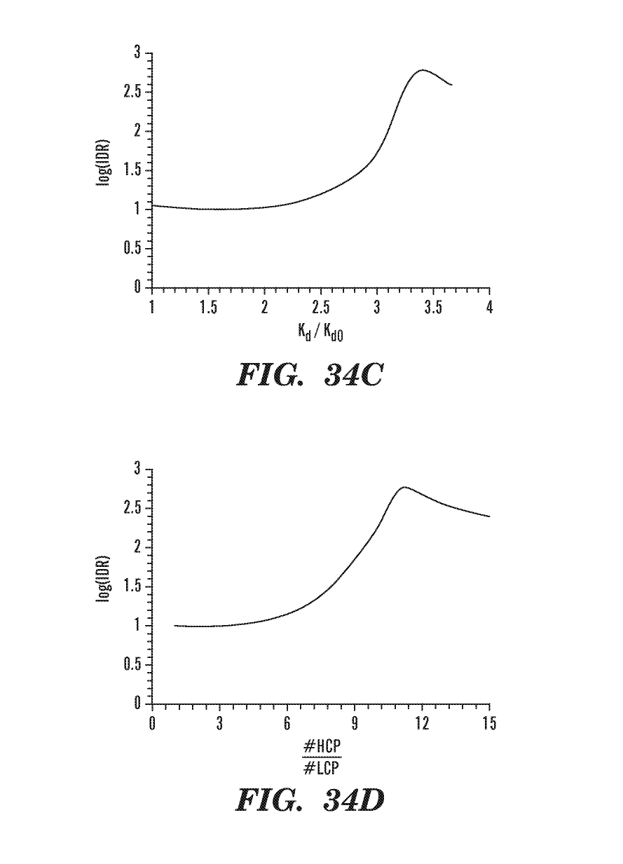

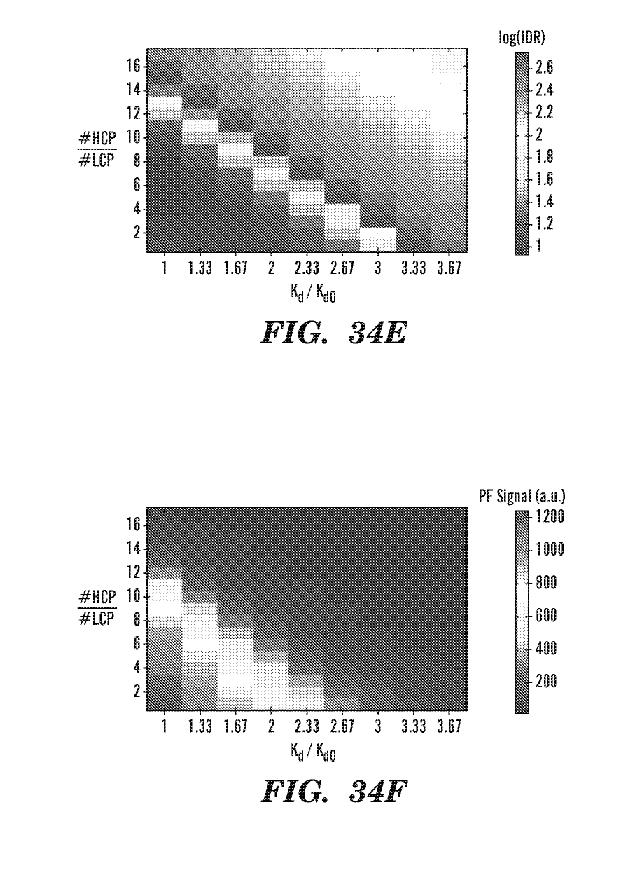

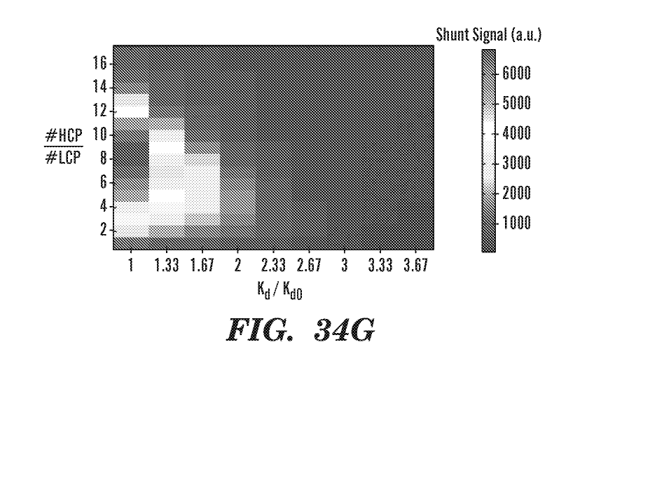

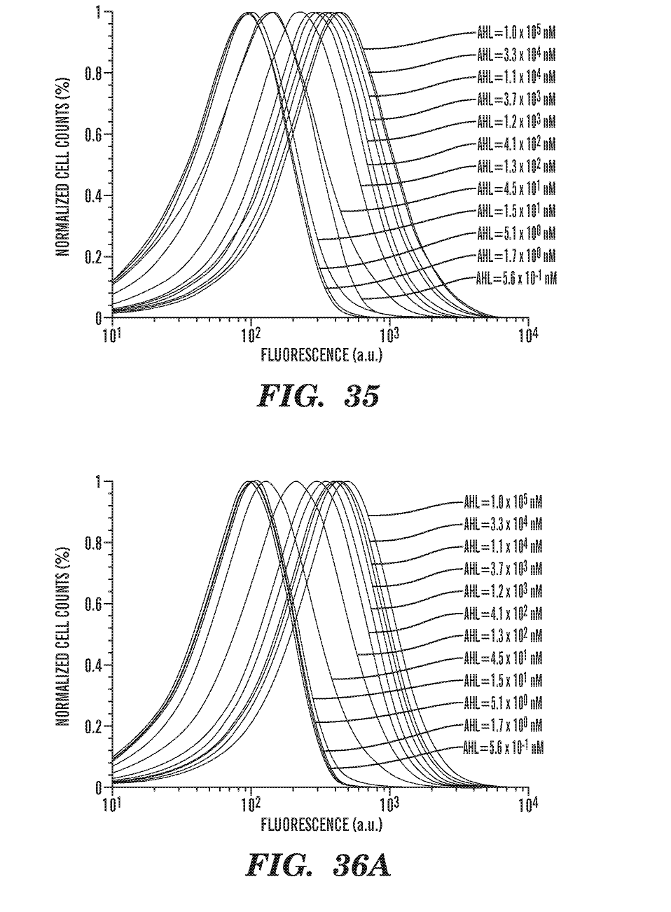

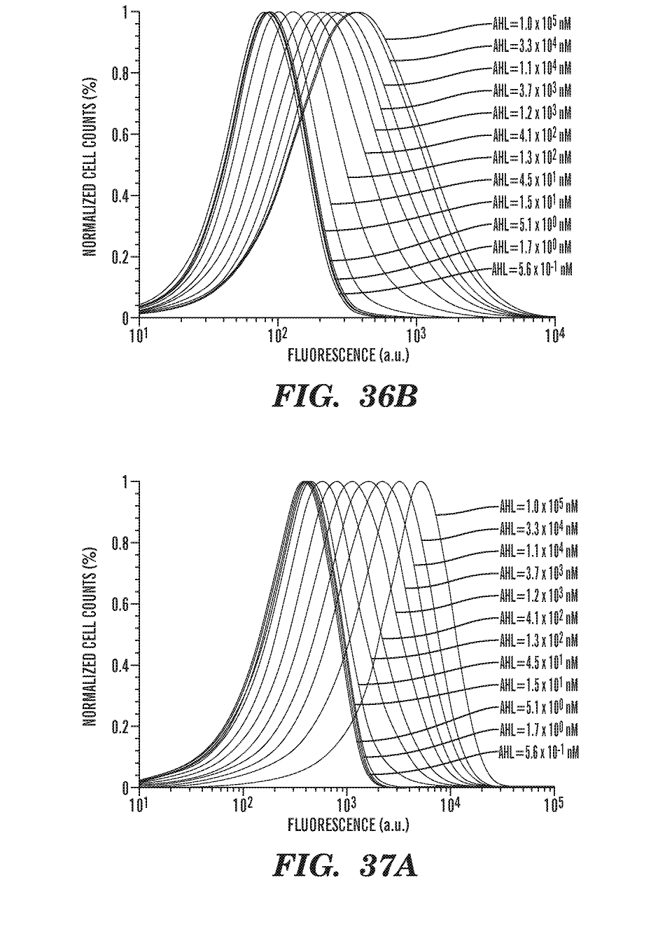

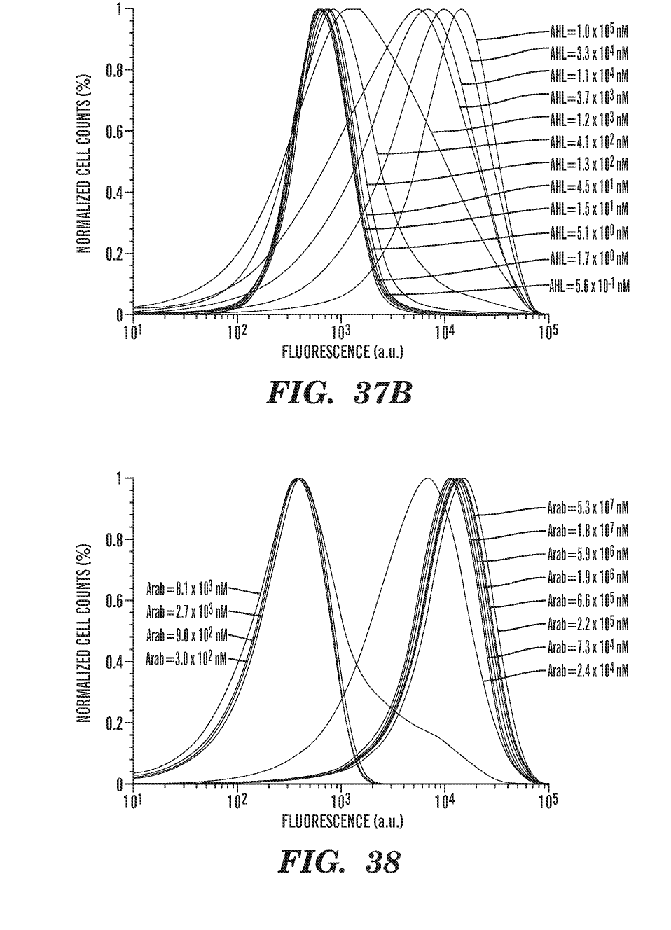

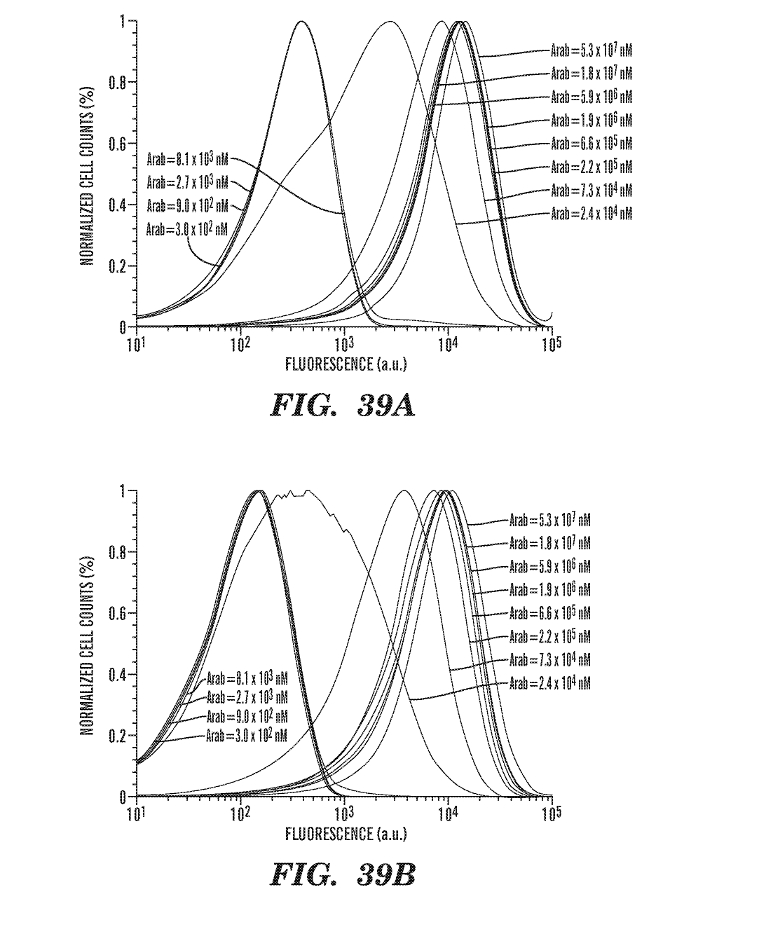

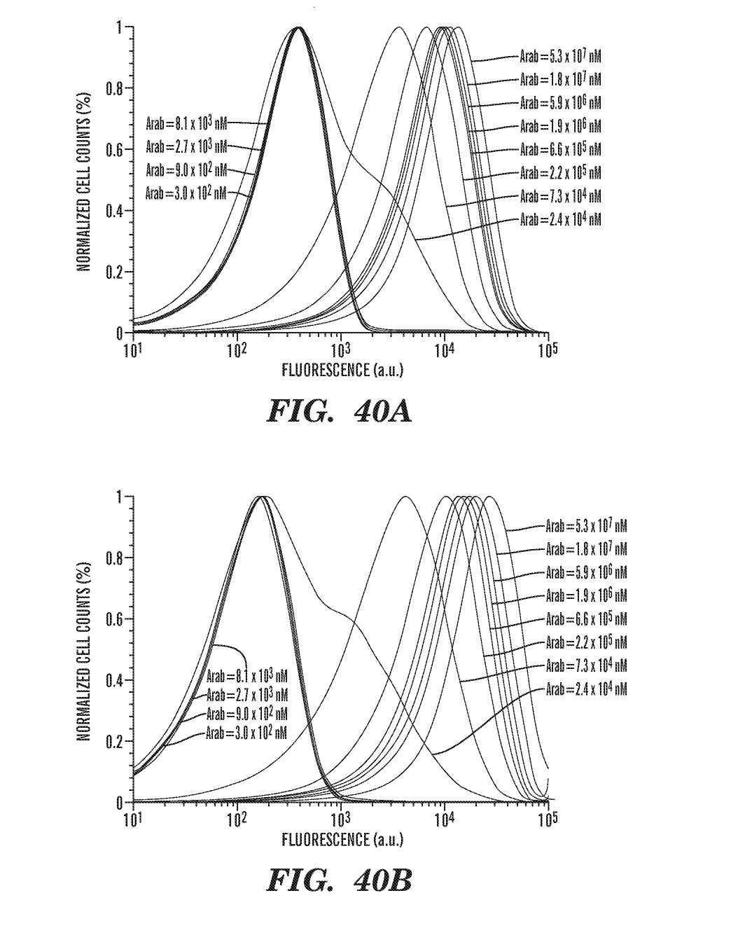

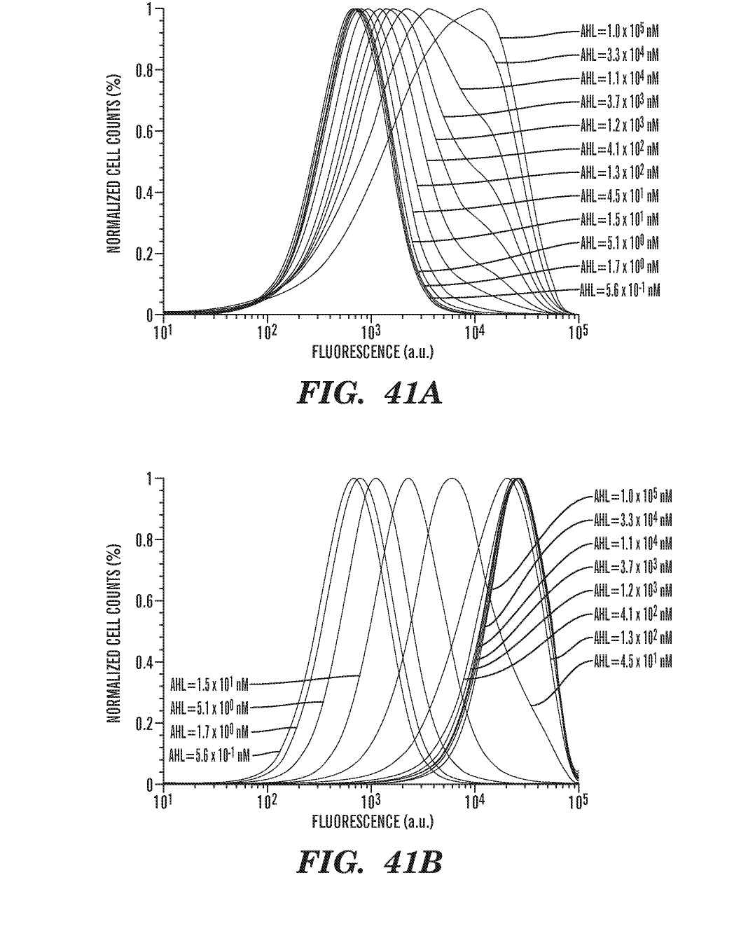

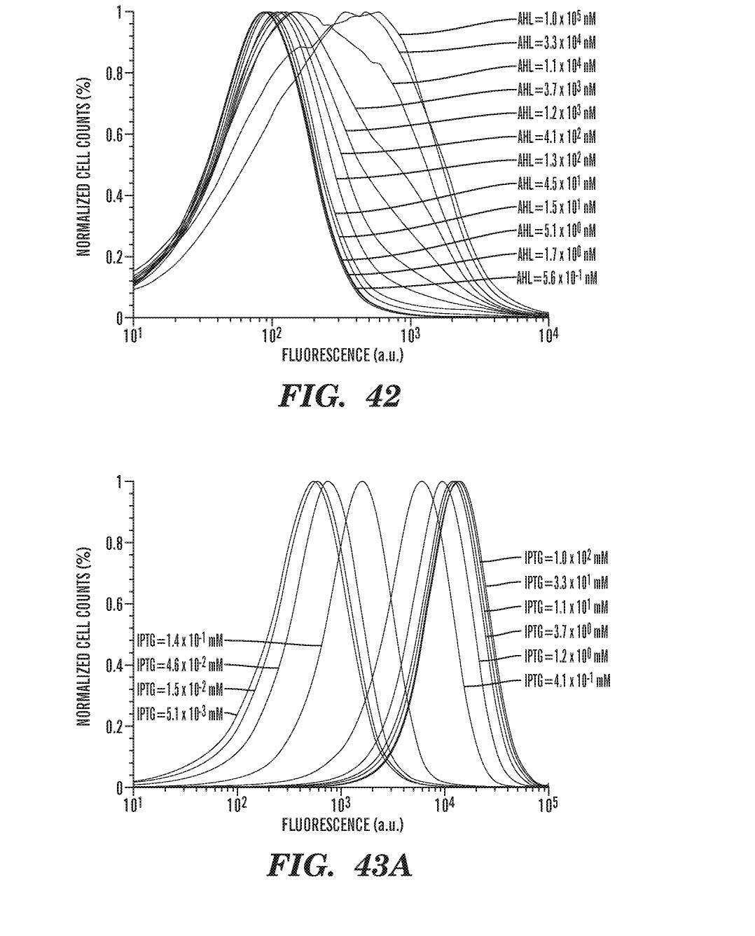

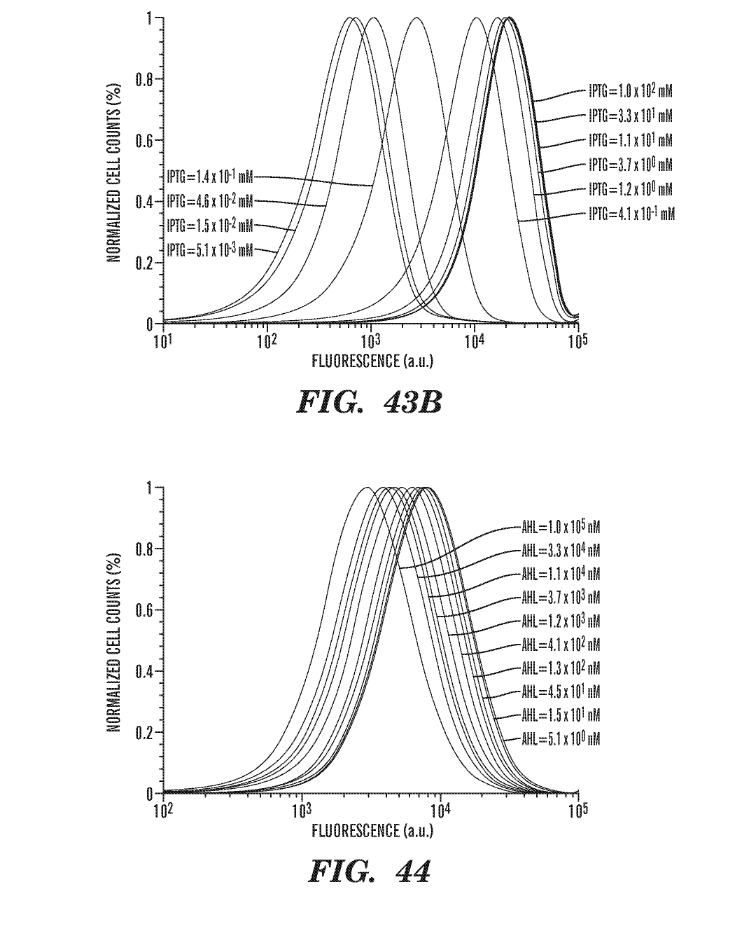

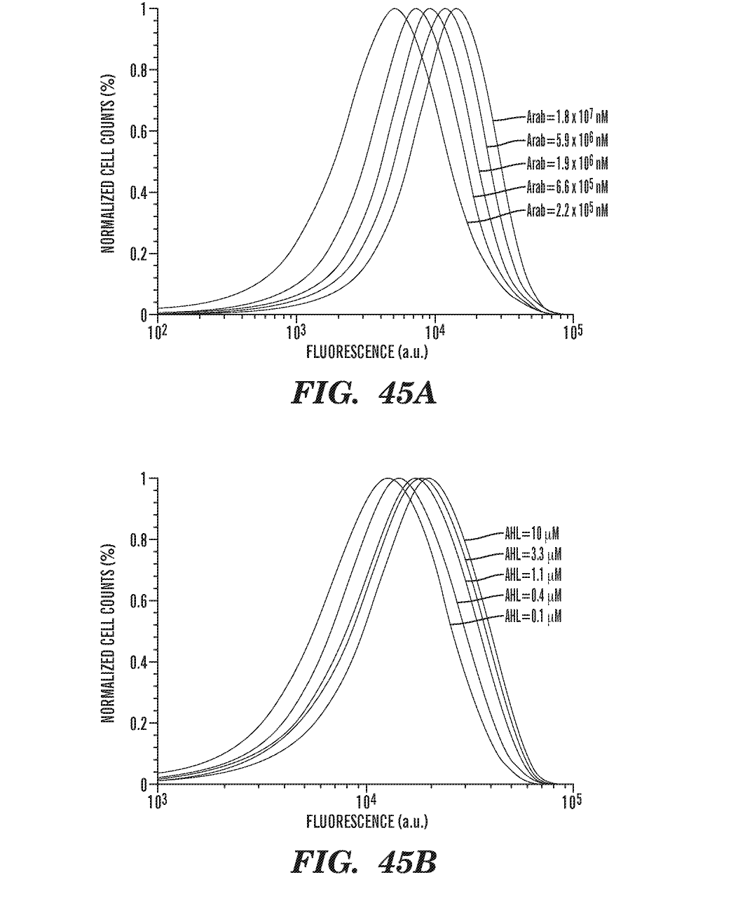

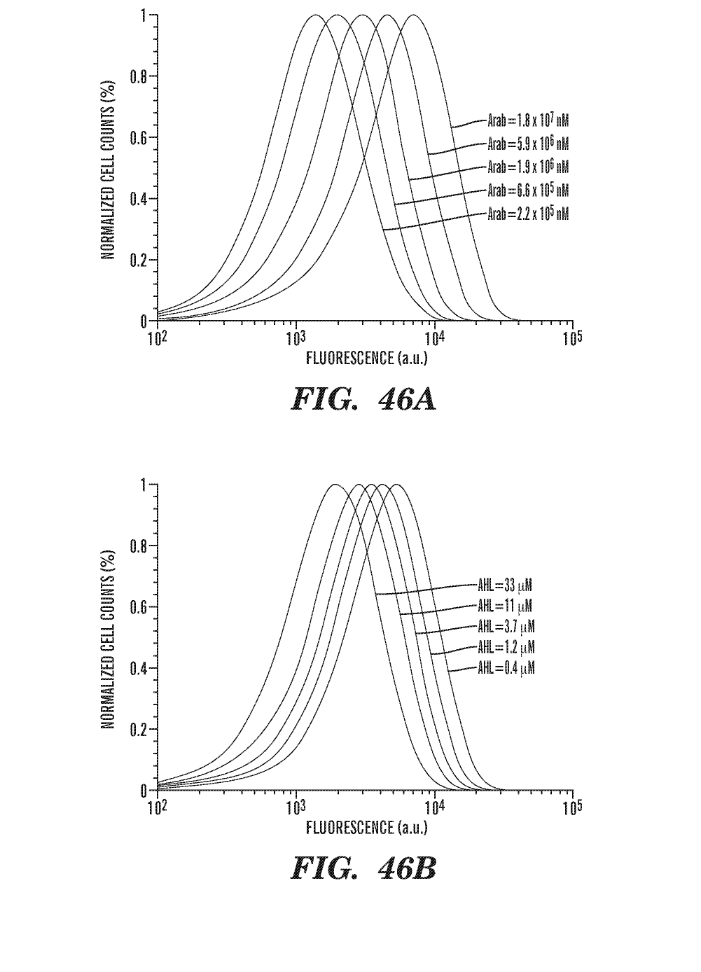

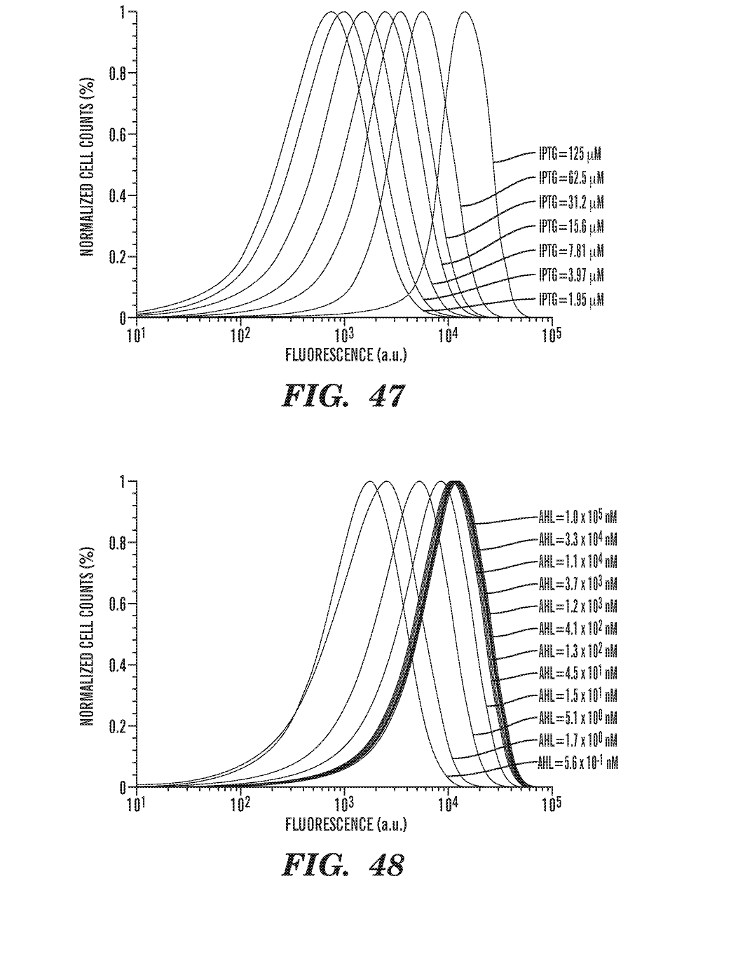

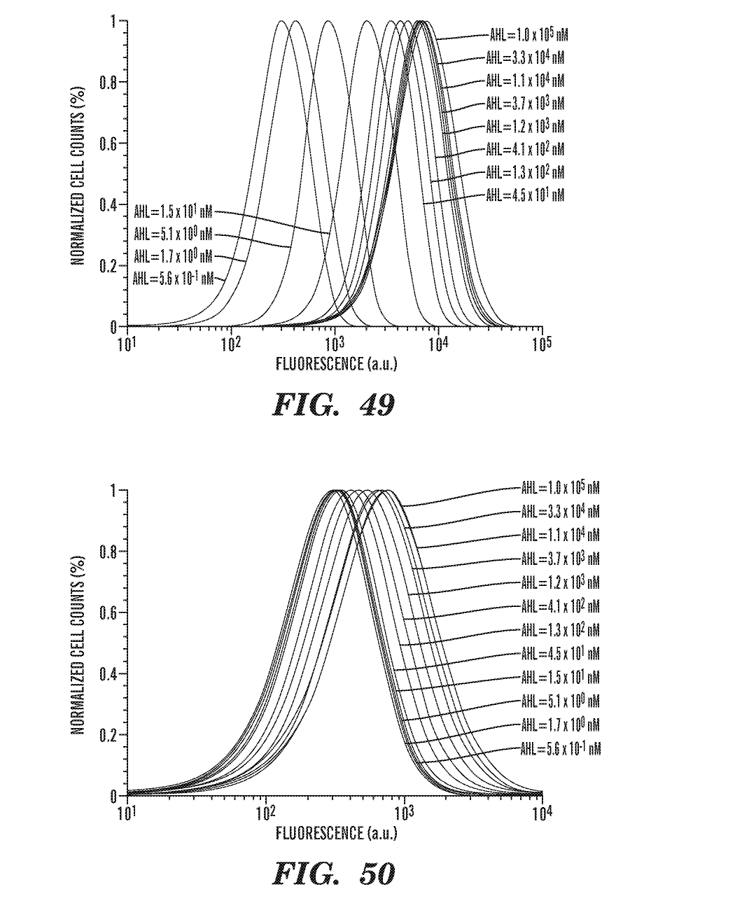

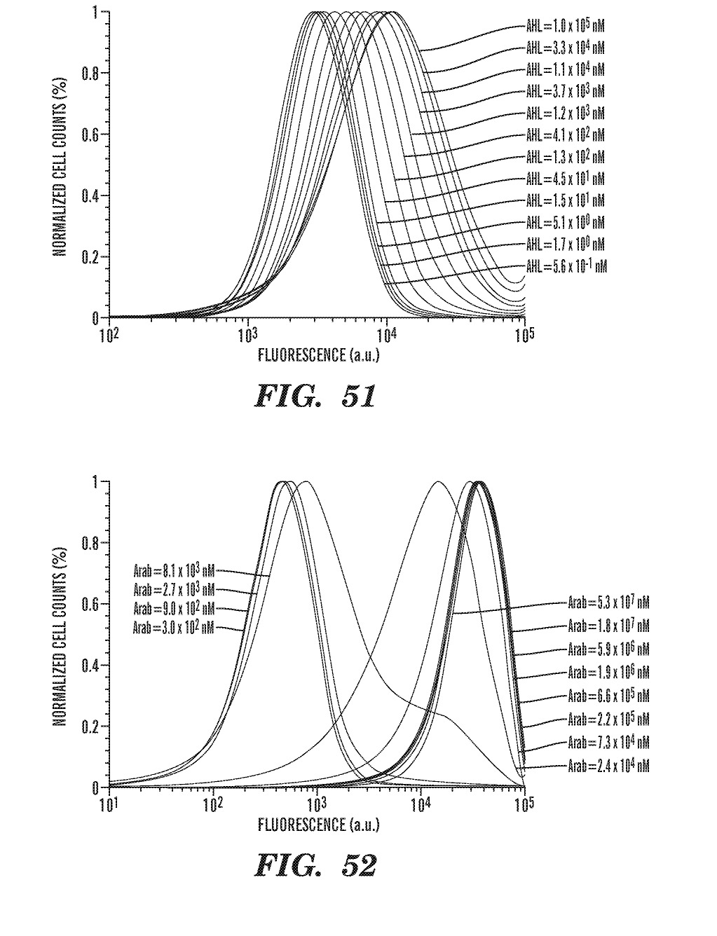

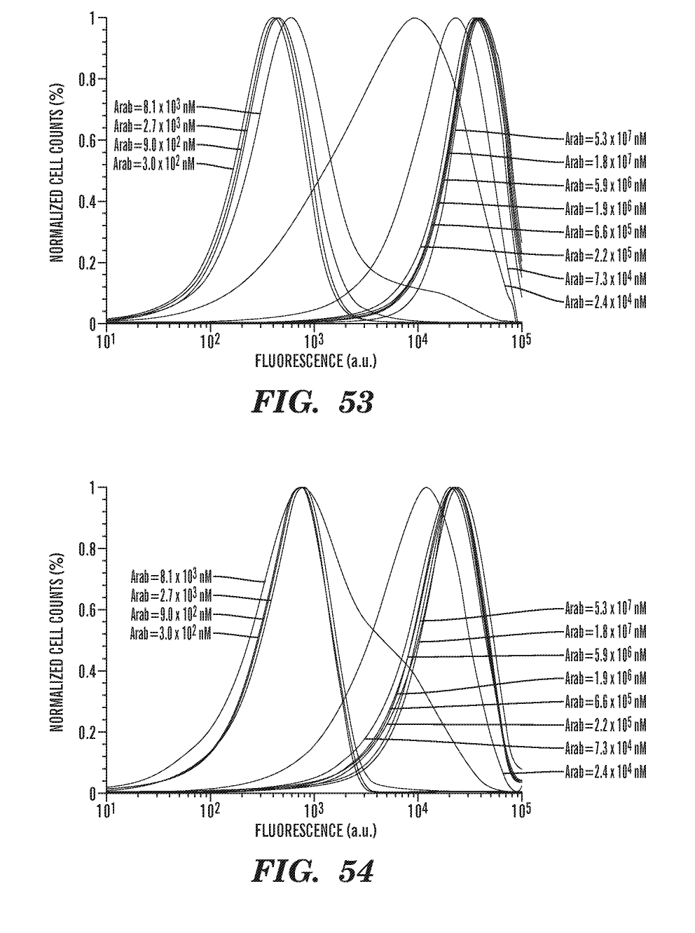

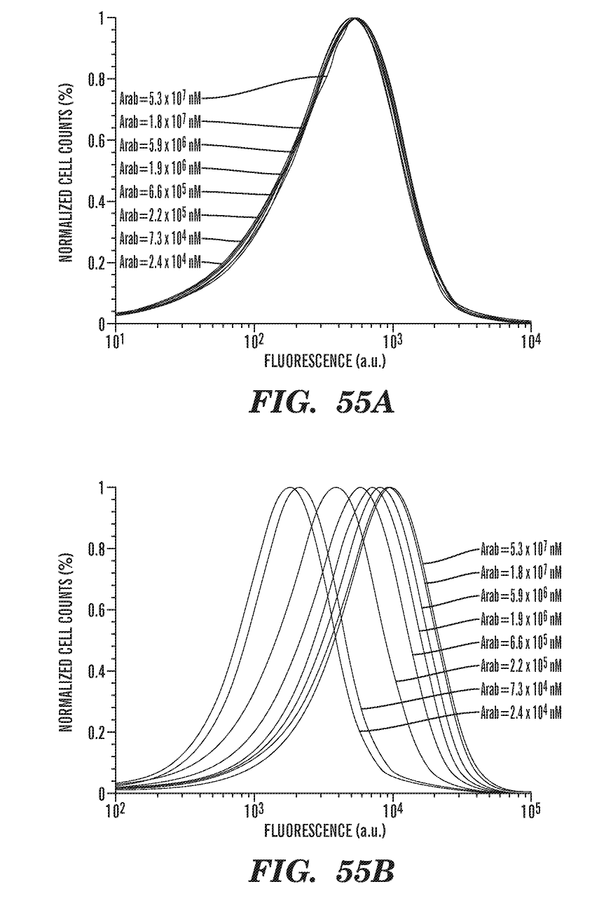

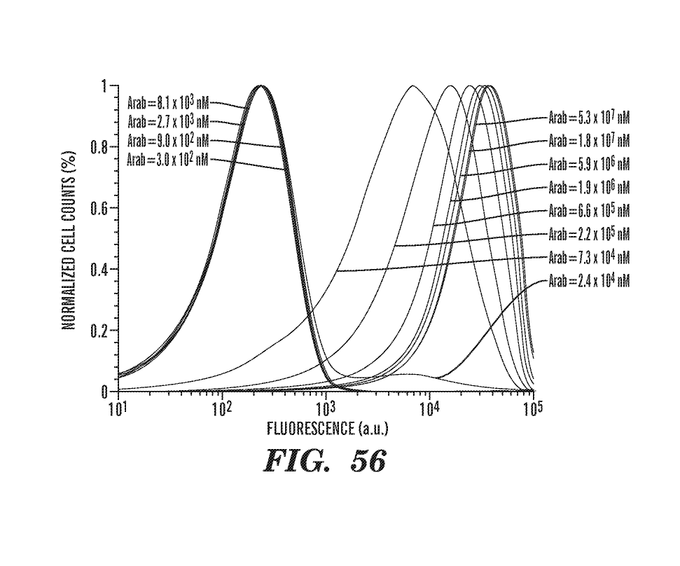

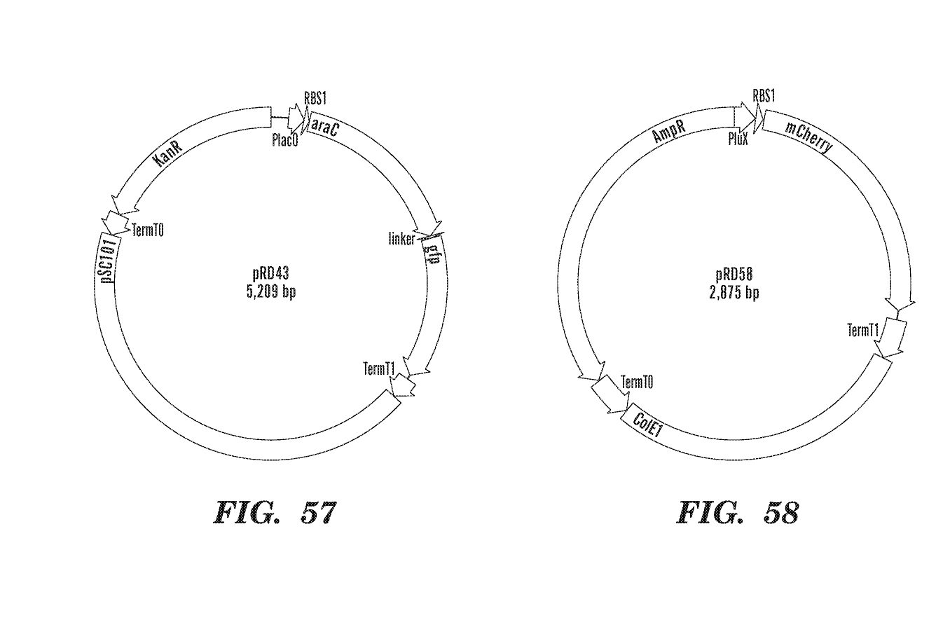

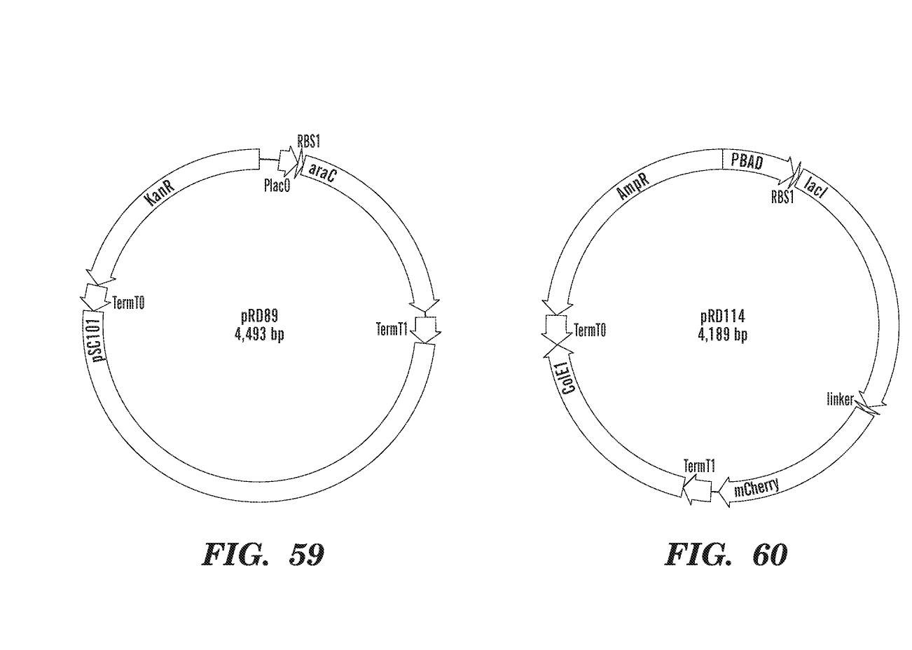

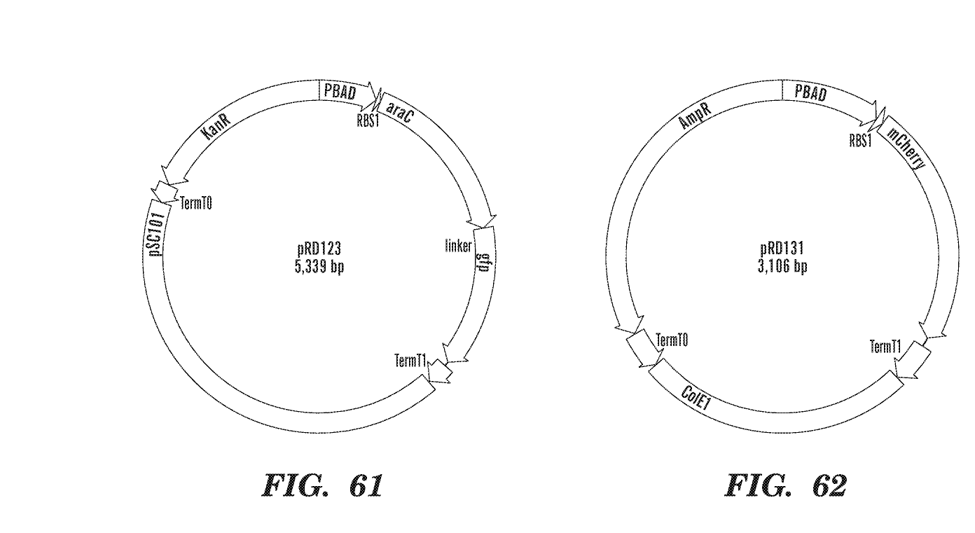

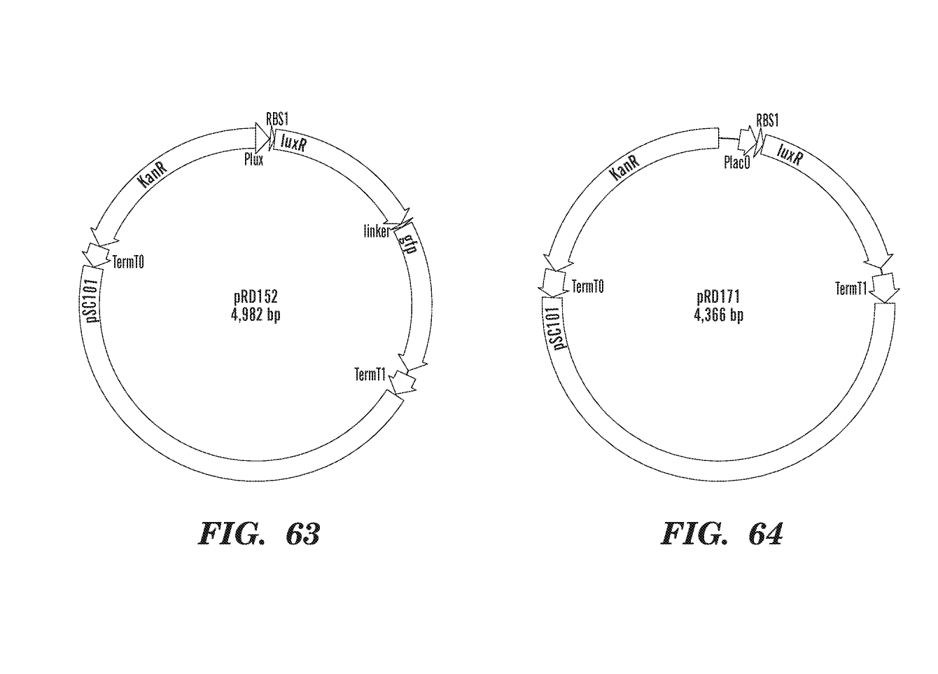

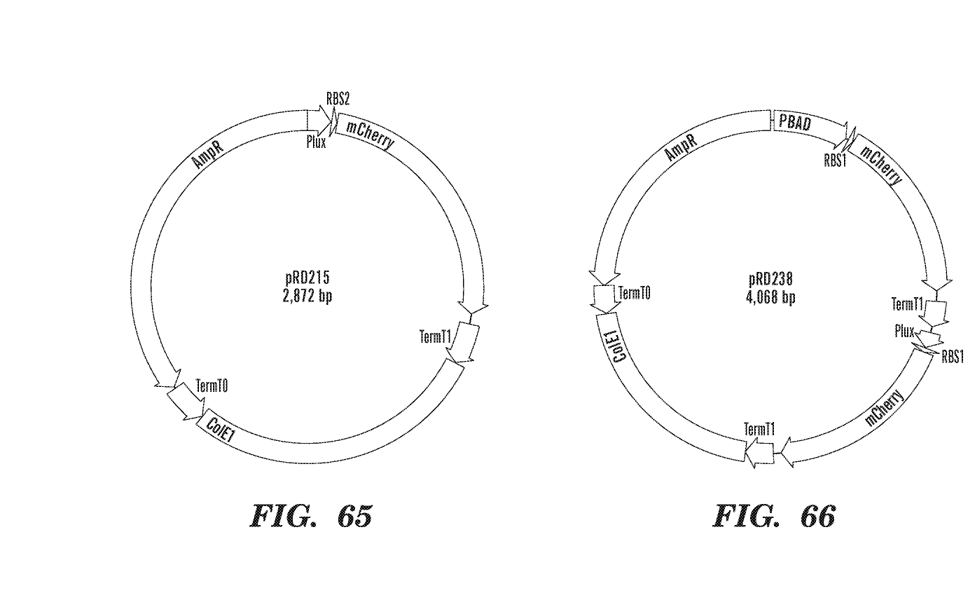

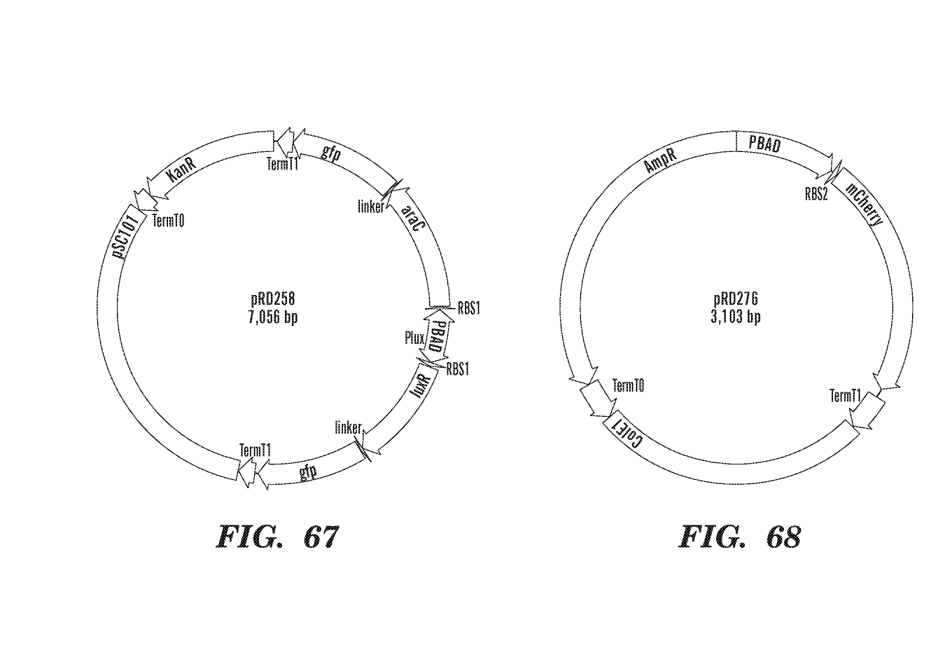

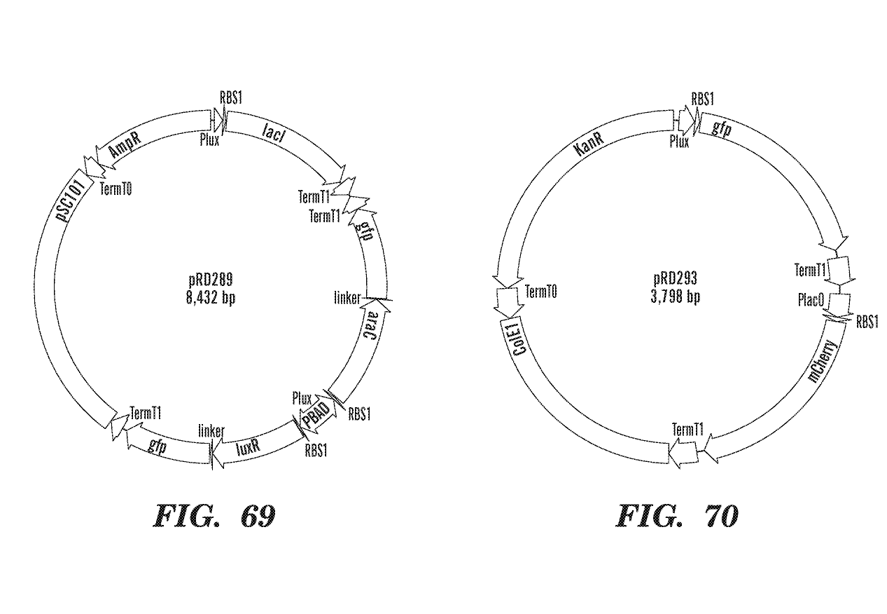

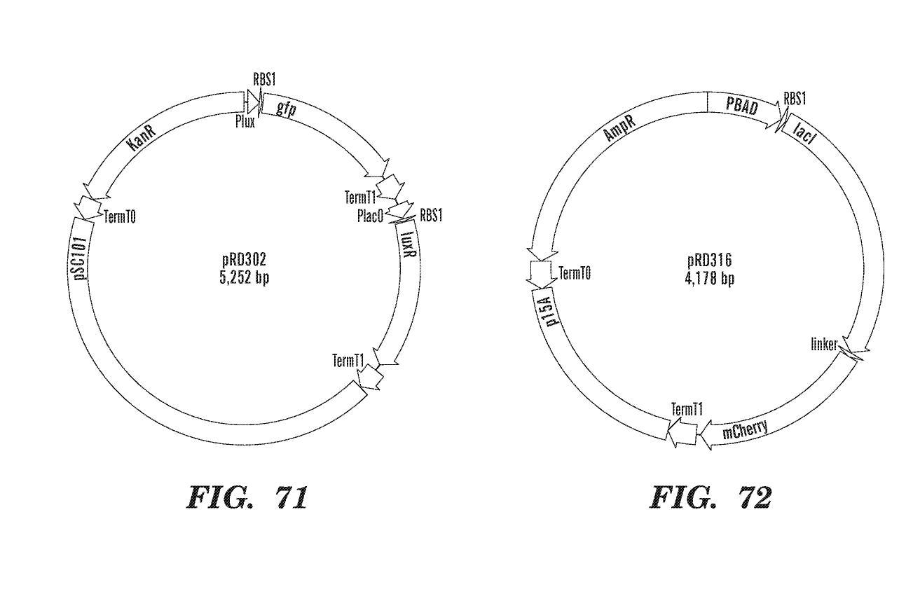

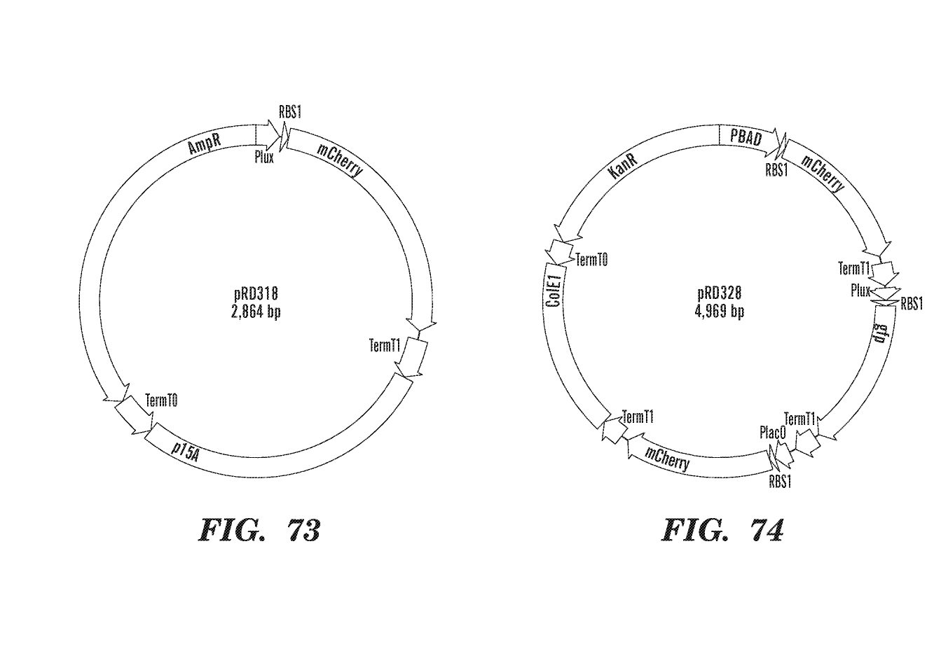

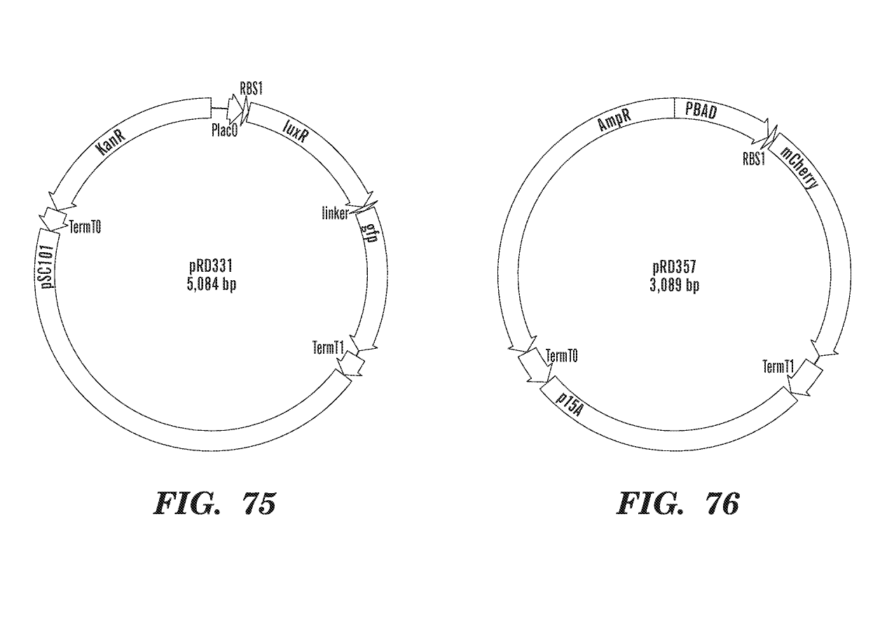

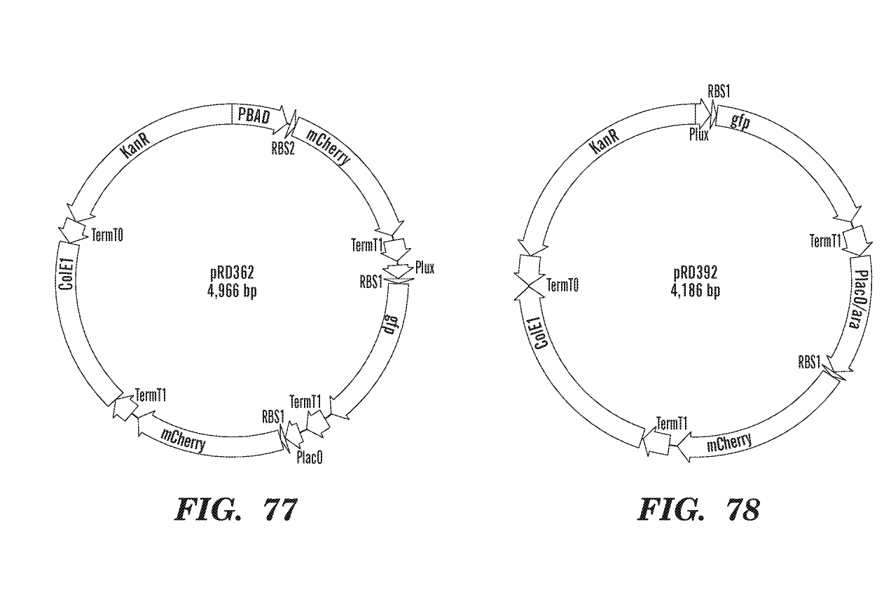

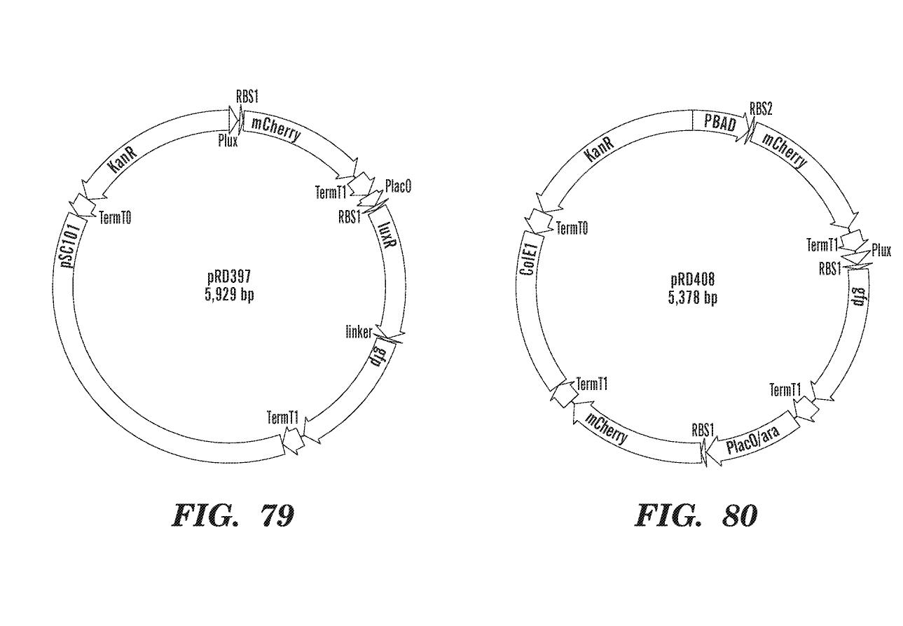

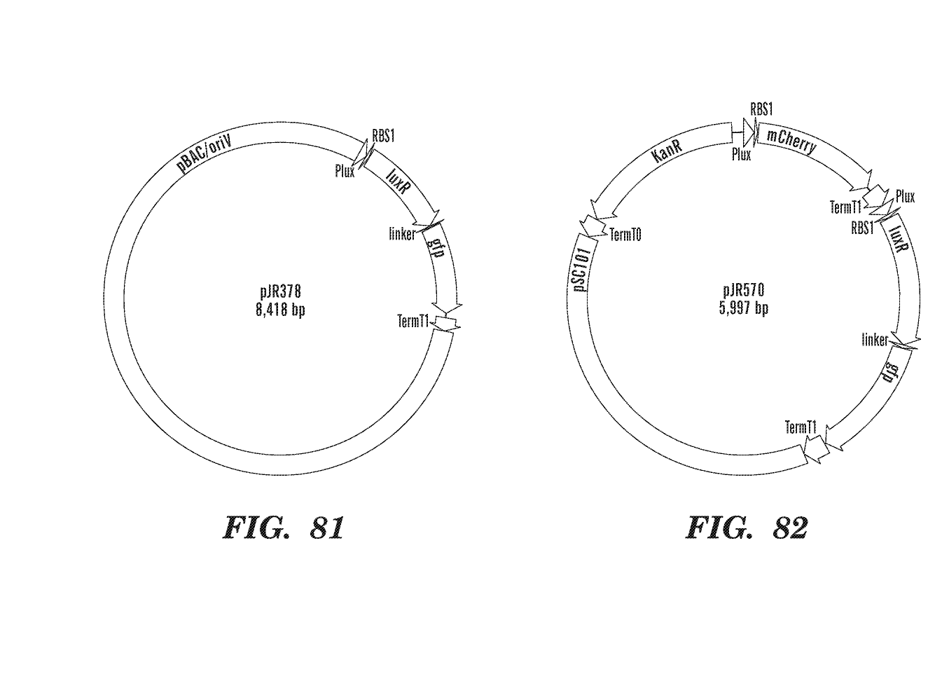

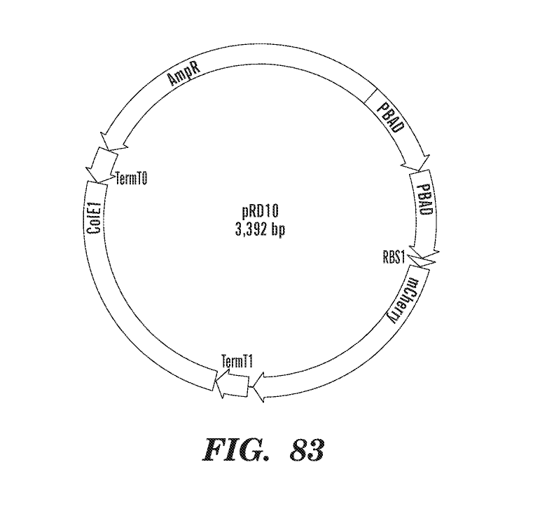

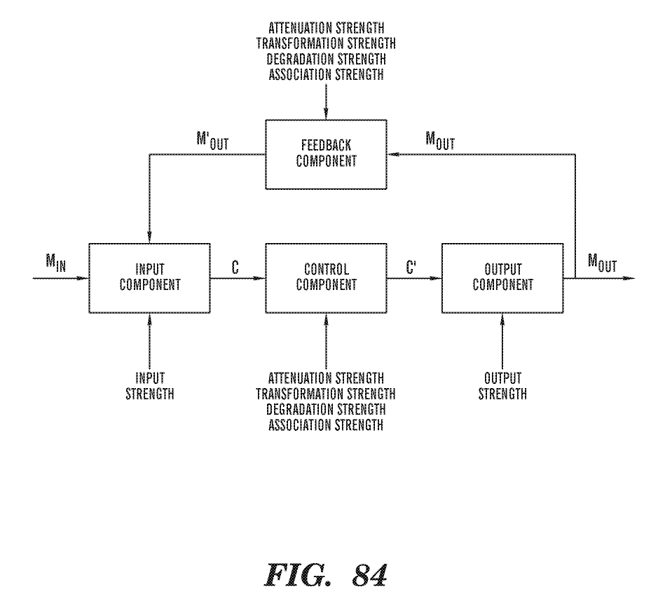

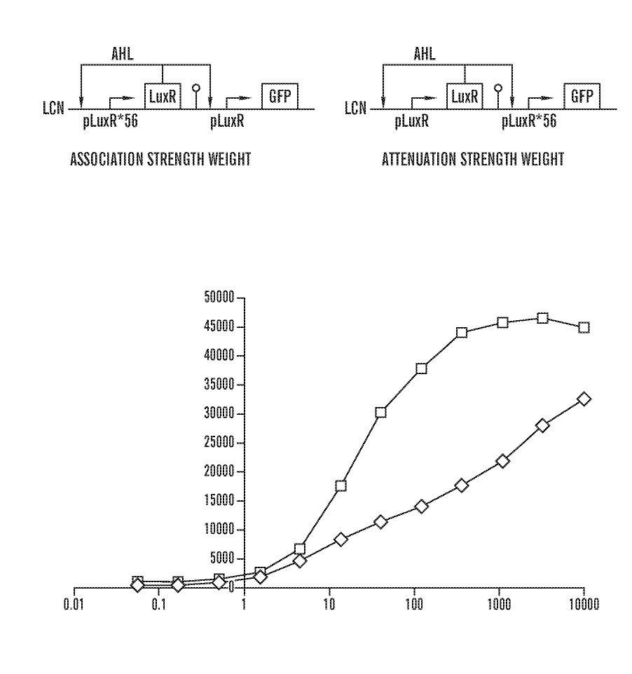

The AraC-based embodiment of the graded molecular circuits described herein exhibited an input-output transfer function that was well-fit by a simple mathematical function of the form ln(1+x), which is a first-order approximation for the Hill function at small values of x, where x is a scaled version of the input concentration (FIG. 1D). Furthermore, this circuit had a wide input dynamic range of greater than three orders of magnitude, where the dynamic range is taken to be the span of inputs over which the output is well-fit by ln(x) (FIG. 1D and FIGS. 22A-22F). The simple logarithmic mathematical functions that describe the wide-dynamic-range circuits described herein are useful, in some aspects, for designing higher-order functions. The wide-dynamic-range behavior of the circuits described herein were especially striking when compared with the narrow dynamic range of the open-loop (OL) control circuit, which has a shunt motif but no positive-feedback motif. This ‘OL-shunt’ motif is shown in FIGS. 1B and 1n FIGS. 20A-20C. When the shunt plasmid in the PF-shunt motif contains a Pₗᵤₓ promoter rather than a P_{BAD} promoter, wide-dynamic-range logarithmic operation for the AraC-based circuit is also absent (FIGS. 19A-19B). These control circuits demonstrate the importance of graded positive feedback, as implemented herein with the PF-shunt motif components, to achieve wide-dynamic-range operation in the graded molecular circuits described herein.

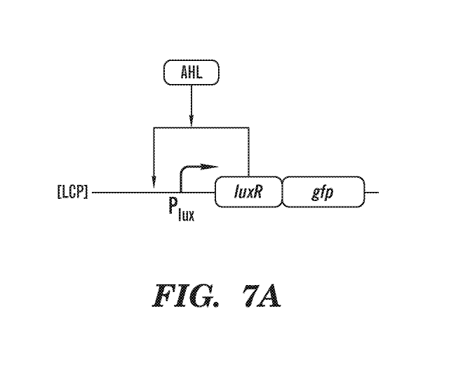

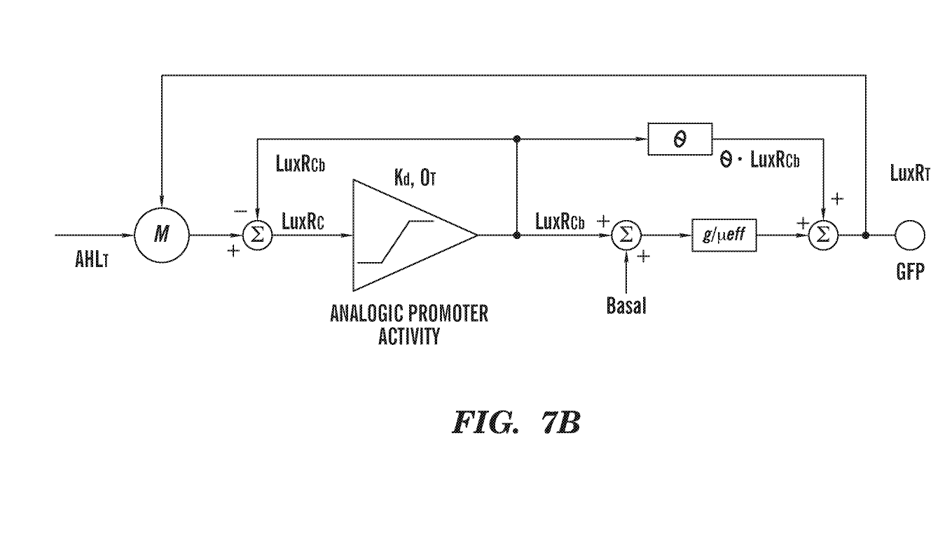

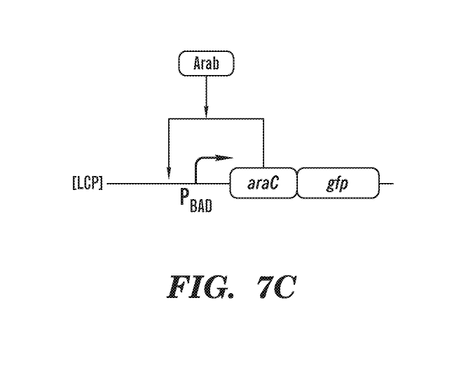

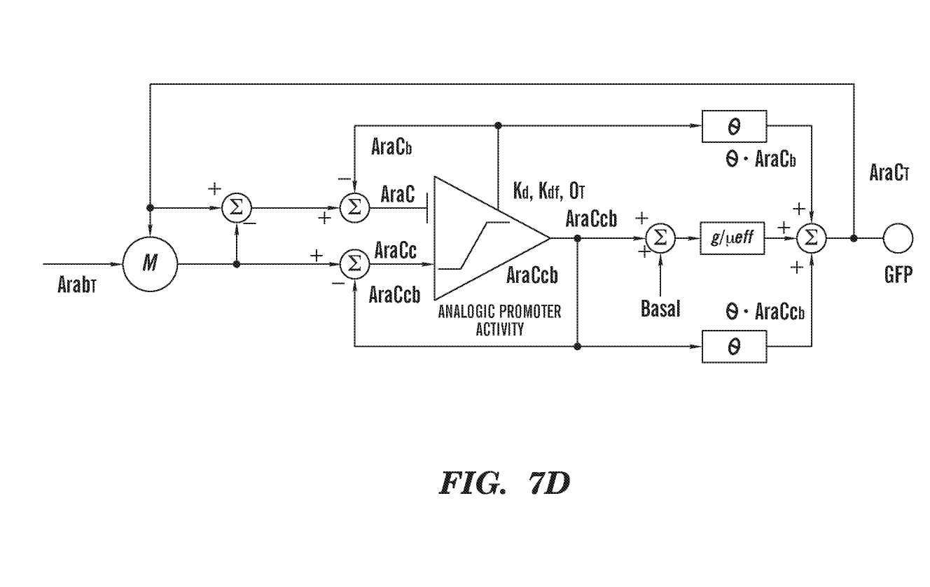

To gain deeper insights into the mechanisms that may give rise to logarithmically linear transfer functions, detailed biochemical models were built which capture the effects of inducer-to-TF binding, TF-to-DNA binding, the “PF-shunt” circuit topology, and protein degradation (FIGS. 1E and 7D). Using a consistent set of model parameters that only differ based on the various circuit topologies (e.g., in plasmid copy number), our biochemical models accurately capture the behaviors of the multiple circuits described herein (FIGS. 1A-1E, 2A-2E, and 3A-3H). A minimal biochemical model, which only incorporates the basic effects of graded positive feedback also exhibits linearization (FIGS. 34A-34G). Indeed, the circuit topologies described herein for widening the log-linear dynamic range of operation via graded positive feedback is conceptually general and applies to both genetic and electronic circuits: expansive sin h-based linearization of compressive tan h-based functions in log-domain electronic circuits²³ is analogous to the use of expansive positive-feedback linearization of compressive biochemical binding functions in log-domain genetic circuits.

In some embodiments of the aspects described herein, the quorum-sensing LuxR transcriptional activator, which is induced by Acyl Homoserine Lactone (AHL) and activates the promoter Pₗᵤₓ, can be applied to a graded molecular circuit comprising a positive-feedback (PF) component located on a low-copy plasmid (LCP) and a shunt component located on a high-copy plasmid (HCP) (FIG. 2A), as described herein.

In some such embodiments of the aspects described herein, the positive-feedback component on the LCP comprises one or more inducible promoters operably linked to sequences encoding the luxR transcription factor that binds to the Pₗᵤₓ promoter, which is induced by AHL. In some such embodiments, the one or more inducible promoters of the positive-feedback component is/are also operably linked to sequences encoding a protein output, such as a detectable output, for example, a reporter protein, such as GFP, in addition to the transcription factor specific. Thus, the luxR transcription factor, generated by the positive-feedback component,t increase its own generation via a positive-feedback loop, and alleviates saturation of the inducer (AHL)-TF interaction.

In some embodiments of the aspects described herein, the shunt component on the HCP is comprised of one or more inducible promoters, such as Pₗᵤₓ, that are bound by and shunt away the luxR transcription factor generated by the LCP, thus reducing saturation of the luxR transcription factor-DNA interaction on the LCP.

In addition, in some embodiments, the shunt component on the HCP also generates a protein output, such as a reporter protein, that is different from the TF output of the LCP and the reporter output of the LCP, such as mCherry (FIG. 2A). As such, the one or more inducible promoters of the shunt component is/are operably linked to sequences encoding a protein output, such as a detectable output, for example, mCherry.

Accordingly, as demonstrated herein, in some embodiments of these aspects, a graded molecular circuit uses AHL as the molecular input species Mᵢₙ; LuxR bound to AHL, termed “LuxR_{c},” as the output molecular species produced by the association block or C, and LuxR_{d}, bound to DNA, i.e., the Pₗᵤₓ promoter as the C′ molecular species produced by the control component. The output transformation block then produces LuxR as Mₒᵤₜ with a transformation strength that may be altered by ribosome binding sequences (FIG. 4C) or by the use of other transcription factor inputs. The shunt component also comprises a Pₗᵤₓ promoter operably linked to a sequence encoding an output product, such as a reporter protein, e.g., mCherry (see, for example, FIGS. 2A-2E). In some such embodiments, Mₒᵤₜ=Mₒᵤₜ′=LuxR in terms of molecular species, but not in terms of concentration. Again, other similarly functioning molecules can be used than the exemplary Lux, a Pₗᵤₓ promoter, and mCherry reporter.

In some embodiments of the graded molecular circuits described herein, where a configuration involving a “positive-feedback (PF) component” located on a low-copy plasmid (LCP) and a “shunt component” located on a high-copy plasmid (HCP) is used, the association strength and consequent effective strength of the control block is determined by the K_{d} of the molecular binding of C to DNA, i.e., LuxR_{c} to Pₗᵤₓ in the control block of the exemplary circuit described above. In addition, the degradation strength can be set, in some embodiments, by dilution and protein degradation of the bound molecular species C′=LuxR_{cb}, such as dilution and protein degradation of LuxR_{cb} in the control block of the exemplary circuit described above. Similarly, the degradation strength of the feedback blocks of the circuits is determined by dilution and protein degradation of the molecular species Mₒᵤₜ or Mₒᵤₜ′, for example, LuxR or LuxR_{c} in the feedback block of the exemplary circuit described herein. The attenuation strength of the feedback block and the attenuation strength of the control block can be altered, in some embodiments, by changing the ratio of the HCP and LCP.

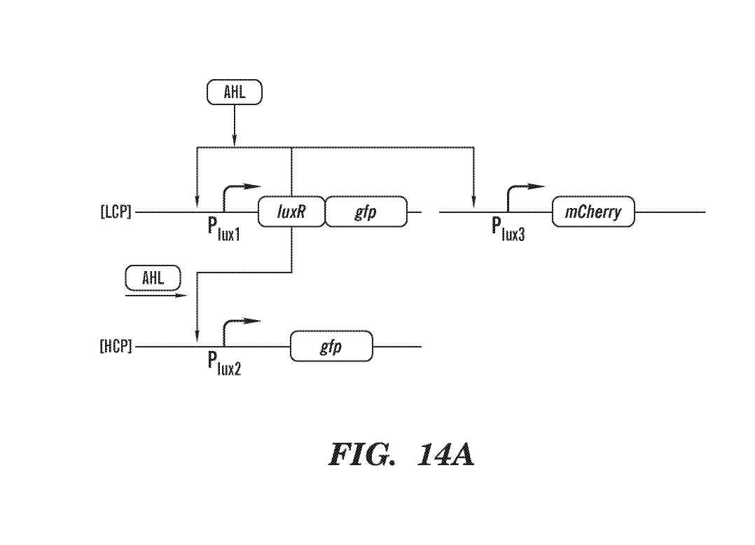

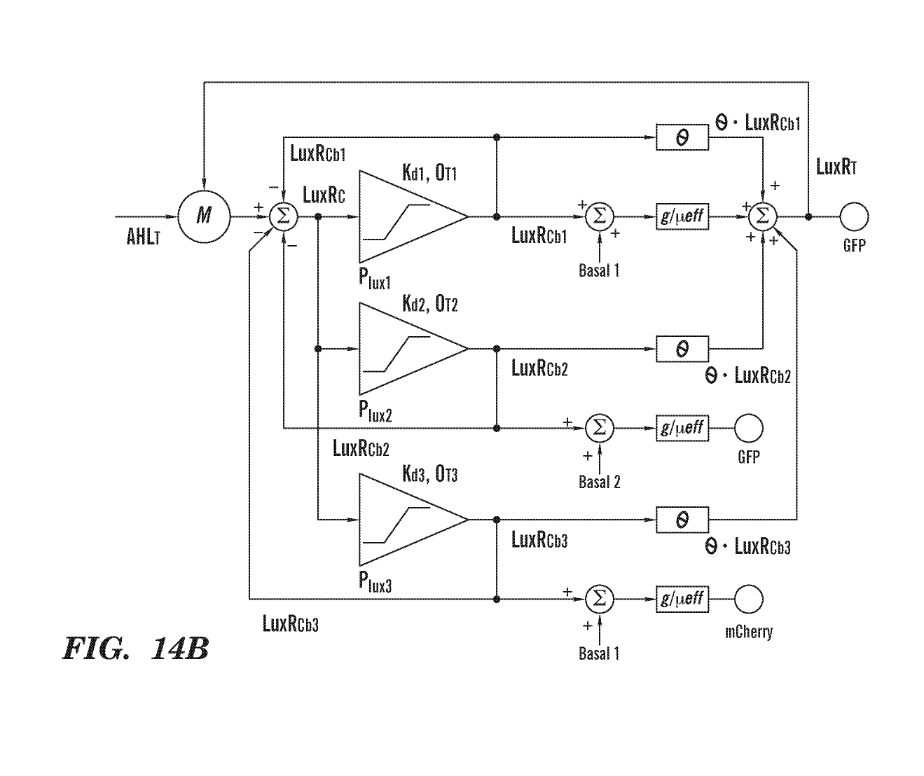

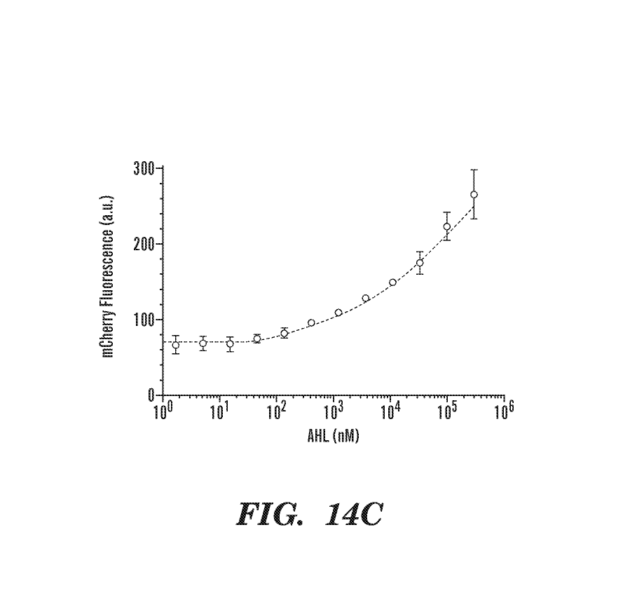

As demonstrated herein, a fluorescent output of this circuit, GFP, was fused to the C-terminus of LuxR and used a HCP Pₗᵤₓ-mCherry shunt. The LuxR PF-shunt circuit also had an input dynamic range of more than three orders of magnitude (FIG. 2B) and performed robustly over multiple time points (FIG. 30). This input dynamic range was significantly greater than that achieved with control LuxR-GFP positive feedback alone or with LuxR-GFP positive feedback with a medium-copy plasmid (MCP) shunt (FIG. 2B). The output of the shunt plasmid (mCherry) exhibited similar properties and thus can also be used for computation (FIG. 2C). As in the AraC-based circuits (FIGS. 1A-1E), detailed biochemical models (FIGS. 2B-2C and FIG. 14B), where the only varying parameter was the plasmid copy number, and the simple ln(1+x) mathematical function (FIGS. 2B-2C) captured the behavior of the LuxR-based circuits.

In some embodiments of the aspects described herein, the behavior of the PF-shunt circuit motifs can be dynamically tuned by changing the relative copy numbers of the PF and shunt plasmids. For example, in some embodiments, such tuning can be achieved by combining a HCP shunt with a variable-copy plasmid (VCP), based on a pBAC/oriV vector 24, carrying the PF component (FIG. 2D). When the VCP was induced to a high-copy state, the circuit had a narrow dynamic range of about two orders of magnitude and was poorly fit by a ln(1+x) function but could be fit by a ‘digital-like’ Hill function (FIG. 2E). When the VCP was in a low-copy state, the circuit behaved in an analog fashion, followed a ln(1+x) mathematical relationship, and exhibited a broad dynamic range of nearly four orders of magnitude. Such tuning demonstrates the importance of the relative copy numbers of the PF and shunt plasmids in enabling wide-dynamic-range logarithmic operation using the circuits described herein. It also provides a mechanism for actively changing circuit behavior between analog and digital modes and shows that the PF-shunt circuit motif can be reliably utilized in different Escherichia coli strain backgrounds.

Accordingly, in some embodiments of the graded positive-feedback molecular/biological circuits described herein, where a configuration involving a “positive-feedback (PF) component” located on a low-copy plasmid (LCP) and a “shunt component” located on a high-copy plasmid (HCP) is used, the ratio of the number of high-copy plasmids versus the low-copy plasmids is at least 2:1, at least 3:1, at least 4:1, at least 5:1, at least 6:1, at least 7:1, at least 8:1, at least 9:1, at least 10:1, at least 11:1, at least 12:1, at least 13:1, at least 14:1, at least 15:1, at least 16:1, at least 17:1, at least 18:1, at least 19:1, at least 20:1, at least 25:1, at least 30:1, at least 40:1, at least 50:1, at least 60:1, at least 70:1, at least 80:1, at least 90:1, at least 100:1, or more, or any ratio in between, e.g., 63:1, 27:5 and the like. Modeling and experimental data indicate that the ratio of 63:1 is effective in this embodiment.

Embodiments for graded molecular circuits do not necessarily need an LCP and HCP and can be all implemented on the same plasmid, in some embodiments. For example, FIG. 85 shows that increasing the association strength weight of the control block of FIG. 84 via a mutation to the pLuxR promoter termed pLuxR*56 causes strong positive feedback and a quickly saturating curve with a narrow dynamic range of operation (the top S-shaped curve in FIG. 85). In contrast, if the same strong promoter is used to create decoy binding sites such that the attenuation weight of the control block in FIG. 84 is changed, wide dynamic range analog operation (the linear curve in FIG. 85) results. The curves in FIG. 85 correspond to GFP output on the Y axis and AHL concentration on the X axis. Thus, the use of graded positive feedback to alleviate molecular binding saturation and achieve wide-dynamic-range analog operation as outlined in FIG. 84 provides a general strategy that can be embodied through several mechanisms.

The difference between the DNA sequence of PluxR vs. PluxR56 corresponds to just four base pairs: The ACCT start of the standard PluxR promoter was mutated to TGGG in PluxR56 to obtain the results shown in FIG. 85. The detailed promoter sequences for the normal vs. mutated promoter are provided in the section on component molecular species and parts.

In some aspects, the analog computation modules described herein can be used to generate more complex circuits for higher-order functions. For example, as described herein, in some aspects, a molecular circuit can be created for implementing wide-dynamic-range negative logarithms, a broadly useful computation for calculations, such as for example in division, which can be achieved via logarithmic subtraction for applications that need to compute pH or pKa. Such functionality can be built by combining the PF-shunt positive-logarithm component parts described herein with an additional repressor component part, or inversion component, as shown in FIGS. 3A-3H. Since the PF-shunt component has an inducer input and a protein output, and the repressor component has a protein input and a protein output, they can be cascaded together to yield a multi-module system, in some aspects.

For example, in some embodiments, to achieve a molecular circuit having a wide-dynamic-range negative logarithm function, an additional output promoter is added to the LCP of the PF-shunt motif as described for the graded positive-feedback molecular circuits. As shown herein, the behavior of such a circuit was predicted by the biochemical models described herein and was also well fit by a ln(1+x) mathematical function (FIGS. 3A-3H).

FIG. 4A reveals how two wide-dynamic-range positive-feedback logarithmic circuits can be composed together to architect higher order computational functions: The molecular fluxes from a common output molecule (mCherry in FIG. 4A) from both circuits get automatically summed to effectively implement addition. Addition of two logarithmically transformed inputs effectively encodes a multiplication operation. FIG. 4B reveals data from the circuit of FIG. 4A. The ribosome binding sequences in FIG. 4A can be altered to change the weights of each added output such that a scaled and weighted summation may be also be performed. Similarly, FIG. 4C shows how a wide-dynamic-range positive-feedback logarithmic circuit and a wide-dynamic-range negative-logarithm circuit can be composed together to architect higher order computational functions: The molecular fluxes from a common output molecule (mCherry in FIG. 4C) from both circuits get automatically subtracted from one other (since one circuit represses its production while the other enhances its production) to effectively implement subtraction. Subtraction of two logarithmically transformed inputs effectively encodes a division operation. If the ribosome binding sequences of FIG. 4C or the IPTG concentration is adjusted to make the positive and negative slopes of the two logarithmic circuits equal, then the logarithmic concentration ratio or “pRATIO” of the two input molecules can be obtained over four orders of magnitude. FIG. 4D shows experimental data from the circuit of FIG. 4C. The pRATIO is log(Arab/AHL) in the embodiment corresponding to FIG. 4C with associated experimental data for this embodiment shown in FIG. 4D. Such tuning can also be achieved, in some embodiments, by tagging LacI with an ssrA-based degradation tag and expressing it from a weaker ribosome-binding sequence (FIG. 24E), or, in some embodiments, by mutagenizing the LacI transcription factor or its cognate promoter.

In the embodiment of FIG. 4A, summation is achieved by combining two parallel wide-dynamic-range positive-logarithm circuits that accept different input molecules (e.g., AHL and arabinose) but that produce a common output molecule. The adder exhibited log-linear behavior over a range of two orders of magnitude (FIG. 4B and FIG. 25). Since log-linear addition of two inputs effectively implements the logarithm of their product, and an analog product is equivalent to a ‘soft AND’, the data of FIG. 4B has similarities to the data exhibited by digital AND circuit,s except that the overall function is more graded in nature.

The log-transformed ratio of two different input inducers as shown in the embodiment of FIG. 4C, can be used, in some aspects, to create a “ratiometric circuit” or “ratiometric molecular circuit.” Ratiometric calculations are useful in biological systems, as they enable the normalization of measurements, comparisons between variables, and decisions based on competing inputs. The ratiometer circuits described herein were built by combining a wide-dynamic-range negative-logarithm circuit and a wide-dynamic-range positive-logarithm circuit that accept different input molecules but that produce a common output molecule (FIGS. 4C and 4D). This circuit essentially calculates the difference between the log-transformed outputs of the two inputs (subtraction in the logarithmic domain). By tuning the ribosome-binding sequences of the negative-logarithm and positive-logarithm such that the magnitude of their slopes are similar, the resulting mathematical function is a log-transformed ratio between the two inputs and functions over four orders of magnitude of this ratio. The wide-dynamic-range ratiometer circuits described herein enable, for example, the concept of pH, which measures the logarithmic concentration ratio of H⁺ with respect to an absolute value, to be generalized to the concept of pRATIO, which can be useful for measuring the logarithmic concentration ratio of one input with respect to another input.

In addition to the above positive-feedback logarithmic transduction, addition, and subtraction circuits, also provided herein, in some aspects, are “negative-feedback molecular circuits” comprising two or more modular functional components for implementing wide-dynamic range computations, wherein the output molecular species concentration is a desired power-law function of the input molecular species concentration can be constructed. The latter molecular circuit can be implementable or executable in a cell, cellular system, or in vitro system comprising molecular or biological machinery or components, such as transcriptional or translational machinery or components.

In some embodiments of these aspects and all such aspects described herein, the two or more modular components comprise an input association block, a control block, an output transformation block, and a feedback block as in FIG. 84. Negative feedback, rather than positive feedback, is implemented because the signs of the functional derivatives of the blocks in the feedback loop are configured such that small changes in C (or in any other variable in the feedback loop such as C′, Mₒᵤₜ, or Mₒᵤₜ′) propagate around the loop and return as further changes in C that reduce the change in C, thus creating a negative-feedback loop²⁰. These negative-feedback molecular circuits can use, for example, transcriptional and translational regulation mechanisms via component parts to implement logarithmic mathematical functions in a cell, cellular system, or in vitro system, as described herein.

For example, in some embodiments of these aspects and all such aspects described herein, for example in FIG. 4E, a negative-feedback molecular circuit comprises an input association block wherein an input inducer molecule Mᵢₙ (IPTG in FIG. 4E) and “feedback transcription factor” Mₒᵤₜ (lacI-mCherry in FIG. 4E) are associated, a control block wherein the feedback transcription factor binds to DNA located on a low-copy plasmid (LCP) and represses production of a “working transcription factor” (araC-GFP in FIG. 4E) and an output transformation block comprised of a promoter located on a high-copy plasmid (HCP) that transforms the working transcription factor to the feedback transcription factor, Mₒᵤₜ (lacI-mCherry in FIG. 4E), which also serves as the output. From the point of view of the general feedback loop of FIG. 84, Mₒᵤₜ=Mₒᵤₜ′ in this circuit with the overall feedback being negative because of the repressory action of LacI.

In some embodiments of these aspects, the LCP comprises one or more inducible promoters operably linked to sequences encoding transcription factors (TFs) that bind to these same promoters, i.e., TFs that are “specific for the inducible promoter.” In some embodiments, the one or more inducible promoters of the PF component is/are also operably linked to sequences encoding a protein output, such as a detectable output, for example, a reporter protein.

In some embodiments of these aspects, the HCP, acting in its function as an output transformation block, generates a protein output, that can also be operably linked to sequences encoding a reporter protein (lacI-mCherry in FIG. 4E).

In addition, in some embodiments, the feedback loop can comprise any other molecular species acting on another molecular species, such as any other protein acting on a promoter, or other genetic regulatory element, a microRNA (miRNA) or any other RNA species acting on a promoter or other genetic regulatory element, or a microRNA (miRNA) or any other RNA species bound to a protein acting on a promoter, or other genetic regulatory element.

The circuit of FIG. 4E implements a power law through the use of negative feedback: An inducer-transcription-factor binding function is introduced into a strong negative-feedback loop that includes two stages of amplification (FIG. 4E). The topology uses LacI-mCherry produced from a HCP to repress the production of AraC-GFP on an LCP, which in turn activates the production of LacI-mCherry to create a negative-feedback loop. The power-law nature of the circuits described herein arise via the interactions of saturated-repressor polynomial functions and a linear activator polynomial function in a feedback loop. As demonstrated herein, the power-law behavior of the circuits described herein extended over two orders of magnitude, was accurately predicted by detailed biochemical models, and well matched by a simple xⁿ mathematical function (FIG. 4F).

The circuits described herein, which represent exemplary embodiments, provide a complete basis function set for logarithmically linear analog computation that requires logarithmic transduction (FIGS. 1C, 1E and 2A,2B), addition (FIG. 4A and FIG. 4B that illustrate analog addition/multiplication), subtraction (FIGS. 4C and 4D that illustrate analog subtraction/division), and scaling (FIGS. 4E and 4F that illustrate analog scaling/power laws).

As described herein, complex synthetic analog circuits can be designed using detailed biochemical models. However, a simpler predictive abstraction can be derived from the fact that the behavior of the circuit motifs described herein can be well fit to logarithmic functions. These biochemical models and mathematical functions provide complementary tools with varying levels of granularity for composing simple analog circuit modules (e.g., input-inducer-to-output-protein modules and input-protein-to-output-protein modules) to implement more complex functions in a predictable fashion. Indeed, abstractions with different levels of granularity are commonly used in other engineering fields during various stages of design²⁰. For example, the straightforward cascade of logarithms from FIG. 3B and FIG. 3D yield a good fit to the experimental data (FIG. 3H). Furthermore, mathematical approximations can simplify this cascade to a negative logarithm −ln(x) over the experimentally observed wide dynamic range (FIGS. 24A-24F).

As demonstrated herein, we have shown that powerful wide-dynamic-range analog computations can be performed with just three biological parts in living cells. Qian and Winfree recently demonstrated the impressive implementation of an in vitro 4-input-bit and 2-output-bit square-root digital calculator using 130 DNA strands within a DNA-based computation framework²⁵. In comparison, the in-vivo analog power-law circuits described herein exploit binding functions that are already present in the biochemistry and therefore only requires two transcription factors. Even 1-bit full adders and subtractors in digital computation require several logic gates and thus, numerous synthetic parts^{8,9,11}. The wide-dynamic-range analog adders and ratiometer circuits described herein are inherently implemented by circuits that add flux to or subtract flux from a common output molecule and can be constructed with no more than three transcription factors (FIGS. 4A-4F).

As demonstrated herein, the analog motifs described herein can be applied to different transcription factor families (e.g., AraC and LuxR). Thus, the analog circuits and motifs described herein are generalizable to other transcription factor-inducer systems, such as those provided herein, via part mining to enable wide-dynamic-range biosensors that provide quantitative measurements of inducer concentrations, rather than binary read-outs^{26,27}.

In some aspects, the mechanisms underlying the analog circuits and motifs described herein are adaptable to other host cells, including yeast and mammalian cells. Indeed, shunt or decoy TF binding sites are naturally present in eukaryotes and are expected to influence the behavior of gene networks²⁸. They can also find applications, in some aspects, in biotechnology by allowing engineers to finely tune the expression level of toxic proteins, enzymes in a metabolic pathway, or stress-response proteins^{29,30}. For example, in some embodiments, ratios between small-molecules (e.g., NAD+/NADH) and proteins (e.g., Oct3/4, Sox2, Klf4, and c-Myc for cellular reprogramming) are important control parameters that could serve as inputs into ratiometric circuits that trigger downstream effectors. More advanced systems can incorporate analog biosensors with feedback control of endogenous genetic circuits to regulate phenotypes in a precise and dynamic fashion. The wide-dynamic-range analog computation circuits and motifs described herein can be further integrated with dynamical systems, such as timers³¹ and oscillators³²⁻³⁴, negative-feedback linearizing circuits^{35,36}, endogenous circuits³⁷, cell-cell communication^{8,9,38,39} and implemented using RNA components^{7,40}, synthetic transcriptional regulation^{3,41}, or protein-protein interactions⁴².

Using fundamental properties of the scaling laws of thermodynamic noise with temperature and molecular count, which are true in both biological and in electronic systems, the pros and cons of analog versus digital computation have been analyzed for neurobiological systems²¹ and for systems in cell biology²⁰. These results show that analog computation is more efficient than digital computation in part count, speed, and energy consumption below a certain crossover computational precision. While the exact crossover precision varies with the computation, in both electronics and in actual biological cells, the exploitation of feedback loops, calibration loops, technological basis functions, redundancy, signal averaging, and error-correcting topologies can push this crossover precision to higher values. Alternatively, for a given speed of operation, more energy must be expended in creating a higher molecular production rate that leads to a higher molecular count and thus higher precision^{2,21}. Thus, tradeoffs between error and use of resources are inherent to the design of synthetic circuits in living cells. To demonstrate the tunability of the analog circuits described herein, an AraC PF-shunt circuit with two P_{BAD} promoters on the shunt plasmid, was constructed leading to an increase in the log-linear gain of about 2-fold over its single P_{BAD} counterpart (FIGS. 29A-29B). The sensitivities of the circuits described herein, defined as the fractional change in the output divided by the fractional change in the input, were also analyzed and it was found that they compare favorably to circuits operating with positive feedback only or in open-loop configurations (FIGS. 31A-31E).

Efficient and accurate computational paradigm for synthetic biological networks can ultimately be used to integrate both analog and digital processing (a simple example of switched analog computation is shown, for example, in FIGS. 28A-28C). This mixed-signal approach can utilize analog or collective analog²⁰ functions for front-end processing in concert with decision-making digital circuits; or, it can use graded feedback for simultaneous analog and digital computation, as in neuronal networks in the brain⁴³. Thus, efforts using the circuits and motifs described herein can seek to integrate synthetic analog and digital computation in living cells to achieve enhanced computational power, efficiency, reliability, and memory. Such mixed-signal processing would benefit from the development of circuits to convert signals from analog to digital and vice versa^{20,44}.

Also, provided herein, in some aspects, are positive-feedback molecular circuits comprising:
a. a positive feedback component comprising:
   i. a first molecular species, and
   ii. a second molecular species that increases activity of the first molecular species, wherein the first molecular species regulates expression, activity, and/or generation of the second molecular species, thereby forming a positive-feedback loop;
b. a shunt component comprising:
   i. a first molecular species identical to or functionally equivalent to the first molecular species of the positive feedback component, the activity of which is regulated by the second molecular species of the positive-feedback component;
and
c. an inducing molecular species that: (i) induces activity of the first molecular species of the positive feedback component, (ii) induces activity of the first molecular species of the shunt component, and (iii) interacts with the second molecular species of the positive feedback component to further induce activity of the first molecular species of the positive feedback and shunt components
wherein the positive-feedback molecular circuit executes in a cell, cellular system, or in vitro system.

In some embodiments of these circuits and all such circuits described herein, the shunt component further comprises a second molecular species, the expression, activity, and/or generation of which is regulated by the first molecular species of the shunt component. In some embodiments of these circuits and all such circuits described herein, the second molecular species is a detectable output, such as a fluorescent molecule or other well-known detectable biomolecule.

In some embodiments of these circuits and all such circuits described herein, the positive feedback component further comprises a third molecular species, expression, activity, and/or generation of which is regulated by the first molecular species of the positive feedback loop. In some embodiments of these circuits and all such circuits described herein, the second molecular species is a detectable output. In some embodiments of these circuits and all such circuits described herein, the third molecular species of the positive feedback component is different from the second molecular species of the shunt component.

In some embodiments of these circuits and all such circuits described herein, the first molecular species of the shunt component is an inducible promoter sequence.

In some embodiments of these circuits and all such circuits described herein, the first molecular species of the positive feedback component is an inducible promoter sequence. In some embodiments of these circuits and all such circuits described herein, a sequence encoding the second molecular species of the positive feedback component is operably linked to the inducible promoter sequence. In some embodiments of these circuits and all such circuits described herein, the sequence encoding the second molecular species of the positive feedback component encodes for an RNA molecule or protein that is specific for the inducible promoter sequence and increases its transcriptional activity. In some embodiments of these circuits and all such circuits described herein, the protein that is specific for the inducible promoter sequence is a transcription factor. In some embodiments of these circuits and all such circuits described herein, the transcription factor is an engineered transcription factor.

In some embodiments of these circuits and all such circuits described herein, the second molecular species of the feedback component increases transcriptional activity of the first molecular species of the positive feedback component and the first molecular species of the shunt component.

In some embodiments of these circuits and all such circuits described herein, the second molecular species is a transcriptional activator.

In some embodiments of these circuits and all such circuits described herein, a ratio of the shunt component to the positive feedback component is at least 2:1.

In some embodiments of these circuits and all such circuits described herein, the positive feedback component is located on a low-copy plasmid.

In some embodiments of these circuits and all such circuits described herein, the shunt component is located on a high-copy plasmid.

In some embodiments of these circuits and all such circuits described herein,
a. the first molecular species of the positive feedback component comprises an inducible promoter sequence;
b. the second molecular species of the positive feedback component comprises a sequence encoding a transcriptional activator operably linked to the inducible promoter sequence, wherein the activator is specific for the inducible promoter sequence;
c. the first molecular species of the shunt component comprises an inducible promoter sequence identical to or functionally equivalent to the inducible promoter sequence of the positive feedback component; and
d. the inducing molecular species comprises a molecule that induces the inducible promoter sequence of the positive feedback component and the shunt component.

In some embodiments of these circuits and all such circuits described herein, the positive feedback component further comprises a sequence encoding a detectable output operably linked to the first molecular species.

In some embodiments of these circuits and all such circuits described herein, the shunt component further comprises a sequence encoding a detectable output operably linked to the inducible promoter sequence.

In some embodiments of these circuits and all such circuits described herein, the detectable output of the positive feedback component is different from the detectable output of the shunt component.

In some embodiments of these circuits and all such circuits described herein,
a. the first molecular species of the positive feedback component comprises a P_{LUX} promoter sequence;
b. the second molecular species of the positive feedback component comprises a sequence encoding luxR operably linked to the P_{LUX} promoter sequence that is specific for the P_{LUX} promoter sequence;
c. the first molecular species of the shunt component comprises a P_{LUX} promoter sequence identical to or functionally equivalent to the P_{LUX} promoter sequence of the positive feedback component; and
d. the inducing molecular species comprises AHL that induces the F_{LUX} promoter sequence.

In some embodiments of these circuits and all such circuits described herein, the positive feedback component further comprises a sequence encoding a detectable output operably linked to the P_{LUX} promoter sequence.

In some embodiments of these circuits and all such circuits described herein, the shunt component further comprises a sequence encoding a detectable output operably linked to the P_{LUX} promoter sequence.

In some embodiments of these circuits and all such circuits described herein, the detectable output of the positive feedback component is different from the detectable output of the shunt component.

In some embodiments of these circuits and all such circuits described herein, the detectable output is a reporter output. In some embodiments of these circuits and all such circuits described herein, the detectable output is a fluorescent output.

In some embodiments of these circuits and all such circuits described herein,
a. the first molecular species of the positive feedback component comprises a P_{BAD} promoter sequence;
b. the second molecular species of the positive feedback component comprises a sequence encoding arabinose C (araC) operably linked to the P_{BAD} promoter sequence that is specific for the P_{BAD} promoter sequence;
c. the first molecular species of the shunt component comprises a P_{BAD} promoter sequence identical to or functionally equivalent to the P_{BAD} promoter sequence of the positive feedback component; and
d. the inducing molecular species comprises arabinose (Arab) that induces the P_{BAD} promoter sequence.

In some embodiments of these circuits and all such circuits described herein, the positive feedback component further comprises a sequence encoding a detectable output operably linked to the P_{BAD} promoter sequence.

In some embodiments of these circuits and all such circuits described herein, the shunt component further comprises a sequence encoding a detectable output operably linked to the P_{BAD} promoter sequence.

In some embodiments of these circuits and all such circuits described herein, the detectable output of the positive feedback component is different from the detectable output of the shunt component.

In some embodiments of these circuits and all such circuits described herein, the detectable output is a reporter output.

In some embodiments of these circuits and all such circuits described herein, the detectable output is a fluorescent output.

Also provided herein, in some aspects, are adder molecular circuits or molecular circuits for performing addition or weighted addition comprising two or more of the positive feedback molecular circuits described herein, as shown in, for example, FIG. 4A.

In some embodiments of these circuits and all such circuits described herein, the inducing molecular species of each of the two or more positive feedback molecular circuits is different.

In some embodiments of these circuits and all such circuits described herein, the inducing molecular species of at least one of the two or more positive feedback molecular circuits is different from the inducing molecular species of any of the other two or more positive feedback molecular circuits.

In some embodiments of these circuits and all such circuits described herein, the shunt component of each of the two or more positive feedback molecular circuits comprises a second molecular species. In some embodiments of these circuits, the second molecular species of the shunt component is a detectable output. In some embodiments of these circuits, the second molecular species of the shunt components of each of the two or more positive feedback molecular circuits is the same or functionally equivalent.

Also provided herein, in some aspects, are negative-slope molecular circuits comprising:
a. a positive feedback component comprising:
   i. a first molecular species, and
   ii. a second molecular species that increases activity of the first molecular species, wherein the first molecular species regulates expression, activity, and/or generation of the second molecular species, thereby forming a positive-feedback loop;
b. a shunt component comprising:
   i. a first molecular species identical to or functionally equivalent to the first molecular species of the positive feedback component, the activity of which is regulated by the second molecular species of the positive-feedback component;
c. an inversion component comprising:
   i. a first molecular species identical to or functionally equivalent to the first molecular species of the positive feedback component, the activity of which is regulated by the second molecular species of the positive-feedback component;
   ii. a second molecular species, wherein the first molecular species regulates expression, activity, and/or generation of the second molecular species; and
   iii. a third molecular species, the activity of which is inhibited by the second molecular species;
d. an inducing molecular species that: (i) induces activity of the first molecular species of the positive feedback component, (ii) induces activity of the first molecular species of the shunt component, and (iii) interacts with the second molecular species of the positive feedback component to further induce activity of the first molecular species of the positive feedback and shunt components; and
e. a repressing molecular species that interacts with and inhibits the activity of the second molecular species of the inversion component, thereby increasing activity of the third molecular species;
wherein the negative-slope molecular circuit executes in a cell, cellular system, or in vitro system.

In some embodiments of these circuits and all such circuits described herein, the shunt component further comprises a second molecular species, the expression, activity, and/or generation of which is regulated by the first molecular species of the shunt component.

In some embodiments of these circuits and all such circuits described herein, the second molecular species is a detectable output.

In some embodiments of these circuits and all such circuits described herein, the positive feedback component further comprises a third molecular species, expression, activity, and/or generation of which is regulated by the first molecular species of the positive feedback component.

In some embodiments of these circuits and all such circuits described herein, the second molecular species is a detectable output.

In some embodiments of these circuits and all such circuits described herein, the third molecular species of the positive feedback component is different from the second molecular species of the shunt component.

In some embodiments of these circuits and all such circuits described herein, the first molecular species of the shunt component is an inducible promoter sequence.

In some embodiments of these circuits and all such circuits described herein, the first molecular species of the positive feedback component is an inducible promoter sequence.

In some embodiments of these circuits and all such circuits described herein, a sequence encoding the second molecular species of the positive feedback component is operably linked to the inducible promoter sequence.

In some embodiments of these circuits and all such circuits described herein, the sequence encoding the second molecular species of the positive feedback component encodes for an RNA molecule or protein that is specific for the inducible promoter sequence and increases its transcriptional activity.

In some embodiments of these circuits and all such circuits described herein, the protein that is specific for the inducible promoter sequence is a transcription factor.

In some embodiments of these circuits and all such circuits described herein, the transcription factor is an engineered transcription factor.

In some embodiments of these circuits and all such circuits described herein, the second molecular species of the feedback component increases transcriptional activity of: (i) the first molecular species of the positive feedback component and (ii) the first molecular species of the shunt component.

In some embodiments of these circuits and all such circuits described herein, the second molecular species is a transcriptional activator.

In some embodiments of these circuits and all such circuits described herein, the inversion component further comprises a fourth molecular species, the expression, activity, and/or generation of which is regulated by the third molecular species of the inversion component.

In some embodiments of these circuits and all such circuits described herein, the fourth molecular species is a detectable output.

In some embodiments of these circuits and all such circuits described herein, the first molecular species of the inversion component is an inducible promoter sequence.

In some embodiments of these circuits and all such circuits described herein, a sequence encoding the second molecular species of the inversion component is operably linked to the inducible promoter sequence.

In some embodiments of these circuits and all such circuits described herein, the sequence encoding the second molecular species of the inversion component encodes for an RNA molecule or protein that is specific for the third molecular species and decreases its activity.

In some embodiments of these circuits and all such circuits described herein, the third molecular species is an inducible promoter sequence.

In some embodiments of these circuits and all such circuits described herein, a ratio of the shunt component to the positive feedback component is at least 2:1.

In some embodiments of these circuits and all such circuits described herein, the positive feedback component and the first and second molecular species of the inversion component are located on a low-copy plasmid.

In some embodiments of these circuits and all such circuits described herein, the shunt component and the third molecular species of the inversion component is located on a high-copy plasmid.

In some embodiments of these circuits and all such circuits described herein,
a. the first molecular species of the positive feedback component comprises an inducible promoter sequence;
b. the second molecular species of the positive feedback component comprises a sequence encoding a transcriptional activator operably linked to the inducible promoter sequence, wherein the activator is specific for the inducible promoter sequence;
c. the first molecular species of the shunt component comprises an inducible promoter sequence identical to or functionally equivalent to the inducible promoter sequence of the positive feedback component;
d. the first molecular species of the inversion component comprises an inducible promoter sequence identical to or functionally equivalent to the inducible promoter sequence of the positive feedback component and the shunt component;
e. the second molecular species of the inversion component comprises a sequence encoding a transcriptional repressor operably linked to the inducible promoter sequence that is specific for and represses the third molecular species;
f. the third molecular species of the inversion component comprises an inducible promoter that is repressed by the second molecular species; and
g. the inducing molecular species comprises a molecule that induces the inducible promoter sequences of the positive feedback component and the shunt component;
h. the repressing molecular species comprises a molecule that interacts with the second molecular species of the inversion component, thereby inhibiting repression of the third molecular species.

In some embodiments of these circuits and all such circuits described herein, the positive feedback component further comprises a sequence encoding a detectable output operably linked to the first molecular species.

In some embodiments of these circuits and all such circuits described herein, the shunt component further comprises a sequence encoding a detectable output operably linked to the inducible promoter sequence.

In some embodiments of these circuits and all such circuits described herein, the detectable output of the positive feedback component is different from the detectable output of the shunt component.

In some embodiments of these circuits and all such circuits described herein, the inversion component further comprises a sequence encoding a detectable output operably linked to the inducible promoter sequence.
a. In some embodiments of these circuits and all such circuits described herein, the first molecular species of the positive feedback component comprises a P_{LUX} promoter sequence;
b. the second molecular species of the positive feedback component comprises a sequence encoding luxR operably linked to the P_{LUX} promoter sequence, wherein luxR is specific for the P_{LUX} promoter sequence;
c. the first molecular species of the shunt component comprises a P_{LUX} promoter sequence identical to or functionally equivalent to the P_{LUX} promoter sequence of the positive feedback component;
d. the first molecular species of the inversion component comprises a P_{LUX} promoter sequence;
e. the second molecular species of the inversion component comprises a sequence encoding lad operably linked to the P_{LUX} promoter sequence, wherein lad is specific for and a P_{lacO} promoter sequence;
f. the third molecular species of the inversion component comprises a P_{lacO} promoter sequence;
g. the inducing molecular species comprises AHL that induces the P_{LUX} promoter sequence; and
h. the repressing molecular species comprises IPTG that is specific for and inhibits lacI.

In some embodiments of these circuits and all such circuits described herein, the positive feedback component further comprises a sequence encoding a detectable output operably linked to the P_{LUX} promoter sequence.

In some embodiments of these circuits and all such circuits described herein, the shunt component further comprises a sequence encoding a detectable output operably linked to the P_{LUX} promoter sequence.

In some embodiments of these circuits and all such circuits described herein, the detectable output of the positive feedback component is different from the detectable output of the shunt component.

In some embodiments of these circuits and all such circuits described herein, the inversion component further comprises a sequence encoding a detectable output operably linked to the P_{lacO} promoter sequence.

In some embodiments of these circuits and all such circuits described herein, the detectable output is a reporter output.

In some embodiments of these circuits and all such circuits described herein, the detectable output is a fluorescent output.

Also provided herein, in some aspects, are ratiometric molecular circuits or molecular circuits for performing division comprising at least one positive feedback molecular circuit and at least one negative-slope molecular circuit, as shown in, for example, FIG. 4C.

Provided herein, in other aspects, are power-law molecular circuit comprising:
a. a feedback component comprising:
   i. a first molecular species, and
   ii. a second molecular species, wherein the first molecular species regulates expression, activity, and/or generation of the second molecular species;
b. a shunt component comprising:
   i. a first molecular species, the activity of which is regulated by the second molecular species of the feedback component;
   ii. a second molecular species, wherein the first molecular regulates expression, activity, and/or generation of the second molecular species, and wherein the second molecular species inhibits the activity of the first molecular species of the feedback component;
c. an inducing molecular species that induces activity of the first molecular species of the shunt component, and (ii) interacts with the first molecular species of the feedback component; and
d. a repressing molecular species that interacts with and inhibits the activity of the second molecular species of the shunt component, thereby increasing activity of the first molecular species of the feedback component;
wherein the power-law molecular circuit executes in a cell, cellular system, or in vitro system.

In some embodiments of these circuits and all such circuits described herein, the shunt component further comprises a third molecular species, the expression, activity, and/or generation of which is regulated by the first molecular species of the shunt component.

In some embodiments of these circuits and all such circuits described herein, the second molecular species is a detectable output.

In some embodiments of these circuits and all such circuits described herein, the feedback component further comprises a third molecular species, expression, activity, and/or generation of which is regulated by the first molecular species of the feedback component.

In some embodiments of these circuits and all such circuits described herein, the third molecular species is a detectable output.

In some embodiments of these circuits and all such circuits described herein, the third molecular species of the feedback component is different from the third molecular species of the shunt component.

In some embodiments of these circuits and all such circuits described herein, the first molecular species of the feedback component is an inducible promoter sequence.

In some embodiments of these circuits and all such circuits described herein, a sequence encoding the second molecular species of the feedback component is operably linked to the inducible promoter sequence.

In some embodiments of these circuits and all such circuits described herein, the sequence encoding the second molecular species of the feedback component encodes for an RNA molecule or protein that is specific for the first molecular species of the shunt component and increases its activity.

In some embodiments of these circuits and all such circuits described herein, the protein that is specific for the first molecular species of the shunt component is a transcription factor.

In some embodiments of these circuits and all such circuits described herein, the transcription factor is an engineered transcription factor.

In some embodiments of these circuits and all such circuits described herein, the first molecular species of the shunt component is an inducible promoter sequence.

In some embodiments of these circuits and all such circuits described herein, a sequence encoding the second molecular species of the shunt component is operably linked to the inducible promoter sequence.

In some embodiments of these circuits and all such circuits described herein, the sequence encoding the second molecular species of the shunt component encodes for an RNA molecule or protein that is specific for the first molecular species of the shunt component and decreases its activity.

In some embodiments of these circuits and all such circuits described herein, the protein that is specific for the first molecular species of the shunt component is a transcription factor.

In some embodiments of these circuits and all such circuits described herein, the transcription factor is an engineered transcription factor.

In some embodiments of these circuits and all such circuits described herein, the second molecular species of the feedback component increases transcriptional activity of the shunt component.

In some embodiments of these circuits and all such circuits described herein, the second molecular species is a transcriptional activator.

In some embodiments of these circuits and all such circuits described herein, a ratio of the shunt component to the feedback component is at least 2:1.

In some embodiments of these circuits and all such circuits described herein, the feedback component is located on a low-copy plasmid.

In some embodiments of these circuits and all such circuits described herein, the shunt component is located on a high-copy plasmid.

In some embodiments of these circuits and all such circuits described herein,
a. the first molecular species of the feedback component comprises an inducible promoter sequence;
b. the second molecular species of the feedback component comprises a sequence encoding a transcriptional activator operably linked to the inducible promoter sequence;
c. the first molecular species of the shunt component comprises an inducible promoter sequence that is activated by the transcriptional activator of the feedback component;
d. the second molecular species of the shunt component comprises a sequence encoding a transcriptional repressor operably linked to the inducible promoter sequence that is specific for and represses the inducible promoter sequence of the feedback component;
e. the inducing molecular species comprises a molecule that induces the inducible promoter sequence of the shunt component;
f. the repressing molecular species comprises a molecule that interacts with the second molecular species of the shunt component, thereby inhibiting repression of the inducible promoter sequence of the feedback component.

In some embodiments of these circuits and all such circuits described herein, the feedback component further comprises a sequence encoding a detectable output operably linked to the inducible promoter sequence.

In some embodiments of these circuits and all such circuits described herein, the shunt component further comprises a sequence encoding a detectable output operably linked to the inducible promoter sequence.

In some embodiments of these circuits and all such circuits described herein, the detectable output of the feedback component is different from the detectable output of the shunt component.
a. In some embodiments of these circuits and all such circuits described herein, the first molecular species of the feedback component comprises a P_{lacO} promoter sequence;
b. the second molecular species of the feedback component comprises a sequence encoding araC operably linked to the P promoter sequence, wherein araC is specific for a P_{BAD} promoter sequence;
c. the first molecular species of the shunt component comprises a P_{BAD} promoter sequence, wherein araC of the feedback component is specific for it;
d. the second molecular species of the shunt component comprises a sequence encoding lad operably linked to the P_{BAD} promoter sequence, wherein lad is specific for and represses the P_{lacO} promoter sequence of the feedback component;
e. the inducing molecular species comprises Arabinose that induces the P_{BAD} promoter sequence; and
f. the repressing molecular species comprises IPTG that is specific for and inhibits lad of the shunt component.

In some embodiments of these circuits and all such circuits described herein, the feedback component further comprises a sequence encoding a detectable output operably linked to the P_{lacO} promoter sequence.

In some embodiments of these circuits and all such circuits described herein, the shunt component further comprises a sequence encoding a detectable output operably linked to the P_{BAD} promoter sequence.

In some embodiments of these circuits and all such circuits described herein, the detectable output of the feedback component is different from the detectable output of the shunt component.

In some embodiments of these circuits and all such circuits described herein, the detectable output is a reporter output.

In some embodiments of these circuits and all such circuits described herein, the detectable output is a fluorescent output.

In some aspects of all the embodiments of the invention, the circuits are made using nucleic acids as “building blocks” to encode other nucleic acids or proteins that interact with a promoter, enhancer, repressor or other responsive component that can regulate the circuit's expression.

In some aspects of all the embodiments of the invention, the circuits are made using enzymes and ligands thereto to execute the similar functions by regulating the enzyme activity, using, e.g., catalysts and coenzymes to provide the increase or decrease for the enzymatic reaction driving the circuits.

### Component Molecular Parts and Molecular Species

Provided herein are component molecular species or molecular parts that can be used to generate the molecular circuit configurations comprising the modular functional blocks for performing complex mathematical functions described herein. Such molecular species include nucleic acid sequences, such as inducible promoters, transcriptional activators and repressors, degaradation tages, ribosome binding sites, micro RNA binding sequences, and the like. As understood by one of skill in the art, these molecular species can be used to generate the circuit configurations, and specific combinations of these molecular species can be used alone and in combination to modulate the functionalities of the circuits and alter circuit parameters, such as the strength of a given modular functional block, for example.

### Promoters

Accordingly, provided herein are promoter sequences as component molecular species for use in the molecular/biological circuits, and functional and physical modules described herein. In some embodiments of the aspects described herein, the promoters used in the multi-input molecular circuits, and functional and physical modules described herein drive expression of an operably linked output sequence, such as, for example, a transcription factor sequence, a reporter sequence, an enzyme sequence, or a microRNA or other nucleic acid sequence.

The term “promoter” as used herein refers to any nucleic acid sequence that regulates the expression of another nucleic acid sequence by driving transcription of the nucleic acid sequence, which can be a heterologous target gene, encoding a protein or an RNA. Promoters can be constitutive, inducible, activateable, repressible, tissue-specific, or any combination thereof. A promoter is a control region of a nucleic acid sequence at which initiation and rate of transcription of the remainder of a nucleic acid sequence are controlled. A promoter can also contain genetic elements at which regulatory proteins and molecules can bind, such as RNA polymerase and other transcription factors.

In some embodiments of the aspects, a promoter can drive the expression of a transcription factor that regulates the expression of the promoter itself, or that of another promoter used in another modular component described herein.

A promoter can be said to drive expression or drive transcription of the nucleic acid sequence that it regulates. The phrases “operably linked”, “operatively positioned,” “operatively linked,” “under control,” and “under transcriptional control” indicate that a promoter is in a correct functional location and/or orientation in relation to a nucleic acid sequence it regulates to control transcriptional initiation and/or expression of that sequence. An “inverted promoter” is a promoter in which the nucleic acid sequence is in the reverse orientation, such that what was the coding strand is now the non-coding strand, and vice versa.

In addition, in various embodiments described herein, a promoter can be used in conjunction with an “enhancer,” which refers to a cis-acting regulatory sequence involved in the transcriptional activation of a nucleic acid sequence downstream of the promoter. The enhancer can be located at any functional location before or after the promoter, and/or the encoded nucleic acid. A promoter for use in the molecular/biological circuits described herein can also be “bidirectional,” wherein such promoters can initiate transcription of operably linked sequences in both directions.

A promoter can be one naturally associated with a gene or sequence, as can be obtained by isolating the 5′ non-coding sequences located upstream of the coding segment and/or exon of a given gene or sequence. Such a promoter can be referred to as “endogenous.” Similarly, an enhancer can be one naturally associated with a nucleic acid sequence, located either downstream or upstream of that sequence.

Alternatively, certain advantages can be gained by positioning a coding nucleic acid segment under the control of a recombinant or heterologous promoter, which refers to a promoter that is not normally associated with the encoded nucleic acid sequence in its natural environment. A recombinant or heterologous enhancer refers to an enhancer not normally associated with a nucleic acid sequence in its natural environment. Such promoters or enhancers can include promoters or enhancers of other genes; promoters or enhancers isolated from any other prokaryotic, viral, or eukaryotic cell; and synthetic promoters or enhancers that are not “naturally occurring”, i.e., contain different elements of different transcriptional regulatory regions, and/or mutations that alter expression through methods of genetic engineering that are known in the art. In addition to producing nucleic acid sequences of promoters and enhancers synthetically, sequences can be produced using recombinant cloning and/or nucleic acid amplification technology, including PCR, in connection with the molecular/biological circuits described herein (see U.S. Pat. No. 4,683,202, U.S. Pat. No. 5,928,906, each incorporated herein by reference). Furthermore, it is contemplated that control sequences that direct transcription and/or expression of sequences within non-nuclear organdies such as mitochondria, chloroplasts, and the like, can be employed as well.

### Inducible Promoters

As described herein, an “inducible promoter” is one that is characterized by initiating or enhancing transcriptional activity when in the presence of, influenced by, or contacted by an inducer or inducing agent. An “inducer” or “inducing agent” can be endogenous, or a normally exogenous compound or protein that is administered in such a way as to be active in inducing transcriptional activity from the inducible promoter.

In some embodiments of the aspects described herein, the inducer or inducing agent, i.e., a chemical, a compound or a protein, can itself be the result of transcription or expression of a nucleic acid sequence (i.e., an inducer can be a transcriptional repressor protein, such as Lad), which itself can be under the control of an inducible promoter. In some embodiments, an inducible promoter is induced in the absence of certain agents, such as a repressor. In other words, in such embodiments, the inducible promoter drives transcription of an operably linked sequence except when the repressor is present. Examples of inducible promoters include but are not limited to, tetracycline, metallothionine, ecdysone, mammalian viruses (e.g., the adenovirus late promoter; and the mouse mammary tumor virus long terminal repeat (MMTV-LTR)) and other steroid-responsive promoters, rapamycin responsive promoters and the like.

Inducible promoters useful in molecular/biological circuits, methods of use, and systems described herein are capable of functioning in both prokaryotic and eukaryotic host organisms. In some embodiments of the different aspects described herein, mammalian inducible promoters are included, although inducible promoters from other organisms, as well as synthetic promoters designed to function in a prokaryotic or eukaryotic host can be used. One important functional characteristic of the inducible promoters described herein is their ultimate inducibility by exposure to an externally applied inducer, such as an environmental inducer. Appropriate environmental inducers include exposure to heat (i.e., thermal pulses or constant heat exposure), various steroidal compounds, divalent cations (including Cu²⁺ and Zn²⁺), galactose, tetracycline or doxycycline, IPTG (isopropyl-β-D thiogalactoside), as well as other naturally occurring and synthetic inducing agents and gratuitous inducers.

The promoters for use in the molecular/biological circuits described herein encompass the inducibility of a prokaryotic or eukaryotic promoter by, in part, either of two mechanisms. In some embodiments of the aspects described herein, the molecular/biological circuits comprise suitable inducible promoters that can be dependent upon transcriptional activators that, in turn, are reliant upon an environmental inducer. In other embodiments, the inducible promoters can be repressed by a transcriptional repressor which itself is rendered inactive by an environmental inducer, such as the product of a sequence driven by another promoter. Thus, unless specified otherwise, an inducible promoter can be either one that is induced by an inducing agent that positively activates a transcriptional activator, or one which is derepressed by an inducing agent that negatively regulates a transcriptional repressor. In such embodiments of the various aspects described herein, where it is required to distinguish between an activating and a repressing inducing agent, explicit distinction will be made.

Inducible promoters that are useful in the molecular/biological circuits and methods of use described herein also include those controlled by the action of latent transcriptional activators that are subject to induction by the action of environmental inducing agents. Some non-limiting examples include the copper-inducible promoters of the yeast genes CUP1, CRS5, and SOD1 that are subject to copper-dependent activation by the yeast ACE1 transcriptional activator (see e.g. Strain and Culotta, 1996; Hottiger et al., 1994; Lapinskas et al., 1993; and Gralla et al., 1991). Alternatively, the copper inducible promoter of the yeast gene CTT1 (encoding cytosolic catalase T), which operates independently of the ACE1 transcriptional activator (Lapinskas et al., 1993), can be utilized. The copper concentrations required for effective induction of these genes are suitably low so as to be tolerated by most cell systems, including yeast and Drosophila cells. Alternatively, other naturally occurring inducible promoters can be used in the present invention including: steroid inducible gene promoters (see e.g. Oligino et al. (1998) Gene Ther. 5: 491-6); galactose inducible promoters from yeast (see e.g. Johnston (1987) Microbiol Rev 51: 458-76; Ruzzi et al. (1987) Mol Cell Biol 7: 991-7); and various heat shock gene promoters. Many eukaryotic transcriptional activators have been shown to function in a broad range of eukaryotic host cells, and so, for example, many of the inducible promoters identified in yeast can be adapted for use in a mammalian host cell as well. For example, a unique synthetic transcriptional induction system for mammalian cells has been developed based upon a GAL4-estrogen receptor fusion protein that induces mammalian promoters containing GAL4 binding sites (Braselmann et al. (1993) Proc Natl Acad Sci USA 90: 1657-61). These and other inducible promoters responsive to transcriptional activators that are dependent upon specific inducers are suitable for use with the molecular/biological circuits described herein.

Inducible promoters useful in some embodiments of the molecular/biological circuits and methods of use disclosed herein also include those that are repressed by “transcriptional repressors” that are subject to inactivation by the action of environmental, external agents, or the product of another gene. Such inducible promoters can also be termed “repressible promoters” where it is required to distinguish between other types of promoters in a given module or component of a molecular/biological circuit described herein. Examples include prokaryotic repressors that can transcriptionally repress eukaryotic promoters that have been engineered to incorporate appropriate repressor-binding operator sequences.

In some embodiments, repressors for use in the circuits described herein are sensitive to inactivation by physiologically benign agent. Thus, where a lac repressor protein is used to control the expression of a promoter sequence that has been engineered to contain a lacO operator sequence, treatment of the host cell with IPTG will cause the dissociation of the lac repressor from the engineered promoter containing a lacO operator sequence and allow transcription to occur. Similarly, where a tet repressor is used to control the expression of a promoter sequence that has been engineered to contain a tetO operator sequence, treatment of the host cell with tetracycline or doxycycline will cause the dissociation of the tet repressor from the engineered promoter and allow transcription of the sequence downstream of the engineered promoter to occur.

An inducible promoter useful in the methods and systems as disclosed herein can be induced by one or more physiological conditions, such as changes in pH, temperature, radiation, osmotic pressure, saline gradients, cell surface binding, and the concentration of one or more extrinsic or intrinsic inducing agents. The extrinsic inducer or inducing agent can comprise amino acids and amino acid analogs, saccharides and polysaccharides, nucleic acids, protein transcriptional activators and repressors, cytokines, toxins, petroleum-based compounds, metal containing compounds, salts, ions, enzyme substrate analogs, hormones, and combinations thereof. In specific embodiments, the inducible promoter is activated or repressed in response to a change of an environmental condition, such as the change in concentration of a chemical, metal, temperature, radiation, nutrient or change in pH. Thus, an inducible promoter useful in the molecular/biological circuits, methods and systems as disclosed herein can be a phage inducible promoter, nutrient inducible promoter, temperature inducible promoter, radiation inducible promoter, metal inducible promoter, hormone inducible promoter, steroid inducible promoter, and/or hybrids and combinations thereof.

Promoters that are inducible by ionizing radiation can be used in certain embodiments, where gene expression is induced locally in a cell by exposure to ionizing radiation such as UV or x-rays. Radiation inducible promoters include the non-limiting examples of fos promoter, c-jun promoter or at least one CArG domain of an Egr-1 promoter. Further non-limiting examples of inducible promoters include promoters from genes such as cytochrome P450 genes, inducible heat shock protein genes, metallothionein genes, hormone-inducible genes, such as the estrogen gene promoter, and such. In further embodiments, an inducible promoter useful in the methods and systems as described herein can be Zn²⁺ metallothionein promoter, metallothionein-1 promoter, human metallothionein IIA promoter, lac promoter, lacO promoter, mouse mammary tumor virus early promoter, mouse mammary tumor virus LTR promoter, triose dehydrogenase promoter, herpes simplex virus thymidine kinase promoter, simian virus 40 early promoter or retroviral myeloproliferative sarcoma virus promoter. Examples of inducible promoters also include mammalian probasin promoter, lactalbumin promoter, GRP78 promoter, or the bacterial tetracycline-inducible promoter. Other examples include phorbol ester, adenovirus E1A element, interferon, and serum inducible promoters.

Inducible promoters useful in the functional modules and molecular/biological circuits as described herein for in vivo uses can include those responsive to biologically compatible agents, such as those that are usually encountered in defined animal tissues or cells. An example is the human PAI-1 promoter, which is inducible by tumor necrosis factor. Further suitable examples include cytochrome P450 gene promoters, inducible by various toxins and other agents; heat shock protein genes, inducible by various stresses; hormone-inducible genes, such as the estrogen gene promoter, and such.

The administration or removal of an inducer or repressor as disclosed herein results in a switch between the “on” or “off” states of the transcription of the operably linked heterologous target gene. Thus, as defined herein the “on” state, as it refers to a promoter operably linked to a nucleic acid sequence, refers to the state when the promoter is actively driving transcription of the operably linked nucleic acid sequence, i.e., the linked nucleic acid sequence is expressed. Several small molecule ligands have been shown to mediate regulated gene expressions, either in tissue culture cells and/or in transgenic animal models. These include the FK1012 and rapamycin immunosupressive drugs (Spencer et al., 1993; Magari et al., 1997), the progesterone antagonist mifepristone (RU486) (Wang, 1994; Wang et al., 1997), the tetracycline antibiotic derivatives (Gossen and Bujard, 1992; Gossen et al., 1995; Kistner et al., 1996), and the insect steroid hormone ecdysone (No et al., 1996). All of these references are herein incorporated by reference. By way of further example, Yao discloses in U.S. Pat. No. 6,444,871, which is incorporated herein by reference, prokaryotic elements associated with the tetracycline resistance (tet) operon, a system in which the tet repressor protein is fused with polypeptides known to modulate transcription in mammalian cells. The fusion protein is then directed to specific sites by the positioning of the tet operator sequence. For example, the tet repressor has been fused to a transactivator (VP16) and targeted to a tet operator sequence positioned upstream from the promoter of a selected gene (Gussen et al., 1992; Kim et al., 1995; Hennighausen et al., 1995). The tet repressor portion of the fusion protein binds to the operator thereby targeting the VP16 activator to the specific site where the induction of transcription is desired. An alternative approach has been to fuse the tet repressor to the KRAB repressor domain and target this protein to an operator placed several hundred base pairs upstream of a gene. Using this system, it has been found that the chimeric protein, but not the tet repressor alone, is capable of producing a 10 to 15-fold suppression of CMV-regulated gene expression (Deuschle et al., 1995).

One example of a repressible promoter useful in the molecular/biological circuits described herein is the Lac repressor (lacR)/operator/inducer system of E. coli that has been used to regulate gene expression by three different approaches: (1) prevention of transcription initiation by properly placed lac operators at promoter sites (Hu and Davidson, 1987; Brown et al., 1987; Figge et al., 1988; Fuerst et al., 1989; Deuschle et al., 1989; (2) blockage of transcribing RNA polymerase II during elongation by a LacR/operator complex (Deuschle et al. (1990); and (3) activation of a promoter responsive to a fusion between LacR and the activation domain of herpes simples virus (HSV) virion protein 16 (VP16) (Labow et al., 1990; Bairn et al., 1991). In one version of the Lac system, expression of lac operator-linked sequences is constitutively activated by a LacR-VP16 fusion protein and is turned off in the presence of isopropyl-β-D-1-thiogalactopyranoside (IPTG) (Labow et al. (1990), cited supra). In another version of the system, a lacR-VP16 variant is used that binds to lac operators in the presence of IPTG, which can be enhanced by increasing the temperature of the cells (Baim et al. (1991), cited supra).

Thus, in some embodiments described herein, components of the Lac system are utilized. For example, a lac operator (LacO) can be operably linked to tissue specific promoter, and control the transcription and expression of the heterologous target gene and another protein, such as a repressor protein for another inducible promoter. Accordingly, the expression of the heterologous target gene is inversely regulated as compared to the expression or presence of Lac repressor in the system.

Components of the tetracycline (Tc) resistance system of E. coli have also been found to function in eukaryotic cells and have been used to regulate gene expression. For example, the Tet repressor (TetR), which binds to tet operator (tetO) sequences in the absence of tetracycline or doxycycline and represses gene transcription, has been expressed in plant cells at sufficiently high concentrations to repress transcription from a promoter containing tet operator sequences (Gatz, C. et al. (1992) Plant J. 2:397-404). In some embodiments described herein, the Tet repressor system is similarly utilized in the molecular/biological circuits described herein.

A temperature- or heat-inducible gene regulatory system can also be used in the circuits and modules described herein, such as the exemplary TIGR system comprising a cold-inducible transactivator in the form of a fusion protein having a heat shock responsive regulator, rheA, fused to the VP16 transactivator (Weber et al., 2003a). The promoter responsive to this fusion thermosensor comprises a rheO element operably linked to a minimal promoter, such as the minimal version of the human cytomegalovirus immediate early promoter. At the permissive temperature of 37° C., the cold-inducible transactivator transactivates the exemplary rheO-CMVmin promoter, permitting expression of the target gene. At 41° C., the cold-inducible transactivator no longer transactivates the rheO promoter. Any such heat-inducible or heat-regulated promoter can be used in accordance with the circuits and methods described herein, including but not limited to a heat-responsive element in a heat shock gene (e.g., hsp20-30, hsp27, hsp40, hsp60, hsp70, and hsp90). See Easton et al. (2000) Cell Stress Chaperones 5(4):276-290; Csermely et al. (1998) Pharmacol Ther 79(2): 129-1 68; Ohtsuka & Hata (2000) Int J Hyperthermia 16(3):231-245; and references cited therein. Sequence similarity to heat shock proteins and heat-responsive promoter elements have also been recognized in genes initially characterized with respect to other functions, and the DNA sequences that confer heat inducibility are suitable for use in the disclosed gene therapy vectors. For example, expression of glucose-responsive genes (e.g., grp94, grp78, mortalin/grp75) (Merrick et al. (1997) Cancer Lett 119(2): 185-1 90; Kiang et al. (1998) FASEB J 12(14):1571-16-579), calreticulin (Szewczenko-Pawlikowski et al. (1997) MoI Cell Biochem 177(1-2): 145-1 52); clusterin (Viard et al. (1999) J Invest Dermatol 112(3):290-296; Michel et al. (1997) Biochem J 328(Ptl):45-50; Clark & Griswold (1997) J Androl 18(3):257-263), histocompatibility class I gene (HLA-G) (Ibrahim et al. (2000) Cell Stress Chaperones 5(3):207-218), and the Kunitz protease isoform of amyloid precursor protein (Shepherd et al. (2000) Neuroscience 99(2):31 7-325) are upregulated in response to heat. In the case of clusterin, a 14 base pair element that is sufficient for heat-inducibility has been delineated (Michel et al. (1997) Biochem J 328(Ptl):45-50). Similarly, a two sequence unit comprising a 10- and a 14-base pair element in the calreticulin promoter region has been shown to confer heat-inducibility (Szewczenko-Pawlikowski et al. (1997) MoI Cell Biochem 177(1-2): 145-1 52).

Other inducible promoters useful in the molecular/biological circuits described herein include the erythromycin-resistance regulon from E. coli, having repressible (E_{off}) and inducible (Eₒₙ) systems responsive to macrolide antibiotics, such as erythromycin, clarithromycin, and roxithromycin (Weber et al., 2002). The E_{off} system utilizes an erythromycin-dependent transactivator, wherein providing a macrolide antibiotic represses transgene expression. In the Eₒₙ system, the binding of the repressor to the operator results in repression of transgene expression. Thus, in the presence of macrolides, gene expression is induced.

Fussenegger et al. (2000) describe repressible and inducible systems using a Pip (pristinamycin-induced protein) repressor encoded by the streptogramin resistance operon of Streptomyces coelicolor, wherein the systems are responsive to streptogramin-type antibiotics (such as, for example, pristinamycin, virginiamycin, and Synercid). The Pip DNA-binding domain is fused to a VP16 transactivation domain or to the KRAB silencing domain, for example. The presence or absence of, for example, pristinamycin, regulates the PipON and PipOFF systems in their respective manners, as described therein.

Another example of a promoter expression system useful for the molecular/biological circuits described herein utilizes a quorum-sensing (referring to particular prokaryotic molecule communication systems having diffusible signal molecules that prevent binding of a repressor to an operator site, resulting in derepression of a target regulon) system. For example, Weber et al. (2003b) employ a fusion protein comprising the Streptomyces coelicolor quorum-sending receptor to a transactivating domain that regulates a chimeric promoter having a respective operator that the fusion protein binds. The expression is fine-tuned with non-toxic butyrolactones, such as SCB1 and MP133.

In some embodiments, multiregulated, multigene gene expression systems that are functionally compatible with one another are utilized in the the modules and molecular/biological circuits described herein (see, for example, Kramer et al. (2003)). For example, in Weber et al. (2002), the macrolide-responsive erythromycin resistance regulon system is used in conjunction with a streptogramin (PIP)-regulated and tetracycline-regulated expression systems.

Other promoters responsive to non-heat stimuli can also be used. For example, the mortalin promoter is induced by low doses of ionizing radiation (Sadekova (1997) Int J Radiat Biol 72(6):653-660), the hsp27 promoter is activated by 17-β-estradiol and estrogen receptor agonists (Porter et al. (2001) J MoI Endocrinol 26(1):31-42), the HLA-G promoter is induced by arsenite, hsp promoters can be activated by photodynamic therapy (Luna et al. (2000) Cancer Res 60(6): 1637-1 644). A suitable promoter can incorporate factors such as tissue-specific activation. For example, hsp70 is transcriptionally impaired in stressed neuroblastoma cells (Drujan & De Maio (1999) 12(6):443-448) and the mortalin promoter is up-regulated in human brain tumors (Takano et al. (1997) Exp Cell Res 237(1):38-45). A promoter employed in methods described herein can show selective up-regulation in tumor cells as described, for example, for mortalin (Takano et al. (1997) Exp Cell Res 237(1):38-45), hsp27 and calreticulin (Szewczenko-Pawlikowski et al. (1997) MoI Cell Biochem 177(1-2): 145-1 52; Yu et al. (2000) Electrophoresis 2 1(14):3058-3068)), grp94 and grp78 (Gazit et al. (1999) Breast Cancer Res Treat 54(2): 135-146), and hsp27, hsp70, hsp73, and hsp90 (Cardillo et al. (2000) Anticancer Res 20(6B):4579-4583; Strik et al. (2000) Anticancer Res 20(6B):4457-4552).

In some exemplary embodiments of the circuits described herein, an inducible promoter is an arabinose-inducible promoter P_{BAD} comprising the sequence:

(SEQ ID NO: 1)

AAGAAACCAATTGTCCATATTGCATCAGACATTGCCGTCACTGCGTCTTT
TACTGGCTCTTCTCGCTAACCAAACCGGTAACCCCGCTTATTAAAAGCAT
TCTGTAACAAAGCGGGACCAAAGCCATGACAAAAACGCGTAACAAAAGTG
TCTATAATCACGGCAGAAAAGTCCACATTGATTATTTGCACGGCGTCACA
CTTTGCTATGCCATAGCATTTTTATCCATAAGATTAGCGGATCCTACCTG
ACGCTTTTTATCGCAACTCTCTACTGTTTCTCCATA.

In some exemplary embodiments of the circuits described herein, an inducible promoter is an LuxR-inducible promoter P_{LuxR} comprising the sequence:

(SEQ ID NO: 2)

ACCTGTAGGATCGTACAGGTTTACGCAAGAAAATGGTTTGTTATAGTCGA
ATAAA.

In some exemplary embodiments of the circuits described herein, an inducible promoter is an mutated LuxR-targeted promoter with modulated binding efficiency for LuxR, such as, for example,

(SEQ ID NO: 3)

pluxR3:
AATTTGGGGATCGTACAGGTTTACGCAAGAAAATGGTTTGTTATAGTCG
AATAAA
pluxR28:

(SEQ ID NO: 4)

CTGGCGGGGATCGTACAGGTTTACGCAAGAAAATGGTTTGTTATAGTCG
AATAAA
pluxR56:

(SEQ ID NO: 5)

TGGGGTAGGATCGTACAGGTTTACGCAAGAAAATGGTTTGTTATAGTCG
AATAAA.

In some exemplary embodiments of the circuits described herein, the inducible promoter comprises an Anhydrotetracycline (aTc)-inducible promoter as provided in PLtetO-1 (Pubmed Nucleotide# U66309) with the sequence comprising:

(SEQ ID NO: 6)

GCATGCTCCCTATCAGTGATAGAGATTGACATCCCTATCAGTGATAGAGA
TACTGAGCACATCAGCAGGACGCACTGACCAGGA.

In some exemplary embodiments of the circuits described herein, the inducible promoter is an isopropyl β-D-1-thiogalactopyranoside (IPTG) inducible promoter. In one embodiment, the IPTG-inducible promoter comprises the P_{TAC} sequence found in the vector encoded by PubMed Accession ID #EU546824. In one embodiment, the IPTG-inducible promoter sequence comprises the P_{Trc-2} sequence:

(SEQ ID NO: 7)

CCATCGAATGGCTGAAATGAGCTGTTGACAATTAATCATCCGGCTCGTA
TAATGTGTGGAATTGTGAGCGGATAACAATTTCACACAGGA.

In some exemplary embodiments of the circuits described herein, the IPTG-inducible promoter comprises the P_{LlacO-1} sequence:

(SEQ ID NO: 8)

ATAAATGTGAGCGGATAACATTGACATTGTGAGCGGATAACAAGATACT
GAGCACTCAGCAGGACGCACTGACC.

In some exemplary embodiments of the circuits described herein, the IPTG-inducible promoter comprises the P_{AllacO-1} sequence:

(SEQ ID NO: 9)

AAAATTTATCAAAAAGAGTGTTGACTTGTGAGCGGATAACAATGATACT
TAGATTCAATTGTGAGCGGATAACAATTTCACACA.

In some exemplary embodiments of the circuits described herein, the IPTG-inducible promoter comprises the P_{lac/ara-1} sequence

(SEQ ID NO: 10)

CATAGCATTTTTATCCATAAGATTAGCGGATCCTAAGCTTTACAATTGTG
AGCGCTCACAATTATGATAGATTCAATTGTGAGCGGATAACAATTTCA
CACA.

In some exemplary embodiments, the inducible promoter sequence comprises the P_{Ls1con} sequence:

(SEQ ID NO: 11)

GCATGCACAGATAACCATCTGCGGTGATAAATTATCTCTGGCGGTGTTG
ACATAAATACCACTGGCGGTtATAaTGAGCACATCAGCAGG//GTATGCA
AAGGA.

Other non-limiting examples of promoters that are useful for use in the low- and molecular circuits described herein are provided in Tables 1-36.

TABLE 1
Examples of Constitutive E. coli σ⁷⁰ Promoters

| Name | Description | Promoter Sequence |
|---|---|---|
| BBa_I14018 | SEQ ID NO: 12 P(Bla) | ...gtttatacataggcgagtactctgttatgg |
| BBa_I14033 | SEQ ID NO: 13 P(Cat) | ... |
| | | agaggttccaactttcaccataatgaaaca |
| BBa_I14034 | SEQ ID NO: 14 P(Kat) | ... |
| | | taaacaactaacggacaattctacctaaca |
| BBa_I732021 | SEQ ID NO: 15 Template for Building Primer Family | ... |
| | Member | acatcaagccaaattaaacaggattaacac |
| BBa_J742126 | SEQ ID NO: 16 Reverse lambda cI-regulated promoter | ... |
| | | gaggtaaaatagtcaacacgcacggtgtta |
| BBa_J01006 | SEQ ID NO: 17 Key Promoter absorbs 3 | ... |
| | | caggccggaataactccctataatgcgcca |
| BBa_J23100 | SEQ ID NO: 18 constitutive promoter family member | ... |
| | | ggctagctcagtcctaggtacagtgctagc |
| BBa_J23101 | SEQ ID NO: 19 constitutive promoter family member | ... |
| | | agctagctcagtcctaggtattatgctagc |
| BBa_J23102 | SEQ ID NO: 20 constitutive promoter family member | ... |
| | | agctagctcagtcctaggtactgtgctagc |
| BBa_J23103 | SEQ ID NO: 21 constitutive promoter family member | ... |
| | | agctagctcagtcctagggattatgctagc |
| BBa_J23104 | SEQ ID NO: 22 constitutive promoter family member | ... |
| | | agctagctcagtcctaggtattgtgctagc |
| BBa_J23105 | SEQ ID NO: 23 constitutive promoter family member | ... |
| | | ggctagctcagtcctaggtactatgctagc |
| BBa_J23106 | SEQ ID NO: 24 constitutive promoter family member | ... |
| | | ggctagctcagtcctaggtatagtgctagc |
| BBa_J23107 | SEQ ID NO: 25 constitutive promoter family member | ... |
| | | ggctagctcagccctaggtattatgctagc |
| BBa_J23108 | SEQ ID NO: 26 constitutive promoter family member | ... |
| | | agctagctcagtcctaggtataatgctagc |
| BBa_J23109 | SEQ ID NO: 27 constitutive promoter family member | ... |
| | | agctagctcagtcctagggactgtgctagc |
| BBa_J23110 | SEQ ID NO: 28 constitutive promoter family member | ... |
| | | ggctagctcagtcctaggtacaatgctagc |
| BBa_J23111 | SEQ ID NO: 29 constitutive promoter family member | ... |
| | | ggctagctcagtcctaggtatagtgctagc |
| BBa_J23112 | SEQ ID NO: 30 constitutive promoter family member | ... |
| | | agctagctcagtcctagggattatgctagc |
| BBa_J23113 | SEQ ID NO: 31 constitutive promoter family member | ... |
| | | ggctagctcagtcctagggattatgctagc |
| BBa_J23114 | SEQ ID NO: 32 constitutive promoter family member | ... |
| | | ggctagctcagtcctaggtacaatgctagc |
| BBa_J23115 | SEQ ID NO: 33 constitutive promoter family member | ... |
| | | agctagctcagcccttggtacaatgctagc |
| BBa_J23116 | SEQ ID NO: 34 constitutive promoter family member | ... |
| | | agctagctcagtcctagggactatgctagc |
| BBa_J23117 | SEQ ID NO: 35 constitutive promoter family member | ... |
| | | agctagctcagtcctagggattgtgctagc |
| BBa_J23118 | SEQ ID NO: 36 constitutive promoter family member | ... |
| | | ggctagctcagtcctaggtattgtgctagc |
| BBa_J23119 | SEQ ID NO: 37 constitutive promoter family member | ... |
| | | agctagctcagtcctaggtataatgctagc |
| BBa_J23150 | SEQ ID NO: 38 1bp mutant from J23107 | ... |
| | | ggctagctcagtcctaggtattatgctagc |
| BBa_J23151 | SEQ ID NO: 39 1bp mutant from J23114 | ... |
| | | ggctagctcagtcctaggtacaatgctagc |
| BBa_J44002 | SEQ ID NO: 40 pBAD reverse | ... |
| | | aaagtgtgacgccgtgcaaataatcaatgt |
| BBa_J48104 | SEQ ID NO: 41 NikR promoter, a protein of the ribbon | ...gacgaatacttaaaatcgtcatacttattt |
| | helix-helix family of transcription factors that repress | |
| | expre | |
| BBa_J54200 | SEQ ID NO: 42 lacq_Promoter | ... |
| | | aaacctttcgcggtatggcatgatagcgcc |
| BBa_J56015 | SEQ ID NO: 43 lacIQ - promoter sequence | ... |
| | | tgatagcgcccggaagagagtcaattcagg |
| BBa_J64951 | SEQ ID NO: 44 E. coli CreABCD phosphate sensing | ...ttatttaccgtgacgaactaattgctcgtg |
| | operon promoter | |
| BBa_K088007 | SEQ ID NO: 45 GlnRS promoter | ...catacgccgttatacgttgtttacgctttg |
| BBa_K119000 | SEQ ID NO: 46 Constitutive weak promoter of lacZ | ...ttatgcttccggctcgtatgttgtgtggac |
| BBa_K119001 | SEQ ID NO: 47 Mutated LacZ promoter | ... |
| | | ttatgcttccggctcgtatggtgtgtggac |
| BBa_K137029 | SEQ ID NO: 48 constitutive promoter with (TA)10 | ...atatatatatatatataatggaagcgtttt |
| | between -10 and -35 elements | |
| BBa_K137030 | SEQ ID NO: 49 constitutive promoter with (TA)9 | ...atatatatatatatataatggaagcgtttt |
| | between -10 and -35 elements | |
| BBa_K137031 | SEQ ID NO: 50 constitutive promoter with (C)10 | ... |
| | between -10 and -35 elements | ccccgaaagcttaagaatataattgtaagc |
| BBa_K137032 | SEQ ID NO: 51 constitutive promoter with (C)12 | ... |
| | between -10 and -35 elements | ccccgaaagcttaagaatataattgtaagc |
| BBa_K137085 | SEQ ID NO: 52 optimized (TA) repeat constitutive | ...tgacaatatatatatatatataatgctagc |
| | promoter with 13 bp between -10 and -35 elements | |
| BBa_K137086 | SEQ ID NO: 53 optimized (TA) repeat constitutive | ...acaatatatatatatatatataatgctagc |
| | promoter with 15 bp between -10 and -35 elements | |
| BBa_K137087 | SEQ ID NO: 54 optimized (TA) repeat constitutive | ...aatatatatatatatatatataatgctagc |
| | promoter with 17 by between -10 and -35 elements | |
| BBa_K137088 | SEQ ID NO: 55 optimized (TA) repeat constitutive | ...tatatatatatatatatatataatgctagc |
| | promoter with 19 bp between -10 and -35 elements | |
| BBa_K137089 | SEQ ID NO: 56 optimized (TA) repeat constitutive | ...tatatatatatatatatatataatgctagc |
| | promoter with 21 bp between -10 and -35 elements | |
| BBa_K137090 | SEQ ID NO: 57 optimized (A) repeat constitutive | ... |
| | promoter with 17 bp between -10 and -35 elements | aaaaaaaaaaaaaaaaaatataatgctagc |
| BBa_K137091 | SEQ ID NO: 58 optimized (A) repeat constitutive | ... |
| | promoter with 18 bp between -10 and -35 elements | aaaaaaaaaaaaaaaaaatataatgctagc |
| BBa_K256002 | SEQ ID NO: 59 J23101:GFP | ...caccttcgggtgggcctttctgcgtttata |
| BBa_K256018 | SEQ ID NO: 60 J23119:IFP | ...caccttcgggtgggcctttctgcgtttata |
| BBa_K256020 | SEQ ID NO: 61 J23119:H01 | ...caccttcgggtgggcctttctgcgtttata |
| BBa_K256033 | SEQ ID NO: 62 Infrared signal reporter | ...caccttcgggtgggcctttctgcgtttata |
| | (J23119:IFP:J23119:HO1) | |
| BBa_K292000 | SEQ ID NO: 63 Double terminator + constitutive | ... |
| | promoter | ggctagctcagtcctaggtacagtgctagc |
| BBa_K292001 | SEQ ID NO: 64 Double terminator + Constitutive | ... |
| | promoter + Strong RBS | tgctagctactagagattaaagaggagaaa |
| BBa_M13101 | SEQ ID NO: 65 M13K07 gene I promoter | ...cctgtttttatgttattctctctgtaaagg |
| BBa_M13102 | SEQ ID NO: 66 M13K07 gene II promoter | ...aaatatttgcttatacaatcttcctgtttt |
| BBa_M13103 | SEQ ID NO: 67 M13K07 gene III promoter | ... |
| | | gctgataaaccgatacaattaaaggctcct |
| BBa_M13104 | SEQ ID NO: 68 M13K07 gene IV promoter | ...ctcttctcagcgtcttaatctaagctatcg |
| BBa_M13105 | SEQ ID NO: 69 M13K07 gene V promoter | ... |
| | | atgagccagttcttaaaatcgcataaggta |
| BBa_M13106 | SEQ ID NO: 70 M13K07 gene VI promoter | ...ctattgattgtgacaaaataaacttattcc |
| BBa_M13108 | SEQ ID NO: 71 M13K07 gene VIII promoter | ... |
| | | gtttcgcgcttggtataatcgctgggggtc |
| BBa_M13110 | SEQ ID NO: 72 M13110 | ...ctttgcttctgactataatagtcagggtaa |
| BBa_M31519 | SEQ ID NO: 73 Modified promoter sequence of g3. | ... |
| | | aaaccgatacaattaaaggctcctgctagc |
| BBa_R1074 | SEQ ID NO: 74 Constitutive Promoter I | ... |
| | | gccggaataactccctataatgcgccacca |
| BBa_R1075 | SEQ ID NO: 75 Constitutive Promoter II | ... |
| | | gccggaataactccctataatgcgccacca |
| BBa_S03331 | SEQ ID NO: 76 | ttgacaagcttttcctcagctccgtaaact |

TABLE 2
Examples of Constitutive E. coli σ⁷⁰ Promoters

| Identifier | | Sequence | |
|---|---|---|---|
| BBa_J23119 | SEQ ID NO: 77 | ttgacagctagctcagtcctaggtataatgctagc | n/a |
| BBa_J23100 | SEQ ID NO: 78 | ttgacggctagctcagtcctaggtacagtgctagc | 1 |
| BBa_J23101 | SEQ ID NO: 79 | tttacagctagctcagtcctaggtattatgctagc | 0.70 |
| BBa_J23102 | SEQ ID NO: 80 | ttgacagctagctcagtcctaggtactgtgctagc | 0.86 |
| BBa_J23103 | SEQ ID NO: 81 | ctgatagctagctcagtcctagggattatgctagc | 0.01 |
| BBa_J23104 | SEQ ID NO: 82 | ttgacagctagctcagtcctaggtattgtgctagc | 0.72 |
| BBa_J23105 | SEQ ID NO: 83 | tttacggctagctcagtcctaggtactatgctagc | 0.24 |
| BBa_J23106 | SEQ ID NO: 84 | tttacggctagctcagtcctaggtatagtgctagc | 0.47 |
| BBa_J23107 | SEQ ID NO: 85 | tttacggctagctcagccctaggtattatgctagc | 0.36 |
| BBa_J23108 | SEQ ID NO: 86 | ctgacagctagctcagtcctaggtataatgctagc | 0.51 |
| BBa_J23109 | SEQ ID NO: 87 | tttacagctagctcagtcctagggactgtgctagc | 0.04 |
| BBa_J23110 | SEQ ID NO: 88 | tttacggctagctcagtcctaggtacaatgctagc | 0.33 |
| BBa_J23111 | SEQ ID NO: 89 | ttgacggctagctcagtcctaggtatagtgctagc | 0.58 |
| BBa_J23112 | SEQ ID NO: 90 | ctgatagctagctcagtcctagggattatgctagc | 0.00 |
| BBa_J23113 | SEQ ID NO: 91 | ctgatggctagctcagtcctagggattatgctagc | 0.01 |
| BBa_J23114 | SEQ ID NO: 92 | tttatggctagctcagtcctaggtacaatgctagc | 0.10 |
| BBa_J23115 | SEQ ID NO: 93 | tttatagctagctcagcccttggtacaatgctagc | 0.15 |
| BBa_J23116 | SEQ ID NO: 94 | ttgacagctagctcagtcctagggactatgctagc | 0.16 |
| BBa_J23117 | SEQ ID NO: 95 | ttgacagctagctcagtcctagggattgtgctagc | 0.06 |
| BBa_J23118 | SEQ ID NO: 96 | ttgacggctagctcagtcctaggtattgtgctagc | 0.56 |

TABLE 3
Examples of Constitutive E. coli σ^{S} Promoters

| Name | Description | Promoter Sequence |
|---|---|---|
| BBa_J45992 | SEQ ID NO: 97 Full-length stationary phase osmY | ... |
| | promoter | ggtttcaaaattgtgatctatatttaacaa |
| BBa_J45993 | SEQ ID NO: 98 Minimal stationary phase osmY promoter | ... |
| | | ggtttcaaaattgtgatctatatttaacaa |

TABLE 4
Examples of Constitutive E. coli σ³² Promoters

| Name | Description | Promoter Sequence |
|---|---|---|
| BBa_J45504 | SEQ ID NO: 99 htpG Heat Shock Promoter | ...tctattccaataaagaaatcttcctgcgtg |

TABLE 5
Examples of Constitutive B. subtilis σ^{A} Promoters

| Name | Description | Promoter Sequence |
|---|---|---|
| BBa_K143012 | SEQ ID NO: 100 Promoter veg a | ... |
| | constitutive promoter for B. subtilis | aaaaatgggctcgtgttgtacaataaatgt |
| BBa_K143013 | SEQ ID NO: 101 Promoter 43 a constitutive | ... |
| | promoter for B. subtilis | aaaaaaagcgcgcgattatgtaaaatataa |

TABLE 6
Examples of Constitutive B. subtilis σ^{B} Promoters

| Name | Description | Promoter Sequence |
|---|---|---|
| BBa_K143010 | SEQ ID NO: 102 Promoter ctc for B. subtilis | ...atccttatcgttatgggtattgtttgtaat |
| BBa_K143011 | SEQ ID NO: 103 Promoter gsiB for B. subtilis | ... |
| | | taaaagaattgtgagcgggaatacaacaac |
| BBa_K143013 | SEQ ID NO: 104 Promoter 43 a constitutive | ... |
| | promoter for B. subtilis | aaaaaaagcgcgcgattatgtaaaatataa |

TABLE 7
Examples of Constitutive Promoters from Miscellaneous Prokaryotes

| Name | Description | Promoter Sequence |
|---|---|---|
| BBa_K112706 | SEQ ID NO: 105 Pspv2 from Salmonella | ...tacaaaataattcccctgcaaacattatca |
| BBa_K112707 | SEQ ID NO: 106 Pspv from Salmonella | ...tacaaaataattcccctgcaaacattatcg |

TABLE 8
Examples of Constitutive Promoters from bacteriophage T7

| Name | Description | Promoter Sequence |
|---|---|---|
| BBa_I712074 | SEQ ID NO: 107 T7 promoter (strong | ...agggaatacaagctacttgttctttttgca |
| | promoter from T7 bacteriophage) | |
| BBa_J719005 | SEQ ID NO: 108 T7 Promoter | taatacgactcactatagggaga |
| BBa_J34814 | SEQ ID NO: 109 T7 Promoter | gaatttaatacgactcactatagggaga |
| BBa_J64997 | SEQ ID NO: 110 T7 consensus -10 and rest | taatacgactcactatagg |
| BBa_K113010 | SEQ ID NO: 111 overlapping T7 promoter | ... |
| | | gagtcgtattaatacgactctctatagggg |
| BBa_K113011 | SEQ ID NO: 112 more overlapping T7 | ... |
| | promoter | agtgagtcgtactacgactcactatagggg |
| BBa_K113012 | SEQ ID NO: 113 weaken overlapping T7 | ... |
| | promoter | gagtcgtattaatacgactctctatagggg |
| BBa_R0085 | SEQ ID NO: 114 T7 Consensus Promoter | taatacgactcactatagggaga |
| | Sequence | |
| BBa_R0180 | SEQ ID NO: 115 T7 RNAP promoter | ttatacgactcactatagggaga |
| BBa_R0181 | SEQ ID NO: 116 T7 RNAP promoter | gaatacgactcactatagggaga |
| BBa_R0182 | SEQ ID NO: 117 T7 RNAP promoter | taatacgtctcactatagggaga |
| BBa_R0183 | SEQ ID NO: 118 T7 RNAP promoter | tcatacgactcactatagggaga |
| BBa_Z0251 | SEQ ID NO: 119 T7 strong promoter | ... |
| | | taatacgactcactatagggagaccacaac |
| BBa_Z0252 | SEQ ID NO: 120 T7 weak binding and | ... |
| | processivity | taattgaactcactaaagggagaccacagc |
| BBa_Z0253 | SEQ ID NO: 121 T7 weak binding promoter | ... |
| | | cgaagtaatacgactcactattagggaaga |
| | SEQ ID NO: 122 T7 14.3 m | attaaccctcactaaagggaga |

TABLE 9
Examples of Constitutive Promoters from bacteriophage SP6

| Name | Description | Promoter Sequence |
|---|---|---|
| BBa_J64998 | SEQ ID NO: 123 consensus-10 and rest from SP6 | atttaggtgacactataga |

TABLE 10
Examples of Constitutive Promoters from Yeast

| Name | Description | Promoter Sequence |
|---|---|---|
| BBa_I766555 | SEQ ID NO: 124 pCyc (Medium) Promoter | ... |
| | | acaaacacaaatacacacactaaattaata |
| BBa_I766556 | SEQ ID NO: 125 pAdh (Strong) Promoter | ... |
| | | ccaagcatacaatcaactatctcatataca |
| BBa_I766557 | SEQ ID NO: 126 pSte5 (Weak) Promoter | ... |
| | | gatacaggatacagcggaaacaacttttaa |
| BBa_J63005 | SEQ ID NO: 127 yeast ADH1 promoter | ... |
| | | tttcaagctataccaagcatacaatcaact |
| BBa_K105027 | SEQ ID NO: 128 cyc100 minimal promoter | ... cctttgcagcataaattactatacttctat |
| BBa_K105028 | SEQ ID NO: 129 cyc70 minimal promoter | ... cctttgcagcataaattactatacttctat |
| BBa_K105029 | SEQ ID NO: 130 cyc43 minimal promoter | ... cctttgcagcataaattactatacttctat |
| BBa_K105030 | SEQ ID NO: 131 cyc28 minimal promoter | ... cctttgcagcataaattactatacttctat |
| BBa_K105031 | SEQ ID NO: 132 cyc16 minimal promoter | ... cctttgcagcataaattactatacttctat |
| BBa_K122000 | SEQ ID NO: 133 pPGK1 | ... ttatctactttttacaacaaatataaaaca |
| BBa_K124000 | SEQ ID NO: 134 pCYC Yeast Promoter | ... |
| | | acaaacacaaatacacacactaaattaata |
| BBa_K124002 | SEQ ID NO: 135 Yeast GPD (TDH3) | ... |
| | Promoter | gtttcgaataaacacacataaacaaacaaa |
| BBa_M31201 | SEQ ID NO: 136 Yeast CLB1 promoter | ... |
| | region, G2/M cell cycle specific | accatcaaaggaagctttaatcttctcata |

TABLE 11
Examples of Constitutive Promoters from Miscellaneous Eukaryotes

| Name | Description | Promoter Sequence |
|---|---|---|
| BBa_I712004 | SEQ ID NO: 137 CMV promoter | ... agaacccactgcttactggcttatcgaaat |
| BBa_K076017 | SEQ ID NO: 138 Ubc Promoter | ... ggccgtttttggcttttttgttagacgaag |

TABLE 12
Examples of Cell Signaling Promoters

| Name | Description | Promoter Sequence |
|---|---|---|
| BBa_I1051 | SEQ ID NO: 139 Lux cassette right promoter | ... |
| | | tgttatagtcgaatacctctggcggtgata |
| BBa_I14015 | SEQ ID NO: 140 P(Las) TetO | ... |
| | | ttttggtacactccctatcagtgatagaga |
| BBa_I14016 | SEQ ID NO: 141 P(Las) CIO | ... |
| | | ctttttggtacactacctctggcggtgata |
| BBa_I14017 | SEQ ID NO: 142 P(Rhl) | ... |
| | | tacgcaagaaaatggtttgttatagtcgaa |
| BBa_I739105 | SEQ ID NO: 143 Double Promoter | ... |
| | (LuxR/HSL, positive/cI, negative) | cgtgcgtgttgataacaccgtgcgtgttga |
| BBa_I746104 | SEQ ID NO: 144 P2 promoter in agr operon | ... |
| | from S. aureus | agattgtactaaatcgtataatgacagtga |
| BBa_I751501 | SEQ ID NO: 145 plux-cI hybrid promoter | ... |
| | | gtgttgatgcttttatcaccgccagtggta |
| BBa_I751502 | SEQ ID NO: 146 plux-lac hybrid promoter | ... |
| | | agtgtgtggaattgtgagcggataacaatt |
| BBa_I761011 | SEQ ID NO: 147 CinR, CinL and glucose | ... acatcttaaaagttttagtatcatattcgt |
| | controlled promoter | |
| BBa_J06403 | SEQ ID NO: 148 RhIR promoter repressible | ... |
| | by CI | tacgcaagaaaatggtttgttatagtcgaa |
| BBa_J64000 | SEQ ID NO: 149 rhlI promoter | ... atcctcctttagtcttccccctcatgtgtg |
| BBa_J64010 | SEQ ID NO: 150 lasI promoter | ... taaaattatgaaatttgcataaattcttca |
| BBa_J64067 | SEQ ID NO: 151 LuxR + 3OC6HSL | ... gtgttgactattttacctctggcggtgata |
| | independent R0065 | |
| BBa_J64712 | SEQ ID NO: 152 LasR/LasI Inducible & | ... |
| | RHLR/RHLI repressible Promoter | gaaatctggcagtttttggtacacgaaagc |
| BBa_K091107 | SEQ ID NO: 153 pLux/cI Hybrid Promoter | ... |
| | | acaccgtgcgtgttgatatagtcgaataaa |
| BBa_K091117 | SEQ ID NO: 154 pLas promoter | ... aaaattatgaaatttgtataaattcttcag |
| BBa_K091143 | SEQ ID NO: 155 pLas/cI Hybrid Promoter | ... ggttctttttggtacctctggcggtgataa |
| BBa_K091146 | SEQ ID NO: 156 pLas/Lux Hybrid Promoter | ... |
| | | tgtaggatcgtacaggtataaattcttcag |
| BBa_K091156 | SEQ ID NO: 157 pLux | ... |
| | | caagaaaatggtttgttatagtcgaataaa |
| BBa_K091157 | SEQ ID NO: 158 pLux/Las Hybrid Promoter | ... ctatctcatttgctagtatagtcgaataaa |
| BBa_K145150 | SEQ ID NO: 159 Hybrid promoter: HSL- | ... tagtttataatttaagtgttctttaatttc |
| | LuxR activated, P22 C2 repressed | |
| BBa_K266000 | SEQ ID NO: 160 PAI + LasR -> LuxI (AI) | ... |
| | | caccttcgggtgggcctttctgcgtttata |
| BBa_K266005 | SEQ ID NO: 161 PAI + LasR -> LasI & | ... |
| | AI + LuxR --l LasI | aataactctgatagtgctagtgtagatctc |
| BBa_K266006 | SEQ ID NO: 162 PAI + LasR -> LasI + GFP & | ... |
| | AI + LuxR --l LasI + GFP | caccttcgggtgggcctttctgcgtttata |
| BBa_K266007 | SEQ ID NO: 163 Complex QS -> LuxI & | ... |
| | Last circuit | caccttcgggtgggcctttctgcgtttata |
| BBa_R0061 | SEQ ID NO: 164 Promoter (HSL mediated | ttgacacctgtaggatcgtacaggtataat |
| | luxR repressor) | |
| BBa_R0062 | SEQ ID NO: 165 Promoter (luxR & HSL | ... |
| | regulated -- lux pR) | caagaaaatggtttgttatagtcgaataaa |
| BBa_R0063 | SEQ ID NO: 166 Promoter (luxR & HSL | ... |
| | regulated -- lux pL) | cacgcaaaacttgcgacaaacaataggtaa |
| BBa_R0071 | SEQ ID NO: 167 Promoter (RhlR & C4-HSL | ... |
| | regulated) | gttagctttcgaattggctaaaaagtgttc |
| BBa_R0078 | SEQ ID NO: 168 Promoter (cinR and HSL | ... |
| | regulated) | ccattctgctttccacgaacttgaaaacgc |
| BBa_R0079 | SEQ ID NO: 169 Promoter (LasR & PAI | ... |
| | regulated) | ggccgcgggttctttttggtacacgaaagc |
| BBa_R1062 | SEQ ID NO: 170 Promoter, Standard (luxR | ... |
| | and HSL regulated -- lux pR) | aagaaaatggtttgttgatactcgaataaa |

TABLE 13
Examples of Metal Inducible Promoters

| Name | Description | Promoter Sequence |
|---|---|---|
| BBa_I721001 | SEQ ID NO: 171 Lead Promoter | ... gaaaaccttgtcaatgaagagcgatctatg |
| BBa_I731004 | SEQ ID NO: 172 FecA promoter | ... ttctcgttcgactcatagctgaacacaaca |
| BBa_I760005 | SEQ ID NO: 173 Cu-sensitive promoter | atgacaaaattgtcat |
| BBa_I765000 | SEQ ID NO: 174 Fe promoter | ... |
| | | accaatgctgggaacggccagggcacctaa |
| BBa_I765007 | SEQ ID NO: 175 Fe and UV promoters | ... ctgaaagcgcataccgctatggagggggtt |
| BBa_J3902 | SEQ ID NO: 176 PrFe (PI + PII rus | ... tagatatgcctgaaagcgcataccgctatg |
| | operon) | |

TABLE 14
Examples of T7 Promoters

| Name | Description | Promoter Sequence |
|---|---|---|
| BBa_I712074 | SEQ ID NO: 177 T7 promoter (strong | ... agggaatacaagctacttgttctttttgca |
| | promoter from T7 bacteriophage) | |
| BBa_I719005 | SEQ ID NO: 178 T7 Promoter | taatacgactcactatagggaga |
| BBa_J34814 | SEQ ID NO: 179 T7 Promoter | gaatttaatacgactcactatagggaga |
| BBa_J64997 | SEQ ID NO: 180 T7 consensus-10 and rest | taatacgactcactatagg |
| BBa_J64998 | SEQ ID NO: 181 consensus-10 and rest from | atttaggtgacactataga |
| | SP6 | |
| BBa_K113010 | SEQ ID NO: 182 overlapping T7 promoter | ... |
| | | gagtcgtattaatacgactcactatagggg |
| BBa_K113011 | SEQ ID NO: 183 more overlapping T7 | ... |
| | promoter | agtgagtcgtactacgactcactatagggg |
| BBa_K113012 | SEQ ID NO: 184 weaken overlapping T7 | ... |
| | promoter | gagtcgtattaatacgactctctatagggg |
| BBa_R0085 | SEQ ID NO: 185 T7 Consensus Promoter | ttatacgactcactatagggaga |
| | Sequence | |
| BBa_R0180 | SEQ ID NO: 186 T7 RNAP promoter | ttatacgactcactatagggaga |
| BBa_R0181 | SEQ ID NO: 187 T7 RNAP promoter | gaatacgactcactatagggaga |
| BBa_R0182 | SEQ ID NO: 188 T7 RNAP promoter | taatacgtctcactatagggaga |
| BBa_R0183 | SEQ ID NO: 189 T7 RNAP promoter | tcatacgactcactatagggaga |
| BBa_R0184 | SEQ ID NO: 190 T7 promoter (lacI | ... |
| | repressible) | ataggggaattgtgagcggataacaattcc |
| BBa_R0185 | SEQ ID NO: 191 T7 promoter (lacI | ... |
| | repressible) | ataggggaattgtgagcggataacaattcc |
| BBa_R0186 | SEQ ID NO: 192 T7 promoter (lacI | ... |
| | repressible) | ataggggaattgtgagcggataacaattcc |
| BBa_R0187 | SEQ ID NO: 193 T7 promoter (lacI | ... |
| | repressible) | ataggggaattgtgagcggataacaattcc |
| BBa_Z0251 | SEQ ID NO: 194 T7 strong promoter | ... |
| | | taatacgactcactatagggagaccacaac |
| BBa_Z0252 | SEQ ID NO: 195 T7 weak binding and | ... |
| | processivity | taattgaactcactaaagggagaccacagc |
| BBa_Z0253 | SEQ ID NO: 196 T7 weak binding promoter | ... |
| | | cgaagtaatacgactcactattagggaaga |

TABLE 15
Examples of Stress Kit Promoters

| Name | Description | Promoter Sequence |
|---|---|---|
| BBa_K086017 | SEQ ID NO: 197 unmodified Lutz-Bujard | ... |
| | LacO promoter | ttgtgagcggataacaagatactgagcaca |
| BBa_K086018 | SEQ ID NO: 198 modified Lutz-Bujard LacO | ... |
| | promoter, with alternative sigma factor σ24 | ttgtgagcggataacaattctgaagaacaa |
| BBa_K086019 | SEQ ID NO: 199 modified Lutz-Bujard LacO | ... |
| | promoter, with alternative sigma factor σ24 | ttgtgagcggataacaattctgataaaaca |
| BBa_K086020 | SEQ ID NO: 200 modified Lutz-Bujard LacO | ... |
| | promoter, with alternative sigma factor σ24 | ttgtgagcggataacatctaaccctttaga |
| BBa_K086021 | SEQ ID NO: 201 modified Lutz-Bujard LacO | ... |
| | promoter, with alternative sigma factor σ24 | ttgtgagcggataacatagcagataagaaa |
| BBa_K086022 | SEQ ID NO: 202 modified Lutz-Bujard LacO | ... |
| | promoter, with alternative sigma factor σ28 | gtttgagcgagtaacgccgaaaatcttgca |
| BBa_K086023 | SEQ ID NO: 203 modified Lutz-Bujard LacO | ... |
| | promoter, with alternative sigma factor σ28 | gtgtgagcgagtaacgacgaaaatcttgca |
| BBa_K086024 | SEQ ID NO: 204 modified Lutz-Bujard LacO | ... |
| | promoter, with alternative sigma factor σ28 | tttgagcgagtaacagccgaaaatcttgca |
| BBa_K086025 | SEQ ID NO: 205 modified Lutz-Bujard LacO | ... |
| | promoter, with alternative sigma factor σ28 | tgtgagcgagtaacagccgaaaatcttgca |
| BBa_K086026 | SEQ ID NO: 206 modified Lutz-Bujard LacO | . . . |
| | promoter, with alternative sigma factor σ32 | ttgtgagcgagtggcaccattaagtacgta |
| BBa_K086027 | SEQ ID NO: 207 modified Lutz-Bujard LacO | ... |
| | promoter, with alternative sigma factor σ32 | ttgtgagcgagtgacaccattaagtacgta |
| BBa_K086028 | SEQ ID NO: 208 modified Lutz-Bujard LacO | ... |
| | promoter, with alternative sigma factor σ32 | ttgtgagcgagtaacaccattaagtacgta |
| BBa_K086029 | SEQ ID NO: 209 modified Lutz-Bujard LacO | ... |
| | promoter, with alternative sigma factor σ32 | ttgtgagcgagtaacaccattaagtacgta |
| BBa_K086030 | SEQ ID NO: 210 modified Lutz-Bujard LacO | ... |
| | promoter, with alternative sigma factor σ38 | cagtgagcgagtaacaactacgctgtttta |
| BBa_K086031 | SEQ ID NO: 211 modified Lutz-Bujard LacO | ... |
| | promoter, with alternative sigma factor σ38 | cagtgagcgagtaacaactacgctgtttta |
| BBa_K086032 | SEQ ID NO: 212 modified Lutz-Bujard LacO | ... |
| | promoter, with alternative sigma factor σ38 | atgtgagcggataacactataattaataga |
| BBa_K086033 | SEQ ID NO: 213 modified Lutz-Bujard LacO | ... |
| | promoter, with alternative sigma factor σ38 | atgtgagcggataacactataattaataga |

TABLE 16
Examples of Logic Promoters

| Name | Description | Promoter Sequence |
|---|---|---|
| BBa_I732200 | SEQ ID NO: 214 NOT Gate Promoter | ... |
| | Family Member (D001O1wt1) | gaattgtgagcggataacaattggatccgg |
| BBa_I732201 | SEQ ID NO: 215 NOT Gate Promoter | ... |
| | Family Member (D001O11) | ggaattgtgagcgctcacaattggatccgg |
| BBa_I732202 | SEQ ID NO: 216 NOT Gate Promoter | ... |
| | Family Member (D001O22) | ggaattgtaagcgcttacaattggatccgg |
| BBa_I732203 | SEQ ID NO: 217 NOT Gate Promoter | ... |
| | Family Member (D001O33) | ggaattgtaaacgtttacaattggatccgg |
| BBa_I732204 | SEQ ID NO: 218 NOT Gate Promoter | ... |
| | Family Member (D001O44) | ggaattgtgaacgttcacaattggatccgg |
| BBa_I732205 | SEQ ID NO: 219 NOT Gate Promoter | ... |
| | Family Member (D001O55) | ggaattttgagcgctcaaaattggatccgg |
| BBa_I732206 | SEQ ID NO: 220 NOT Gate Promoter | ... |
| | Family Member (D001O66) | ggaattatgagcgctcataattggatccgg |
| BBa_I732207 | SEQ ID NO: 221 NOT Gate Promoter | ... |
| | Family Member (D001O77) | gggacgactgtatacagtcgtcggatccgg |
| BBa_I732270 | SEQ ID NO: 222 Promoter Family Member | ... |
| | with Hybrid Operator (D001O12) | ggaattgtgagcgcttacaattggatccgg |
| BBa_I732271 | SEQ ID NO: 223 Promoter Family Member | ... |
| | with Hybrid Operator (D001O16) | ggaattgtgagcgctcataattggatccgg |
| BBa_I732272 | SEQ ID NO: 224 Promoter Family Member | ... |
| | with Hybrid Operator (D001O17) | ggaattgtgagctacagtcgtcggatccgg |
| BBa_I732273 | SEQ ID NO: 225 Promoter Family Member | ... |
| | with Hybrid Operator (D001O21) | ggaattgtaagcgctcacaattggatccgg |
| BBa_I732274 | SEQ ID NO: 226 Promoter Family Member | ... |
| | with Hybrid Operator (D001O24) | ggaattgtaagcgttcacaattggatccgg |
| BBa_I732275 | SEQ ID NO: 227 Promoter Family Member | ... |
| | with Hybrid Operator (D001O26) | ggaattgtaagcgctcataattggatccgg |
| BBa_I732276 | SEQ ID NO: 228 Promoter Family Member | ... |
| | with Hybrid Operator (D001O27) | ggaattgtaagctacagtcgtcggatccgg |
| BBa_I732277 | SEQ ID NO: 229 Promoter Family Member | ... |
| | with Hybrid Operator (D001O46) | ggaattgtgaacgctcataattggatccgg |
| BBa_I732278 | SEQ ID NO: 230 Promoter Family Member | ... |
| | with Hybrid Operator (D001O47) | ggaattgtgaactacagtcgtcggatccgg |
| BBa_I732279 | SEQ ID NO: 231 Promoter Family Member | ... |
| | with Hybrid Operator (D001O61) | ggaattatgagcgctcacaattggatccgg |
| BBa_I732301 | SEQ ID NO: 232 NAND Candidate | ... |
| | (U073O26D001O16) | ggaattgtgagcgctcataattggatccgg |
| BBa_I732302 | SEQ ID NO: 233 NAND Candidate | ... |
| | (U073O27D001O17) | ggaattgtgagctacagtcgtcggatccgg |
| BBa_I732303 | SEQ ID NO: 234 NAND Candidate | ... |
| | (U073O22D001O46) | ggaattgtgaacgctcataattggatccgg |
| BBa_I732304 | SEQ ID NO: 235 NAND Candidate | ... |
| | (U073O22D001O47) | ggaattgtgaactacagtcgtcggatccgg |
| BBa_I732305 | SEQ ID NO: 236 NAND Candidate | ... |
| | (U073O22D059O46) | taaattgtgaacgctcataattggatccgg |
| BBa_I732306 | SEQ ID NO: 237 NAND Candidate | ... |
| | (U073O11D002O22) | gaaattgtaagcgcttacaattggatccgg |
| BBa_I732351 | SEQ ID NO: 238 NOR Candidate | ... |
| | (U037O11D002O22) | gaaattgtaagcgcttacaattggatccgg |
| BBa_I732352 | SEQ ID NO: 239 NOR Candidate | ... |
| | (U035O44D001O22) | ggaattgtaagcgcttacaattggatccgg |
| BBa_I732400 | SEQ ID NO: 240 Promoter Family Member | ... |
| | (U097NUL + D062NUL) | gccaaattaaacaggattaacaggatccgg |
| BBa_I732401 | SEQ ID NO: 241 Promoter Family Member | ... |
| | (U097O11 + D062NUL) | gccaaattaaacaggattaacaggatccgg |
| BBa_I732402 | SEQ ID NO: 242 Promoter Family Member | ... |
| | (U085O11 + D062NUL) | gccaaattaaacaggattaacaggatccgg |
| BBa_I732403 | SEQ ID NO: 243 Promoter Family Member | ... |
| | (U073O11 + D062NUL) | gccaaattaaacaggattaacaggatccgg |
| BBa_I732404 | SEQ ID NO: 244 Promoter Family Member | ... |
| | (U061O11 + D062NUL) | gccaaattaaacaggattaacaggatccgg |
| BBa_I732405 | SEQ ID NO: 245 Promoter Family Member | ... |
| | (U049O11 + D062NUL) | gccaaattaaacaggattaacaggatccgg |
| BBa_I732406 | SEQ ID NO: 246 Promoter Family Member | ... |
| | (U037O11 + D062NUL) | gccaaattaaacaggattaacaggatccgg |
| BBa_I732407 | SEQ ID NO: 247 Promoter Family Member | ... |
| | (U097NUL + D002O22) | gaaattgtaagcgcttacaattggatccgg |
| BBa_I732408 | SEQ ID NO: 248 Promoter Family Member | ... |
| | (U097NUL + D014O22) | taaattgtaagcgcttacaattggatccgg |
| BBa_I732409 | SEQ ID NO: 249 Promoter Family Member | ... |
| | (U097NUL + D026O22) | gtaattgtaagcgcttacaattggatccgg |
| BBa_I732410 | SEQ ID NO: 250 Promoter Family Member | ... |
| | (U097NUL + D038O22) | tcaattgtaagcgcttacaattggatccgg |
| BBa_I732411 | SEQ ID NO: 251 Promoter Family Member | ... |
| | (U097NUL + D050O22) | aaaattgtaagcgcttacaattggatccgg |
| BBa_I732412 | SEQ ID NO: 252 Promoter Family Member | ... |
| | (U097NUL + D062O22) | caaattgtaagcgcttacaattggatccgg |
| BBa_I732413 | SEQ ID NO: 253 Promoter Family Member | ... |
| | (U097O11 + D002O22) | gaaattgtaagcgcttacaattggatccgg |
| BBa_I732414 | SEQ ID NO: 254 Promoter Family Member | ... |
| | (U097O11 + D014O22) | taaattgtaagcgcttacaattggatccgg |
| BBa_I732415 | SEQ ID NO: 255 Promoter Family Member | ... |
| | (U097O11 + D026O22) | gtaattgtaagcgcttacaattggatccgg |
| BBa_I732416 | SEQ ID NO: 256 Promoter Family Member | ... |
| | (U097O11 + D038O22) | tcaattgtaagcgcttacaattggatccgg |
| BBa_I732417 | SEQ ID NO: 257 Promoter Family Member | ... |
| | (U097O11 + D050O22) | aaaattgtaagcgcttacaattggatccgg |
| BBa_I732418 | SEQ ID NO: 258 Promoter Family Member | ... |
| | (U097O11 + D062O22) | caaattgtaagcgcttacaattggatccgg |
| BBa_I732419 | SEQ ID NO: 259 Promoter Family Member | ... |
| | (U085O11 + D002O22) | gaaattgtaagcgcttacaattggatccgg |
| BBa_I732420 | SEQ ID NO: 260 Promoter Family Member | ... |
| | (U085O11 + D014O22) | taaattgtaagcgcttacaattggatccgg |
| BBa_I732421 | SEQ ID NO: 261 Promoter Family Member | ... |
| | (U085O11 + D026O22) | gtaattgtaagcgcttacaattggatccgg |
| BBa_I732422 | SEQ ID NO: 262 Promoter Family Member | ... |
| | (U085O11 + D038O22) | tcaattgtaagcgcttacaattggatccgg |
| BBa_I732423 | SEQ ID NO: 263 Promoter Family Member | ... |
| | (U085O11 + D050O22) | aaaattgtaagcgcttacaattggatccgg |
| BBa_I732424 | SEQ ID NO: 264 Promoter Family Member | ... |
| | (U085O11 + D062O22) | caaattgtaagcgcttacaattggatccgg |
| BBa_I732425 | SEQ ID NO: 265 Promoter Family Member | ... |
| | (U073O11 + D002O22) | gaaattgtaagcgcttacaattggatccgg |
| BBa_I732426 | SEQ ID NO: 266 Promoter Family Member | ... |
| | (U073O11 + D014O22) | taaattgtaagcgcttacaattggatccgg |
| BBa_I732427 | SEQ ID NO: 267 Promoter Family Member | ... |
| | (U073O11 + D026O22) | gtaattgtaagcgcttacaattggatccgg |
| BBa_I732428 | SEQ ID NO: 268 Promoter Family Member | ... |
| | (U073O11 + D038O22) | tcaattgtaagcgcttacaattggatccgg |
| BBa_I732429 | SEQ ID NO: 269 Promoter Family Member | ... |
| | (U073O11 + D050O22) | aaaattgtaagcgcttacaattggatccgg |
| BBa_I732430 | SEQ ID NO: 270 Promoter Family Member | ... |
| | (U073O11 + D062O22) | caaattgtaagcgcttacaattggatccgg |
| BBa_I732431 | SEQ ID NO: 271 Promoter Family Member | ... |
| | (U061O11 + D002O22) | gaaattgtaagcgcttacaattggatccgg |
| BBa_I732432 | SEQ ID NO: 272 Promoter Family Member | ... |
| | (U061O11 + D014O22) | taaattgtaagcgcttacaattggatccgg |
| BBa_I732433 | SEQ ID NO: 273 Promoter Family Member | ... |
| | (U061O11 + D026O22) | gtaattgtaagcgcttacaattggatccgg |
| BBa_I732434 | SEQ ID NO: 274 Promoter Family Member | ... |
| | (U061O11 + D038O22) | tcaattgtaagcgcttacaattggatccgg |
| BBa_I732435 | SEQ ID NO: 275 Promoter Family Member | ... |
| | (U061O11 + D050O22) | aaaattgtaagcgcttacaattggatccgg |
| BBa_I732436 | SEQ ID NO: 276 Promoter Family Member | ... |
| | (U061O11 + D062O22) | caaattgtaagcgcttacaattggatccgg |
| BBa_I732437 | SEQ ID NO: 277 Promoter Family Member | ... |
| | (U049O11 + D002O22) | gaaattgtaagcgcttacaattggatccgg |
| BBa_I732438 | SEQ ID NO: 278 Promoter Family Member | ... |
| | (U049O11 + D014O22) | taaattgtaagcgcttacaattggatccgg |
| BBa_I732439 | SEQ ID NO: 279 Promoter Family Member | ... |
| | (U049O11 + D026O22) | gtaattgtaagcgcttacaattggatccgg |
| BBa_I732440 | SEQ ID NO: 280 Promoter Family Member | ... |
| | (U049O11 + D038O22) | tcaattgtaagcgcttacaattggatccgg |
| BBa_I732441 | SEQ ID NO: 281 Promoter Family Member | ... |
| | (U049O11 + D050O22) | aaaattgtaagcgcttacaattggatccgg |
| BBa_I732442 | SEQ ID NO: 282 Promoter Family Member | ... |
| | (U049O11 + D062O22) | caaattgtaagcgcttacaattggatccgg |
| BBa_I732443 | SEQ ID NO: 283 Promoter Family Member | ... |
| | (U037O11 + D002O22) | gaaattgtaagcgcttacaattggatccgg |
| BBa_I732444 | SEQ ID NO: 284 Promoter Family Member | ... |
| | (U037O11 + D014O22) | taaattgtaagcgcttacaattggatccgg |
| BBa_I732445 | SEQ ID NO: 285 Promoter Family Member | ... |
| | (U037O11 + D026O22) | gtaattgtaagcgcttacaattggatccgg |
| BBa_I732446 | SEQ ID NO: 286 Promoter Family Member | ... |
| | (U037O11 + D038O22) | tcaattgtaagcgcttacaattggatccgg |
| BBa_I732447 | SEQ ID NO: 287 Promoter Family Member | ... |
| | (U037O11 + D050O22) | aaaattgtaagcgcttacaattggatccgg |
| BBa_I732448 | SEQ ID NO: 288 Promoter Family Member | ... |
| | (U037O11 + D062O22) | caaattgtaagcgcttacaattggatccgg |
| BBa_I732450 | SEQ ID NO: 289 Promoter Family Member | ... |
| | (U073O26 + D062NUL) | gccaaattaaacaggattaacaggatccgg |
| BBa_I732451 | SEQ ID NO: 290 Promoter Family Member | ... |
| | (U073O27 + D062NUL) | gccaaattaaacaggattaacaggatccgg |
| BBa_I732452 | SEQ ID NO: 291 Promoter Family Member | ... |
| | (U073O26 + D062O61) | caaattatgagcgctcacaattggatccgg |

TABLE 17
Examples of Positively Regulated E. coli σ70 Promoters

| Name | Description | Promoter Sequence |
|---|---|---|
| BBa_I0500 | SEQ ID NO: 292 Inducible pBad/araC | ...gtttctccatacccgtttttttgggctagc |
| | promoter | |
| BBa_I1051 | SEQ ID NO: 293 Lux cassette right | ...tgttatagtcgaatacctctggcggtgata |
| | promoter | |
| BBa_I12006 | SEQ ID NO: 294 Modified lamdba Prm | ...attacaaactttcttgtatagatttaacgt |
| | promoter (repressed by 434 cI) | |
| BBa_I12007 | SEQ ID NO: 295 Modified lambda Prm | ...atttataaatagtggtgatagatttaacgt |
| | promoter (OR-3 obliterated) | |
| BBa_I12036 | SEQ ID NO: 296 Modified lamdba Prm | ...tttcttgtatagatttacaatgtatcttgt |
| | promoter (cooperative repression by 434 cI) | |
| BBa_I12040 | SEQ ID NO: 297 Modified lambda | ...tttcttgtagatacttacaatgtatcttgt |
| | P(RM) promoter: -10 region from P(L) and | |
| | cooperatively repressed by 434 cI | |
| BBa_I12210 | SEQ ID NO: 298 plac Or2-62 (positive) | ...ctttatgcttccggctcgtatgttgtgtgg |
| BBa_I13406 | SEQ ID NO: 299 Pbad/AraC with extra | ...ttttttgggctagcaagctttaccatggat |
| | REN sites | |
| BBa_I13453 | SEQ ID NO: 300 Pbad promoter | ...tgtttctccataccgtttttttgggctagc |
| BBa_I14015 | SEQ ID NO: 301 P(Las) TetO | ...ttttggtacactccctatcagtgatagaga |
| BBa_I14016 | SEQ ID NO: 302 P(Las) CIO | ...ctttttggtacactacctctggcggtgata |
| BBa_I14017 | SEQ ID NO: 303 P(Rhl) | ...tacgcaagaaaatggtttgttatagtcgaa |
| BBa_I721001 | SEQ ID NO: 304 Lead Promoter | ...gaaaaccttgtcaatgaagagcgatctatg |
| BBa_I723020 | SEQ ID NO: 305 Pu | ...ctcaaagcgggccagccgtagccgttacgc |
| BBa_I731004 | SEQ ID NO: 306 FecA promoter | ...ttctcgttcgactcatagctgaacacaaca |
| BBa_I739104 | SEQ ID NO: 307 Double Promoter | ...gttctttaattatttaagtgttctttaatt |
| | (LuxR/HSL, positive/P22 cII, negative) | |
| BBa_I739105 | SEQ ID NO: 308 Double Promoter | ...cgtgcgtgttgataacaccgtgcgtgttga |
| | (LuxR/HSL, positive/cI, negative) | |
| BBa_I741018 | SEQ ID NO: 309 Right facing promoter | ...gttacgtttatcgcggtgattgttacttat |
| | (for xylF) controlled by xylR and CRP-cAMP | |
| BBa_I741019 | SEQ ID NO: 310 Right facing promoter | ...gcaaaataaaatggaatgatgaaactgggt |
| | (for xylA) controlled by xylR and CRP-cAMP | |
| BBa_I741020 | SEQ ID NO: 311 promoter to xylF | ...gttacgtttatcgcggtgattgttacttat |
| | without CRP and several binding sites for xylR | |
| BBa_I741021 | SEQ ID NO: 312 promoter to xylA | ...atttcacactgctattgagataattcacaa |
| | without CRP and several binding sites for xylR | |
| BBa_I746104 | SEQ ID NO: 313 P2 promoter in agr | ...agattgtactaaatcgtataatgacagtga |
| | operon from S. aureus | |
| BBa_I746360 | SEQ ID NO: 314 PF promoter from P2 | ...gacatctccggcgcaactgaaaataccact |
| | phage | |
| BBa_I746361 | SEQ ID NO: 315 PO promoter from P2 | ...gaggatgcgcatcgtcgggaaactgatgcc |
| | phage | |
| BBa_I746362 | SEQ ID NO: 316 PP promoter from P2 | ...catccgggactgatggcggaggatgcgcat |
| | phage | |
| BBa_I746363 | SEQ ID NO: 317 PV promoter from P2 | ...aacttttatatattgtgcaatctcacatgc |
| | phage | |
| BBa_I746364 | SEQ ID NO: 318 Psid promoter from P4 | ...tgttgtccggtgtacgtcacaattttctta |
| | phage | |
| BBa_I746365 | SEQ ID NO: 319 PLL promoter from P4 | ...aatggctgtgtgttttttgttcatctccac |
| | phage | |
| BBa_I751501 | SEQ ID NO: 320 plux-cI hybrid promoter | ...gtgttgatgcttttatcaccgccagtggta |
| BBa_I751502 | SEQ ID NO: 321 plux-lac hybrid | ...agtgtgtggaattgtgagcggataacaatt |
| | promoter | |
| BBa_I760005 | SEQ ID NO: 322 Cu-sensitive promoter | atgacaaaattgtcat |
| BBa_I761011 | SEQ ID NO: 323 CinR, CinL and glucose | ...acatcttaaaagttttagtatcatattcgt |
| | controlled promoter | |
| BBa_I765001 | SEQ ID NO: 324 UV promoter | ...ctgaaagcgcataccgctatggagggggtt |
| BBa_I765007 | SEQ ID NO: 325 Fe and UV promoters | ...ctgaaagcgcataccgctatggagggggtt |
| BBa_J01005 | SEQ ID NO: 326 pspoIIE promoter | ...aacgaatataacaggtgggagatgagagga |
| | (spo0A J01004, positive) | |
| BBa_J03007 | SEQ ID NO: 327 Maltose specific | ...aatatttcctcattttccacagtgaagtga |
| | promoter | |
| BBa_J06403 | SEQ ID NO: 328 RhIR promoter | ...tacgcaagaaaatggtttgttatagtcgaa |
| | repressible by CI | |
| BBa_J07007 | SEQ ID NO: 329 ctx promoter | ...atttaattgttttgatcaattatttttctg |
| BBa_J13210 | SEQ ID NO: 330 pOmpR dependent | ...attattctgcatttttggggagaatggact |
| | POPS producer | |
| BBa_J15502 | SEQ ID NO: 331 copA promoter | ...ccttgctggaaggtttaacctttatcacag |
| BBa_J16101 | SEQ ID NO: 332 BanAp - Banana- | atgatgtgtccatggatta |
| | induced Promoter | |
| BBa_J16105 | SEQ ID NO: 333 HelPp - “Help” | atgatagacgatgtgcggacaacgtg |
| | Dependant promoter | |
| BBa_J45503 | SEQ ID NO: 334 hybB Cold Shock | ...cattagccgccaccatggggttaagtagca |
| | Promoter | |
| BBa_J58100 | SEQ ID NO: 335 AND type promoter | ...atttataaatagtggtgatagatttaacgt |
| | synergistically activated by cI and CRP | |
| BBa_J61051 | SEQ ID NO: 336 [Psal1] | ...ataaagccatcacgagtaccatagaggatc |
| BBa_J61054 | SEQ ID NO: 337 [HIP-1] Promoter | ...tttgtcttttcttgcttaataatgttgtca |
| BBa_J61055 | SEQ ID NO: 338 [HIP-1fnr] Promoter | ...tttgtcttttcttgcttaataatgttgtca |
| BBa_J64000 | SEQ ID NO: 339 rhlI promoter | ...atcctcctttagtcttccccctcatgtgtg |
| BBa_J64010 | SEQ ID NO: 340 lasI promoter | ...taaaattatgaaatttgcataaattcttca |
| BBa_J64712 | SEQ ID NO: 341 LasR/LasI Inducible & | ...gaaatctggcagtttttggtacacgaaagc |
| | RHLR/RHLI repressible Promoter | |
| BBa_J64800 | SEQ ID NO: 342 RHLR/RHLI Inducible | ...tgccagttctggcaggtctaaaaagtgttc |
| | & LasR/LasI repressible Promoter | |
| BBa_J64804 | SEQ ID NO: 343 The promoter region | ...cacagaacttgcatttatataaagggaaag |
| | (inclusive of regulator binding sites) | |
| | of the B. subtilis RocDEF operon | |
| BBa_K091107 | SEQ ID NO: 344 pLux/cI Hybrid | ...acaccgtgcgtgttgatatagtcgaataaa |
| | Promoter | |
| BBa_K091117 | SEQ ID NO: 345 pLas promoter | ...aaaattatgaaatttgtataaattcttcag |
| BBa_K091143 | SEQ ID NO: 346 pLas/cI Hybrid | ...ggttctttttggtacctctggcggtgataa |
| | Promoter | |
| BBa_K091146 | SEQ ID NO: 347 pLas/Lux Hybrid | ...tgtaggatcgtacaggtataaattcttcag |
| | Promoter | |
| BBa_K091156 | SEQ ID NO: 348 pLux | ...caagaaaatggtttgttatagtcgaataaa |
| BBa_K091157 | SEQ ID NO: 349 pLux/Las Hybrid | ...ctatctcatttgctagtatagtcgaataaa |
| | Promoter | |
| BBa_K100000 | SEQ ID NO: 350 Natural Xylose | ...gttacgtttatcgcggtgattgttacttat |
| | Regulated Bi-Directional Operator | |
| BBa_K100001 | SEQ ID NO: 351 Edited Xylose | ...gttacgtttatcgcggtgattgttacttat |
| | Regulated Bi-Directional Operator 1 | |
| BBa_K100002 | SEQ ID NO: 352 Edited Xylose | ...gttacgtttatcgcggtgattgttacttat |
| | Regulated Bi-Directional Operator 2 | |
| BBa_K112118 | SEQ ID NO: 353 rrnB P1 promoter | ...ataaatgcttgactctgtagcgggaaggcg |
| BBa_K112320 | SEQ ID NO: 354 {<ftsAZ promoter>} in | ...aaaactggtagtaggactggagattggtac |
| | BBb format | |
| BBa_K112322 | SEQ ID NO: 355 {Pdps} in BBb format | ...gggacacaaacatcaagaggatatgagatt |
| BBa_K112402 | SEQ ID NO: 356 promoter for FabA gene - | ...gtcaaaatgaccgaaacgggtggtaacttc |
| | Membrane Damage and Ultrasound Sensitive | |
| BBa_K112405 | SEQ ID NO: 357 Promoter for CadA and | ...agtaatcttatcgccagtttggtctggtca |
| | CadB genes | |
| BBa_K112406 | SEQ ID NO: 358 cadC promoter | ...agtaatcttatcgccagtttggtctggtca |
| BBa_K112701 | SEQ ID NO: 359 hns promoter | ...aattctgaacaacatccgtactcttcgtgc |
| BBa_K112900 | SEQ ID NO: 360 Pbad | ...tcgataagattaccgatcttacctgaagct |
| BBa_K116001 | SEQ ID NO: 361 nhaA promoter, which | ...cgatctattcacctgaaagagaaataaaaa |
| | can be regulated by pH and nhaR protein. | |
| BBa_K116401 | SEQ ID NO: 362 external phosphate | ...atcgcaacctatttattacaacactagtgc |
| | sensing promoter | |
| BBa_K116500 | SEQ ID NO: 363 OmpF promoter that is | ...aaacgttagtttgaatggaaagatgcctgc |
| | activated or repressed by OmpR according to | |
| | osmolarity. | |
| BBa_K116603 | SEQ ID NO: 364 pRE promoter from λ | ...tttgcacgaaccatatgtaagtatttcctt |
| | phage | |
| BBa_K117002 | SEQ ID NO: 365 LsrA promoter | ...taacacttatttaattaaaaagaggagaaa |
| | (indirectly activated by AI-2) | |
| BBa_K118011 | SEQ ID NO: 366 PcstA (glucose- | ...tagaaacaaaatgtaacatctctatggaca |
| | repressible promoter) | |
| BBa_K121011 | SEQ ID NO: 367 promoter (lacI | ...acaggaaacagctatgaccatgattacgcc |
| | regulated) | |
| BBa_K135000 | SEQ ID NO: 368 pCpxR (CpxR | ...agcgacgtctgatgacgtaatttctgcctc |
| | responsive promoter) | |
| BBa_K136010 | SEQ ID NO: 369 fliA promoter | ...gttcactctataccgctgaaggtgtaatgg |
| BBa_K145150 | SEQ ID NO: 370 Hybrid promoter: HSL- | ...tagtttataatttaagtgttctttaatttc |
| | LuxR activated, P22 C2 repressed | |
| BBa_K180000 | SEQ ID NO: 371 Hybrid promoter (trp & | ...cgagcacttcaccaacaaggaccatagcat |
| | lac regulated - tac pR) | |
| BBa_K180002 | SEQ ID NO: 372 tac pR testing plasmid | ...caccttcgggtgggcctttctgcgtttata |
| | (GFP) | |
| BBa_K180003 | SEQ ID NO: 373 PTAC testing plasmid | ...catggcatggatgaactatacaaataataa |
| | (GFP) - basic | |
| BBa_K180004 | SEQ ID NO: 374 Game of Life - Primary | ...caccttcgggtgggcctttctgcgtttata |
| | plasmid | |
| BBa_K180005 | SEQ ID NO: 375 GoL—Primary plasmid | ...caccttcgggtgggcctttctgcgtttata |
| | (part 1)/RPS - Paper primary plasmid (part 1) | |
| | [LuxR generator] | |
| BBa_K180006 | SEQ ID NO: 376 Game of Life - Primary | ...caccttcgggtgggcctttctgcgtttata |
| | plasmid (part 2) [lux pR, GFP and LacI generator] | |
| BBa_K180007 | SEQ ID NO: 377 Game of Life - | ...caccttcgggtgggcctttctgcgtttata |
| | Secondary plasmid [tac pR, LuxI generator] | |
| BBa_K180010 | SEQ ID NO: 378 Rock-paper-scissors - | ...caccttcgggtgggcctttctgcgtttata |
| | Rock primary plasmid | |
| BBa_K180011 | SEQ ID NO: 379 Rock - Primary plasmid | ...caccttcgggtgggcctttctgcgtttata |
| | (part 1) [Rh1R generator] | |
| BBa_K180012 | SEQ ID NO: 380 Rock - Primary plasmid | ...caccttcgggtgggcctttctgcgtttata |
| | (part 2) [tac pR, mCherry and LasI generator] | |
| BBa_K180013 | SEQ ID NO: 381 Rock-paper-scissors - | ...caccttcgggtgggcctttctgcgtttata |
| | Rock secondary plasmid [rhl pR, LacI generator] | |
| BBa_K180014 | SEQ ID NO: 382 Rock-paper-scissors - | ...caccttcgggtgggcctttctgcgtttata |
| | Paper primary plasmid | |
| BBa_K180015 | SEQ ID NO: 383 Paper - Primary plasmid | ...caccttcgggtgggcctttctgcgtttata |
| | (part 2) [tac pR, GFP and RhlI generator] | |
| BBa_K180016 | SEQ ID NO: 384 Rock-paper-scissors - | ...caccttcgggtgggcctttctgcgtttata |
| | Paper secondary plasmid [lux pR, LacI generator] | |
| BBa_K180017 | SEQ ID NO: 385 Rock-paper-scissors - | ...caccttcgggtgggcctttctgcgtttata |
| | Scissors primary plasmid | |
| BBa_K180018 | SEQ ID NO: 386 Scissors - Primary | ...caccttcgggtgggcctttctgcgtttata |
| | plasmid (part 1) [LasR generator] | |
| BBa_K180019 | SEQ ID NO: 387 Scissors - Primary | ...caccttcgggtgggcctttctgcgtttata |
| | plasmid (part 2) [tac pR, mBanana and LuxI | |
| | generator] | |
| BBa_K180020 | SEQ ID NO: 388 Rock-paper-scissors - | ...caccttcgggtgggcctttctgcgtttata |
| | Scissors secondary plasmid [las pR, LacI | |
| | generator] | |
| BBa_K206000 | SEQ ID NO: 389 pBAD strong | ...tgtttctccataccgtttttttgggctagc |
| BBa_K206001 | SEQ ID NO: 390 pBAD weak | ...tgtttctccataccgtttttttgggctagc |
| BBa_K259005 | SEQ ID NO: 391 AraC Rheostat Promoter | ...ttttatcgcaactctctactgtttctccat |
| BBa_K259007 | SEQ ID NO: 392 AraC Promoter fused | ...gtttctccattactagagaaagaggggaca |
| | with RBS | |
| BBa_K266000 | SEQ ID NO: 393 PAI + LasR -> LuxI (AI) | ...caccttcgggtgggcctttctgcgtttata |
| BBa_K266005 | SEQ ID NO: 394 PAI + LasR -> LasI & | ...aataactctgatagtgctagtgtagatctc |
| | AI + LuxR—\|LasI | |
| BBa_K266006 | SEQ ID NO: 395 PAI + LasR -> LasI + GFP | ...caccttcgggtgggcctttctgcgtttata |
| | & AI + LuxR—\|LasI + GFP | |
| BBa_K266007 | SEQ ID NO: 396 Complex QS -> LuxI & | ...caccttcgggtgggcctttctgcgtttata |
| | LasI circuit | |

TABLE 18
Examples of Positively regulated E. coli σS promoters

| Name | Description | Promoter Sequence |
|---|---|---|
| BBa_K112322 | SEQ ID NO: 397 {Pdps} in BBb format | ...gggacacaaacatcaagaggatatgagatt |

TABLE 19
Examples of Positively regulated E. coli σ32 promoters

| Name | Description | Promoter Sequence |
|---|---|---|
| BBa_K112400 | SEQ ID NO: 398 Promoter for grpE gene - | ... |
| | Heat Shock and Ultrasound Sensitiveata | ataataagcgaagttagcgagatgaatgcg |

TABLE 20
Examples of Positively regulated E coli σ54 promoters

| Name | Description | Promoter Sequence |
|---|---|---|
| BBa_J64979 | SEQ ID NO: 399 glnAp2 | ...agttggcacagatttcgctttatctttttt |

TABLE 21
Examples of Positively regulated B. subtilis σA promoters

| Name | Description | Promoter Sequence |
|---|---|---|
| BBa_R0062 | SEQ ID NO: 400 Promoter (luxR & HSL regulated -- | ... |
| | lux pR) | caagaaaatggtttgttatagtcgaataaa |
| BBa_R0065 | SEQ ID NO: 401 Promoter (lambda cI and luxR | ...gtgttgactattttacctctggcggtgata |
| | regulated -- hybrid) | |
| BBa_R0071 | SEQ ID NO: 402 Promoter (RhlR & C4-HSL | ... |
| | regulated) | gttagctttcgaattggctaaaaagtgttc |
| BBa_R0078 | SEQ ID NO: 403 Promoter (cinR and HSL | ... |
| | regulated) | ccattctgctttccacgaacttgaaaacgc |
| BBa_R0079 | SEQ ID NO: 404 Promoter (LasR & PAI regulated) | ... |
| | | ggccgcgggttctttttggtacacgaaagc |
| BBa_R0080 | SEQ ID NO: 405 Promoter (AraC regulated) | ...ttttatcgcaactctctactgtttctccat |
| BBa_R0082 | SEQ ID NO: 406 Promoter (OmpR, positive) | ...attattctgcatttttggggagaatggact |
| BBa_R0083 | SEQ ID NO: 407 Promoter (OmpR, positive) | ...attattctgcatttttggggagaatggact |
| BBa_R0084 | SEQ ID NO: 408 Promoter (OmpR, positive) | ... |
| | | aacgttagtttgaatggaaagatgcctgca |
| BBa_R1062 | SEQ ID NO: 409 Promoter, Standard (luxR and | ... |
| | HSL regulated -- lux pR) | aagaaaatggtttgttgatactcgaataaa |

TABLE 22
Examples of Miscellaneous Prokaryotic Induced Promoters

| Name | Description | Promoter Sequence |
|---|---|---|
| BBa_J64001 | SEQ ID NO: 410 psicA from Salmonella | ...aacgcagtcgttaagttctacaaagtcggt |
| BBa_J64750 | SEQ ID NO: 411 SPI-1 TTSS secretion-linked | ... |
| | promoter from Salmonella | gtcggtgacagataacaggagtaagtaatg |
| BBa_K112149 | SEQ ID NO: 412 PmgtCB Magnesium promoter | ...tattggctgactataataagcgcaaattca |
| | from Salmonella | |
| BBa_K116201 | SEQ ID NO: 413 ureD promoter from P | |
| | mirabilis | |
| BBa_K125100 | SEQ ID NO: 414 nir promoter | ...cgaaacgggaaccctatattgatctctact |
| | from Synechocystis sp. PCC6803 | |
| BBa_K131017 | SEQ ID NO: 415 p_qrr4 from Vibrio harveyi | ...aagttggcacgcatcgtgctttatacagat |

TABLE 23
Examples of Yeast Positive (Activatible) Promoters

| Name | Description | Promoter Sequence |
|---|---|---|
| BBa_J63006 | SEQ ID NO: 416 yeast GAL1 promoter | ... |
| | | gaggaaactagacccgccgccaccatggag |
| BBa_K284002 | SEQ ID NO: 417 JEN1 Promoter from | ... |
| | Kluyveromyces lactis | gagtaaccaaaaccaaaacagatttcaacc |
| BBa_K106699 | SEQ ID NO: 418 Gal1 Promoter | ...aaagtaagaatttttgaaaattcaatataa |
| BBa_K165041 | SEQ ID NO: 419 Zif268-HIV binding sites + | ...atacggtcaacgaactataattaactaaac |
| | TEF constitutive yeast promoter | |
| BBa_K165034 | SEQ ID NO: 420 Zif268-HIV bs + LexA bs + | ...cacaaatacacacactaaattaataactag |
| | mCYC promoter | |
| BBa_K165031 | SEQ ID NO: 421 mCYC promoter plus | ...cacaaatacacacactaaattaataactag |
| | LexA binding sites | |
| BBa_K165030 | SEQ ID NO: 422 mCYC promoter plus | ...cacaaatacacacactaaattaataactag |
| | Zif268-HIV binding sites | |
| BBa_K165001 | SEQ ID NO: 423 pGAL1+ w/XhoI sites | ...atactttaacgtcaaggagaaaaaactata |
| BBa_K110016 | SEQ ID NO: 424 A-Cell Promoter STE2 | ... |
| | (backwards) | accgttaagaaccatatccaagaatcaaaa |
| BBa_K110015 | SEQ ID NO: 425 A-Cell Promoter MFA1 | ...cttcatatataaaccgccagaaatgaatta |
| | (RtL) | |
| BBa_K110014 | SEQ ID NO: 426 A-Cell Promoter MFA2 | ...atcttcatacaacaataactaccaacctta |
| | (backwards) | |
| BBa_K110006 | SEQ ID NO: 427 Alpha-Cell Promoter | ...tttcatacacaatataaacgattaaaagaa |
| | MF(ALPHA)1 | |
| BBa_K110005 | SEQ ID NO: 428 Alpha Cell Promoter | ...aaattccagtaaattcacatattggagaaa |
| | MF(ALPHA)2 | |
| BBa_K110004 | SEQ ID NO: 429 Alpha-Cell Promoter Ste3 | ... |
| | | gggagccagaacgcttctggtggtgtaaat |
| BBa_J24813 | SEQ ID NO: 430 URA3 Promoter from S. cerevisiae | ...gcacagacttagattggtatatatacgcat |
| BBa_K284003 | SEQ ID NO: 431 Partial DLD Promoter | ... |
| | from Kluyveromyces lactic | aagtgcaagaaagaccagaaacgcaactca |

TABLE 24
Examples of Eukaryotic Positive (Activatible) Promoters

| Name | Description | Promoter Sequence |
|---|---|---|
| BBa_I10498 | SEQ ID NO: 432 Oct-4 promoter | ...taaaaaaaaaaaaaaaaaaaaaaaaaaaaa |
| BBa_J05215 | SEQ ID NO: 433 Regulator for R1- | ... |
| | CREBH | ggggcgagggccccgcctccggaggcgggg |
| BBa_J05216 | SEQ ID NO: 434 Regulator for R3- | ... |
| | ATF6 | gaggggacggctccggccccggggccggag |
| BBa_J05217 | SEQ ID NO: 435 Regulator for R2- | ... |
| | YAP7 | ggggcgagggctccggccccggggccggag |
| BBa_J05218 | SEQ ID NO: 436 Regulator for R4-cMaf | ... |
| | | gaggggacggccccgcctccggaggcgggg |

TABLE 25
Examples of Negatively regulated (repressible) E. coli σ70 promoters

| Name | Description | Promoter Sequence |
|---|---|---|
| BBa_I1051 | SEQ ID NO: 437 Lux cassette right promoter | ...tgttatagtcgaatacctctggcggtgata |
| BBa_I12001 | SEQ ID NO: 438 Promoter (PRM+) | ... |
| | | gatttaacgtatcagcacaaaaaagaaacc |
| BBa_I12006 | SEQ ID NO: 439 Modified lamdba Prm promoter | ...attacaaactttcttgtatagatttaacgt |
| | (repressed by 434 cI) | |
| BBa_I12036 | SEQ ID NO: 440 Modified lamdba Prm promoter | ...tttcttgtatagatttacaatgtatcttgt |
| | (cooperative repression by 434 cI) | |
| BBa_I12040 | SEQ ID NO: 441 Modified lambda P(RM) | ...tttcttgtagatacttacaatgtatcttgt |
| | promoter: -10 region from P(L) and cooperatively | |
| | repressed by 434 cI | |
| BBa_I12212 | SEQ ID NO: 442 TetR-TetR-4C heterodimer | ... |
| | promoter (negative) | actctgtcaatgatagagtggattcaaaaa |
| BBa_I14015 | SEQ ID NO: 443 P(Las) TetO | ...ttttggtacactccctatcagtgatagaga |
| BBa_I14016 | SEQ ID NO: 444 P(Las) CIO | ...ctttttggtacactacctctggcggtgata |
| BBa_I14032 | SEQ ID NO: 445 promoter P(Lac) IQ | ... |
| | | aaacctttcgcggtatggcatgatagcgcc |
| BBa_I714889 | SEQ ID NO: 446 OR21 of PR and PRM | ...tattttacctctggcggtgataatggttgc |
| BBa_I714924 | SEQ ID NO: 447 RecA_DlexO_DLacO1 | ... |
| | | actctcggcatggacgagctgtacaagtaa |
| BBa_I715003 | SEQ ID NO: 448 hybrid pLac with UV5 mutation | ... |
| | | ttgtgagcggataacaatatgttgagcaca |
| BBa_I718018 | SEQ ID NO: 449 dapAp promoter | ... |
| | | cattgagacacttgtttgcacagaggatgg |
| BBa_I731004 | SEQ ID NO: 450 FecA promoter | ...ttctcgttcgactcatagctgaacacaaca |
| BBa_I732200 | SEQ ID NO: 451 NOT Gate Promoter Family | ... |
| | Member (D001O1wt1) | gaattgtgagcggataacaattggatccgg |
| BBa_I732201 | SEQ ID NO: 452 NOT Gate Promoter Family | ... |
| | Member (D001O11) | ggaattgtgagcgctcacaattggatccgg |
| BBa_I732202 | SEQ ID NO: 453 NOT Gate Promoter Family | ... |
| | Member (D001O22) | ggaattgtaagcgcttacaattggatccgg |
| BBa_I732203 | SEQ ID NO: 454 NOT Gate Promoter Family | ... |
| | Member (D001O33) | ggaattgtaaacgtttacaattggatccgg |
| BBa_I732204 | SEQ ID NO: 455 NOT Gate Promoter Family | ... |
| | Member (D001O44) | ggaattgtgaacgttcacaattggatccgg |
| BBa_I732205 | SEQ ID NO: 456 NOT Gate Promoter Family | ... |
| | Member (D001O55) | ggaattttgagcgctcaaaattggatccgg |
| BBa_I732206 | SEQ ID NO: 457 NOT Gate Promoter Family | ... |
| | Member (D001O66) | ggaattatgagcgctcataattggatccgg |
| BBa_I732207 | SEQ ID NO: 458 NOT Gate Promoter Family | ... |
| | Member (D001O77) | gggacgactgtatacagtcgtcggatccgg |
| BBa_I732270 | SEQ ID NO: 459 Promoter Family Member with | ... |
| | Hybrid Operator (D001O12) | ggaattgtgagcgcttacaattggatccgg |
| BBa_I732271 | SEQ ID NO: 460 Promoter Family Member with | ... |
| | Hybrid Operator (D001O16) | ggaattgtgagcgctcataattggatccgg |
| BBa_I732272 | SEQ ID NO: 461 Promoter Family Member with | ... |
| | Hybrid Operator (D001O17) | ggaattgtgagctacagtcgtcggatccgg |
| BBa_I732273 | SEQ ID NO: 462 Promoter Family Member with | ... |
| | Hybrid Operator (D001O21) | ggaattgtaagcgctcacaattggatccgg |
| BBa_I732274 | SEQ ID NO: 463 Promoter Family Member with | ... |
| | Hybrid Operator (D001O24) | ggaattgtaagcgttcacaattggatccgg |
| BBa_I732275 | SEQ ID NO: 464 Promoter Family Member with | ... |
| | Hybrid Operator (D001O26) | ggaattgtaagcgctcataattggatccgg |
| BBa_I732276 | SEQ ID NO: 465 Promoter Family Member with | ... |
| | Hybrid Operator (D001O27) | ggaattgtaagctacagtcgtcggatccgg |
| BBa_I732277 | SEQ ID NO: 466 Promoter Family Member with | ... |
| | Hybrid Operator (D001O46) | ggaattgtgaacgctcataattggatccgg |
| BBa_I732278 | SEQ ID NO: 467 Promoter Family Member with | ... |
| | Hybrid Operator (D001O47) | ggaattgtgaactacagtcgtcggatccgg |
| BBa_I732279 | SEQ ID NO: 468 Promoter Family Member with | ... |
| | Hybrid Operator (D001O61) | ggaattatgagcgctcacaattggatccgg |
| BBa_I732301 | SEQ ID NO: 469 NAND Candidate | ... |
| | (U073O26D001O16) | ggaattgtgagcgctcataattggatccgg |
| BBa_I732302 | SEQ ID NO: 470 NAND Candidate | ... |
| | (U073O27D001O17) | ggaattgtgagctacagtcgtcggatccgg |
| BBa_I732303 | SEQ ID NO: 471 NAND Candidate | ... |
| | (U073O22D001O46) | ggaattgtgaacgctcataattggatccgg |
| BBa_I732304 | SEQ ID NO: 472 NAND Candidate | ... |
| | (U073O22D001O47) | ggaattgtgaactacagtcgtcggatccgg |
| BBa_I732305 | SEQ ID NO: 473 NAND Candidate | ...taaattgtgaacgctcataattggatccgg |
| | (U073O22D059O46) | |
| BBa_I732306 | SEQ ID NO: 474 NAND Candidate | ... |
| | (U073O11D002O22) | gaaattgtaagcgcttacaattggatccgg |
| BBa_I732351 | SEQ ID NO: 475 NOR Candidate | ... |
| | (U037O11D002O22) | gaaattgtaagcgcttacaattggatccgg |
| BBa_I732352 | SEQ ID NO: 476 NOR Candidate | ... |
| | (U035O44D001O22) | ggaattgtaagcgcttacaattggatccgg |
| BBa_I732400 | SEQ ID NO: 477 Promoter Family Member | ... |
| | (U097NUL + D062NUL) | gccaaattaaacaggattaacaggatccgg |
| BBa_I732401 | SEQ ID NO: 478 Promoter Family Member | ... |
| | (U097O11 + D062NUL) | gccaaattaaacaggattaacaggatccgg |
| BBa_I732402 | SEQ ID NO: 479 Promoter Family Member | ... |
| | (U085O11 + D062NUL) | gccaaattaaacaggattaacaggatccgg |
| BBa_I732403 | SEQ ID NO: 480 Promoter Family Member | ... |
| | (U073O11 + D062NUL) | gccaaattaaacaggattaacaggatccgg |
| BBa_I732404 | SEQ ID NO: 481 Promoter Family Member | ... |
| | (U061O11 + D062NUL) | gccaaattaaacaggattaacaggatccgg |
| BBa_I732405 | SEQ ID NO: 482 Promoter Family Member | ... |
| | (U049O11 + D062NUL) | gccaaattaaacaggattaacaggatccgg |
| BBa_I732406 | SEQ ID NO: 483 Promoter Family Member | ... |
| | (U037O11 + D062NUL) | gccaaattaaacaggattaacaggatccgg |
| BBa_I732407 | SEQ ID NO: 484 Promoter Family Member | ... |
| | (U097NUL + D002O22) | gaaattgtaagcgcttacaattggatccgg |
| BBa_I732408 | SEQ ID NO: 485 Promoter Family Member | ...taaattgtaagcgcttacaattggatccgg |
| | (U097NUL + D014O22) | |
| BBa_I732409 | SEQ ID NO: 486 Promoter Family Member | ... |
| | (U097NUL + D026O22) | gtaattgtaagcgcttacaattggatccgg |
| BBa_I732410 | SEQ ID NO: 487 Promoter Family Member | ...tcaattgtaagcgcttacaattggatccgg |
| | (U097NUL + D038O22) | |
| BBa_I732411 | SEQ ID NO: 488 Promoter Family Member | ... |
| | (U097NUL + D050O22) | aaaattgtaagcgcttacaattggatccgg |
| BBa_I732412 | SEQ ID NO: 489 Promoter Family Member | ... |
| | (U097NUL + D062O22) | caaattgtaagcgcttacaattggatccgg |
| BBa_I732413 | SEQ ID NO: 490 Promoter Family Member | ... |
| | (U097O11 + D002O22) | gaaattgtaagcgcttacaattggatccgg |
| BBa_I732414 | SEQ ID NO: 491 Promoter Family Member | ...taaattgtaagcgcttacaattggatccgg |
| | (U097O11 + D014O22) | |
| BBa_I732415 | SEQ ID NO: 492 Promoter Family Member | ... |
| | (U097O11 + D026O22) | gtaattgtaagcgcttacaattggatccgg |
| BBa_I732416 | SEQ ID NO: 493 Promoter Family Member | ...tcaattgtaagcgcttacaattggatccgg |
| | (U097O11 + D038O22) | |
| BBa_I732417 | SEQ ID NO: 494 Promoter Family Member | ... |
| | (U097O11 + D050O22) | aaaattgtaagcgcttacaattggatccgg |
| BBa_I732418 | SEQ ID NO: 495 Promoter Family Member | ... |
| | (U097O11 + D062O22) | caaattgtaagcgcttacaattggatccgg |
| BBa_I732419 | SEQ ID NO: 496 Promoter Family Member | ... |
| | (U085O11 + D002O22) | gaaattgtaagcgcttacaattggatccgg |
| BBa_I732420 | SEQ ID NO: 497 Promoter Family Member | ...taaattgtaagcgcttacaattggatccgg |
| | (U085O11 + D014O22) | |
| BBa_I732421 | SEQ ID NO: 498 Promoter Family Member | ... |
| | (U085O11 + D026O22) | gtaattgtaagcgcttacaattggatccgg |
| BBa_I732422 | SEQ ID NO: 499 Promoter Family Member | ...tcaattgtaagcgcttacaattggatccgg |
| | (U085O11 + D038O22) | |
| BBa_I732423 | SEQ ID NO: 500 Promoter Family Member | ... |
| | (U085O11 + D050O22) | aaaattgtaagcgcttacaattggatccgg |
| BBa_I732424 | SEQ ID NO: 501 Promoter Family Member | ... |
| | (U085O11 + D062O22) | caaattgtaagcgcttacaattggatccgg |
| BBa_I732425 | SEQ ID NO: 502 Promoter Family Member | ... |
| | (U073O11 + D002O22) | gaaattgtaagcgcttacaattggatccgg |
| BBa_I732426 | SEQ ID NO: 503 Promoter Family Member | ...taaattgtaagcgcttacaattggatccgg |
| | (U073O11 + D014O22) | |
| BBa_I732427 | SEQ ID NO: 504 Promoter Family Member | ... |
| | (U073O11 + D026O22) | gtaattgtaagcgcttacaattggatccgg |
| BBa_I732428 | SEQ ID NO: 505 Promoter Family Member | ...tcaattgtaagcgcttacaattggatccgg |
| | (U073O11 + D038O22) | |
| BBa_I732429 | SEQ ID NO: 506 Promoter Family Member | ... |
| | (U073O11 + D050O22) | aaaattgtaagcgcttacaattggatccgg |
| BBa_I732430 | SEQ ID NO: 507 Promoter Family Member | ... |
| | (U073O11 + D062O22) | caaattgtaagcgcttacaattggatccgg |
| BBa_I732431 | SEQ ID NO: 508 Promoter Family Member | ... |
| | (U061O11 + D002O22) | gaaattgtaagcgcttacaattggatccgg |
| BBa_I732432 | SEQ ID NO: 509 Promoter Family Member | ...taaattgtaagcgcttacaattggatccgg |
| | (U061O11 + D014O22) | |
| BBa_I732433 | SEQ ID NO: 510 Promoter Family Member | ... |
| | (U061O11 + D026O22) | gtaattgtaagcgcttacaattggatccgg |
| BBa_I732434 | SEQ ID NO: 511 Promoter Family Member | ...tcaattgtaagcgcttacaattggatccgg |
| | (U061O11 + D038O22) | |
| BBa_I732435 | SEQ ID NO: 512 Promoter Family Member | ... |
| | (U061O11 + D050O22) | aaaattgtaagcgcttacaattggatccgg |
| BBa_I732436 | SEQ ID NO: 513 Promoter Family Member | ... |
| | (U061O11 + D062O22) | caaattgtaagcgcttacaattggatccgg |
| BBa_I732437 | SEQ ID NO: 514 Promoter Family Member | ... |
| | (U049O11 + D002O22) | gaaattgtaagcgcttacaattggatccgg |
| BBa_I732438 | SEQ ID NO: 515 Promoter Family Member | ...taaattgtaagcgcttacaattggatccgg |
| | (U049O11 + D014O22) | |
| BBa_I732439 | SEQ ID NO: 516 Promoter Family Member | ... |
| | (U049O11 + D026O22) | gtaattgtaagcgcttacaattggatccgg |
| BBa_I732440 | SEQ ID NO: 517 Promoter Family Member | ...tcaattgtaagcgcttacaattggatccgg |
| | (U049O11 + D038O22) | |
| BBa_I732441 | SEQ ID NO: 518 Promoter Family Member | ... |
| | (U049O11 + D050O22) | aaaattgtaagcgcttacaattggatccgg |
| BBa_I732442 | SEQ ID NO: 519 Promoter Family Member | ... |
| | (U049O11 + D062O22) | caaattgtaagcgcttacaattggatccgg |
| BBa_I732443 | SEQ ID NO: 520 Promoter Family Member | ... |
| | (U037O11 + D002O22) | gaaattgtaagcgcttacaattggatccgg |
| BBa_I732444 | SEQ ID NO: 521 Promoter Family Member | ...taaattgtaagcgcttacaattggatccgg |
| | (U037O11 + D014O22) | |
| BBa_I732445 | SEQ ID NO: 522 Promoter Family Member | ... |
| | (U037O11 + D026O22) | gtaattgtaagcgcttacaattggatccgg |
| BBa_I732446 | SEQ ID NO: 523 Promoter Family Member | ...tcaattgtaagcgcttacaattggatccgg |
| | (U037O11 + D038O22) | |
| BBa_I732447 | SEQ ID NO: 524 Promoter Family Member | ... |
| | (U037O11 + D050O22) | aaaattgtaagcgcttacaattggatccgg |
| BBa_I732448 | SEQ ID NO: 525 Promoter Family Member | ... |
| | (U037O11 + D062O22) | caaattgtaagcgcttacaattggatccgg |
| BBa_I732450 | SEQ ID NO: 526 Promoter Family Member | ... |
| | (U073O26 + D062NUL) | gccaaattaaacaggattaacaggatccgg |
| BBa_I732451 | SEQ ID NO: 527 Promoter Family Member | ... |
| | (U073O27 + D062NUL) | gccaaattaaacaggattaacaggatccgg |
| BBa_I732452 | SEQ ID NO: 528 Promoter Family Member | ... |
| | (U073O26 + D062O61) | caaattatgagcgctcacaattggatccgg |
| BBa_I739101 | SEQ ID NO: 529 Double Promoter (constitutive/ | ...tgatagagattccctatcagtgatagagat |
| | TetR, negative) | |
| BBa_I739102 | SEQ ID NO: 530 Double Promoter (cI, negative/ | ...tgatagagattccctatcagtgatagagat |
| | TetR, negative) | |
| BBa_I739103 | SEQ ID NO: 531 Double Promoter (lacI, negative/ | ...gttctttaattatttaagtgttctttaatt |
| | P22 cII, negative) | |
| BBa_I739104 | SEQ ID NO: 532 Double Promoter (LuxR/HSL, | ...gttctttaattatttaagtgttctttaatt |
| | positive/P22 cII, negative) | |
| BBa_I739105 | SEQ ID NO: 533 Double Promoter (LuxR/HSL, | ... |
| | positive/cI, negative) | cgtgcgtgttgataacaccgtgcgtgttga |
| BBa_I739106 | SEQ ID NO: 534 Double Promoter (TetR, negative/ | ...gtgttctttaatatttaagtgttctttaat |
| | P22 cII, negative) | |
| BBa_I739107 | SEQ ID NO: 535 Double Promoter (cI, negative/ | ... |
| | LacI, negative) | ggaattgtgagcggataacaatttcacaca |
| BBa_I746665 | SEQ ID NO: 536 Pspac-hy promoter | ...tgtgtgtaattgtgagcggataacaattaa |
| BBa_I751500 | SEQ ID NO: 537 pcI (for positive control of pcI- | ...ttttacctctggcggtgataatggttgcag |
| | lux hybrid promoter) | |
| BBa_I751501 | SEQ ID NO: 538 plux-cI hybrid promoter | ...gtgttgatgcttttatcaccgccagtggta |
| BBa_I751502 | SEQ ID NO: 539 plux-lac hybrid promoter | ... |
| | | agtgtgtggaattgtgagcggataacaatt |
| BBa_I756014 | SEQ ID NO: 540 LexAoperator- | ... |
| | MajorLatePromoter | agggggtgggggcgcgttggcgcgccacac |
| BBa_I761011 | SEQ ID NO: 541 CinR, CinL and glucose | ...acatcttaaaagttttagtatcatattcgt |
| | controlled promoter | |
| BBa_J05209 | SEQ ID NO: 542 Modified Pr Promoter | ...tattttacctctggcggtgataatggttgc |
| BBa_J05210 | SEQ ID NO: 543 Modified Prm + Promoter | ...atttataaatagtggtgatagatttaacgt |
| BBa_J07019 | SEQ ID NO: 544 FecA Promoter (with Fur box) | ...acccttctcgttcgactcatagctgaacac |
| BBa_J15301 | SEQ ID NO: 545 Pars promoter from Escherichia | ... |
| | coli chromosomal ars operon. | tgacttatccgcttcgaagagagacactac |
| BBa_J22052 | SEQ ID NO: 546 Pcya | ...aggtgttaaattgatcacgttttagaccat |
| BBa_J22106 | SEQ ID NO: 547 rec A (SOS) Promoter | ...caatttggtaaaggctccatcatgtaataa |
| BBa_J22126 | SEQ ID NO: 548 Rec A (SOS) promoter | ... |
| | | gagaaacaatttggtaaaggctccatcatg |
| BBa_J31013 | SEQ ID NO: 549 pLac Backwards [cf. | ... |
| | BBa_R0010] | aacgcgcggggagaggcggtttgcgtattg |
| BBa_J34800 | SEQ ID NO: 550 Promoter tetracycline inducible | ... |
| | | cagtgatagagatactgagcacatcagcac |
| BBa_J34806 | SEQ ID NO: 551 promoter lac induced | ...ttatgcttccggctcgtataatgtttcaaa |
| BBa_J34809 | SEQ ID NO: 552 promoter lac induced | ... |
| | | ggctcgtatgttgtgtcgaccgagctgcgc |
| BBa_J54016 | SEQ ID NO: 553 promoter_lacq | ... |
| | | aaacctttcgcggtatggcatgatagcgcc |
| BBa_J54120 | SEQ ID NO: 554 EmrR_regulated promoter | ...atttgtcactgtcgttactatatcggctgc |
| BBa_J54130 | SEQ ID NO: 555 BetI_regulated promoter | ...gtccaatcaataaccgctttaatagataaa |
| BBa_J56012 | SEQ ID NO: 556 Invertible sequence of dna | ...actttattatcaataagttaaatcggtacc |
| | includes Ptrc promoter | |
| BBa_J64065 | SEQ ID NO: 557 cI repressed promoter | ...gtgttgactattttacctctggcggtgata |
| BBa_J64067 | SEQ ID NO: 558 LuxR + 3OC6HSL independent | ...gtgttgactattttacctctggcggtgata |
| | R0065 | |
| BBa_J64068 | SEQ ID NO: 559 increased strength R0051 | ...atacctctggcggtgatatataatggttgc |
| BBa_J64069 | SEQ ID NO: 560 R0065 with lux box deleted | ...gtgttgactattttacctctggcggtgata |
| BBa_J64712 | SEQ ID NO: 561 LasR/LasI Inducible & | ... |
| | RHLR/RHLI repressible Promoter | gaaatctggcagtttttggtacacgaaagc |
| BBa_J64800 | SEQ ID NO: 562 RHLR/RHLI Inducible & | ... |
| | LasR/LasI repressible Promoter | tgccagttctggcaggtctaaaaagtgttc |
| BBa_J64981 | SEQ ID NO: 563 OmpR-P strong binding, | ...agcgctcacaatttaatacgactcactata |
| | regulatory region for Team Challenge03-2007 | |
| BBa_J64987 | SEQ ID NO: 564 LacI Consensus Binding Site in | ...taataattgtgagcgctcacaattttgaca |
| | sigma 70 binding region | |
| BBa_J72005 | SEQ ID NO: 565 {Ptet} promoter in BBb | ... |
| | | atccctatcagtgatagagatactgagcac |
| BBa_K086017 | SEQ ID NO: 566 unmodified Lutz-Bujard LacO | ... |
| | promoter | ttgtgagcggataacaagatactgagcaca |
| BBa_K091100 | SEQ ID NO: 567 pLac_lux hybrid promoter | ... |
| | | ggaattgtgagcggataacaatttcacaca |
| BBa_K091101 | SEQ ID NO: 568 pTet_Lac hybrid promoter | ... |
| | | ggaattgtgagcggataacaatttcacaca |
| BBa_K091104 | SEQ ID NO: 569 pLac/Mnt Hybrid Promoter | ... |
| | | ggaattgtgagcggataacaatttcacaca |
| BBa_K091105 | SEQ ID NO: 570 pTet/Mnt Hybrid Promoter | ... |
| | | agaactgtaatccctatcagtgatagagat |
| BBa_K091106 | SEQ ID NO: 571 LsrA/cI hybrid promoter | ...tgttgatttatctaacaccgtgcgtgttga |
| BBa_K091107 | SEQ ID NO: 572 pLux/cI Hybrid Promoter | ... |
| | | acaccgtgcgtgttgatatagtcgaataaa |
| BBa_K091110 | SEQ ID NO: 573 LacI Promoter | ... |
| | | cctttcgcggtatggcatgatagcgcccgg |
| BBa_K091111 | SEQ ID NO: 574 LacIQ promoter | ... |
| | | cctttcgcggtatggcatgatagcgcccgg |
| BBa_K091112 | SEQ ID NO: 575 pLacIQ1 promoter | ... |
| | | cctttcgcggtatggcatgatagcgcccgg |
| BBa_K091143 | SEQ ID NO: 576 pLas/cI Hybrid Promoter | ...ggttctttttggtacctctggcggtgataa |
| BBa_K091146 | SEQ ID NO: 577 pLas/Lux Hybrid Promoter | ...tgtaggatcgtacaggtataaattcttcag |
| BBa_K091157 | SEQ ID NO: 578 pLux/Las Hybrid Promoter | ...ctatctcatttgctagtatagtcgaataaa |
| BBa_K093000 | SEQ ID NO: 579 pRecA with LexA binding site | ...gtatatatatacagtataattgcttcaaca |
| BBa_K093008 | SEQ ID NO: 580 reverse BBa_R0011 | ...cacaatgtcaattgttatccgctcacaatt |
| BBa_K094120 | SEQ ID NO: 581 pLacI/ara-1 | ... |
| | | aattgtgagcggataacaatttcacacaga |
| BBa_K094140 | SEQ ID NO: 582 pLacIq | ... |
| | | ccggaagagagtcaattcagggtggtgaat |
| BBa_K101000 | SEQ ID NO: 583 Dual-Repressed Promoter for | ... |
| | p22 mnt and TetR | acggtgacctagatctccgatactgagcac |
| BBa_K101001 | SEQ ID NO: 584 Dual-Repressed Promoter for | ... |
| | LacI and LambdacI | tggaattgtgagcggataaaatttcacaca |
| BBa_K101002 | SEQ ID NO: 585 Dual-Repressed Promoter for | ...tagtagataatttaagtgttctttaatttc |
| | p22 cII and TetR | |
| BBa_K101017 | SEQ ID NO: 586 MioC Promoter (DNAa- | ... |
| | Repressed Promoter) | ccaacgcgttcacagcgtacaattactagt |
| BBa_K109200 | SEQ ID NO: 587 AraC and TetR promoter | ... |
| | (hybrid) | aacaaaaaaacggatcctctagttgcggcc |
| BBa_K112118 | SEQ ID NO: 588 rrnB P1 promoter | ... |
| | | ataaatgcttgactctgtagcgggaaggcg |
| BBa_K112318 | SEQ ID NO: 589 {<bolA promoter>} in BBb | ... |
| | format | atttcatgatgatacgtgagcggatagaag |
| BBa_K112401 | SEQ ID NO: 590 Promoter for recA gene - SOS | ... |
| | and Ultrasound Sensitive | caaacagaaagcgttggcggcagcactggg |
| BBa_K112402 | SEQ ID NO: 591 promoter for FabA gene - | ... |
| | Membrane Damage and Ultrasound Sensitive | gtcaaaatgaccgaaacgggtggtaacttc |
| BBa_K112405 | SEQ ID NO: 592 Promoter for CadA and CadB | ...agtaatcttatcgccagtttggtctggtca |
| | genes | |
| BBa_K112406 | SEQ ID NO: 593 cadC promoter | ...agtaatcttatcgccagtttggtctggtca |
| BBa_K112701 | SEQ ID NO: 594 hns promoter | ...aattctgaacaacatccgtactcttcgtgc |
| BBa_K112708 | SEQ ID NO: 595 PfhuA | ...tttacgttatcattcactttacatcagagt |
| BBa_K113009 | SEQ ID NO: 596 pBad/araC | ...gtttctccatacccgtttttttgggctagc |
| BBa_K116001 | SEQ ID NO: 597 nhaA promoter that can be | ... |
| | regulated by pH and nhaR protein. | cgatctattcacctgaaagagaaataaaaa |
| BBa_K116500 | SEQ ID NO: 598 OmpF promoter that is activated | ... |
| | or repressed by OmpR according to osmolarity. | aaacgttagtttgaatggaaagatgcctgc |
| BBa_K119002 | SEQ ID NO: 599 RcnR operator (represses RcnA) | ...attgccgaattaatactaagaattattatc |
| BBa_K121011 | SEQ ID NO: 600 promoter (lacI regulated) | ... |
| | | acaggaaacagctatgaccatgattacgcc |
| BBa_K121014 | SEQ ID NO: 601 promoter (lambda cI regulated) | ... |
| | | actggcggttataatgagcacatcagcagg |
| BBa_K137046 | SEQ ID NO: 602 150 bp inverted tetR promoter | ... |
| | | caccgacaaacaacagataaaacgaaaggc |
| BBa_K137047 | SEQ ID NO: 603 250 bp inverted tetR promoter | ...agtgttattaagctactaaagcgtagtttt |
| BBa_K137048 | SEQ ID NO: 604 350 bp inverted tetR promoter | ... |
| | | gaataagaaggctggctctgcaccttggtg |
| BBa_K137049 | SEQ ID NO: 605 450 bp inverted tetR promoter | ...ttagcgacttgatgctcttgatcttccaat |
| BBa_K137050 | SEQ ID NO: 606 650 bp inverted tetR promoter | ...acatctaaaacttttagcgttattacgtaa |
| BBa_K137051 | SEQ ID NO: 607 850 bp inverted tetR promoter | ... |
| | | ttccgacctcattaagcagctctaatgcgc |
| BBa_K137124 | SEQ ID NO: 608 LacI-repressed promoter A81 | ...caatttttaaacctgtaggatcgtacaggt |
| BBa_K137125 | SEQ ID NO: 609 LacI-repressed promoter B4 | ...caatttttaaaattaaaggcgttacccaac |
| BBa_K145150 | SEQ ID NO: 610 Hybrid promoter: HSL-LuxR | ...tagtttataatttaagtgttctttaatttc |
| | activated, P22 C2 repressed | |
| BBa_K145152 | SEQ ID NO: 611 Hybrid promoter: P22 c2, LacI | ... |
| | NOR gate | gaaaatgtgagcgagtaacaacctcacaca |
| BBa_K256028 | SEQ ID NO: 612 placI: CHE | ...caccttcgggtgggcctttctgcgtttata |
| BBa_K259005 | SEQ ID NO: 613 AraC Rheostat Promoter | ...ttttatcgcaactctctactgtttctccat |
| BBa_K259007 | SEQ ID NO: 614 AraC Promoter fused with RBS | ... |
| | | gtttctccattactagagaaagaggggaca |
| BBa_K266001 | SEQ ID NO: 615 Inverter TetR -> LuxR | ...caccttcgggtgggcctttctgcgtttata |
| BBa_K266003 | SEQ ID NO: 616 POPS -> Lac Inverter -> LasR | ...caccttcgggtgggcctttctgcgtttata |
| BBa_K266004 | SEQ ID NO: 617 Const Lac Inverter -> LasR | ...caccttcgggtgggcctttctgcgtttata |
| BBa_K266005 | SEQ ID NO: 618 PAI + LasR -> LasI + AI + LuxR - | ...aataactctgatagtgctagtgtagatctc |
| | -\|LasI | |
| BBa_K266006 | SEQ ID NO: 619 PAI + LasR -> LasI + GFP & | ...caccttcgggtgggcctttctgcgtttata |
| | AI + LuxR --\|LasI + GFP | |
| BBa_K266007 | SEQ ID NO: 620 Complex QS -> LuxI & LasI | ...caccttcgggtgggcctttctgcgtttata |
| | circuit | |
| BBa_K266008 | SEQ ID NO: 621 J23100 + Lac inverter | ... |
| | | ttgtgagcggataacaagatactgagcaca |
| BBa_K266009 | SEQ ID NO: 622 J23100 + Lac inverter + RBS | ... |
| | | actgagcacatactagagaaagaggagaaa |
| BBa_K266011 | SEQ ID NO: 623 Lac Inverter and strong RBS | ... |
| | | actgagcacatactagagaaagaggagaaa |
| BBa_K292002 | SEQ ID NO: 624 pLac (LacI regulated) + Strong | ... |
| | RBS | tcacacatactagagattaaagaggagaaa |
| BBa_M31370 | SEQ ID NO: 625 tacI Promoter | ... |
| | | ggaattgtgagcggataacaatttcacaca |
| BBa_R0010 | SEQ ID NO: 626 promoter (lacI regulated) | ... |
| | | ggaattgtgagcggataacaatttcacaca |
| BBa_R0011 | SEQ ID NO: 627 Promoter (lacI regulated, lambda | ... |
| | pL hybrid) | ttgtgagcggataacaagatactgagcaca |
| BBa_R0040 | SEQ ID NO: 628 TetR repressible promoter | ... |
| | | atccctatcagtgatagagatactgagcac |
| BBa_R0050 | SEQ ID NO: 629 Promoter (HK022 cI regulated) | ... |
| | | ccgtcataatatgaaccataagttcaccac |
| BBa_R0051 | SEQ ID NO: 630 promoter (lambda cI regulated) | ...tattttacctctggcggtgataatggttgc |
| BBa_R0052 | SEQ ID NO: 631 Promoter (434 cI regulated) | ...attgtatgaaaatacaagaaagtttgttga |
| BBa_R0053 | SEQ ID NO: 632 Promoter (p22 cII regulated) | ...tagtagataatttaagtgttctttaatttc |
| BBa_R0061 | SEQ ID NO: 633 Promoter (HSL-mediated luxR | ttgacacctgtaggatcgtacaggtataat |
| | repressor) | |
| BBa_R0063 | SEQ ID NO: 634 Promoter (luxR & HSL | ... |
| | regulated -- lux pL) | cacgcaaaacttgcgacaaacaataggtaa |
| BBa_R0065 | SEQ ID NO: 635 Promoter (lambda cI and luxR | ...gtgttgactattttacctctggcggtgata |
| | regulated -- hybrid) | |
| BBa_R0073 | SEQ ID NO: 636 Promoter (Mnt regulated) | ...tagatctcctatagtgagtcgtattaattt |
| BBa_R0074 | SEQ ID NO: 637 Promoter (PenI regulated) | ...tactttcaaagactacatttgtaagatttg |
| BBa_R0075 | SEQ ID NO: 638 Promoter (TP901 cI regulated) | ... |
| | | cataaagttcatgaaacgtgaactgaaatt |
| BBa_R1050 | SEQ ID NO: 639 Promoter, Standard (HK022 cI | ... |
| | regulated) | ccgtgatactatgaaccataagttcaccac |
| BBa_R1051 | SEQ ID NO: 640 Promoter, Standard (lambda cI | ...aattttacctctggcggtgatactggttgc |
| | regulated) | |
| BBa_R1052 | SEQ ID NO: 641 Promoter, Standard (434 cI | ...attgtatgatactacaagaaagtttgttga |
| | regulated) | |
| BBa_R1053 | SEQ ID NO: 642 Promoter, Standard (p22 cII | ...tagtagatactttaagtgttctttaatttc |
| | regulated) | |
| BBa_R2000 | SEQ ID NO: 643 Promoter, Zif23 regulated, test: | ... |
| | between | tggtcccacgcgcgtgggatactacgtcag |
| BBa_R2001 | SEQ ID NO: 644 Promoter, Zif23 regulated, test: | ... |
| | after | attacggtgagatactcccacgcgcgtggg |
| BBa_R2002 | SEQ ID NO: 645 Promoter, Zif23 regulated, test: | ... |
| | between and after | acgcgcgtgggatactcccacgcgcgtggg |
| BBa_R2108 | SEQ ID NO: 646 Promoter with operator site for | ...gattagattcataaatttgagagaggagtt |
| | C2003 | |
| BBa_R2109 | SEQ ID NO: 647 Promoter with operator site for | ...acttagattcataaatttgagagaggagtt |
| | C2003 | |
| BBa_R2110 | SEQ ID NO: 648 Promoter with operator site for | ...ggttagattcataaatttgagagaggagtt |
| | C2003 | |
| BBa_R2111 | SEQ ID NO: 649 Promoter with operator site for | ...acttagattcataaatttgagagaggagtt |
| | C2003 | |
| BBa_R2112 | SEQ ID NO: 650 Promoter with operator site for | ...aattagattcataaatttgagagaggagtt |
| | C2003 | |
| BBa_R2113 | SEQ ID NO: 651 Promoter with operator site for | ...acttagattcataaatttgagagaggagtt |
| | C2003 | |
| BBa_R2114 | SEQ ID NO: 652 Promoter with operator site for | ...atttagattcataaatttgagagaggagtt |
| | C2003 | |
| BBa_R2201 | SEQ ID NO: 653 C2006-repressible promoter | ... |
| | | cacgcgcgtgggaatgttataatacgtcag |
| BBa_S04209 | SEQ ID NO: 654 R0051:Q04121:B0034:C0079:B0015 | ... |
| | | actgagcacatactagagaaagaggagaaa |

TABLE 26
Examples of Negatively regulated (repressible) E. coli σ^{S} promoters

| Name | Description | Promoter Sequence |
|---|---|---|
| BBa_K086030 | SEQ ID NO: 655 modified Lutz-Bujard LacO | ... |
| | promoter, with alternative sigma factor σ38 | cagtgagcgagtaacaactacgctgtttta |
| BBa_K086031 | SEQ ID NO: 656 modified Lutz-Bujard LacO | ... |
| | promoter, with alternative sigma factor σ38 | cagtgagcgagtaacaactacgctgtttta |
| BBa_K086032 | SEQ ID NO: 657 modified Lutz-Bujard LacO | ... |
| | promoter, with alternative sigma factor σ38 | atgtgagcggataacactataattaataga |
| BBa_K086033 | SEQ ID NO: 658 modified Lutz-Bujard LacO | ... |
| | promoter, with alternative sigma factor σ38 | atgtgagcggataacactataattaataga |
| BBa_K112318 | SEQ ID NO: 659 {<bolA promoter>} in BBb | ... |
| | format | atttcatgatgatacgtgagcggatagaag |

TABLE 27
Examples of Negatively regulated (repressible) E. coli σ32 promoters

| Name | Description | Promoter Sequence |
|---|---|---|
| BBa_K086026 | SEQ ID NO: 660 modified Lutz-Bujard LacO | ... |
| | promoter, with alternative sigma factor σ32 | ttgtgagcgagtggcaccattaagtacgta |
| BBa_K086027 | SEQ ID NO: 661 modified Lutz-Bujard LacO | ... |
| | promoter, with alternative sigma factor σ32 | ttgtgagcgagtgacaccattaagtacgta |
| BBa_K086028 | SEQ ID NO: 662 modified Lutz-Bujard LacO | ... |
| | promoter, with alternative sigma factor σ32 | ttgtgagcgagtaacaccattaagtacgta |
| BBa_K086029 | SEQ ID NO: 663 modified Lutz-Bujard LacO | ... |
| | promoter, with alternative sigma factor σ32 | ttgtgagcgagtaacaccattaagtacgta |

TABLE 28
Examples of Negatively regulated (repressible)
E. coli σ54 promoters

| Name | Description | Promoter Sequence |
|---|---|---|
| BBa_J64979 | SEQ ID NO: 664 glnAp2 | ...agttggcacaga |
| | | tttcgctttatctttttt |

TABLE 29
Examples of Repressible B. subtilis σ_{A} promoters

| | | Promoter |
|---|---|---|
| Name | Description | Sequence |
| BBa_K090501 | SEQ ID NO: 665 Gram- | ... |
| | Positive IPTG- | tggaattgtgagcgg |
| | Inducible Promoter | ataacaattaagctt |
| BBa_K143014 | SEQ ID NO: 666 | ... |
| | Promoter Xyl for | agtttgtttaaacaac |
| | B. subtilis | aaactaataggtga |
| BBa_K143015 | SEQ ID NO: 667 | ... |
| | Promoter hyper-spank | aatgtgtgtaattgtg |
| | for B. subtilis | agcggataacaatt |

TABLE 30
Examples of T7 Repressible Promoters

| Name | Description | Promoter Sequence |
|---|---|---|
| BBa_R0184 | SEQ ID NO: 668 T7 promoter (lacI | ... |
| | repressible) | ataggggaattgtgagcggataacaattcc |
| BBa_R0185 | SEQ ID NO: 669 T7 promoter (lacI | ... |
| | repressible) | ataggggaattgtgagcggataacaattcc |
| BBa_R0186 | SEQ ID NO: 670 T7 promoter (lacI | ... |
| | repressible) | ataggggaattgtgagcggataacaattcc |
| BBa_R0187 | SEQ ID NO: 671 T7 promoter (lacI | ... |
| | repressible) | ataggggaattgtgagcggataacaattcc |

TABLE 31
Examples of Yeast Repressible Promoters

| Name | Description | Promoter Sequence |
|---|---|---|
| BBa_I766558 | SEQ ID NO: 672 pFig1 | ... |
| | (Inducible) Promoter | aaacaaacaaacaaaaa |
| | | aaaaaaaaaaaaa |
| BBa_I766214 | SEQ ID NO: 673 | ...atactttaacgtca |
| | pGal1 | aggagaaaaaactata |
| BBa_K165000 | SEQ ID NO: 674 | ...tagatacaattcta |
| | MET 25 Promoter | ttacccccatccatac |

TABLE 32
Examples of Eukaryotic Repressible Promoters

| Name | Description | Promoter Sequence |
|---|---|---|
| BBa_I756015 | SEQ ID NO: 675 CMV Promoter with lac | ...ttagtgaaccgtcagatcactagtctgcag |
| | operator sites | |
| BBa_I756016 | SEQ ID NO: 676 CMV-tet promoter | ...ttagtgaaccgtcagatcactagtctgcag |
| BBa_I756017 | SEQ ID NO: 677 U6 promoter with tet | ... |
| | operators | ggaaaggacgaaacaccgactagtctgcag |
| BBa_I756018 | SEQ ID NO: 678 Lambda Operator in SV- | ...attgtttgtgtattttagactagtctgcag |
| | 40 intron | |
| BBa_I756019 | SEQ ID NO: 679 Lac Operator in SV-40 | ...attgtttgtgtattttagactagtctgcag |
| | intron | |
| BBa_I756020 | SEQ ID NO: 680 Tet Operator in SV-40 | ...attgtttgtgtattttagactagtctgcag |
| | intron | |
| BBa_I756021 | SEQ ID NO: 681 CMV promoter with | ...ttagtgaaccgtcagatcactagtctgcag |
| | Lambda Operator | |

TABLE 33
Examples of Combination Inducible & Repressible E. coli Promoters

| Name | Description | Promoter Sequence |
|---|---|---|
| BBa_I1051 | SEQ ID NO: 682 Lux cassette right promoter | ... |
| | | tgttatagtcgaatacctctggcggtgata |
| BBa_I12006 | SEQ ID NO: 683 Modified lamdba Prm promoter | ...attacaaactttcttgtatagatttaacgt |
| | (repressed by 434 cI) | |
| BBa_I12036 | SEQ ID NO: 684 Modified lamdba Prm promoter | ...tttcttgtatagatttacaatgtatcttgt |
| | (cooperative repression by 434 cI) | |
| BBa_I12040 | SEQ ID NO: 685 Modified lambda P(RM) | ...tttcttgtagatacttacaatgtatcttgt |
| | promoter: −10 region from P(L) and cooperatively | |
| | repressed by 434 cI | |
| BBa_I14015 | SEQ ID NO: 686 P(Las) TetO | ... |
| | | ttttggtacactccctatcagtgatagaga |
| BBa_I14016 | SEQ ID NO: 687 P(Las) CIO | ... |
| | | ctttttggtacactacctctggcggtgata |
| BBa_I714924 | SEQ ID NO: 688 RecA_DlexO_DLacO1 | ... |
| | | actctcggcatggacgagctgtacaagtaa |
| BBa_I731004 | SEQ ID NO: 689 FecA promoter | ... |
| | | ttctcgttcgactcatagctgaacacaaca |
| BBa_I732301 | SEQ ID NO: 690 NAND Candidate | ... |
| | (U073O26D001O16) | ggaattgtgagcgctcataattggatccgg |
| BBa_I732302 | SEQ ID NO: 691 NAND Candidate | ... |
| | (U073O27D001O17) | ggaattgtgagctacagtcgtcggatccgg |
| BBa_I732303 | SEQ ID NO: 692 NAND Candidate | ... |
| | (U073O22D001O46) | ggaattgtgaacgctcataattggatccgg |
| BBa_I732304 | SEQ ID NO: 693 NAND Candidate | ... |
| | (U073O22D001O47) | ggaattgtgaactacagtcgtcggatccgg |
| BBa_I732305 | SEQ ID NO: 694 NAND Candidate | ... |
| | (U073O22D059O46) | taaattgtgaacgctcataattggatccgg |
| BBa_I732306 | SEQ ID NO: 695 NAND Candidate | ... |
| | (U073O11D002O22) | gaaattgtaagcgcttacaattggatccgg |
| BBa_I732351 | SEQ ID NO: 696 NOR Candidate | ... |
| | (U037O11D002O22) | gaaattgtaagcgcttacaattggatccgg |
| BBa_I732352 | SEQ ID NO: 697 NOR Candidate | ... |
| | (U035O44D001O22) | ggaattgtaagcgcttacaattggatccgg |
| BBa_I732400 | SEQ ID NO: 698 Promoter Family Member | ... |
| | (U097NUL + D062NUL) | gccaaattaaacaggattaacaggatccgg |
| BBa_I732401 | SEQ ID NO: 699 Promoter Family Member | ... |
| | (U097O11 + D062NUL) | gccaaattaaacaggattaacaggatccgg |
| BBa_I732402 | SEQ ID NO: 700 Promoter Family Member | ... |
| | (U085O11 + D062NUL) | gccaaattaaacaggattaacaggatccgg |
| BBa_I732403 | SEQ ID NO: 701 Promoter Family Member | ... |
| | (U073O11 + D062NUL) | gccaaattaaacaggattaacaggatccgg |
| BBa_I732404 | SEQ ID NO: 702 Promoter Family Member | ... |
| | (U061O11 + D062NUL) | gccaaattaaacaggattaacaggatccgg |
| BBa_I732405 | SEQ ID NO: 703 Promoter Family Member | ... |
| | (U049O11 + D062NUL) | gccaaattaaacaggattaacaggatccgg |
| BBa_I732406 | SEQ ID NO: 704 Promoter Family Member | ... |
| | (U037O11 + D062NUL) | gccaaattaaacaggattaacaggatccgg |
| BBa_I732407 | SEQ ID NO: 705 Promoter Family Member | ... |
| | (U097NUL + D002O22) | gaaattgtaagcgcttacaattggatccgg |
| BBa_I732408 | SEQ ID NO: 706 Promoter Family Member | ... |
| | (U097NUL + D014O22) | taaattgtaagcgcttacaattggatccgg |
| BBa_I732409 | SEQ ID NO: 707 Promoter Family Member | ... |
| | (U097NUL + D026O22) | gtaattgtaagcgcttacaattggatccgg |
| BBa_I732410 | SEQ ID NO: 708 Promoter Family Member | ... |
| | (U097NUL + D038O22) | tcaattgtaagcgcttacaattggatccgg |
| BBa_I732411 | SEQ ID NO: 709 Promoter Family Member | ... |
| | (U097NUL + D050O22) | aaaattgtaagcgcttacaattggatccgg |
| BBa_I732412 | SEQ ID NO: 710 Promoter Family Member | ... |
| | (U097NUL + D062O22) | caaattgtaagcgcttacaattggatccgg |
| BBa_I732413 | SEQ ID NO: 711 Promoter Family Member | ... |
| | (U097O11 + D002O22) | gaaattgtaagcgcttacaattggatccgg |
| BBa_I732414 | SEQ ID NO: 712 Promoter Family Member | ... |
| | (U097O11 + D014O22) | taaattgtaagcgcttacaattggatccgg |
| BBa_I732415 | SEQ ID NO: 713 Promoter Family Member | ... |
| | (U097O11 + D026O22) | gtaattgtaagcgcttacaattggatccgg |
| BBa_I732416 | SEQ ID NO: 714 Promoter Family Member | ... |
| | (U097O11 + D038O22) | tcaattgtaagcgcttacaattggatccgg |
| BBa_I732417 | SEQ ID NO: 715 Promoter Family Member | ... |
| | (U097O11 + D050O22) | aaaattgtaagcgcttacaattggatccgg |
| BBa_I732418 | SEQ ID NO: 716 Promoter Family Member | ... |
| | (U097O11 + D062O22) | caaattgtaagcgcttacaattggatccgg |
| BBa_I732419 | SEQ ID NO: 717 Promoter Family Member | ... |
| | (U085O11 + D002O22) | gaaattgtaagcgcttacaattggatccgg |
| BBa_I732420 | SEQ ID NO: 718 Promoter Family Member | ... |
| | (U085O11 + D014O22) | taaattgtaagcgcttacaattggatccgg |
| BBa_I732421 | SEQ ID NO: 719 Promoter Family Member | ... |
| | (U085O11 + D026O22) | gtaattgtaagcgcttacaattggatccgg |
| BBa_I732422 | SEQ ID NO: 720 Promoter Family Member | ... |
| | (U085O11 + D038O22) | tcaattgtaagcgcttacaattggatccgg |
| BBa_I732423 | SEQ ID NO: 721 Promoter Family Member | ... |
| | (U085O11 + D050O22) | aaaattgtaagcgcttacaattggatccgg |
| BBa_I732424 | SEQ ID NO: 722 Promoter Family Member | ... |
| | (U085O11 + D062O22) | caaattgtaagcgcttacaattggatccgg |
| BBa_I732425 | SEQ ID NO: 723 Promoter Family Member | ... |
| | (U073O11 + D002O22) | gaaattgtaagcgcttacaattggatccgg |
| BBa_I732426 | SEQ ID NO: 724 Promoter Family Member | ... |
| | (U073O11 + D014O22) | taaattgtaagcgcttacaattggatccgg |
| BBa_I732427 | SEQ ID NO: 725 Promoter Family Member | ... |
| | (U073O11 + D026O22) | gtaattgtaagcgcttacaattggatccgg |
| BBa_I732428 | SEQ ID NO: 726 Promoter Family Member | ... |
| | (U073O11 + D038O22) | tcaattgtaagcgcttacaattggatccgg |
| BBa_I732429 | SEQ ID NO: 727 Promoter Family Member | ... |
| | (U073O11 + D050O22) | aaaattgtaagcgcttacaattggatccgg |
| BBa_I732430 | SEQ ID NO: 728 Promoter Family Member | ... |
| | (U073O11 + D062O22) | caaattgtaagcgcttacaattggatccgg |
| BBa_I732431 | SEQ ID NO: 729 Promoter Family Member | ... |
| | (U061O11 + D002O22) | gaaattgtaagcgcttacaattggatccgg |
| BBa_I732432 | SEQ ID NO: 730 Promoter Family Member | ... |
| | (U061O11 + D014O22) | taaattgtaagcgcttacaattggatccgg |
| BBa_I732433 | SEQ ID NO: 731 Promoter Family Member | ... |
| | (U061O11 + D026O22) | gtaattgtaagcgcttacaattggatccgg |
| BBa_I732434 | SEQ ID NO: 732 Promoter Family Member | ... |
| | (U061O11 + D038O22) | tcaattgtaagcgcttacaattggatccgg |
| BBa_I732435 | SEQ ID NO: 733 Promoter Family Member | ... |
| | (U061O11 + D050O22) | aaaattgtaagcgcttacaattggatccgg |
| BBa_I732436 | SEQ ID NO: 734 Promoter Family Member | ... |
| | (U061O11 + D062O22) | caaattgtaagcgcttacaattggatccgg |
| BBa_I732437 | SEQ ID NO: 735 Promoter Family Member | ... |
| | (U049O11 + D002O22) | gaaattgtaagcgcttacaattggatccgg |
| BBa_I732438 | SEQ ID NO: 736 Promoter Family Member | ... |
| | (U049O11 + D014O22) | taaattgtaagcgcttacaattggatccgg |
| BBa_I732439 | SEQ ID NO: 737 Promoter Family Member | ... |
| | (U049O11 + D026O22) | gtaattgtaagcgcttacaattggatccgg |
| BBa_I732440 | SEQ ID NO: 738 Promoter Family Member | ... |
| | (U049O11 + D038O22) | tcaattgtaagcgcttacaattggatccgg |
| BBa_I732441 | SEQ ID NO: 739 Promoter Family Member | ... |
| | (U049O11 + D050O22) | aaaattgtaagcgcttacaattggatccgg |
| BBa_I732442 | SEQ ID NO: 740 Promoter Family Member | ... |
| | (U049O11 + D062O22) | caaattgtaagcgcttacaattggatccgg |
| BBa_I732443 | SEQ ID NO: 741 Promoter Family Member | ... |
| | (U037O11 + D002O22) | gaaattgtaagcgcttacaattggatccgg |
| BBa_I732444 | SEQ ID NO: 742 Promoter Family Member | ... |
| | (U037O11 + D014O22) | taaattgtaagcgcttacaattggatccgg |
| BBa_I732445 | SEQ ID NO: 743 Promoter Family Member | ... |
| | (U037O11 + D026O22) | gtaattgtaagcgcttacaattggatccgg |
| BBa_I732446 | SEQ ID NO: 744 Promoter Family Member | ... |
| | (U037O11 + D038O22) | tcaattgtaagcgcttacaattggatccgg |
| BBa_I732447 | SEQ ID NO: 745 Promoter Family Member | ... |
| | (U037O11 + D050O22) | aaaattgtaagcgcttacaattggatccgg |
| BBa_I732448 | SEQ ID NO: 746 Promoter Family Member | ... |
| | (U037O11 + D062O22) | caaattgtaagcgcttacaattggatccgg |
| BBa_I732450 | SEQ ID NO: 747 Promoter Family Member | ... |
| | (U073O26 + D062NUL) | gccaaattaaacaggattaacaggatccgg |
| BBa_I732451 | SEQ ID NO: 748 Promoter Family Member | ... |
| | (U073O27 + D062NUL) | gccaaattaaacaggattaacaggatccgg |
| BBa_I732452 | SEQ ID NO: 749 Promoter Family Member | ... |
| | (U073O26 + D062O61) | caaattatgagcgctcacaattggatccgg |
| BBa_I739102 | SEQ ID NO: 750 Double Promoter (cI, negative/ | ... |
| | TetR, negative) | tgatagagattccctatcagtgatagagat |
| BBa_I739103 | SEQ ID NO: 751 Double Promoter (lacI, | ...gttctttaattatttaagtgttctttaatt |
| | negative/P22 cII, negative) | |
| BBa_I739104 | SEQ ID NO: 752 Double Promoter (LuxR/HSL, | ...gttctttaattatttaagtgttctttaatt |
| | positive/P22 cII, negative) | |
| BBa_I739105 | SEQ ID NO: 753 Double Promoter LuxR/HSL, | ... |
| | positive/cI, negative) | cgtgcgtgttgataacaccgtgcgtgttga |
| BBa_I739106 | SEQ ID NO: 754 Double Promoter (TetR, | ...gtgttctttaatatttaagtgttctttaat |
| | negative/P22 cII, negative) | |
| BBa_I739107 | SEQ ID NO: 755 Double Promoter (cI, negative/ | ... |
| | LacI, negative) | ggaattgtgagcggataacaatttcacaca |
| BBa_I741018 | SEQ ID NO: 756 Right facing promoter (for | ... |
| | xylF) controlled by xylR and CRP-cAMP | gttacgtttatcgcggtgattgttacttat |
| BBa_I741019 | SEQ ID NO: 757 Right facing promoter (for | ... |
| | xylA) controlled by xylR and CRP-cAMP | gcaaaataaaatggaatgatgaaactgggt |
| BBa_I742124 | SEQ ID NO: 758 Reverse complement Lac | ... |
| | promoter | aacgcgcggggagaggcggtttgcgtattg |
| BBa_I751501 | SEQ ID NO: 759 plux-cI hybrid promoter | ... |
| | | gtgttgatgcttttatcaccgccagtggta |
| BBa_I751502 | SEQ ID NO: 760 plux-lac hybrid promoter | ... |
| | | agtgtgtggaattgtgagcggataacaatt |
| BBa_I761011 | SEQ ID NO: 761 CinR, CinL and glucose | ...acatcttaaaagttttagtatcatattcgt |
| | controlled promoter | |
| BBa_I765007 | SEQ ID NO: 762 Fe and UV promoters | ... |
| | | ctgaaagcgcataccgctatggagggggtt |
| BBa_J05209 | SEQ ID NO: 763 Modified Pr Promoter | ...tattttacctctggcggtgataatggttgc |
| BBa_J05210 | SEQ ID NO: 764 Modified Prm+ Promoter | ...atttataaatagtggtgatagatttaacgt |
| BBa_J58100 | SEQ ID NO: 765 AND-type promoter | ...atttataaatagtggtgatagatttaacgt |
| | synergistically activated by cI and CRP | |
| BBa_J64712 | SEQ ID NO: 766 LasR/LasI Inducible & | ... |
| | RHLR/RHLI repressible Promoter | gaaatctggcagtttttggtacacgaaagc |
| BBa_J64800 | SEQ ID NO: 767 RHLR/RHLI Inducible & | ... |
| | LasR/LasI repressible Promoter | tgccagttctggcaggtctaaaaagtgttc |
| BBa_J64804 | SEQ ID NO: 768 The promoter region (inclusive | ... |
| | of regulator binding sites) of the B. subtilis RocDEF | cacagaacttgcatttatataaagggaaag |
| | operon | |
| BBa_J64979 | SEQ ID NO: 769 glnAp2 | ...agttggcacagatttcgctttatctttttt |
| BBa_J64981 | SEQ ID NO: 770 OmpR-P strong binding, | ... |
| | regulatory region for Team Challenge03-2007 | agcgctcacaatttaatacgactcactata |
| BBa_K091100 | SEQ ID NO: 771 pLac_lux hybrid promoter | ... |
| | | ggaattgtgagcggataacaatttcacaca |
| BBa_K091101 | SEQ ID NO: 772 pTet_Lac hybrid promoter | ... |
| | | ggaattgtgagcggataacaatttcacaca |
| BBa_K091104 | SEQ ID NO: 773 pLac/Mnt Hybrid Promoter | ... |
| | | ggaattgtgagcggataacaatttcacaca |
| BBa_K091105 | SEQ ID NO: 774 pTet/Mnt Hybrid Promoter | ... |
| | | agaactgtaatccctatcagtgatagagat |
| BBa_K091106 | SEQ ID NO: 775 LsrA/cI hybrid promoter | ...tgttgatttatctaacaccgtgcgtgttga |
| BBa_K091107 | SEQ ID NO: 776 pLux/cI Hybrid Promoter | ... |
| | | acaccgtgcgtgttgatatagtcgaataaa |
| BBa_K091143 | SEQ ID NO: 777 pLas/cI Hybrid Promoter | ... |
| | | ggttctttttggtacctctggcggtgataa |
| BBa_K091146 | SEQ ID NO: 778 pLas/Lux Hybrid Promoter | ... |
| | | tgtaggatcgtacaggtataaattcttcag |
| BBa_K091157 | SEQ ID NO: 779 pLux/Las Hybrid Promoter | ...ctatctcatttgctagtatagtcgaataaa |
| BBa_K094120 | SEQ ID NO: 780 pLacI/ara-1 | ... |
| | | aattgtgagcggataacaatttcacacaga |
| BBa_K100000 | SEQ ID NO: 781 Natural Xylose Regulated Bi- | ...gttacgtttatcgcggtgattgttacttat |
| | Directional Operator | |
| BBa_K101000 | SEQ ID NO: 782 Dual-Repressed Promoter for | ... |
| | p22 mnt and TetR | acggtgacctagatctccgatactgagcac |
| BBa_K101001 | SEQ ID NO: 783 Dual-Repressed Promoter for | ... |
| | LacI and LambdacI | tggaattgtgagcggataaaatttcacaca |
| BBa_K101002 | SEQ ID NO: 784 Dual-Repressed Promoter for | ...tagtagataatttaagtgttctttaatttc |
| | p22 cII and TetR | |
| BBa_K109200 | SEQ ID NO: 785 AraC and TetR promoter | ... |
| | (hybrid) | aacaaaaaaacggatcctctagttgcggcc |
| BBa_K112118 | SEQ ID NO: 786 rrnB P1 promoter | ... |
| | | ataaatgcttgactctgtagcgggaaggcg |
| BBa_K112318 | SEQ ID NO: 787 {<bolA promoter>} in BBb | ... |
| | format | atttcatgatgatacgtgagcggatagaag |
| BBa_K112322 | SEQ ID NO: 788 {Pdps} in BBb format | ... |
| | | gggacacaaacatcaagaggatatgagatt |
| BBa_K112402 | SEQ ID NO: 789 promoter for FabA gene - | ... |
| | Membrane Damage and Ultrasound Sensitive | gtcaaaatgaccgaaacgggtggtaacttc |
| BBa_K112405 | SEQ ID NO: 790 Promoter for CadA and CadB | ... |
| | genes | agtaatcttatcgccagtttggtctggtca |
| BBa_K112406 | SEQ ID NO: 791 cadC promoter | ... |
| | | agtaatcttatcgccagtttggtctggtca |
| BBa_K112701 | SEQ ID NO: 792 hns promoter | ... |
| | | aattctgaacaacatccgtactcttcgtgc |
| BBa_K116001 | SEQ ID NO: 793 nhaA promoter, that can be | ... |
| | regulated by pH and nhaR protein. | cgatctattcacctgaaagagaaataaaaa |
| BBa_K116500 | SEQ ID NO: 794 OmpF promoter that is | ... |
| | activated or repressed by OmpR according to osmolarity. | aaacgttagtttgaatggaaagatgcctgc |
| BBa_K121011 | SEQ ID NO: 795 promoter (lacI regulated) | ... |
| | | acaggaaacagctatgaccatgattacgcc |
| BBa_K136010 | SEQ ID NO: 796 fliA promoter | ... |
| | | gttcactctataccgctgaaggtgtaatgg |
| BBa_K145150 | SEQ ID NO: 797 Hybrid promoter: HSL-LuxR | ...tagtttataatttaagtgttctttaatttc |
| | activated, P22 C2 repressed | |
| BBa_K145152 | SEQ ID NO: 798 Hybrid promoter: P22 c2, LacI | ... |
| | NOR gate | gaaaatgtgagcgagtaacaacctcacaca |
| BBa_K259005 | SEQ ID NO: 799 AraC Rheostat Promoter | ...ttttatcgcaactctctactgtttctccat |
| BBa_K259007 | SEQ ID NO: 800 AraC Promoter fused with RBS | ... |
| | | gtttctccattactagagaaagaggggaca |
| BBa_K266005 | SEQ ID NO: 801 PAI + LasR -> LasI & AI + LuxR --\| | ... |
| | LasI | aataactctgatagtgctagtgtagatctc |
| BBa_K266006 | SEQ ID NO: 802 PAI + LasR -> LasI + GFP & | ... |
| | AI + LuxR --\| LasI + GFP | caccttcgggtgggcctttctgcgtttata |
| BBa_K266007 | SEQ ID NO: 803 Complex QS -> LuxI & LasI | ... |
| | circuit | caccttcgggtgggcctttctgcgtttata |
| BBa_R0065 | SEQ ID NO: 804 Promoter (lambda cI and luxR | ...gtgttgactattttacctctggcggtgata |
| | regulated -- hybrid) | |

TABLE 34
Examples of Combination Inducible & Repressible
Miscellaneous Prokaryotic Promoters

| Name | Description | Promoter Sequence |
|---|---|---|
| BBa_K125100 | SEQ ID NO: 805 nir | ... |
| | promoter from | cgaaacgggaa |
| | Synechocystis | ccctatattgatctctact |
| | sp. PCC6803 | |

TABLE 35
Examples of Combination Inducible & Repressible Miscellaneous Yeast Promoters

| Name | Description | Promoter Sequence |
|---|---|---|
| BBa_I766200 | SEQ ID NO: 806 pSte2 | ... |
| | | accgttaagaaccatatccaagaatcaaaa |
| BBa_K110016 | SEQ ID NO: 807 A-Cell Promoter STE2 | ... |
| | (backwards) | accgttaagaaccatatccaagaatcaaaa |
| BBa_K165034 | SEQ ID NO: 808 Zif268-HIV bs + LexA bs + | ... |
| | mCYC promoter | cacaaatacacacactaaattaataactag |
| BBa_K165041 | SEQ ID NO: 809 Zif268-HIV binding sites + | ... |
| | TEF constitutive yeast promoter | atacggtcaacgaactataattaactaaac |
| BBa_K165043 | SEQ ID NO: 810 Zif268-HIV binding sites + | ... |
| | MET25 constitutive yeast promoter | tagatacaattctattacccccatccatac |

TABLE 36
Examples of Combination Inducible & Repressible Miscellaneous
Eukaryotic Promoters

| Name | Description | Promoter Sequence |
|---|---|---|
| BBa_J05215 | SEQ ID NO: 811 Regulator for R1- | ... |
| | CREBH | ggggcgagggccccgcctccggaggcgggg |
| BBa_J05216 | SEQ ID NO: 812 Regulator for R3-ATF6 | ... |
| | | gaggggacggctccggccccggggccggag |
| BBa_J05217 | SEQ ID NO: 813 Regulator for R2- | ... |
| | YAP7 | ggggcgagggctccggccccggggccggag |
| BBa_J05218 | SEQ ID NO: 814 Regulator for R4-cMaf | ... |
| | | gaggggacggccccgcctccggaggcgggg |

In addition to the above-described promoter sequences, the molecular circuits and modular functional blocks described herein can comprise, in addition, one or more molecular species, including, but not limited to, ribosome binding sequences, degradation tag sequences, translational terminator sequences, and anti-sense sequences, that are added to, for example, enhance translation of mRNA sequences for protein synthesis, prevent further transcription downstream of the an encoded protein, or enhance degradation of an mRNA sequence or protein sequence. Such additional molecular species, by enhancing the fidelity and accuracy of the molecular circuits described herein permit, for example, increased numbers and combinations of molecular circuits and improve the capabilities of the molecular circuits described herein. Known enhancer and repressor sequences from promoter regions or intronic regions and their corresponding regulatory proteins or RNAs can also be used to regulate, e.g., transcription.

### Ribosome Binding Sites

Ribosome binding sites (RBS) are sequences that promote efficient and accurate translation of mRNAs for protein synthesis, and are also provided for use as molecular species in the molecular circuits and modular functional blocks described herein to enable modulation of the efficiency and rates of synthesis of the proteins encoded by the molecular circuits and modular functional blocks. An RBS affects the translation rate of an open reading frame in two main ways—i) the rate at which ribosomes are recruited to the mRNA and initiate translation is dependent on the sequence of the RBS, and ii) the RBS can also affect the stability of the mRNA, thereby affecting the number of proteins made over the lifetime of the mRNA. Accordingly, one or more ribosome binding site sequences (RBS) can be added to the molecular circuits and modular functional blocks described herein to control expression of proteins, such as transcription factors or protein output products.

Translation initiation in prokaryotes is a complex process involving the ribosome, the mRNA, and several other proteins, such as initiation factors, as described in Laursen B S, et al., Microbiol Mol Biol Rev 2005 March; 69(1) 101-23. Translation initiation can be broken down into two major steps—i) binding of the ribosome and associated factors to the mRNA, and ii) conversion of the bound ribosome into a translating ribosome lengthening processing along the mRNA. The rate of the first step can be increased by making the RBS highly complementary to the free end of the 16s rRNA and by ensuring that the start codon is AUG. The rate of ribosome binding can also be increased by ensuring that there is minimal secondary structure in the neighborhood of the RBS. Since binding between the RBS and the ribosome is mediated by base-pairing interactions, competition for the RBS from other sequences on the mRNA, can reduce the rate of ribosome binding. The rate of the second step in translation initiation, conversion of the bound ribosome into an initiation complex is dependent on the spacing between the RBS and the start codon being optimal (5-6 bp).

Thus, a “ribosome binding site” (“RBS”), as defined herein, is a segment of the 5′ (upstream) part of an mRNA molecule that binds to the ribosome to position the message correctly for the initiation of translation. The RBS controls the accuracy and efficiency with which the translation of mRNA begins. In prokaryotes (such as E. coli) the RBS typically lies about 7 nucleotides upstream from the start codon (i.e., the first AUG). The sequence itself in general is called the “Shine-Dalgarno” sequence after its discoverers, regardless of the exact identity of the bases. Strong Shine-Dalgarno sequences are rich in purines (A's,G's), and the “Shine-Dalgarno consensus” sequence—derived statistically from lining up many well-characterized strong ribosome binding sites—has the sequence AGGAGG. The complementary sequence (CCUCCU) occurs at the 3′-end of the structural RNA (“16S”) of the small ribosomal subunit and it base-pairs with the Shine-Dalgarno sequence in the mRNA to facilitate proper initiation of protein synthesis. In some embodiments of the aspects described herein, a ribosome binding site (RBS) is added to a molecular circuits to regulate expression of a protein encoded by the circuit.

For protein synthesis in eukaryotes and eukaryotic cells, the 5′ end of the mRNA has a modified chemical structure (“cap”) recognized by the ribosome, which then binds the mRNA and moves along it (“scans”) until it finds the first AUG codon. A characteristic pattern of bases (called a “Kozak sequence”) is sometimes found around that codon and assists in positioning the mRNA correctly in a manner reminiscent of the Shine-Dalgarno sequence, but does not involve base pairing with the ribosomal RNA.

RBSs can include only a portion of the Shine-Dalgarno sequence. When looking at the spacing between the RBS and the start codon, the aligned spacing rather than just the absolute spacing is important. In essence, if only a portion of the Shine-Dalgarno sequence is included in the RBS, the spacing that matters is between wherever the center of the full Shine-Dalgarno sequence would be and the start codon rather than between the included portion of the Shine-Dalgarno sequence and the start codon.

While the Shine-Dalgarno portion of the RBS is critical to the strength of the RBS, the sequence upstream of the Shine-Dalgarno sequence is also important. One of the ribosomal proteins, S1, is known to bind to adenine bases upstream from the Shine-Dalgarno sequence. As a result, in some embodiments of the molecular circuits and modular functional blocks described herein, an RBS can be made stronger by adding more adenines to the sequence upstream of the RBS. A promoter may add some bases onto the start of the mRNA that may affect the strength of the RBS by affecting S1 binding.

In addition, the degree of secondary structure can affect the translation initiation rate. This fact can be used to produce regulated translation initiation rates, as described in Isaacs F J et al., Nat Biotechnol 2004 July; 22(7) 841-7.

In addition to affecting the translation rate per unit time, an RBS can affect the level of protein synthesis in a second way. That is because the stability of the mRNA affects the steady state level of mRNA, i.e., a stable mRNA will have a higher steady state level than an unstable mRNA that is being produced as an identical rate. Since the primary sequence and the secondary structure of an RBS (for example, the RBS could introduce an RNase site) can affect the stability of the mRNA, the RBS can affect the amount of mRNA and hence the amount of protein that is synthesized.

A “regulated RBS” is an RBS for which the binding affinity of the RBS and the ribosome can be controlled, thereby changing the RBS strength. One strategy for regulating the strength of prokaryotic RBSs is to control the accessibility of the RBS to the ribosome. By occluding the RBS in RNA secondary structure, translation initiation can be significantly reduced. By contrast, by reducing secondary structure and revealing the RBS, translation initiation rate can be increased. Isaacs and coworkers engineered mRNA sequences with an upstream sequence partially complementary to the RBS. Base-pairing between the upstream sequence and the RBS ‘locks’ the RBS off. A ‘key’ RNA molecule that disrupts the mRNA secondary structure by preferentially base-pairing with the upstream sequence can be used to expose the RBS and increase translation initiation rate.

Accordingly, in some embodiments of the aspects described herein, a ribosome binding site (RBS) for use as molecular species in the molecular circuits and modular functional blocks described herein comprises a sequence that is selected from the group consisting of those provided in the MIT Parts Registry. In some embodiments of the aspects described herein, novel ribosome binding sites can be generated using automated design of synthetic ribosome sites, as described in Salis H M et al., Nature Biotechnology 27, 946-950 (2009).

### Terminators

Terminators are sequences that usually occur at the end of a gene or operon and cause transcription to stop, and are also provided for use as molecular species in the molecular circuits and modular functional blocks described herein to regulate transcription and prevent transcription from occurring in an unregulated fashion, i.e., a terminator sequence prevents activation of downstream modules by upstream promoters. A “terminator” or “termination signal”, as described herein, is comprised of the DNA sequences involved in specific termination of an RNA transcript by an RNA polymerase. Thus, in certain embodiments a terminator that ends the production of an RNA transcript is contemplated for use as a molecular species. A terminator can be necessary in vivo to achieve desirable message levels.

In prokaryotes, terminators usually fall into two categories (1) rho-independent terminators and (2) rho-dependent terminators. Rho-independent terminators are generally composed of palindromic sequence that forms a stem loop rich in G-C base pairs followed by several T bases. Without wishing to be bound by a theory, the conventional model of transcriptional termination is that the stem loop causes RNA polymerase to pause, and transcription of the poly-A tail causes the RNA:DNA duplex to unwind and dissociate from RNA polymerase.

The most commonly used type of terminator is a forward terminator. When placed downstream of a nucleic acid sequence that is usually transcribed, a forward transcriptional terminator will cause transcription to abort. In some embodiments, bidirectional transcriptional terminators are provided. Such terminators will usually cause transcription to terminate on both the forward and reverse strand. Finally, in some embodiments, reverse transcriptional terminators are provided that terminate transcription on the reverse strand only.

In eukaryotic systems, the terminator region can also comprise specific DNA sequences that permit site-specific cleavage of the new transcript so as to expose a polyadenylation site. This signals a specialized endogenous polymerase to add a stretch of about 200 A residues (polyA) to the 3′ end of the transcript. RNA molecules modified with this polyA tail appear to more stable and are translated more efficiently. Thus, in those embodiments involving eukaryotes, it is preferred that a terminator comprises a signal for the cleavage of the RNA, and it is more preferred that the terminator signal promotes polyadenylation of the message. The terminator and/or polyadenylation site elements can serve to enhance message levels and/or to minimize read through between modules of the biological converter switches. As disclosed herein, terminators contemplated for use in molecular circuits and modular functional blocks, and methods of use thereof can include any known terminator of transcription described herein or known to one of ordinary skill in the art. Such terminators include, but are not limited to, the termination sequences of genes, such as for example, the bovine growth hormone terminator, or viral termination sequences, such as for example, the SV40 terminator. In certain embodiments, the termination signal encompasses a lack of transcribable or translatable sequence, such as due to a sequence truncation. The terminator used can be unidirectional or bidirectional.

Terminators for use as molecular species in the molecular circuits and modular functional blocks described herein can be selected from the non-limiting examples of Tables 37-41.

TABLE 37
Examples of Forward Terminators

| | | | Efficiency | | |
|---|---|---|---|---|---|
| Name | Description | Direction | Fwd. | Rev. | Length |
| BBa_B0010 | T1 from E. coli rrnB | Forward | | | 80 |
| BBa_B0012 | TE from coliphageT7 | Forward | 0.309[CC] | −0.368[CC] | 41 |
| BBa_B0013 | TE from coliphage T7 (+/−) | Forward | 0.6[CC] | −1.06[CC] | 47 |
| BBa_B0015 | double terminator (B0010-B0012) | Forward | 0.984[CC] | 0.295[CC] | 129 |
| | | | 0.97[JK] | 0.62[JK] | |
| BBa_B0017 | double terminator (B0010-B0010) | Forward | | | 168 |
| BBa_B0053 | Terminator (His) | Forward | | | 72 |
| BBa_B0055 | -- No description -- | | | | 78 |
| BBa_B1002 | Terminator (artificial, small, % T~=85%) | Forward | 0.98[CH] | | 34 |
| BBa_B1003 | Terminator (artificial, small, % T~=80) | Forward | 0.83[CH] | | 34 |
| BBa_B1004 | Terminator (artificial, small, % T~=55) | Forward | 0.93[CH] | | 34 |
| BBa_B1005 | Terminator (artificial, small, % T~=25% | Forward | 0.86[CH] | | 34 |
| BBa_B1006 | Terminator (artificial, large, % T~>90) | Forward | 0.99[CH] | | 39 |
| BBa_B1010 | Terminator (artificial, large, % T~<10) | Forward | 0.95[CH] | | 40 |
| BBa_I11013 | Modification of biobricks part BBa_B0015 | | | | 129 |
| BBa_I51003 | -- No description -- | | | | 110 |
| BBa_J61048 | [rnpB-T1] Terminator | Forward | 0.98[JCA] | | 113 |

TABLE 38
Examples of Bidirectional Terminators

| | | | Efficiency | | |
|---|---|---|---|---|---|
| Name | Description | Direction | Fwd. | Rev. | Length |
| BBa_B0011 | LuxICDABEG (+/−) | Bidirectional | 0.419[CC]/0.95[JK] | 0.636[CC]/0.86[JK] | 46 |
| BBa_B0014 | double terminator (B0012- | Bidirectional | 0.604[CC]/0.96[JK] | 0.86[JK] | 95 |
| | B0011) | | | | |
| BBa_B0021 | LuxICDABEG (+/−), | Bidirectional | 0.636[CC]/0.86[JK] | 0.419[CC]/0.95[JK] | 46 |
| | reversed | | | | |
| BBa_B0024 | double terminator (B0012- | Bidirectional | 0.86[JK] | 0.604[CC]/0.96[JK] | 95 |
| | B0011), reversed | | | | |
| BBa_B0050 | Terminator (pBR322, +/−) | Bidirectional | | | 33 |
| BBa_B0051 | Terminator (yciA/tonA, +/−) | Bidirectional | | | 35 |
| BBa_B1001 | Terminator (artificial, | Bidirectional | 0.81[CH] | | 34 |
| | small, % T~=90) | | | | |
| BBa_B1007 | Terminator (artificial, | Bidirectional | 0.83[CH] | | 40 |
| | large, % T~=80) | | | | |
| BBa_B1008 | Terminator (artificial, | Bidirectional | | | 40 |
| | large, % T~=70) | | | | |
| BBa_B1009 | Terminator (artificial, | Bidirectional | | | 40 |
| | large, % T~=40%) | | | | |
| BBa_K259006 | GFP-Terminator | Bidirectional | 0.604[CC]/0.96[JK] | 0.86[JK] | 823 |

TABLE 39
Examples of Reverse Terminators

| | | | Efficiency | | |
|---|---|---|---|---|---|
| Name | Description | Direction | Fwd. | Rev. | Length |
| BBa_B0020 | Terminator (Reverse B0010) | Reverse | | | 82 |
| BBa_B0022 | TE from coliphageT7, reversed | Reverse | −0.368[CC] | 0.309[CC] | 41 |
| BBa_B0023 | TE from coliphage T7, | Reverse | −1.06[CC] | 0.6[CC] | 47 |
| | reversed | | | | |
| BBa_B0025 | double terminator (B0015), | Reverse | 0.295[CC]/0.62[JK] | 0.984[CC]/0.97[JK] | 129 |
| | reversed | | | | |
| BBa_B0052 | Terminator (rrnC) | Forward | | | 41 |
| BBa_B0060 | Terminator (Reverse B0050) | Bidirectional | | | 33 |
| BBa_B0061 | Terminator (Reverse B0051) | Bidirectional | | | 35 |
| BBa_B0063 | Terminator (Reverse B0053) | Reverse | | | 72 |

TABLE 40
Examples of Yeast Terminators

| | | | Efficiency | | |
|---|---|---|---|---|---|
| Name | Description | Direction | Fwd. | Rev. | Length |
| BBa_J63002 | ADH1 terminator | Forward | | | 225 |
| | from | | | | |
| | S. cerevisiae | | | | |
| BBa_K110012 | STE2 terminator | Forward | | | 123 |
| BBa_Y1015 | CycE1 | | | | 252 |

TABLE 41
Examples of Eukaryotic Terminators

| | | | Efficiency | | | |
|---|---|---|---|---|---|---|
| Name | Description | Direction | Fwd. | Rev. | Chassis | Length |

| | | | |
|---|---|---|---|
| BBa_J52016 | eukaryotic -- derived from SV40 | Forward | 238 |
| | early poly A signal sequence | | |
| BBa_J63002 | ADH1 terminator from S. cerevisiae | Forward | 225 |
| BBa_K110012 | STE2 terminator | Forward | 123 |
| BBa_Y1015 | CycE1 | | 252 |

### Degradation Tags

In some embodiments of the aspects described herein, a nucleic sequence encoding a protein degradation tag can be added as a molecular species to the molecular circuits and modular functional blocks described herein to enhance degradation of a protein. As defined herein, a “degradation tag” is a genetic addition to the end of a nucleic acid sequence that modifies the protein that is expressed from that sequence, such that the protein undergoes faster degradation by cellular degradation mechanisms. Thus, such protein degradation tags ‘mark’ a protein for degradation, thus decreasing a protein's half-life.

One of the useful aspects of degradation tags is the ability to detect and regulate gene activity in a time-sensitive manner. Such protein degradation tags can operate through the use of protein-degrading enzymes, such as proteases, within the cell. In some embodiments, the tags encode for a sequence of about eleven amino acids at the C-terminus of a protein, wherein said sequence is normally generated in E. coli when a ribosome gets stuck on a broken (“truncated”) mRNA. Without a normal termination codon, the ribosome can't detach from the defective mRNA. A special type of RNA known as ssrA (“small stable RNA A”) or tmRNA (“transfer-messenger RNA”) rescues the ribosome by adding the degradation tag followed by a stop codon. This allows the ribosome to break free and continue functioning. The tagged, incomplete protein can get degraded by the proteases ClpXP or ClpAP. Although the initial discovery of the number of amino acids encoding for an ssRA/tmRNA tag was eleven, the efficacy of mutating the last three amino acids of that system has been tested. Thus, the tags AAV, ASV, LVA, and LAA are classified by only three amino acids.

In some exemplary embodiments of the aspects described herein, the protein degradation tag is an ssrA tag. In some embodiments of the aspects described herein, the ssrA tag comprises a sequence that is selected from the group consisting of sequences that encode for the peptides RPAANDENYALAA (SEQ ID NO: 815), RPAANDENYALVA (SEQ ID NO: 816), RPAANDENYAAAV (SEQ ID NO: 817), and RPAANDENYAASV (SEQ ID NO: 818).

In some exemplary embodiments of the aspects described herein, the protein degradation tag is an LAA variant comprising the sequence GCAGCAAACGACGAAAACTACGCTTTAGCAGCTTAA (SEQ ID NO: 819). In some embodiments of the aspects described herein, the protein degradation tag is an AAV variant comprising the sequence GCAGCAAACGACGAAAACTACGCTGCAGCAGTTTAA (SEQ ID NO: 820). In some exemplary embodiments of the aspects described herein, the protein degradation tag is an ASV variant comprising the sequence GCAGCAAACGACGAAAACTACGCTGCATCAGTTTAA (SEQ ID NO: 821).

### Input and Output Product Molecular Species

Also provided herein are a variety of biological outputs for use as molecular species in the various molecular circuits and modular functional blocks described herein. These biological outputs, or “output products,” as defined herein, refer to products that can are used as markers of specific states of the molecular circuits and modular functional blocks described herein, or as the output product of one modular block that becomes the input molecular species for a subsequent modular block. An output sequence for use as a molecular species can encode for a protein or an RNA molecule that is used to track or mark the state of the cell upon receiving a particular input for a molecular circuit. Such output products can be used to distinguish between various states of a cell.

Double-stranded (dsRNA) has been shown to direct the sequence-specific silencing of mRNA through a process known as RNA interference (RNAi). The process occurs in a wide variety of organisms, including mammals and other vertebrates. Accordingly, in some embodiments of the aspects described herein, sequences encoding RNA molecules can be used as molecular species or components or output products in the molecular circuits and modular functional blocks. Such RNA molecules can be double-stranded or single-stranded and are designed, in some embodiments, to mediate RNAi, e.g., with respect to another output product or molecular species. In those embodiments where a sequence encodes an RNA molecule that acts to mediate RNAi, the sequence can be said to encode an “iRNA molecule.”

In some embodiments, an iRNA molecule can have any architecture described herein. e.g., it can be incorporate an overhang structure, a hairpin or other single strand structure or a two-strand structure, as described herein. An “iRNA molecule” as used herein, is an RNA molecule which can by itself, or which can be cleaved into an RNA agent that can, downregulate the expression of a target sequence, e.g., an output product encoded by another molecular circuit or modular functional block, as described herein. While not wishing to be bound by theory, an iRNA molecule can act by one or more of a number of mechanisms, including post-transcriptional cleavage of a target mRNA sometimes referred to in the art as RNAi, or pre-transcriptional or pre-translational mechanisms. An iRNA molecule can include a single strand or can include more than one strand, e.g., it can be a double stranded iRNA molecule.

The sequence encoding an iRNA molecule should include a region of sufficient homology to a target sequence, and be of sufficient length in terms of nucleotides, such that the iRNA molecule, or a fragment thereof, can mediate down regulation of the target sequence. Thus, the iRNA molecule is or includes a region that is at least partially, and in some embodiments fully, complementary to a target RNA sequence. It is not necessary that there be perfect complementarity between the iRNA molecule and the target sequence, but the correspondence must be sufficient to enable the iRNA molecule t, or a cleavage product thereof, to direct sequence specific silencing, e.g., by RNAi cleavage of the target RNA sequence, e.g., mRNA.

Complementarity, or degree of homology with the target strand, is most critical in the antisense strand. While perfect complementarity, particularly in the antisense strand, is often desired some embodiments can include, particularly in the antisense strand, one or more but preferably 6, 5, 4, 3, 2, or fewer mismatches (with respect to the target RNA). The mismatches, particularly in the antisense strand, are most tolerated in the terminal regions and if present are preferably in a terminal region or regions, e.g., within 6, 5, 4, or 3 nucleotides of the 5′ and/or 3′ terminus. The sense strand need only be sufficiently complementary with the antisense strand to maintain the overall double strand character of the molecule.

iRNA molecules for use in the molecular circuits and modular functional blocks described herein include: molecules that are long enough to trigger the interferon response (which can be cleaved by Dicer (Bernstein et al. 2001. Nature, 409:363-366) and enter a RISC (RNAi-induced silencing complex); and, molecules that are sufficiently short that they do not trigger the interferon response (which molecules can also be cleaved by Dicer and/or enter a RISC), e.g., molecules that are of a size which allows entry into a RISC, e.g., molecules which resemble Dicer-cleavage products. Molecules that are short enough that they do not trigger an interferon response are termed “sRNA molecules” or “shorter iRNA molecules” herein. Accordingly, a sRNA molecule or shorter iRNA molecule, as used herein, refers to an iRNA molecule, e.g., a double stranded RNA molecule or single strand molecule, that is sufficiently short that it does not induce a deleterious interferon response in a mammalian cell, such as a human cell, e.g., it has a duplexed region of less than 60 but preferably less than 50, 40, or 30 nucleotide pairs. The sRNA molecule, or a cleavage product thereof, can downregulate a target sequence, e.g., by inducing RNAi with respect to a target RNA sequence.

Each strand of an sRNA molecule can be equal to or less than 30, 25, 24, 23, 22, 21, or 20 nucleotides in length. The strand is preferably at least 19 nucleotides in length. For example, each strand can be between 21 and 25 nucleotides in length. Preferred sRNA molecules have a duplex region of 17, 18, 19, 29, 21, 22, 23, 24, or 25 nucleotide pairs, and one or more overhangs, preferably one or two 3′ overhangs, of 2-3 nucleotides.

A “single strand iRNA molecule” as used herein, is an iRNA molecule that is made up of a single molecule. It may include a duplexed region, formed by intra-strand pairing, e.g., it may be, or include, a hairpin or pan-handle structure. Single strand iRNA molecules are preferably antisense with regard to the target sequence. A single strand iRNA molecule should be sufficiently long that it can enter the RISC and participate in RISC mediated cleavage of a target mRNA. A single strand iRNA molecule for use in the modules and biological converter switches described herein is at least 14, and more preferably at least 15, 20, 25, 29, 35, 40, or 50 nucleotides in length. It is preferably less than 200, 100, or 60 nucleotides in length.

Hairpin iRNA molecules can have a duplex region equal to or at least 17, 18, 19, 29, 21, 22, 23, 24, or 25 nucleotide pairs. The duplex region is preferably equal to or less than 200, 100, or 50, in length. Preferred ranges for the duplex region are 15-30, 17 to 23, 19 to 23, and 19 to 21 nucleotides pairs in length. The hairpin preferably has a single strand overhang or terminal unpaired region, preferably the 3′, and preferably of the antisense side of the hairpin. Preferred overhangs are 2-3 nucleotides in length.

A “double stranded (ds) iRNA molecule” as used herein, refers to an iRNA molecule that includes more than one, and preferably two, strands in which interchain hybridization can form a region of duplex structure. The antisense strand of a double stranded iRNA molecule should be equal to or at least, 14, 15, 16 17, 18, 19, 25, 29, 40, or 60 nucleotides in length. It should be equal to or less than 200, 100, or 50, nucleotides in length. Preferred ranges are 17 to 25, 19 to 23, and 19 to 21 nucleotides in length. The sense strand of a double stranded iRNA molecule should be equal to or at least 14, 15, 16 17, 18, 19, 25, 29, 40, or 60 nucleotides in length. It should be equal to or less than 200, 100, or 50, nucleotides in length. Preferred ranges are 17 to 25, 19 to 23, and 19 to 21 nucleotides in length. The double strand portion of a double stranded iRNA molecule should be equal to or at least, 14, 15, 16 17, 18, 19, 20, 21, 22, 23, 24, 25, 29, 40, or 60 nucleotide pairs in length. It should be equal to or less than 200, 100, or 50, nucleotides pairs in length. Preferred ranges are 15-30, 17 to 23, 19 to 23, and 19 to 21 nucleotides pairs in length.

In some embodiments, the ds iRNA molecule is sufficiently large that it can be cleaved by an endogenous molecule, e.g., by Dicer, to produce smaller ds iRNA agents, e.g., sRNAs agents

It is preferred that the sense and antisense strands be chosen such that the ds iRNA molecule includes a single strand or unpaired region at one or both ends of the molecule. Thus, an iRNA agent contains sense and antisense strands, preferable paired to contain an overhang, e.g., one or two 5′ or 3′ overhangs but preferably a 3′ overhang of 2-3 nucleotides. Most embodiments have a 3′ overhang. Preferred sRNA molecule have single-stranded overhangs, preferably 3′ overhangs, of 1 or preferably 2 or 3 nucleotides in length at each end. The overhangs can be the result of one strand being longer than the other, or the result of two strands of the same length being staggered. 5′ ends are preferably phosphorylated.

Preferred lengths for the duplexed region is between 15 and 30, most preferably 18, 19, 20, 21, 22, and 23 nucleotides in length, e.g., in the sRNA molecule range discussed above. sRNA molecules can resemble in length and structure the natural Dicer processed products from long dsRNAs. Hairpin, or other single strand structures which provide the required double stranded region, and preferably a 3′ overhang are also encompassed within the term sRNA molecule, as used herein.

The iRNA molecules described herein, including ds iRNA molecules and sRNA molecules, can mediate silencing of a target RNA, e.g., mRNA, e.g., a transcript of a sequence that encodes a protein expressed in one or more modules or biological converter switches as described herein. For convenience, such a target mRNA is also referred to herein as an mRNA to be silenced or translationally regulated. Such a sequence is also referred to as a target sequence. As used herein, the phrase “mediates RNAi” refers to the ability to silence, in a sequence specific manner, a target RNA molecule or sequence. While not wishing to be bound by theory, it is believed that silencing uses the RNAi machinery or process and a guide RNA, e.g., an sRNA agent of 21 to 23 nucleotides.

In other embodiments of the aspects described herein, RNA molecules for use as molecular species in the molecular circuits and modular functional blocks described herein comprise natural or engineered microRNA sequences. Also provided herein are references and resources, such as programs and databases found on the World Wide Web, that can be used for obtaining information on endogenous microRNAs and their expression patterns, as well as information in regard to cognate microRNA sequences and their properties.

Mature microRNAs (also referred to as miRNAs) are short, highly conserved, endogenous non-coding regulatory RNAs (18 to 24 nucleotides in length), expressed from longer transcripts (termed “pre-microRNAs”) encoded in animal, plant and virus genomes, as well as in single-celled eukaryotes. Endogenous miRNAs found in genomes regulate the expression of target genes by binding to complementary sites, termed herein as “microRNA target sequences,” in the mRNA transcripts of target genes to cause translational repression and/or transcript degradation. miRNAs have been implicated in processes and pathways such as development, cell proliferation, apoptosis, metabolism and morphogenesis, and in diseases including cancer (S. Griffiths-Jones et al., “miRBase: tools for microRNA genomics.” Nuc. Acid. Res., 2007: 36, D154-D158). Expression of a microRNA target sequence refers to transcription of the DNA sequence that encodes the microRNA target sequence to RNA. In some embodiments, a microRNA target sequence is operably linked to or driven by a promoter sequence. In some embodiments, a microRNA target sequence comprises part of another sequence that is operably linked to a promoter sequence, and is said to be linked to, attached to, or fused to, the sequence encoding the output product.

The way microRNA and their targets interact in animals and plants is different in certain aspects. Translational repression is thought to be the primary mechanism in animals, with transcript degradation the dominant mechanism for plant target transcripts. The difference in mechanisms lies in the fact that plant miRNA exhibits perfect or nearly perfect base pairing with the target but in the case of animals, the pairing is rather imperfect. Also, miRNAs in plants bind to their targets within coding regions cleaving at single sites, whereas most of the miRNA binding sites in animals are in the 3′ un-translated regions (UTR). In animals, functional miRNA:miRNA target sequence duplexes are found to be more variable in structure and they contain only short complementary sequence stretches, interrupted by gaps and mismatches. In animal miRNA: miRNA target sequence interactions, multiplicity (one miRNA targeting more than one gene) and cooperation (one gene targeted by several miRNAs) are very common but rare in the case of plants. All these make the approaches in miRNA target prediction in plants and animals different in details (V. Chandra et al., “MTar: a computational microRNA target prediction architecture for human transcriptome.” BMC Bioinformatics 2010, 11(Suppl 1):S2).

Experimental evidence shows that the miRNA target sequence needs enough complementarities in either the 3′ end or in the 5′ end for its binding to a miRNA. Based on these complementarities of miRNA: miRNA target sequence target duplex, the miRNA target sequence can be divided into three main classes. They are the 5′ dominant seed site targets (5′ seed-only), the 5′ dominant canonical seed site targets (5′ dominant) and the 3′ complementary seed site targets (3′ canonical). The 5′ dominant canonical targets possess high complementarities in 5′ end and a few complementary pairs in 3′ end. The 5′ dominant seed-only targets possess high complementarities in 5′ end (of the miRNA) and only a very few or no complementary pairs in 3′ end. The seed-only sites have a perfect base pairing to the seed portion of 5′ end of the miRNA and limited base pairing to 3′ end of the miRNA. The 3′ complimentary targets have high complementarities in 3′ end and insufficient pairings in 5′ end. The seed region of the miRNA is a consecutive stretch of seven or eight nucleotides at 5′ end. The 3′ complementary sites have an extensive base pairing to 3′ end of the miRNA that compensate for imperfection or a shorter stretch of base pairing to a seed portion of the miRNA. All of these site types are used to mediate regulation by miRNAs and show that the 3′ complimentary class of target site is used to discriminate among individual members of miRNA families in vivo. A genome-wide statistical analysis shows that on an average one miRNA has approximately 100 evolutionarily conserved target sites, indicating that miRNAs regulate a large fraction of protein-coding genes.

At present, miRNA databases include miRNAs for human, Caenorhabditis elegans, D. melanogaster, Danio rerio (zebrafish), Gallus gallus (chicken), and Arabidopsis thaliana. miRNAs are even present in simple multicellular organisms, such as poriferans (sponges) and cnidarians (starlet sea anemone). Many of the bilaterian animal miRNAs are phylogenetically conserved; 55% of C. elegans miRNAs have homologues in humans, which indicates that miRNAs have had important roles throughout animal evolution. Animal miRNAs seem to have evolved separately from those in plants because their sequences, precursor structure and biogenesis mechanisms are distinct from those in plants (Kim V N et al., “Biogenesis of small RNAs in animals.” Nat Rev Mol Cell Biol. 2009 February; 10(2):126-39).

miRNAs useful as components and output products for designing the molecular circuits and modular functional blocks described herein can be found at a variety of databases as known by one of skill in the art, such as those described at “miRBase: tools for microRNA genomics.” Nuc. Acid. Res., 2007: 36 (Database Issue), D154-D158; “miRBase: microRNA sequences, targets and gene nomenclature.” Nuc. Acid. Res., 2006 34 (Database Issue):D140-D144; and “The microRNA Registry.” Nuc. Acid. Res., 2004 32 (Database Issue):D109-D111), which are incorporated herein in their entirety by reference.

Accordingly, in some embodiments of the aspects described herein, a molecular circuit or modular functional block can further comprise as a molecular species a sequence encoding an RNA molecule, such as an iRNA molecule or microRNA molecule. In such embodiments, the sequence encoding the RNA molecule can be operably linked to a promoter sequence, or comprise part of another sequence, such as a sequence encoding a protein output. In those embodiments where the RNA molecule comprises part of, is linked to, attached to, or fused to, the sequence encoding, e.g., an output product, transcription of the sequence results in expression of both the mRNA of the output product and expression of the RNA molecule.

### Transcriptional Outputs:

In some embodiments of the aspects described herein, the output product of a given molecular circuit, or one modular component of such a circuit, is itself a transcriptional activator or repressor, the production of which by a module or circuit can provide additional input signals to subsequent or additional modules or molecular circuits. For example, the output product encoded by a inversion component can be a transcriptional repressor that prevents transcription from another module of a molecular circuit.

Transcriptional regulators either activate or repress transcription from cognate promoters. Transcriptional activators typically bind nearby to transcriptional promoters and recruit RNA polymerase to directly initiate transcription. Transcriptional repressors bind to transcriptional promoters and sterically hinder transcriptional initiation by RNA polymerase. Some transcriptional regulators serve as either an activator or a repressor depending on where it binds and cellular conditions. Examples of transcriptional regulators for use as output products in the molecular circuits described herein are provided in Table 41.

TABLE 42
Examples of Transcriptional Regulators

| Name | Protein | Description | Tag | Direction | Uniprot | Length |
|---|---|---|---|---|---|---|
| BBa_C0079 | lasR- | lasR activator from P. aeruginosa | LVA | Forward | P25084 | 756 |
| | LVA | PAO1(+LVA) | | | | |
| BBa_C0077 | cinR | cinR activator from | LVA | Forward | ~Q84HT2 | 762 |
| | | Rhizobium leguminosarum (+LVA) | | | | |
| BBa_C0179 | lasR | lasR activator from P. aeruginosa | None | Forward | P25084 | 723 |
| | | PAO1(no LVA) | | | | |
| BBa_J07009 | ToxR | toxicity-gene activator from | None | Forward | P15795 | 630 |
| | | Vibrio cholerae | | | | |
| BBa_K118001 | | appY coding sequence encoding a DNA- | | | | 753 |
| | | binding transcriptional activator | | | | |
| BBa_K137113 | | rcsA | | | | 624 |
| BBa_K131022 | | LuxO D47E, Vibrio harveyi | | | | 1362 |
| BBa_K131023 | | LuxO D47A, Vibrio harveyi | | | | 1362 |
| BBa_K082006 | | LuxR-G2F | | | | 753 |
| BBa_K294205 | | This is a coding sequence of heat shock | | | | 402 |
| | | protein from E. coli | | | | |
| BBa_S04301 | lasR- | C0079: B0015 | LVA | Forward | P25084 | 918 |
| | LVA | | | | | |
| BBa_K266002 | lasR- | LasR + Term | LVA | Forward | P25084 | 918 |
| | LVA | | | | | |
| BBa_C0012 | LacI | lacI repressor from E. coli (+LVA) | LVA | Forward | P03023 | 1128 |
| BBa_C0040 | TetR | tetracycline repressor from transposon | LVA | Forward | P04483 | 660 |
| | | Tn10 (+LVA) | | | | |
| BBa_C0050 | CI | cI repressor from phage HK022 | LVA | Forward | P18680 | 744 |
| | HK022 | (+LVA?) | | | | |
| BBa_C0051 | CI | cI repressor from E. coli phage lambda | LVA | Forward | P03034 | 750 |
| | lambda | (+LVA) | | | | |
| BBa_C0052 | CI 434- | cI repressor from phage 434 (+LVA) | LVA | Forward | P16117 | 669 |
| | LVA | | | | | |
| BBa_C0053 | C2 P22 | c2 repressor from Salmonella phage P22 | LVA | Forward | P69202 | 687 |
| | | (+LVA) | | | | |
| BBa_C0073 | mnt- | mnt repressor (weak) from Salmonella | LVA | Forward | P03049 | 288 |
| | weak | phage P22 (+LVA) | | | | |
| BBa_C0075 | cI TP901 | TP901 cI repressor from phage TP901-1 | LVA | Forward | none | 579 |
| | | (+LVA) | | | | |
| BBa_C0074 | penI | penI repressor from | LVA | Forward | P06555 | 423 |
| | | Bacillus licheniformis (+LVA) | | | | |
| BBa_C0072 | mnt | mnt repressor (strong) from | LVA | Forward | P03049 | 288 |
| | | Salmonella phage P22 (+LVA) | | | | |
| BBa_C2001 | Zif23- | Zif23-GCN4 engineered repressor | LVA | Forward | P03069 | 300 |
| | GCN4 | (+LVA, C2000 codon-optimized for | | | | |
| | | E. coli) | | | | |
| BBa_C0056 | CI 434 | cI repressor from phage 434 (no LVA) | None | Forward | P16117 | 636 |
| BBa_J06501 | LacI- | LacI repressor (temperature-sensitive | LVA | Forward | ~P03023 | 1153 |
| | mut2 | mut 265) (+LVA) | | | | |
| BBa_J06500 | LacI- | LacI repressor (temperature-sensitive | LVA | Forward | ~P03023 | 1153 |
| | mut1 | mut 241) (+LVA) | | | | |
| BBa_C2006 | | MalE.FactorXa.Zif268-GCN4 | | | | 1428 |
| BBa_I715032 | | lacIq reverse | | | | 1128 |
| BBa_I732100 | | LacI | | | | 1086 |
| BBa_I732101 | | LRLa | | | | 1086 |
| BBa_I732105 | | ARL2A0101 | | | | 1086 |
| BBa_I732106 | | ARL2A0102 | | | | 1086 |
| BBa_I732107 | | ARL2A0103 | | | | 1086 |
| BBa_I732110 | | ARL2A0203 | | | | 1086 |
| BBa_I732112 | | ARL2A0301 | | | | 1086 |
| BBa_I732115 | | ARL4A0604 | | | | 1086 |
| BBa_K091001 | | LsrR gene | | Forward | | 954 |
| BBa_K091121 | | LacI wild-type gene | | | | 1083 |
| BBa_K091122 | | LacI_I12 protein | | | | 1083 |
| BBa_K143033 | | LacI (Lva⁻, N-terminal deletion) | | | | 1086 |
| | | regulatory protein | | | | |
| BBa_K142000 | | lacI IS mutant (IPTG unresponsive) | | | | 1128 |
| | | R197A | | | | |
| BBa_K142001 | | lacI IS mutant (IPTG unresponsive) | | | | 1128 |
| | | R197F | | | | |
| BBa_K142002 | | lacI IS mutant (IPTG unresponsive) | | | | 1128 |
| | | T276A | | | | |
| BBa_K142003 | | lacI IS mutant (IPTG unresponsive) | | | | 1128 |
| | | T276F | | | | |
| BBa_K106666 | | Lac Repressor, AarI AB part | | | | 1104 |
| BBa_K106667 | | Lac Repressor, AarI BD part | | | | 1107 |
| BBa_K142004 | | lacI IS mutant (IPTG unresponsive) | | | | 1128 |
| | | R197A T276A | | | | |
| BBa_K106668 | | Tet Repressor, AarI AB part | | | | 618 |
| BBa_K106669 | | Tet Repressor, AarI BD part | | | | 621 |
| BBa_K142005 | | lacI IS mutant (IPTG unresponsive) | | | | 1128 |
| | | R197A T276F | | | | |
| BBa_K142006 | | lacI IS mutant (IPTG unresponsive) | | | | 1128 |
| | | R197F T276A | | | | |
| BBa_K142007 | | lacI IS mutant (IPTG unresponsive) | | | | 1128 |
| | | R197F T276F | | | | |
| BBa_K082004 | LacI | LacI- wild type | | | | 1083 |
| BBa_K082005 | LacI | LacI-Mutant | | | | 1083 |
| BBa_C0062 | LuxR | luxR repressor/activator, (no LVA?) | None | Forward | P12746 | 756 |
| BBa_C0071 | rhlR- | rhlR repressor/activator from | LVA | Forward | P54292 | 762 |
| | LVA | P. aeruginosa PA3477 (+LVA) | | | | |
| BBa_C0080 | araC | araC arabinose operon regulatory protein | LVA | Forward | P0A9E0 | 915 |
| | | (repressor/activator) from E. coli | | | | |
| | | (+LVA) | | | | |
| BBa_C0171 | rhIR | rhlR repressor/activator from | None | Forward | P54292 | 729 |
| | | P. aeruginosa PA3477 (no LVA) | | | | |
| BBa_K108021 | | Fis | | | | 297 |

### Enzyme Outputs

An enzyme can be a molecular species for for use in different embodiments of the molecular circuits described herein. In some embodiments, an enzyme output is used as a response to a particular set of inputs. For example, in response to a particular number of inputs received by one or more molecular circuits described herein, a molecular circuit or modular block thereof can encode as an output product an enzyme as a molecular species that can degrade or otherwise destroy specific products produced by the cell.

In some embodiments, output product sequences encode “biosynthetic enzymes” that catalyze the conversion of substrates to products. For example, such biosynthetic enzymes can be combined together along with or within the modules and molecular circuits described herein to construct pathways that produce or degrade useful chemicals and materials, in response to specific signals. These combinations of enzymes can reconstitute either natural or synthetic biosynthetic pathways. These enzymes have applications in specialty chemicals, biofuels, and bioremediation. Descriptions of enzymes useful as molecular species for the modules and molecular circuits are described herein.

N-Acyl Homoserine lactones (AHLs or N-AHLs) are a class of signaling molecules involved in bacterial quorum sensing. Several similar quorum sensing systems exists across different bacterial species; thus, there are several known enzymes that synthesize or degrade different AHL molecules that can be used for the modules and molecular circuits described herein.

TABLE 43
Examples of AHLs

| Name | Protein | Description | Direction | Uniprot | KEGG | E.C. | Length |
|---|---|---|---|---|---|---|---|
| BBa_C0061 | luxI- | autoinducer synthetase | Forward | P12747 | none | none | 618 |
| | LVA | for AHL | | | | | |
| BBa_C0060 | aiiA- | autoinducer inactivation | Forward | Q1WNZ5 | none | 3.1.1.— | 789 |
| | LVA | enzyme from Bacillus; | | | | | |
| | | hydrolyzes acetyl | | | | | |
| | | homoserine lactone | | | | | |
| BBa_C0070 | rhlI- | autoinducer synthetase | Forward | Q02QW5 | none | none | 642 |
| | LVA | for N-butyryl-HSL | | | | | |
| | | (BHL) and HHL | | | | | |
| BBa_C0076 | cinI | autoinducer synthetase | Forward | Q1MDW1 | none | none | 702 |
| BBa_C0078 | lasI | autoinducer synthetase | Forward | P33883 | pae: PA1432 | none | 642 |
| | | for PAI from | | | | | |
| | | Pseudomonas aeruginosa | | | | | |
| BBa_C0161 | luxI | autoinducer synthetase | Forward | P12747 | none | none | 585 |
| | | for AHL (no LVA) | | | | | |
| BBa_C0170 | rhII | autoinducer synthetase | Forward | Q02QW5 | none | none | 609 |
| | | for N-butyryl-HSL | | | | | |
| | | (BHL) and HHL (no LVA) | | | | | |
| BBa_C0178 | lasI | autoinducer synthetase | Forward | P33883 | pae: PA1432 | none | 609 |
| | | for PAI from | | | | | |
| | | Pseudomonas aeruginosa | | | | | |
| | | (no LVA) | | | | | |
| BBa_K091109 | | LuxS | | | | | 516 |
| BBa_C0060 | aiiA- | autoinducer inactivation | Forward | Q1WNZ5 | none | 3.1.1.— | 789 |
| | LVA | enzyme from Bacillus; | | | | | |
| | | hydrolyzes acetyl | | | | | |
| | | homoserine lactone | | | | | |
| BBa_C0160 | aiiA | autoinducer inactivation | Forward | Q1WNZ5 | none | 3.1.1.— | 756 |
| | | enzyme aiiA (no LVA) | | | | | |

Isoprenoids, also known as terpenoids, are a large and highly diverse class of natural organic chemicals with many functions in plant primary and secondary metabolism. Most are multicyclic structures that differ from one another not only in functional groups but also in their basic carbon skeletons. Isoprenoids are synthesized from common prenyl diphosphate precursors through the action of terpene synthases and terpene-modifying enzymes such as cytochrome P450 monooxygenases. Plant terpenoids are used extensively for their aromatic qualities. They play a role in traditional herbal remedies and are under investigation for antibacterial, antineoplastic, and other pharmaceutical functions. Much effort has been directed toward their production in microbial hosts.

There are two primary pathways for making isoprenoids: the mevalonate pathway and the non-mevalonate pathway.

TABLE 44
Examples of Isoprenoids

| Name | Description | Length |
|---|---|---|
| BBa_K118000 | dxs coding sequence encoding | 1866 |
| | 1-deoxyxylulose-5-phosphate synthase | |
| BBa_K115050 | A-coA -> AA-coA | 1188 |
| BBa_K115056 | IPP -> OPP or DMAPP -> OPP | 552 |
| BBa_K115057 | OPP -> FPP | 903 |
| BBa_K118002 | crtB coding sequence encoding phytoene | 933 |
| | synthase | |
| BBa_K118003 | crtI coding sequence encoding phytoene | 1482 |
| | dehydrogenase | |
| BBa_K118008 | crtY coding sequence encoding lycopene | 1152 |
| | B-cyclase | |

Odorants are volatile compounds that have an aroma detectable by the olfactory system. Odorant enzymes convert a substrate to an odorant product. Exemplary odorant enzymes are described in Table 45.

TABLE 45
Examples of Odorant Enzymes

| Name | Protein | Description | Uniprot | KEGG | E.C. | Length |
|---|---|---|---|---|---|---|
| BBa_J45001 | SAMT | SAM: salicylic acid carboxyl | Q8H6N2 | none | none | 1155 |
| | | methyltransferase; converts | | | | |
| | | salicylic acid to methyl | | | | |
| | | salicylate (winter | | | | |
| BBa_J45002 | BAMT | SAM: benzoic acid carboxyl | Q9FYZ9 | none | 2.1.1.— | 1098 |
| | | methyltransferase; converts | | | | |
| | | benzoic acid to methyl benzoate | | | | |
| | | (floral odor) | | | | |
| BBa_J45004 | BSMT1 | SAM: benzoic acid/salicylic acid | Q84UB5 | none | none | 1074 |
| | | carboxyl methyltransferase I; | | | | |
| | | converts salicylic acid to methyl | | | | |
| | | sali | | | | |
| BBa_J45008 | BAT2 | branched-chain amino acid | P47176 | sce: YJR148W | 2.6.1.42 | 1134 |
| | | transaminase (BAT2); converts | | | | |
| | | leucine to alpha-ketoisocaproate | | | | |
| BBa_J45014 | ATF1- | alcohol acetyltransferase I; | P40353 | sce: YOR377W | 2.3.1.84 | 1581 |
| | 1148 | converts isoamyl alcohol to | | | | |
| | mutant | isoamyl acetate (banana odor) | | | | |
| BBa_J45017 | PchA & | isochorismate pyruvate-lyase | | | | 1736 |
| | PchB | and isochorismate synthase | | | | |
| | | (pchBA); converts chorismate | | | | |
| | | to salicylate | | | | |
| BBa_I742107 | | COMT | | | | 1101 |

The following are exemplary enzymes involved in the biosynthesis of plastic, specifically polyhydroxybutyrate.

TABLE 46
Examples of Plastic Biosynthesis Enzymes

| Name | Description | Length |
|---|---|---|
| BBa_K125504 | phaE BioPlastic polyhydroxybutyrate | 996 |
| | synthesis pathway (origin PCC6803 slr1829) | |
| BBa_K125501 | phaA BioPlastic polyhydroxybutyrate | 1233 |
| | synthesis pathway (origin PCC6803 slr1994) | |
| BBa_K125502 | phaB BioPlastic polyhydroxybutyrate | 726 |
| | synthesis pathway (origin PCC6803 slr1993) | |
| BBa_K125503 | phaC BioPlastic polyhydroxybutyrate | 1140 |
| | synthesis pathway (origin PCC6803 slr1830) | |
| BBa_K156012 | phaA (acetyl-CoA acetyltransferase) | 1182 |
| BBa_K156013 | phaB1 (acetyacetyl-CoA reductase) | 741 |
| BBa_K156014 | phaC1 (Poly(3-hydroxybutyrate) polymerase) | |

The following are exemplary enzymes involved in the biosynthesis of butanol and butanol metabolism.

TABLE 47
Examples of Butanol Biosynthesis Enzymes

| Name | Description | Length |
|---|---|---|
| BBa_I725011 | B-hydroxy butyryl coA dehydrogenase | 870 |
| BBa_I72512 | Enoyl-coa hydratase | 801 |
| BBa_I725013 | Butyryl CoA dehyrogenase | 1155 |
| BBa_I725014 | Butyraldehyde dehydrogenase | 2598 |
| BBa_I725015 | Butanol dehydrogenase | 1188 |

Other miscellaneous enzymes for use as molecular species for the modules and molecular circuits are provided in Table 48.

TABLE 48
Examples of Miscellaneous Biosynthetic Enzymes

| Name | Description | Direction | Uniprot | KEGG | E.C. | Length |
|---|---|---|---|---|---|---|
| BBa_K118022 | cex coding sequence encoding | | | | | 1461 |
| | Cellulomonas fimi exoglucanase | | | | | |
| BBa_K118023 | cenA coding sequence encoding | | | | | 1353 |
| | Cellulomonas fimi endoglucanase A | | | | | |
| BBa_K118028 | beta-glucosidase gene bglX | | | | | 2280 |
| | (chu_2268) from | | | | | |
| | Cytophaga hutchinsonii | | | | | |
| BBa_C0083 | aspartate ammonia-lyase | Forward | P0AC38 | eco: b4139 | 4.3.1.1 | 1518 |
| BBa_I15008 | heme oxygenase (ho1) from | Forward | P72849 | syn: sll1184 | 1.14.99.3 | 726 |
| | Synechocystis | | | | | |
| BBa_I15009 | phycocyanobilin: ferredoxin | Forward | Q55891 | syn: slr0116 | 1.3.7.5 | 750 |
| | oxidoreductase (PcyA) from | | | | | |
| | synechocystis | | | | | |
| BBa_T9150 | orotidine 5 | Forward | P08244 | eco: b1281; | 4.1.1.23 | 741 |
| BBa_I716153 | hemB | | | | | 975 |
| BBa_I716154 | hemC | | | | | 942 |
| BBa_I716155 | hemD | | | | | 741 |
| BBa_I716152 | hemA (from CFT703) | | | | | 1257 |
| BBa_I742141 | sam5 (coumarate hydroxylase) | | | | | 1542 |
| | coding sequence | | | | | |
| BBa_I742142 | sam8 (tyrosine-ammonia lyase) | | | | | 1536 |
| | coding sequence | | | | | |
| BBa_I723024 | PhzM | | | | | 1019 |
| BBa_I723025 | PhzS | | | | | 1210 |
| BBa_K137005 | pabA (from pABA synthesis) | | | | | 585 |
| BBa_K137006 | pabB (from pABA synthesis) | | | | | 1890 |
| BBa_K137009 | folB (dihydroneopterin aldolase) | | | | | 354 |
| BBa_K137011 | folKE (GTP Cyclohydrolase I + | | | | | 1053 |
| | pyrophosphokinase) | | | | | |
| BBa_K137017 | Galactose Oxidase | | | | | 1926 |
| BBa_K118015 | glgC coding sequence encoding | | | | | 1299 |
| | ADP-glucose pyrophosphorylase | | | | | |
| BBa_K118016 | glgC16 (glgC with G336D | | | | | 1299 |
| | substitution) | | | | | |
| BBa_K123001 | BisdB | | | | | 1284 |
| BBa_K108018 | PhbAB | | | | | 1997 |
| BBa_K108026 | XylA | | | | | 1053 |
| BBa_K108027 | XylM | | | | | 1110 |
| BBa_K108028 | XylB | | | | | 1101 |
| BBa_K108029 | XylS | | | | | 966 |
| BBa_K147003 | ohbA | | | | | 531 |
| BBa_K123000 | BisdA | | | | | 330 |
| BBa_K284999 | Deletar este | | | | | 1431 |
| BBa_I716253 | HPI, katG | | | | | 2181 |
| BBa_K137000 | katE | | | | | 2265 |
| BBa_K137014 | katE + LAA | | | | | 2298 |
| BBa_K137067 | katG | | | | | 2184 |
| BBa_K078102 | dxnB | | | | | 886 |
| BBa_K078003 | one part of the initial dioxygenase | | | | | 1897 |
| | of the dioxin degradation pathway | | | | | |

Other enzymes of use as molecular species for the modules and molecular circuits described herein include enzymes that phosphorylate or dephosphorylate either small molecules or other proteins, and enzymes that methylate or demethylate other proteins or DNA.

TABLE 49
Examples of Phosphorylation and Methylation-Related Enzymes

| Name | Protein | Description | Direction | Uniprot | KEGG | E.C. | Length |
|---|---|---|---|---|---|---|---|
| BBa_C0082 | tar- | Receptor, tar-envZ | Forward | | | | 1491 |
| | envZ | | | | | | |
| BBa_J58104 | | Fusion protein Trg-EnvZ for | | | | | 1485 |
| | | signal transduction | | | | | |
| BBa_J58105 | | Synthetic periplasmic binding | | | | | 891 |
| | | protein that docks a vanillin | | | | | |
| | | molecule | | | | | |
| BBa_I752001 | | CheZ coding sequence | | | | | 639 |
| | | (Chemotaxis protein) | | | | | |
| BBa_K091002 | | LsrK gene | Forward | | | | 1593 |
| BBa_K147000 | | cheZ | | | | | 835 |
| BBa_K118015 | | glgC coding sequence | | | | | 1299 |
| | | encoding ADP-glucose | | | | | |
| | | pyrophosphorylase | | | | | |
| BBa_K118016 | | glgC16 (glgC with G336D | | | | | 1299 |
| | | substitution) | | | | | |
| BBa_K094100 | | cheZ gene | | | | | 695 |
| BBa_K136046 | | envZ* | | | | | 1353 |
| BBa_K283008 | chez | chez_Histag | | | | | 713 |
| BBa_C0024 | CheB | CheB chemotaxis coding | Forward | P07330 | JW1872 | 3.1.1.61 | 1053 |
| | | sequence (protein glutamate | | | | | |
| | | methylesterase) | | | | | |
| BBa_K108020 | | Dam | | | | | 837 |

### Selection Markers

In some embodiments of the aspects described herein, nucleic acid sequences encoding selection markers are used as as molecular species for the modules and molecular circuits. “Selection markers,” as defined herein, refer to output products that confer a selective advantage or disadvantage to a biological unit, such as a cell or cellular system. For example, a common type of prokaryotic selection marker is one that confers resistance to a particular antibiotic. Thus, cells that carry the selection marker can grow in media despite the presence of antibiotic. For example, most plasmids contain antibiotic selection markers so that it is ensured that the plasmid is maintained during cell replication and division, as cells that lose a copy of the plasmid will soon either die or fail to grow in media supplemented with antibiotic. A second common type of selection marker, often termed a positive selection marker, includes those selection markers that are toxic to the cell. Positive selection markers are frequently used during cloning to select against cells transformed with the cloning vector and ensure that only cells transformed with a plasmid containing the insert. Examples of selection markers for use as molecular species are provided in Table 50.

TABLE 50
Examples of Selection Markers

| Name | Protein | Description | UniProt | KEGG | Length |
|---|---|---|---|---|---|
| BBa_T9150 | PyrF | orotidine 5 | P08244 | eco:b1281; | 741 |
| BBa_J31002 | AadA- | kanamycin resistance | P0AG05 | none | 816 |
| | bkw | backwards (KanB) [cf. | | | |
| | | BBa_J23012 & | | | |
| | | BBa_J31003] | | | |
| BBa_J31003 | AadA2 | kanamycin resistance | P0AG05 | none | 816 |
| | | forward (KanF) [cf. | | | |
| | | BBa_J23012 & | | | |
| | | BBa_J31002] | | | |
| BBa_J31004 | CAT- | chloramphenicol | P62577 | none | 660 |
| | bkw | acetyltransferase | | | |
| | | (backwards, CmB) [cf. | | | |
| | | BBa_J31005] | | | |
| BBa_J31006 | TetA(C)- | tetracycline resistance | P02981 | | 1191 |
| | bkw | protein TetA(C) | | | |
| | | (backwards) [cf. | | | |
| | | BBa_J31007] | | | |
| BBa_J31005 | CAT | chloramphenicol | P62577 | none | 660 |
| | | acetyltransferase (forwards, | | | |
| | | CmF) [cf. BBa_J31004] | | | |
| BBa_J31007 | TetA(C) | tetracycline resistance | P02981 | | 1191 |
| | | protein TetA(C) (forward), | | | |
| | | [cf. BBa_J31006] | | | |
| BBa_K145151 | | ccdB coding region | | | 306 |
| BBa_K143031 | | Aad9 Spectinomycin | | | 771 |
| | | Resistance Gene | | | |
| BBa_K156011 | | aadA (streptomycin 3′- | | | 789 |
| | | adenyltransferase) | | | |

### Reporter Outputs

In some embodiments of the aspects described herein, the output molecular species are “reporters.” As defined herein, “reporters” refer to proteins that can be used to measure gene expression. Reporters generally produce a measurable signal such as fluorescence, color, or luminescence. Reporter protein coding sequences encode proteins whose presence in the cell or organism is readily observed. For example, fluorescent proteins cause a cell to fluoresce when excited with light of a particular wavelength, luciferases cause a cell to catalyze a reaction that produces light, and enzymes such as β-galactosidase convert a substrate to a colored product. In some embodiments, reporters are used to quantify the strength or activity of the signal received by the modules or biological converter switches of the invention. In some embodiments, reporters can be fused in-frame to other protein coding sequences to identify where a protein is located in a cell or organism.

There are several different ways to measure or quantify a reporter depending on the particular reporter and what kind of characterization data is desired. In some embodiments, microscopy can be a useful technique for obtaining both spatial and temporal information on reporter activity, particularly at the single cell level. In other embodiments, flow cytometers can be used for measuring the distribution in reporter activity across a large population of cells. In some embodiments, plate readers may be used for taking population average measurements of many different samples over time. In other embodiments, instruments that combine such various functions, can be used, such as multiplex plate readers designed for flow cytometers, and combination microscopy and flow cytometric instruments.

Fluorescent proteins are convenient ways to visualize or quantify the output of a molecular circuit or modular functional block described herein. Fluorescence can be readily quantified using a microscope, plate reader or flow cytometer equipped to excite the fluorescent protein with the appropriate wavelength of light. Since several different fluorescent proteins are available, multiple gene expression measurements can be made in parallel. Non-limiting examples of fluorescent proteins are provided in Table 51.

TABLE 51
Examples of Fluorescent Protein Reporters

| Name | Protein | Description | Tag | Emission | Excitation | Length |
|---|---|---|---|---|---|---|
| BBa_E0030 | EYFP | enhanced yellow fluorescent protein | None | 527 | 514 | 723 |
| | | derived from A. victoria GFP | | | | |
| BBa_E0020 | ECFP | engineered cyan fluorescent protein | None | 476 | 439 | 723 |
| | | derived from A. victoria GFP | | | | |
| BBa_E1010 | mRFP1 | **highly** engineered mutant of red | None | 607 | 584 | 681 |
| | | fluorescent protein from | | | | |
| | | Discosoma striata (coral) | | | | |
| BBa_E2050 | mOrange | derivative of mRFP1, yeast-optimized | None | 562 | 548 | 744 |
| BBa_E0040 | GFPmut3b | green fluorescent protein derived | None | 511 | 501 | 720 |
| | | from jellyfish Aequeora victoria wild- | | | | |
| | | type GFP (SwissProt: P42212 | | | | |
| BBa_J52021 | | dnTraf6-linker-GFP | | | | 1446 |
| BBa_J52026 | | dnMyD88-linker-GFP | | | | 1155 |
| BBa_I715022 | | Amino Portion of RFP | | | | 462 |
| BBa_I715023 | | Carboxyl portion of RFP | | | | 220 |
| BBa_I712028 | | CherryNLS - synthetic construct | | | | 733 |
| | | monomeric red fluorescent protein | | | | |
| | | with nuclear localization sequence | | | | |
| BBa_K125500 | | GFP fusion brick | | | | 718 |
| BBa_K106000 | | GFP, AarI BD part | | | | 714 |
| BBa_K106004 | | mCherry, Aar1 AB part | | | | 708 |
| BBa_K106005 | | mCherry, Aar1 BD part | | | | 708 |
| BBa_K106028 | | GFP, AarI AB part | | | | 714 |
| BBa_K165005 | | Venus YFP, yeast optimized for | | | | 744 |
| | | fusion | | | | |
| BBa_K157005 | | Split-Cerulean-cCFP | | | | 261 |
| BBa_K157006 | | Split-Cerulean-nCFP | | | | 483 |
| BBa_K157007 | | Split-Venus-cYFP | | | | 261 |
| BBa_K157008 | | Split-Venus-nYFP | | | | 486 |
| BBa_K125810 | | slr2016 signal sequence + GFP fusion | | | | 779 |
| | | for secretion of GFP | | | | |
| BBa_K082003 | GFP | GFP(+LVA) | | | | 756 |
| BBa_K156009 | | OFP (orange fluorescent protein) | | | | 864 |
| BBa_K156010 | | SBFP2 (strongly enhanced blue | | | | 720 |
| | | fluorescent protein) | | | | |
| BBa_K106671 | | GFP, Aar1 AD part | | | | 714 |
| BBa_K294055 | GFPmut3b | GFP RFP Hybrid | None | 511 | 501 | 720 |
| BBa_K192001 | | CFP + tgt + lva | | | | 858 |
| BBa_K180001 | GFPmut3b | Green fluorescent protein (+LVA) | LVA | | | 754 |
| BBa_K283005 | | lpp_ompA_eGFP_streptavidin | | | | 1533 |
| BBa_K180008 | mCherry | mCherry (rights owned by Clontech) | | | | 708 |
| BBa_K180009 | mBanana | mBanana (rights owned by Clontech) | | | | 708 |

Luminescence can be readily quantified using a plate reader or luminescence counter. Luciferases can be used as output products for various embodiments described herein, for example, measuring low levels of gene expression, because cells tend to have little to no background luminescence in the absence of a luciferase. Non-limiting examples of luciferases are provided in Table 52.

TABLE 52
Examples of Luciferases

| Name | Description | Length |
|---|---|---|
| BBa_J52011 | dnMyD88-linker-Rluc | 1371 |
| BBa_J52013 | dnMyD88-linker-Rluc-linker-PEST191 | 1872 |
| BBa_I712019 | Firefly luciferase - luciferase from | 1653 |
| | Photinus pyralis | |

In other embodiments, enzymes that produce colored substrates can be quantified using spectrophotometers or other instruments that can take absorbance measurements including plate readers. Like luciferases, enzymes like β-galactosidase can be used for measuring low levels of gene expression because they tend to amplify low signals. Non-limiting examples of such enzymes are provided in Table 53.

TABLE 54
Examples of Enzymes that Produce Colored Substrates

| Name | Description | Length |
|---|---|---|
| BBa_I732006 | lacZ alpha fragment | 234 |
| BBa_I732005 | lacZ (encoding beta-galactosidase, full-length) | 3075 |
| BBa_K147002 | xylE | 924 |

Another reporter output product for use as a molecular species in the different aspects and embodiments described herein includes fluoresceine-A-binding (BBa K157004).

Also useful as output products for use as molecular species for the modules and molecular circuits described herein are receptors, ligands, and lytic proteins. Receptors tend to have three domains: an extracellular domain for binding ligands such as proteins, peptides or small molecules, a transmembrane domain, and an intracellular or cytoplasmic domain which frequently can participate in some sort of signal transduction event such as phosphorylation. In some embodiments, transporter, channel, or pump gene sequences are used as molecular species, such as output product genes. Transporters are membrane proteins responsible for transport of substances across the cell membrane. Channels are made up of proteins that form transmembrane pores through which selected ions can diffuse. Pumps are membrane proteins that can move substances against their gradients in an energy-dependent process known as active transport. In some embodiments, nucleic acid sequences encoding proteins and protein domains whose primary purpose is to bind other proteins, ions, small molecules, and other ligands are used. Exemplary receptors, ligands, and lytic proteins are listed in Table 55.

TABLE 55
Examples of Receptors, Ligands, and Lytic Proteins

| Name | Protein | Description | Tag | Direction | UniProt | Length |
|---|---|---|---|---|---|---|
| BBa_J07009 | ToxR | toxicity-gene activator from | None | Forward | P15795 | 630 |
| | | Vibrio cholerae | | | | |
| BBa_K133063 | | (TIR)TLR3 | | | | 453 |
| BBa_K133064 | | (TIR)TLR9 | | | | 585 |
| BBa_K133065 | | (TMTIR)TLR3 | | | | 600 |
| BBa_K133069 | | (TMTIR)TLR3stop | | | | 603 |
| BBa_K133067 | | (TMTIR)TLR4 | | | | 621 |
| BBa_K133060 | | (TMTIR)TLR9 | | | | 645 |
| BBa_K209400 | | AarI B-C part, hM4D | | | | 1434 |
| BBa_K209401 | | AarI B-C part, Rs1.3 | | | | 1407 |
| BBa_I712002 | | CCR5 | | | | 1059 |
| BBa_I712003 | | CCR5-NUb | | | | 1194 |
| BBa_I712010 | | CD4 sequence without signal peptide | | | | 1299 |
| BBa_I712017 | | Chemokine (CXC motif) receptor 4, | | | | 1191 |
| | | fused to N-terminal half of ubiquitin. | | | | |
| BBa_I15010 | Cph8 | cph8 (Cph1/EnvZ fusion) | None | Forward | | 2238 |
| BBa_I728500 | | CPX Terminal Surface Display Protein | | | | 654 |
| | | with Polystyrene-Binding Peptide | | | | |
| BBa_J52035 | | dnMyD88 | | | | 420 |
| BBa_K259000 | | fhuA - Outer membrane transporter for | | | | 2247 |
| | | ferrichrome-iron | | | | |
| BBa_K259001 | | fiu B Outer Membrane Ferric Iron | | | | 2247 |
| | | Transporter | | | | |
| BBa_J58104 | | Fusion protein Trg-EnvZ for signal | | | | 1485 |
| | | transduction | | | | |
| BBa_K137112 | | lamB | | | | 1339 |
| BBa_C0082 | tar- | Receptor, tar-envZ | LVA | Forward | | 1491 |
| | envZ | | | | | |
| BBa_J58105 | | Synthetic periplasmic binding protein | | | | 891 |
| | | that docks a vanillin molecule | | | | |
| BBa_I712012 | | TIR domain of TLR3 | | | | 456 |
| BBa_K143037 | | YtvA Blue Light Receptor for B. subtilis | | | | 789 |
| BBa_J07006 | | malE | | | | 1191 |
| BBa_J07017 | | FecA protein | | | | 2325 |
| BBa_K141000 | UCP1 | Ucp1 | | | | 924 |
| BBa_K141002 | | Ucp 175 deleted | | | | 921 |
| BBa_K141003 | | Ucp 76 deleted | | | | 921 |
| BBa_K190028 | | GlpF | | | | 846 |
| BBa_I746200 | | FepA L8T Mutant - Large Diffusion | | | | 2208 |
| | | pore for E. coli outer membrane. | | | | |
| BBa_I765002 | | ExbB membrane spanning protein in | | | | 735 |
| | | TonB-ExbB-ExbD complex | | | | |
| | | [Escherichia coli K12] | | | | |
| BBa_I765003 | | TonB ferric siderophore transport | | | | 735 |
| | | system, periplasmic binding protein | | | | |
| | | TonB [Pseudomonas entomophila | | | | |
| BBa_K090000 | | Glutamate gated K+ channel | | | | 1194 |
| BBa_K284000 | | Lactate Permease from | | | | 1873 |
| | | Kluyveromyces lactis | | | | |
| BBa_K284997 | | Deletar este | | | | 1069 |
| BBa_J22101 | | Lac Y gene | | | | 1288 |
| BBa_K079015 | | LacY transporter protein from E. coli | | | | 1254 |
| BBa_K119003 | | RcnA (YohM) | | | | 833 |
| BBa_K137001 | | LacY | | | | 1254 |
| BBa_I712024 | | CD4 | | | | 1374 |
| BBa_K133061 | | CD4 ecto | | | | 1113 |
| BBa_K136046 | | envZ* | | | | 1353 |
| BBa_K157002 | | Transmembrane region of the EGF- | | | | 87 |
| | | Receptor (ErbB-1) | | | | |
| BBa_K227006 | | puc BA coding region of R. sphaeroides | | forward | | 336 |
| BBa_M12067 | | E1 | | | | 264 |
| BBa_I721002 | | Lead Binding Protein | | | | 399 |
| BBa_K126000 | | TE33 Fab L chain | | | | 648 |
| BBa_K133070 | | gyrEC | | | | 660 |
| BBa_K133062 | | gyrHP | | | | 660 |
| BBa_K157003 | | Anti-NIP singlechain Fv-Fragment | | | | 753 |
| BBa_K211001 | | RI7 | | | | 987 |
| BBa_K211002 | | RI7-odr10 chimeric GPCR | | | | 1062 |
| BBa_K103004 | | protein Z_{SPA-1} | | | | 190 |
| BBa_K128003 | | p1025 | | | | 101 |
| BBa_K133059 | | RGD | | | | 9 |
| BBa_K283010 | | Streptavidin | | | | 387 |
| BBa_K103004 | | protein Z_{SPA-1} | | | | 190 |
| BBa_K128003 | | p1025 | | | | 101 |
| BBa_K133059 | | RGD | | | | 9 |
| BBa_K283010 | | Streptavidin | | | | 387 |
| BBa_K112000 | Holin | T4 holin, complete CDS, berkeley | | | | 657 |
| | | standard | | | | |
| BBa_K112002 | Holin | T4 holin, without stop codon, berkeley | | | | 654 |
| | | standard | | | | |
| BBa_K112004 | | a~T4 holin in BBb | | | | 661 |
| BBa_K112006 | | T4 antiholin in BBb | | | | 294 |
| BBa_K112009 | | in BBb | | | | 288 |
| BBa_K112010 | | a~T4 antiholin in BBb | | | | 298 |
| BBa_K112012 | | T4 lysozyme in BBb | | | | 495 |
| BBa_K112015 | | in BBb | | | | 489 |
| BBa_K112016 | | a~T4 lysozyme in BBb | | | | 499 |
| BBa_K117000 | | Lysis gene (promotes lysis in colicin- | | | | 144 |
| | | producing bacteria strain) | | | | |
| BBa_K124014 | | Bacteriophage Holin Gene pS105 | | | | 317 |
| BBa_K108001 | | SRRz | | | | 1242 |
| BBa_K112300 | | {lambda lysozyme} in BBb format | | | | 477 |
| BBa_K112304 | | {a~lambda lysozyme} in BBb format | | | | 481 |
| BBa_K112306 | | {lambda holin} in BBb format | | | | 318 |
| BBa_K112310 | | {a~lambda holin}; adheres to Berkeley | | | | 322 |
| | | standard | | | | |
| BBa_K112312 | | {lambda antiholin}; adheres to Berkeley | | | | 324 |
| | | standard | | | | |
| BBa_K112316 | | {a~lambda antiholin}; adheres to | | | | 328 |
| | | Berkeley standard | | | | |
| BBa_K124017 | | Bacteriophage Lysis Cassette S105, R, | | | | 1257 |
| | | and Rz | | | | |
| BBa_K112806 | | [T4 endolysin] | | | | 514 |
| BBa_K284001 | | Lysozyme from Gallus gallus | | | | 539 |

### DEFINITIONS

The methods and uses of the molecular circuits described herein can involve in vivo, ex vivo, or in vitro systems. The term “in vivo” refers to assays or processes that occur in or within an organism, such as a multicellular animal. In some of the aspects described herein, a method or use can be said to occur “in vivo” when a unicellular organism, such as a bacteria, is used. The term “ex vivo” refers to methods and uses that are performed using a living cell with an intact membrane that is outside of the body of a multicellular animal or plant, e.g., explants, cultured cells, including primary cells and cell lines, transformed cell lines, and extracted tissue or cells, including blood cells, among others. The term “in vitro” refers to assays and methods that do not require the presence of a cell with an intact membrane, such as cellular extracts, and can refer to the introducing a molecular circuit in a non-cellular system, such as a media or solutions not comprising cells or cellular systems, such as cellular extracts.

A cell for use with the molecular circuits described herein can be any cell or host cell. As defined herein, a “cell” or “cellular system” is the basic structural and functional unit of all known independently living organisms. It is the smallest unit of life that is classified as a living thing, and is often called the building block of life. Some organisms, such as most bacteria, are unicellular (consist of a single cell). Other organisms, such as humans, are multicellular. A “natural cell,” as defined herein, refers to any prokaryotic or eukaryotic cell found naturally. A “prokaryotic cell” can comprise a cell envelope and a cytoplasmic region that contains the cell genome (DNA) and ribosomes and various sorts of inclusions.

In some embodiments, the cell is a eukaryotic cell, preferably a mammalian cell. A eukaryotic cell comprises membrane-bound compartments in which specific metabolic activities take place, such as a nucleus. In other embodiments, the cell or cellular system is an artificial or synthetic cell. As defined herein, an “artificial cell” or a “synthetic cell” is a minimal cell formed from artificial parts that can do many things a natural cell can do, such as transcribe and translate proteins and generate ATP.

Cells of use in the various aspects described herein upon transformation or transfection with molecular r circuits described herein include any cell that is capable of supporting the activation and expression of the molecular circuits. In some embodiments of the aspects described herein, a cell can be from any organism or multi-cell organism. Examples of eukaryotic cells that can be useful in aspects described herein include eukaryotic cells selected from, e.g., mammalian, insect, yeast, or plant cells. The molecular circuits described herein can be introduced into a variety of cells including, e.g., fungal, plant, or animal (nematode, insect, plant, bird, reptile, or mammal (e.g., a mouse, rat, rabbit, hamster, gerbil, dog, cat, goat, pig, cow, horse, whale, monkey, or human)). The cells can be primary cells, immortalized cells, stem cells, or transformed cells. In some preferred embodiments, the cells comprise stem cells. Expression vectors for the components of the molecular circuit will generally have a promoter and/or an enhancer suitable for expression in a particular host cell of interest. The present invention contemplates the use of any such vertebrate cells for the molecular circuits, including, but not limited to, reproductive cells including sperm, ova and embryonic cells, and non-reproductive cells, such as kidney, lung, spleen, lymphoid, cardiac, gastric, intestinal, pancreatic, muscle, bone, neural, brain, and epithelial cells.

As used herein, the term “stem cells” is used in a broad sense and includes traditional stem cells, progenitor cells, preprogenitor cells, reserve cells, and the like. The term “stem cell” or “progenitor cell” are used interchangeably herein, and refer to an undifferentiated cell which is capable of proliferation and giving rise to more progenitor cells having the ability to generate a large number of mother cells that can in turn give rise to differentiated, or differentiable daughter cells. Stem cells for use with the molecular circuits and the methods described herein can be obtained from endogenous sources such as cord blood, or can be generated using in vitro or ex vivo techniques as known to one of skill in the art. For example, a stem cell can be an induced pluripotent stem cell (iPS cell) derived using any methods known in the art. The daughter cells themselves can be induced to proliferate and produce progeny that subsequently differentiate into one or more mature cell types, while also retaining one or more cells with parental developmental potential. The term “stem cell” refers then, to a cell with the capacity or potential, under particular circumstances, to differentiate to a more specialized or differentiated phenotype, and which retains the capacity, under certain circumstances, to proliferate without substantially differentiating. In one embodiment, the term progenitor or stem cell refers to a generalized mother cell whose descendants (progeny) specialize, often in different directions, by differentiation, e.g., by acquiring completely individual characters, as occurs in progressive diversification of embryonic cells and tissues. Cellular differentiation is a complex process typically occurring through many cell divisions. A differentiated cell can derive from a multipotent cell which itself is derived from a multipotent cell, and so on. While each of these multipotent cells can be considered stem cells, the range of cell types each can give rise to can vary considerably. Some differentiated cells also have the capacity to give rise to cells of greater developmental potential. Such capacity can be natural or can be induced artificially upon treatment with various factors. In many biological instances, stem cells are also “multipotent” because they can produce progeny of more than one distinct cell type, but this is not required for “stem-ness.” Self-renewal is the other classical part of the stem cell definition, and it is essential as used in this document. In theory, self-renewal can occur by either of two major mechanisms. Stem cells can divide asymmetrically, with one daughter retaining the stem state and the other daughter expressing some distinct other specific function and phenotype. Alternatively, some of the stem cells in a population can divide symmetrically into two stems, thus maintaining some stem cells in the population as a whole, while other cells in the population give rise to differentiated progeny only. Formally, it is possible that cells that begin as stem cells might proceed toward a differentiated phenotype, but then “reverse” and re-express the stem cell phenotype, a term often referred to as “dedifferentiation”.

Exemplary stem cells include, but are not limited to, embryonic stem cells, adult stem cells, pluripotent stem cells, induced pluripotent stem cells (iPS cells), neural stem cells, liver stem cells, muscle stem cells, muscle precursor stem cells, endothelial progenitor cells, bone marrow stem cells, chondrogenic stem cells, lymphoid stem cells, mesenchymal stem cells, hematopoietic stem cells, central nervous system stem cells, peripheral nervous system stem cells, and the like. Descriptions of stem cells, including method for isolating and culturing them, can be found in, among other places, Embryonic Stem Cells, Methods and Protocols, Turksen, ed., Humana Press, 2002; Weisman et al., Annu. Rev. Cell. Dev. Biol. 17:387 403; Pittinger et al., Science, 284:143 47, 1999; Animal Cell Culture, Masters, ed., Oxford University Press, 2000; Jackson et al., PNAS 96(25):14482 86, 1999; Zuk et al., Tissue Engineering, 7:211 228, 2001 (“Zuk et al.”); Atala et al., particularly Chapters 33 41; and U.S. Pat. Nos. 5,559,022, 5,672,346 and 5,827,735. Descriptions of stromal cells, including methods for isolating them, can be found in, among other places, Prockop, Science, 276:71 74, 1997; Theise et al., Hepatology, 31:235 40, 2000; Current Protocols in Cell Biology, Bonifacino et al., eds., John Wiley & Sons, 2000 (including updates through March, 2002); and U.S. Pat. No. 4,963,489; Phillips B W and Crook J M, Pluripotent human stem cells: A novel tool in drug discovery. BioDrugs. 2010 Apr. 1; 24(2):99-108; Mari Ohnuki et al., Generation and Characterization of Human Induced Pluripotent Stem Cells, Current Protocols in Stem Cell Biology Unit Number: UNIT 4A., September, 2009.

The term “biological sample” as used herein refers to a cell or population of cells or a quantity of tissue or fluid from a subject. Most often, the sample has been removed from a subject, but the term “biological sample” can also refer to cells or tissue analyzed in vivo, i.e. without removal from the subject. Often, a “biological sample” will contain cells from the animal, but the term can also refer to non-cellular biological material.

The term “disease” or “disorder” is used interchangeably herein, refers to any alternation in state of the body or of some of the organs, interrupting or disturbing the performance of the functions and/or causing symptoms such as discomfort, dysfunction, distress, or even death to the person afflicted or those in contact with a person. A disease or disorder can also related to a distemper, ailing, ailment, malady, disorder, sickness, illness, complaint, interdisposition, affection. A disease and disorder, includes but is not limited to any condition manifested as one or more physical and/or psychological symptoms for which treatment is desirable, and includes previously and newly identified diseases and other disorders.

In some embodiments of the aspects described herein, the cells for use with the molecular circuits described herein are bacterial cells. The term “bacteria” as used herein is intended to encompass all variants of bacteria, for example, prokaryotic organisms and cyanobacteria. In some embodiments, the bacterial cells are gram-negative cells and in alternative embodiments, the bacterial cells are gram-positive cells. Non-limiting examples of species of bacterial cells useful for engineering with the molecular circuits described herein include, without limitation, cells from Escherichia coli, Bacillus subtilis, Salmonella typhimurium and various species of Pseudomonas, Streptomyces, and Staphylococcus. Other examples of bacterial cells that can be genetically engineered for use with the molecular circuits described herein include, but are not limited to, cells from Yersinia spp., Escherichia spp., Klebsiella spp., Bordetella spp., Neisseria spp., Aeromonas spp., Franciesella spp., Corynebacterium spp., Citrobacter spp., Chlamydia spp., Hemophilus spp., Brucella spp., Mycobacterium spp., Legionella spp., Rhodococcus spp., Pseudomonas spp., Helicobacter spp., Salmonella spp., Vibrio spp., Bacillus spp., and Erysipelothrix spp. In some embodiments, the bacterial cells are E. coli cells.

Other examples of organisms from which cells can be transformed or transfected with the molecular circuits described herein include, but are not limited to the following: Staphylococcus aureus, Bacillus subtilis, Clostridium butyricum, Brevibacterium lactofermentum, Streptococcus agalactiae, Lactococcus lactis, Leuconostoc lactis, Streptomyces, Actinobacillus actinobycetemcomitans, Bacteroides, cyanobacteria, Escherichia coli, Helobacter pylori, Selnomonas ruminatium, Shigella sonnei, Zymomonas mobilis, Mycoplasma mycoides, or Treponema denticola, Bacillus thuringiensis, Staphylococcus lugdunensis, Leuconostoc oenos, Corynebacterium xerosis, Lactobacillus planta rum, Streptococcus faecalis, Bacillus coagulans, Bacillus ceretus, Bacillus popillae, Synechocystis strain PCC6803, Bacillus liquefaciens, Pyrococcus abyssi, Selenomonas nominantium, Lactobacillus hilgardii, Streptococcus ferns, Lactobacillus pentosus, Bacteroides fragilis, Staphylococcus epidermidis, Staphylococcus epidermidis, Zymomonas mobilis, Streptomyces phaechromogenes, Streptomyces ghanaenis, Halobacterium strain GRB, and Halobaferax sp. strain Aa2.2.

In other embodiments of the aspects described herein, molecular circuits can be introduced into a non-cellular system such as a virus or phage, by direct integration of the molecular circuit nucleic acid, for example, into the viral genome. A virus for use with the molecular circuits described herein can be a dsDNA virus (e.g. Adenoviruses, Herpesviruses, Poxviruses), a ssDNA viruses ((+)sense DNA) (e.g. Parvoviruses); a dsRNA virus (e.g. Reoviruses); a (+)ssRNA viruses ((+)sense RNA) (e.g. Picornaviruses, Togaviruses); (−)ssRNA virus ((−)sense RNA) (e.g. Orthomyxoviruses, Rhabdoviruses); a ssRNA-Reverse Transcriptase viruses ((+)sense RNA with DNA intermediate in life-cycle) (e.g. Retroviruses); or a dsDNA—Reverse Transcriptase virus (e.g. Hepadnaviruses).

Viruses can also include plant viruses and bacteriophages or phages. Examples of phage families that can be used with the molecular circuits described herein include, but are not limited to, Myoviridae (T4-like viruses; P1-like viruses; P2-like viruses; Mu-like viruses; SPO1-like viruses; φH-like viruses); Siphoviridaeλ-like viruses (T1-like viruses; T5-like viruses; c2-like viruses; L5-like viruses; ψM1-like viruses; φC31-like viruses; N15-like viruses); Podoviridae (T7-like viruses; φ29-like viruses; P22-like viruses; N4-like viruses); Tectiviridae (Tectivirus); Corticoviridae (Corticovirus); Lipothrixviridae (Alphalipothrixvirus, Betalipothrixvirus, Gammalipothrixvirus, Deltalipothrixvirus); Plasmaviridae (Plasmavirus);Rudiviridae (Rudivirus); Fuselloviridae (Fusellovirus); Inoviridae(Inovirus, Plectrovirus); Microviridae (Microvirus, Spiromicrovirus, Bdellomicrovirus, Chlamydiamicrovirus); Leviviridae (Levivirus, Allolevivirus) and Cystoviridae (Cystovirus). Such phages can be naturally occurring or engineered phages.

In some embodiments of the aspects described herein, the molecular circuits are introduced into a cellular or non-cellular system using a vector or plasmid. As used herein, the term “vector” is used interchangeably with “plasmid” to refer to a nucleic acid molecule capable of transporting another nucleic acid to which it has been linked Vectors capable of directing the expression of genes and/or nucleic acid sequence to which they are operatively linked are referred to herein as “expression vectors.” In general, expression vectors of utility in the methods and molecular circuits described herein are often in the form of “plasmids,” which refer to circular double stranded DNA loops which, in their vector form are not bound to the chromosome. In some embodiments, all components of a given molecular circuit can be encoded in a single vector. For example, a lentiviral vector can be constructed, which contains all components necessary for a functional molecular circuit as described herein. In some embodiments, individual components (e.g., positive-deeback component a shunt component, an inversion component) can be separately encoded in different vectors and introduced into one or more cells separately.

Other expression vectors can be used in different embodiments described herein, for example, but not limited to, plasmids, episomes, bacteriophages or viral vectors, and such vectors can integrate into the host's genome or replicate autonomously in the particular cellular system used. Viral vector include, but are not limited to, retroviral vectors, such as lentiviral vectors or gammaretroviral vectors, adenoviral vectors, and baculoviral vectors. In some embodiments, lentiviral vectors comprising the nucleic acid sequences encoding the molecular circuits described herein are used. For example, a lentiviral vector can be used in the form of lentiviral particles. Other forms of expression vectors known by those skilled in the art which serve the equivalent functions can also be used. Expression vectors comprise expression vectors for stable or transient expression encoding the DNA. A vector can be either a self replicating extrachromosomal vector or a vector which integrates into a host genome. One type of vector is a genomic integrated vector, or “integrated vector”, which can become integrated into the chromosomal DNA or RNA of a host cell, cellular system, or non-cellular system. In some embodiments, the nucleic acid sequence or sequences encoding the biological classifier circuits and component input detector modules described herein integrates into the chromosomal DNA or RNA of a host cell, cellular system, or non-cellular system along with components of the vector sequence.

In other embodiments, the nucleic acid sequence encoding a molecular circuit directly integrates into chromosomal DNA or RNA of a host cell, cellular system, or non-cellular system, in the absence of any components of the vector by which it was introduced. In such embodiments, the nucleic acid sequence encoding the molecular circuits can be integrated using targeted insertions, such as knock-in technologies or homologous recombination techniques, or by non-targeted insertions, such as gene trapping techniques or non-homologous recombination.

Another type of vector for use in the methods and molecular circuits described herein is an episomal vector, i.e., a nucleic acid capable of extra-chromosomal replication. Such plasmids or vectors can include plasmid sequences from bacteria, viruses or phages. Such vectors include chromosomal, episomal and virus-derived vectors e.g., vectors derived from bacterial plasmids, bacteriophages, yeast episomes, yeast chromosomal elements, and viruses, vectors derived from combinations thereof, such as those derived from plasmid and bacteriophage genetic elements, cosmids and phagemids. A vector can be a plasmid, bacteriophage, bacterial artificial chromosome (BAC) or yeast artificial chromosome (YAC). A vector can be a single or double-stranded DNA, RNA, or phage vector. In some embodiments, the molecular circuits and component modules are introduced into a cellular system using a BAC vector.

The vectors comprising the molecular circuits and component modules described herein can be “introduced” into cells as polynucleotides, preferably DNA, by techniques well-known in the art for introducing DNA and RNA into cells. The term “transduction” refers to any method whereby a nucleic acid sequence is introduced into a cell, e.g., by transfection, lipofection, electroporation, biolistics, passive uptake, lipid:nucleic acid complexes, viral vector transduction, injection, contacting with naked DNA, gene gun, and the like. The vectors, in the case of phage and viral vectors can also be introduced into cells as packaged or encapsidated virus by well-known techniques for infection and transduction. Viral vectors can be replication competent or replication defective. In the latter case, viral propagation generally occurs only in complementing host cells. In some embodiments, the biological classifier circuits and component input detector modules are introduced into a cell using other mechanisms known to one of skill in the art, such as a liposome, microspheres, gene gun, fusion proteins, such as a fusion of an antibody moiety with a nucleic acid binding moiety, or other such delivery vehicle.

The molecular circuits or the vectors comprising the molecular circuits described herein can be introduced into a cell using any method known to one of skill in the art. The term “transformation” as used herein refers to the introduction of genetic material (e.g., a vector comprising a biological classifier circuit) comprising one or more modules or biological classifier circuits described herein into a cell, tissue or organism. Transformation of a cell can be stable or transient. The term “transient transformation” or “transiently transformed” refers to the introduction of one or more transgenes into a cell in the absence of integration of the transgene into the host cell's genome. Transient transformation can be detected by, for example, enzyme linked immunosorbent assay (ELISA), which detects the presence of a polypeptide encoded by one or more of the transgenes. For example, a molecular circuit can further comprise a promoter operably linked to an output product, such as a reporter protein. Expression of that reporter protein indicates that a cell has been transformed or transfected with the molecular circuit, and is hence implementing the circuit. Alternatively, transient transformation can be detected by detecting the activity of the protein encoded by the transgene. The term “transient transformant” refers to a cell which has transiently incorporated one or more transgenes.

In contrast, the term “stable transformation” or “stably transformed” refers to the introduction and integration of one or more transgenes into the genome of a cell or cellular system, preferably resulting in chromosomal integration and stable heritability through meiosis. Stable transformation of a cell can be detected by Southern blot hybridization of genomic DNA of the cell with nucleic acid sequences, which are capable of binding to one or more of the transgenes. Alternatively, stable transformation of a cell can also be detected by the polymerase chain reaction of genomic DNA of the cell to amplify transgene sequences. The term “stable transformant” refers to a cell or cellular, which has stably integrated one or more transgenes into the genomic DNA. Thus, a stable transformant is distinguished from a transient transformant in that, whereas genomic DNA from the stable transformant contains one or more transgenes, genomic DNA from the transient transformant does not contain a transgene. Transformation also includes introduction of genetic material into plant cells in the form of plant viral vectors involving epichromosomal replication and gene expression, which can exhibit variable properties with respect to meiotic stability. Transformed cells, tissues, or plants are understood to encompass not only the end product of a transformation process, but also transgenic progeny thereof.

The terms “nucleic acids” and “nucleotides” refer to naturally occurring or synthetic or artificial nucleic acid or nucleotides. The terms “nucleic acids” and “nucleotides” comprise deoxyribonucleotides or ribonucleotides or any nucleotide analogue and polymers or hybrids thereof in either single- or doublestranded, sense or antisense form. As will also be appreciated by those in the art, many variants of a nucleic acid can be used for the same purpose as a given nucleic acid. Thus, a nucleic acid also encompasses substantially identical nucleic acids and complements thereof. Nucleotide analogues include nucleotides having modifications in the chemical structure of the base, sugar and/or phosphate, including, but not limited to, 5-position pyrimidine modifications, 8-position purine modifications, modifications at cytosine exocyclic amines, substitution of 5-bromo-uracil, and the like; and 2′-position sugar modifications, including but not limited to, sugar-modified ribonucleotides in which the 2′-OH is replaced by a group selected from H, OR, R, halo, SH, SR, NH2, NHR, NR2, or CN. shRNAs also can comprise non-natural elements such as non-natural bases, e.g., ionosin and xanthine, nonnatural sugars, e.g., 2′-methoxy ribose, or non-natural phosphodiester linkages, e.g., methylphosphonates, phosphorothioates and peptides.

The term “nucleic acid sequence” or “oligonucleotide” or “polynucleotide” are used interchangeably herein and refers to at least two nucleotides covalently linked together. The term “nucleic acid sequence” is also used inter-changeably herein with “gene”, “cDNA”, and “mRNA”. As will be appreciated by those in the art, the depiction of a single nucleic acid sequence also defines the sequence of the complementary nucleic acid sequence. Thus, a nucleic acid sequence also encompasses the complementary strand of a depicted single strand. Unless otherwise indicated, a particular nucleic acid sequence also implicitly encompasses conservatively modified variants thereof (e.g., degenerate codon substitutions) and complementary sequences, as well as the sequence explicitly indicated. As will also be appreciated by those in the art, a single nucleic acid sequence provides a probe that can hybridize to the target sequence under stringent hybridization conditions. Thus, a nucleic acid sequence also encompasses a probe that hybridizes under stringent hybridization conditions. The term “nucleic acid sequence” refers to a single or double-stranded polymer of deoxyribonucleotide or ribonucleotide bases read from the 5′- to the 3′-end. It includes chromosomal DNA, self-replicating plasmids, infectious polymers of DNA or RNA and DNA or RNA that performs a primarily structural role. “Nucleic acid sequence” also refers to a consecutive list of abbreviations, letters, characters or words, which represent nucleotides. Nucleic acid sequences can be single stranded or double stranded, or can contain portions of both double stranded and single stranded sequence. The nucleic acid sequence can be DNA, both genomic and cDNA, RNA, or a hybrid, where the nucleic acid sequence can contain combinations of deoxyribo- and ribonucleotides, and combinations of bases including uracil, adenine, thymine, cytosine, guanine, inosine, xanthine hypoxanthine, isocytosine and isoguanine. Nucleic acid sequences can be obtained by chemical synthesis methods or by recombinant methods. A nucleic acid sequence will generally contain phosphodiester bonds, although nucleic acid analogs can be included that can have at least one different linkage, e.g., phosphoramidate, phosphorothioate, phosphorodithioate, or O-methylphosphoroamidite linkages and peptide nucleic acid backbones and linkages in the nucleic acid sequence. Other analog nucleic acids include those with positive backbones; non-ionic backbones, and non-ribose backbones, including those described in U.S. Pat. Nos. 5,235,033 and 5,034,506, which are incorporated by reference. Nucleic acid sequences containing one or more non-naturally occurring or modified nucleotides are also included within one definition of nucleic acid sequences. The modified nucleotide analog can be located for example at the 5′-end and/or the 3′-end of the nucleic acid sequence. Representative examples of nucleotide analogs can be selected from sugar- or backbone-modified ribonucleotides. It should be noted, however, that also nucleobase-modified ribonucleotides, i.e. ribonucleotides, containing a non naturally occurring nucleobase instead of a naturally occurring nucleobase such as uridines or cytidines modified at the 5-position, e.g. 5-(2-amino)propyl uridine, 5-bromo uridine; adenosines and guanosines modified at the 8-position, e.g. 8-bromo guanosine; deaza nucleotides, e. g. 7 deaza-adenosine; O- and N-alkylated nucleotides, e.g. N6-methyl adenosine are suitable. The 2′ OH— group can be replaced by a group selected from H. OR, R. halo, SH, SR, NH2, NHR, NR2 or CN, wherein R is C-C6 alkyl, alkenyl or alkynyl and halo is F. Cl, Br or I. Modifications of the ribose-phosphate backbone can be done for a variety of reasons, e.g., to increase the stability and half-life of such molecules in physiological environments or as probes on a biochip. Mixtures of naturally occurring nucleic acids and analogs can be used; alternatively, mixtures of different nucleic acid analogs, and mixtures of naturally occurring nucleic acids and analogs can be used. Nucleic acid sequences include but are not limited to, nucleic acid sequence encoding proteins, for example that act as reporters, transcriptional repressors, antisense molecules, ribozymes, small inhibitory nucleic acid sequences, for example but not limited to RNAi, shRNAi, siRNA, micro RNAi (mRNAi), antisense oligonucleotides etc.

In its broadest sense, the term “substantially complementary”, when used herein with respect to a nucleotide sequence in relation to a reference or target nucleotide sequence, means a nucleotide sequence having a percentage of identity between the substantially complementary nucleotide sequence and the exact complementary sequence of said reference or target nucleotide sequence of at least 60%, at least 70%, at least 80% or 85%, at least 90%, at least 93%, at least 95% or 96%, at least 97% or 98%, at least 99% or 100% (the later being equivalent to the term “identical” in this context). For example, identity is assessed over a length of at least 10 nucleotides, or at least 11, 12, 13, 14, 15, 16, 17, 18, 19, 20, 21, 22 or up to 50 nucleotides of the entire length of the nucleic acid sequence to said reference sequence (if not specified otherwise below). Sequence comparisons are carried out using default GAP analysis with the University of Wisconsin GCG, SEQWEB application of GAP, based on the algorithm of Needleman and Wunsch (Needleman and Wunsch (1970) J MoI. Biol. 48: 443-453; as defined above). A nucleotide sequence “substantially complementary” to a reference nucleotide sequence hybridizes to the reference nucleotide sequence under low stringency conditions, preferably medium stringency conditions, most preferably high stringency conditions (as defined above).

In its broadest sense, the term “substantially identical”, when used herein with respect to a nucleotide sequence, means a nucleotide sequence corresponding to a reference or target nucleotide sequence, wherein the percentage of identity between the substantially identical nucleotide sequence and the reference or target nucleotide sequence is at least 60%, at least 70%, at least 80% or 85%, at least 90%, at least 93%, at least 95% or 96%, at least 97% or 98%, at least 99% or 100% (the later being equivalent to the term “identical” in this context). For example, identity is assessed over a length of 10-22 nucleotides, such as at least 10, 11, 12, 13, 14, 15, 16, 17, 18, 19, 20, 21, 22 or up to 50 nucleotides of a nucleic acid sequence to said reference sequence (if not specified otherwise below). Sequence comparisons are carried out using default GAP analysis with the University of Wisconsin GCG, SEQWEB application of GAP, based on the algorithm of Needleman and Wunsch (Needleman and Wunsch (1970) J MoI. Biol. 48: 443-453; as defined above). A nucleotide sequence that is “substantially identical” to a reference nucleotide sequence hybridizes to the exact complementary sequence of the reference nucleotide sequence (i.e. its corresponding strand in a double-stranded molecule) under low stringency conditions, preferably medium stringency conditions, most preferably high stringency conditions (as defined above). Homologues of a specific nucleotide sequence include nucleotide sequences that encode an amino acid sequence that is at least 24% identical, at least 35% identical, at least 50% identical, at least 65% identical to the reference amino acid sequence, as measured using the parameters described above, wherein the amino acid sequence encoded by the homolog has the same biological activity as the protein encoded by the specific nucleotide. The term “substantially non-identical” refers to a nucleotide sequence that does not hybridize to the nucleic acid sequence under stringent conditions.

As used herein, the term “gene” refers to a nucleic acid sequence comprising an open reading frame encoding a polypeptide, including both exon and (optionally) intron sequences. A “gene” refers to coding sequence of a gene product, as well as non-coding regions of the gene product, including 5′UTR and 3′UTR regions, introns and the promoter of the gene product. These definitions generally refer to a single-stranded molecule, but in specific embodiments will also encompass an additional strand that is partially, substantially or fully complementary to the single-stranded molecule. Thus, a nucleic acid sequence can encompass a double-stranded molecule or a double-stranded molecule that comprises one or more complementary strand(s) or “complement(s)” of a particular sequence comprising a molecule. As used herein, a single stranded nucleic acid can be denoted by the prefix “ss”, a double stranded nucleic acid by the prefix “ds”, and a triple stranded nucleic acid by the prefix “ts.”

The term “operable linkage” or “operably linked” are used interchangeably herein, are to be understood as meaning, for example, the sequential arrangement of a regulatory element (e.g. a promoter) with a nucleic acid sequence to be expressed and, if appropriate, further regulatory elements (such as, e.g., a terminator) in such a way that each of the regulatory elements can fulfill its intended function to allow, modify, facilitate or otherwise influence expression of the linked nucleic acid sequence. The expression can result depending on the arrangement of the nucleic acid sequences in relation to sense or antisense RNA. To this end, direct linkage in the chemical sense is not necessarily required. Genetic control sequences such as, for example, enhancer sequences, can also exert their function on the target sequence from positions which are further away, or indeed from other DNA molecules. In some embodiments, arrangements are those in which the nucleic acid sequence to be expressed recombinantly is positioned behind the sequence acting as promoter, so that the two sequences are linked covalently to each other. The distance between the promoter sequence and the nucleic acid sequence to be expressed recombinantly can be any distance, and in some embodiments is less than 200 base pairs, especially less than 100 base pairs, less than 50 base pairs. In some embodiments, the nucleic acid sequence to be transcribed is located behind the promoter in such a way that the transcription start is identical with the desired beginning of the chimeric RNA described herein. Operable linkage, and an expression construct, can be generated by means of customary recombination and cloning techniques as described (e.g., in Maniatis T, Fritsch E F and Sambrook J (1989) Molecular Cloning: A Laboratory Manual, 2nd Ed., Cold Spring Harbor Laboratory, Cold Spring Harbor (N.Y.); Silhavy et al. (1984) Experiments with Gene Fusions, Cold Spring Harbor Laboratory, Cold Spring Harbor (N.Y.); Ausubel et al. (1987) Current Protocols in Molecular Biology, Greene Publishing Assoc and Wiley Interscience; Gelvin et al. (Eds) (1990) Plant Molecular Biology Manual; Kluwer Academic Publisher, Dordrecht, The Netherlands). However, further sequences can also be positioned between the two sequences. The insertion of sequences can also lead to the expression of fusion proteins, or serves as ribosome binding sites. In some embodiments, the expression construct, consisting of a linkage of promoter and nucleic acid sequence to be expressed, can exist in a vector integrated form and be inserted into a plant genome, for example by transformation.

The term “expression” as used herein refers to the biosynthesis of a gene product, preferably to the transcription and/or translation of a nucleotide sequence, for example an endogenous gene or a heterologous gene, in a cell. For example, in the case of a heterologous nucleic acid sequence, expression involves transcription of the heterologous nucleic acid sequence into mRNA and, optionally, the subsequent translation of mRNA into one or more polypeptides. Expression also refers to biosynthesis of a microRNA or RNAi molecule, which refers to expression and transcription of an RNAi agent such as siRNA, shRNA, and antisense DNA but does not require translation to polypeptide sequences. The term “expression construct” and “nucleic acid construct” as used herein are synonyms and refer to a nucleic acid sequence capable of directing the expression of a particular nucleotide sequence, such as the heterologous target gene sequence in an appropriate host cell (e.g., a prokaryotic cell, eukaryotic cell, or mammalian cell). If translation of the desired heterologous target gene is required, it also typically comprises sequences required for proper translation of the nucleotide sequence. The coding region can code for a protein of interest but can also code for a functional RNA of interest, for example, microRNA, microRNA target sequence, antisense RNA, dsRNA, or a nontranslated RNA, in the sense or antisense direction. The nucleic acid construct as disclosed herein can be chimeric, meaning that at least one of its components is heterologous with respect to at least one of its other components.

The terms “polypeptide”, “peptide”, “oligopeptide”, “polypeptide”, “gene product”, “expression product” and “protein” are used interchangeably herein to refer to a polymer or oligomer of consecutive amino acid residues.

The term “subject” refers to any living organism from which a biological sample, such as a cell sample, can be obtained. The term includes, but is not limited to, humans; non-human primates, such as chimpanzees and other apes and monkey species; farm animals such as cattle, sheep, pigs, goats and horses, domestic subjects such as dogs and cats, laboratory animals including rodents such as mice, rats and guinea pigs, and the like. The term does not denote a particular age or sex. Thus, adult and newborn subjects, as well as fetuses, whether male or female, are intended to be covered. The term “subject” is also intended to include living organisms susceptible to conditions or diseases caused or contributed bacteria, pathogens, disease states or conditions as generally disclosed, but not limited to, throughout this specification. Examples of subjects include humans, dogs, cats, cows, goats, and mice.

The terms “higher” or “increased” or “increase” as used herein in the context of expression or biological activity of a microRNA or protein generally means an increase in the expression level or activity of the microRNA or protein by a statically significant amount relative to a reference level, state or condition. For the avoidance of doubt, a “higher” or “increased”, expression of a microRNA means a statistically significant increase of at least about 50% as compared to a reference level or state, including an increase of at least about 60%, at least about 70%, at least about 80%, at least about 90%, at least about 100% or more, including, for example at least 2-fold, at least 3-fold, at least 4-fold, at least 5-fold, at least 6-fold, at least 7-fold, at least 8-fold, at least 9-fold, at least 10-fold, at least 20-fold, at least 30-fold, at least 40-fold, at least 50-fold, at least 60-fold, at least 70-fold, at least 80-fold, at least 90-fold, at least 100-fold, at least 500-fold, at least 1000-fold increase or greater of the level of expression of the microRNA relative to the reference level.

Similarly, the terms “lower”, “reduced”, or “decreased” are all used herein generally to mean a decrease by a statistically significant amount. However, for avoidance of doubt, “lower”, “reduced”, “reduction” or “decreased” means a decrease by at least 50% as compared to a reference level, for example a decrease by at least about 60%, or at least about 70%, or at least about 80%, or at least about 90%, or at least about 95%, or up to and including a 100% decrease (i.e. absent level as compared to a reference sample), or any decrease between 50-100% as compared to a reference level.

As used herein, the term “comprising” means that other elements can also be present in addition to the defined elements presented. The use of “comprising” indicates inclusion rather than limitation. Accordingly, the terms “comprising” means “including principally, but not necessary solely”. Furthermore, variation of the word “comprising”, such as “comprise” and “comprises”, have correspondingly the same meanings. The term “consisting essentially of” means “including principally, but not necessary solely at least one”, and as such, is intended to mean a “selection of one or more, and in any combination”. Stated another way, the term “consisting essentially of” means that an element can be added, subtracted or substituted without materially affecting the novel characteristics described herein. This applies equally to steps within a described method as well as compositions and components therein. In other embodiments, the inventions, compositions, methods, and respective components thereof, described herein are intended to be exclusive of any element not deemed an essential element to the component, composition or method (“consisting of”). For example, a biological classifier circuit that comprises a repressor sequence and a microRNA target sequence encompasses both the repressor sequence and a microRNA target sequence of a larger sequence. By way of further example, a composition that comprises elements A and B also encompasses a composition consisting of A, B and C.

As used in this specification and the appended claims, the singular forms “a,” “an,” and “the” include plural references unless the context clearly dictates otherwise. Thus for example, references to “the method” includes one or more methods, and/or steps of the type described herein and/or which will become apparent to those persons skilled in the art upon reading this disclosure and so forth.

It is understood that the foregoing detailed description and the following examples are illustrative only and are not to be taken as limitations upon the scope described herein. Various changes and modifications to the disclosed embodiments, which will be apparent to those of skill in the art, can be made without departing from the spirit and scope described herein. Further, all patents, patent applications, publications, and websites identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

Unless otherwise defined herein, scientific and technical terms used in connection with the present application shall have the meanings that are commonly understood by those of ordinary skill in the art to which this disclosure belongs. It should be understood that this invention is not limited to the particular methodology, protocols, and reagents, etc., described herein and as such can vary. The terminology used herein is for the purpose of describing particular embodiments only, and is not intended to limit the scope of the present invention, which is defined solely by the claims. Definitions of common terms in immunology, and molecular biology can be found in The Merck Manual of Diagnosis and Therapy, 18th Edition, published by Merck Research Laboratories, 2006 (ISBN 0-911910-18-2); Robert S. Porter et al. (eds.), The Encyclopedia of Molecular Biology, published by Blackwell Science Ltd., 1994 (ISBN 0-632-02182-9); and Robert A. Meyers (ed.), Molecular Biology and Biotechnology: a Comprehensive Desk Reference, published by VCH Publishers, Inc., 1995 (ISBN 1-56081-569-8); Immunology by Werner Luttmann, published by Elsevier, 2006. Definitions of common terms in molecular biology are found in Benjamin Lewin, Genes IX, published by Jones & Bartlett Publishing, 2007 (ISBN-13: 9780763740634); Kendrew et al. (eds.), The Encyclopedia of Molecular Biology, published by Blackwell Science Ltd., 1994 (ISBN 0-632-02182-9); and Robert A. Meyers (ed.), Maniatis et al., Molecular Cloning: A Laboratory Manual, Cold Spring Harbor Laboratory Press, Cold Spring Harbor, N.Y., USA (1982); Sambrook et al., Molecular Cloning: A Laboratory Manual (2 ed.), Cold Spring Harbor Laboratory Press, Cold Spring Harbor, N.Y., USA (1989); Davis et al., Basic Methods in Molecular Biology, Elsevier Science Publishing, Inc., New York, USA (1986); or Methods in Enzymology: Guide to Molecular Cloning Techniques Vol. 152, S. L. Berger and A. R. Kimmerl Eds., Academic Press Inc., San Diego, USA (1987); Current Protocols in Molecular Biology (CPMB) (Fred M. Ausubel, et al. ed., John Wiley and Sons, Inc.), Current Protocols in Protein Science (CPPS) (John E. Coligan, et. al., ed., John Wiley and Sons, Inc.) and Current Protocols in Immunology (CPI) (John E. Coligan, et. al., ed. John Wiley and Sons, Inc.), which are all incorporated by reference herein in their entireties.

It is understood that the foregoing detailed description and examples are illustrative only and are not to be taken as limitations upon the scope of the invention. Various changes and modifications to the disclosed embodiments, which will be apparent to those of skill in the art, may be made without departing from the spirit and scope of the present invention. Further, all patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

### EXAMPLES

### Introduction to Synthetic Analog Computation in Living Cells

Presented herein are strategies for designing synthetic gene circuits which implement analog computation in living cells. One approach involves detailed biochemical models which capture the effects of positive feedback, shunt plasmids, protein degradation, and transcription-factor diffusion. These detailed biochemical models enable us to accurately capture the behavior of the various analog circuit topologies by solely changing the parameters that are expected to vary between experiments (e.g., plasmid copy number).

Another approach described herein uses simple mathematical functions, such as logarithms, to capture the behaviour of the analog circuit motifs described herein with a handful of parameters. These empirical mathematical functions enable the composition of analog circuit modules together with predictable behavior. Thus, they are useful in the synthetic circuit design process because they are easily interpretable by human designers and remain accurate in circuits of higher complexity.

### Detailed Biochemical Models for Synthetic Analog Genetic Circuits

Described herein are detailed biochemical models for synthetic analog genetic circuits. The models described and demonstrated herein incorporate effects of biochemical interactions, such as binding of inducers to transcription factors, binding of transcription factors to promoters, degradation of free and bound transcription factors to DNA, the effective variation of transcription-factor diffusion-limited binding rates inside the cell with variation in plasmid copy number, and the integration of all these effects in the positive-feedback-and-shunt (PF-shunt) topology described herein. To clarify the various interactions within these biochemical reaction models, analog circuit schematics' that represent steady-state mass-action kinetics are also shown.

The models described and demonstrated herein yield insight into and predict network behavior. The models assume that the concentration of chemical species is uniformly distributed and the behavior of the genetic circuits described herein can be analyzed in the steady state. For each experiment, only model parameter values that varied in that experiment (e.g., the copy number of plasmids used) were adjusted. All other parameter values were used consistently throughout all of our models.

As used herein, to describe interactions between inducers, transcription factors, and DNA, transcription factors are called “free” if they are not interacting with inducers or DNA. When inducers complex with transcription factors, the resulting product is termed the inducer-transcription-factor “complex”. When free transcription factors bind to DNA, these are termed “bound” transcription factors. When inducer-transcription factor complexes bind to DNA, these are termed as “bound complex transcription factors”. (For all the abbreviations, refer to Table 1).

### Modeling Binding of Inducers to Transcription Factors

The set of ordinary differential equations which model the process of free inducer (In) binding to free transcription factor (T) (Iₙ+T⇄T_{C}) can be described by:

$$\frac{d {T}_{C}}{d t} = {k}_{1} \cdot {I}_{n} \cdot T - {k}_{- 1} \cdot {T}_{C} \\ \frac{d T}{d t} = - \frac{d {T}_{C}}{d t} \\ \frac{d {I}_{n}}{d t} = - \frac{d {T}_{C}}{d t} \qquad ( 1 )$$

Where T_{C} is the concentration of transcription factor bound to the inducer, k₁ is the rate of the forward reaction and k₋₁ is the rate of the reverse reaction. At equilibrium, the bound transcription factor is equal to:

$$\begin{matrix}{T}_{C} = \frac{{I}_{n} \cdot T}{{K}_{m}} & ( 2.1 ) \\ {T}_{C} = {I}_{n} = {I}_{nT} & ( 2.2 ) \\ {T}_{C} + T = {T}_{T} & ( 2.3 ) \\ ⇒ {T}_{C} = \frac{( {I}_{nT} + {T}_{T} + {K}_{m} ) - \sqrt{{( {I}_{nT} + {T}_{T} + {K}_{m} )}^{2} - 4 {T}_{T} \cdot {I}_{nT}}}{2} & ( 2.4 )\end{matrix}$$

Where I_{nT} is the concentration of total inducer, T_{T} is the concentration of total transcription factor and Kₘ=k₋₁/k₁ is the dissociation constant. In the case that

$$\frac{{T}_{T}}{{K}_{m}} < 1 + \frac{{I}_{nT}}{{K}_{m}} ,$$

we can approximate Eq. 2.4 as:

$${T}_{C} = {T}_{T} \cdot \frac{\frac{{I}_{nT}}{{K}_{m}}}{1 + \frac{{I}_{nT}}{{K}_{m}} + \frac{{T}_{T}}{{K}_{m}}} \qquad ( 3 )$$

Note that the Michaelis-Menten approximation is a special case of Eq. 3 (where T_{T}<<I_{nT}. Eq. 3 shows that the amount of bound transcription factor (Tₐ) will saturate at high values of total transcription factor (T_{T}) because it is limited by the inducer concentration (I_{nT}); in contrast, in the Michaelis-Menten model, bound transcription factor increases linearly with increasing total transcription factor, without being limited by inducer saturation.

Many binding reactions include cooperativity between inducers and transcription factors. We will study two specific cases of cooperativity (h=2 and 3, where h is the Hill Coefficient):

In the case of h=2 (Hill Coefficient=2):

$$\{ \begin{matrix}{I}_{n} + T ↔ {T}_{c 1} \\ {I}_{n} + {T}_{c 1} ↔ {T}_{c}\end{matrix} \qquad ( 4 )$$

The set of the ordinary differential equations which describes the set of biochemical reactions in Eq. 4 includes:

$$\frac{d {T}_{C 1}}{d t} = {k}_{1} \cdot {I}_{n} \cdot T - {k}_{- 1} \cdot {T}_{C 1} - {k}_{2} \cdot {I}_{n} \cdot {T}_{C 1} + {k}_{- 2} \cdot {T}_{C} \\ \frac{d {T}_{C}}{d t} = {k}_{2} \cdot {I}_{n} \cdot {T}_{C 1} - {k}_{- 2} \cdot {T}_{C} \\ \frac{d T}{d t} = - \frac{d {T}_{C 1}}{d t} - \frac{d {T}_{C}}{d t} \\ \frac{d {I}_{n}}{d t} = - \frac{d {T}_{C 1}}{d t} - \frac{d {T}_{C}}{d t} \qquad ( 5 )$$

At equilibrium:

$$\begin{matrix}{T}_{C 1} = \frac{{I}_{n} \cdot T}{{K}_{m 1}} & ( 6.1 ) \\ {T}_{C} = \frac{{I}_{n} \cdot {T}_{c 1}}{{K}_{m 2}} & ( 6.2 ) \\ T + {T}_{C 1} + {T}_{C} = {T}_{T} & ( 6.3 ) \\ {I}_{n} + {T}_{C 1} + {T}_{C} = {I}_{nT} & ( 6.4 )\end{matrix}$$

Where Kₘ₁=k₋₁/k₁, and Kₘ₂=k₋₂/k₂. Substituting Eq. 6.1, 6.3 and 6.4 into Eq. 6.2, we get:

$${T}_{C} = \frac{{( {I}_{nT} - {T}_{c 1} - {T}_{c} )}^{2} \cdot ( {T}_{T} - {T}_{c 1} - {T}_{c} )}{{K}_{m 1} \cdot {K}_{m 2}} \qquad ( 7 )$$

We will assume that the concentration of the product of the final reaction is larger than the concentration of the product of the intermediate reactions (Kₘ₂<<Kₘ₁); in this case, Eq. 7 can be approximated by:

$${T}_{C} = \frac{{( {I}_{nT} - {T}_{c} )}^{2} \cdot ( {T}_{T} - {T}_{c} )}{{K}_{m 1} \cdot {K}_{m 2}} \\ {T}_{C}^{3} = {T}_{C}^{2} \cdot ( 2 {I}_{nT} + {T}_{T} ) + {T}_{C} \cdot ( 2 {I}_{nT} \cdot {T}_{T} + {I}_{nT}^{2} + {K}_{m}^{2} ) = {T}_{T} \cdot {I}_{nT}^{2} \qquad ( 8 )$$

Where Kₘ²=Kₘ₁·Kₘ₂. In the case that

$$\frac{{T}_{T}}{{K}_{m}} < 1 + \frac{{I}_{nT}}{{K}_{m}} ,$$

we can approximate Eq. 8 as

$${T}_{C} = {T}_{T} \cdot \frac{{( \frac{{I}_{nT}}{{K}_{m}} )}^{2}}{1 + {( \frac{{I}_{nT}}{{K}_{m}} )}^{2} + {( \frac{{I}_{nT}}{{K}_{m}} )}^{1} \cdot \frac{{T}_{T}}{0.5 {K}_{m}}} \qquad ( 9 )$$

In the case of h=3 (Hill Coefficient=3):

$$\{ \begin{matrix}{I}_{n} + T ↔ {T}_{c 1} \\ {I}_{n} + {T}_{c 1} ↔ {T}_{c 2} \\ {I}_{n} + {T}_{c 2} ↔ {T}_{c }\end{matrix} \qquad ( 10 )$$

The set of the ordinary differential equations which describes the set of biochemical reactions in Eq. 10 includes:

$$\frac{d {T}_{C 1}}{d t} = {k}_{1} {I}_{n} \cdot T - {k}_{- 1} \cdot {T}_{C 1} - {k}_{2} {I}_{n} \cdot {T}_{C 1} + {k}_{- 2} \cdot {T}_{C 2} \\ \frac{d {T}_{C 2}}{d t} = {k}_{2} \cdot {I}_{n} \cdot {T}_{C 1} - {k}_{- 2} \cdot {T}_{C 2} - {k}_{3} \cdot {I}_{n} \cdot {T}_{C 2} + {k}_{- 3} \cdot {T}_{C} \\ \frac{d {T}_{C}}{d t} = {k}_{3} \cdot {I}_{n} \cdot {T}_{C 2} - {k}_{- 3} \cdot {T}_{C} \\ \frac{d T}{d t} = - \frac{d {T}_{C 2}}{d t} - \frac{d {T}_{C 1}}{d t} - \frac{d {T}_{C}}{d t} \\ \frac{d {I}_{n}}{d t} = - \frac{d {T}_{C 2}}{d t} - \frac{d {T}_{C 1}}{d t} - \frac{d {T}_{C}}{d t} \qquad ( 11 )$$

At equilibrium:

$$\begin{matrix}{T}_{C 1} = \frac{{I}_{n} \cdot T}{{K}_{m 1}} & ( 12.1 ) \\ {T}_{C 2} = \frac{{I}_{n} \cdot {T}_{c 1}}{{K}_{m 2}} & ( 12.2 ) \\ {T}_{C} = \frac{{I}_{n} \cdot {T}_{c 2}}{{K}_{m 3}} & ( 12.3 ) \\ T + {T}_{C 2} + {T}_{C 1} + {T}_{C} = {T}_{T} & ( 12.4 ) \\ {I}_{n} + {T}_{C 2} + {T}_{C 1} + {T}_{C} = {I}_{nT} & ( 12.5 )\end{matrix}$$

Where Kₘ₁=k₋₁/k₁, Kₘ₂=k₋₂/k₂ and Kₘ₃=k₋₃/k₃. Substituting Eq. 12.1, 12.2, 12.4 and 12.5 into Eq. 12.3 we get:

$${T}_{C} = \frac{{( {I}_{nT} - {T}_{c 2} - {T}_{c 1} - {T}_{c} )}^{3} \cdot ( {T}_{T} - {T}_{c 2} - {T}_{c 1} - {T}_{c} )}{{K}_{m 1} \cdot {K}_{m 2} \cdot {K}_{m3}} \qquad ( 13 )$$

We will assume that the concentration of the product of the final reaction is larger than the concentration of the products of the intermediate reactions (Kₘ₃<<<Kₘ₂, Kₘ₁); in this case Eq. 13 can be approximated by:

$${T}_{C} = \frac{{( {I}_{nT} - {T}_{c} )}^{3} \cdot ( {T}_{T} - {T}_{c} )}{{K}_{m 1} \cdot {K}_{m 2} \cdot {K}_{m3}} \qquad ( 14 )$$

Where Kₘ³=Kₘ₁·Kₘ₂·Kₘ₃. In the case that

$$\frac{{T}_{T}}{{K}_{m}} < 1 + \frac{{I}_{nT}}{{K}_{m}} ,$$

we can approximate Eq. 14 as

$${T}_{C} = {T}_{T} \cdot \frac{{( \frac{{I}_{nT}}{{K}_{m}} )}^{3}}{1 + {( \frac{{I}_{nT}}{{K}_{m}} )}^{3} + {( \frac{{I}_{nT}}{{K}_{m}} )}^{2} \cdot \frac{{T}_{T}}{0.3 {K}_{m}}} \qquad ( 15 )$$

Based on these specific cases, we can generalize Eq. 3, 9 and 15 by using the Hill function²:

$${T}_{C} = {T}_{T} \cdot \frac{{( \frac{{I}_{nT}}{{K}_{m}} )}^{{h}_{1}}}{1 + {( \frac{{I}_{nT}}{{K}_{m}} )}^{{h}_{1}} + {( \frac{{I}_{nT}}{{K}_{m}} )}^{{h}_{2}} \cdot \frac{{T}_{T}}{{K}_{n}}} \qquad ( 16 )$$

where h₁ is the Hill coefficient, h₂ and Kₙ are fitting parameters with h₂<h₁ and <Kₘ. We study the condition

$$\frac{{T}_{T}}{{K}_{m}} < 1 + \frac{{I}_{nT}}{{K}_{m}}$$

in two different cases:
1. Open-loop case: if I_{nT}<<Kₘ, then we must design the circuit such that T_{T}/Kₘ<1 to satisfy the above condition; when I_{nT}>>Kₘ, the condition is automatically satisfied for practical ranges of T_{T} in cells.
2. Closed-loop (feedback) case: in the positive-feedback-and-shunt topology, T_{T} increases as I_{nT} increases from transcriptional positive feedback. Thus, I_{nT} and T_{T} track each other. Hence, if I_{nT}<<Kₘ, T_{T} is small such that we also have T_{T}/Kₘ<I and the condition is automatically satisfied; when I_{nT}>>Kₘ, the condition continues to be satisfied for practical ranges of T_{T} in cells as long as the creation of T_{T} via feedback is not excessively strong, a feature enabled by our shunting mechanism.

We use Eq. 16 to describe inducer-transcription factor binding reactions in combination with literature-based values for the Hill coefficient h₁ and dissociation constant Kₘ (Supplementary Table 2). Supplementary FIG. 1 shows a schematic that represents our model of the binding reaction for an inducer and transcription factor.

### Modeling Pₗᵤₓ and P_{BAD} Promoter Activity

Transcription factor (TF) binding to promoters is modeled according to the Shea-Ackers formalism^{3,4}. The total expression P_{T} from a promoter is described by a weighted sum of the basal level probability (1−P) and the induced level probability P:

P_{T}=Const₁·(1−P)+Const₂·P→P_{T}=Const₁+(Const₂−Const₁)·P, (17)

where Const₁ and Const₂ are constants that correspond to basal or induced expression respectively. In this study we used two activator-type transcription factors: LuxR⁵ and AraC⁶. The probability of the Lux promoter (Pₗᵤₓ) being induced is described by the following equation:

$$P = \frac{\frac{{LuxR}_{C}}{{K}_{d}}}{1 + \frac{{LuxR}_{C}}{{K}_{d}}} , \qquad ( 18 )$$

where K_{d} is the dissociation constant for the binding of the inducer-transcription factor (AHL-LuxR) complex (LuxR_{C}) to the promoter Pₗᵤₓ. The concentration of the bound-promoter complex (AHL-LuxR-Pₗᵤₓ) is directly proportional to the probability of the promoter being induced and the concentration of promoter binding sites (O_{T}):

$${LuxR}_{Cb} = {O}_{T} \cdot \frac{\frac{{LuxR}_{C}}{{K}_{d}}}{1 + \frac{{LuxR}_{C}}{{K}_{d}}} \qquad ( 19 )$$

The sum of the free (AHL-LuxR) complex (LuxR_{C}) and bound (AHL-LuxR) complex (LuxR_{Cb}) are equal to the total (AHL-LuxR) complex LuxR_{CT}:

LuxR_{CT}=LuxR_{C}+LuxR_{Cb} (20)

The P_{BAD} promoter is activated by the AraC transcription factor when it is induced by arabinose. The probability of the P_{BAD} promoter being induced by the arabinose-AraC complex is described by the following equation⁷:

$$P = \frac{\frac{{AraC}_{C}}{{K}_{d}}}{1 + \frac{{AraC}_{C}}{{K}_{d}} + \frac{AraC}{{K}_{df}}} , \qquad ( 21 )$$

where AraC_{C} is the concentration of the arabinose-AraC complex, AraC is the concentration of free AraC transcription factor, K_{d} is the dissociation constant for binding of the arabinose-AraC complex to the P_{BAD} promoter, and K_{df} is the dissociation constant for free AraC binding to P_{BAD}. The probability of free AraC binding to the promoter is equal to:

$$P = \frac{\frac{AraC}{{K}_{df}}}{1 + \frac{{AraC}_{C}}{{K}_{d}} + \frac{AraC}{{K}_{df}}} \qquad ( 22 )$$

The concentration of the bound-promoter complex arabinose-AraC-P_{BAD} (AraC_{Cb}) is directly proportional to the probability of the promoter being induced and the number of the promoter binding sites (O_{T}):

$${AraC}_{Cb} = {O}_{T} \cdot \frac{\frac{{AraC}_{C}}{{K}_{d}}}{1 + \frac{{AraC}_{C}}{{K}_{d}} + \frac{AraC}{{K}_{df}}} \qquad ( 23 )$$

The concentration of the bound AraC (AraC_{b}) to the promoter is directly proportional to the probability of binding the free AraC to the promoter and the number of the promoter binding sites:

$${AraC}_{b} = {O}_{T} \cdot \frac{\frac{AraC}{{K}_{df}}}{1 + \frac{{AraC}_{C}}{{K}_{d}} + \frac{AraC}{{K}_{df}}} \qquad ( 24 )$$

The sum of the free (arabinose-AraC) complex (AraC_{C}) and bound (arabinose-AraC) complex (AraC_{Cb}) to DNA is equal to the total (arabinose-AraC) complex AraC_{CT}, and the sum of free AraC (AraC) and bound AraC (AraC_{b}) to DNA is equal to AraC_{T}−AraC_{CT}:

AraC_{CT}=AraC_{C}+AraC_{Cb} (25)

AraC_{T}−AraC_{CT}=AraC+AraC_{b} (26)

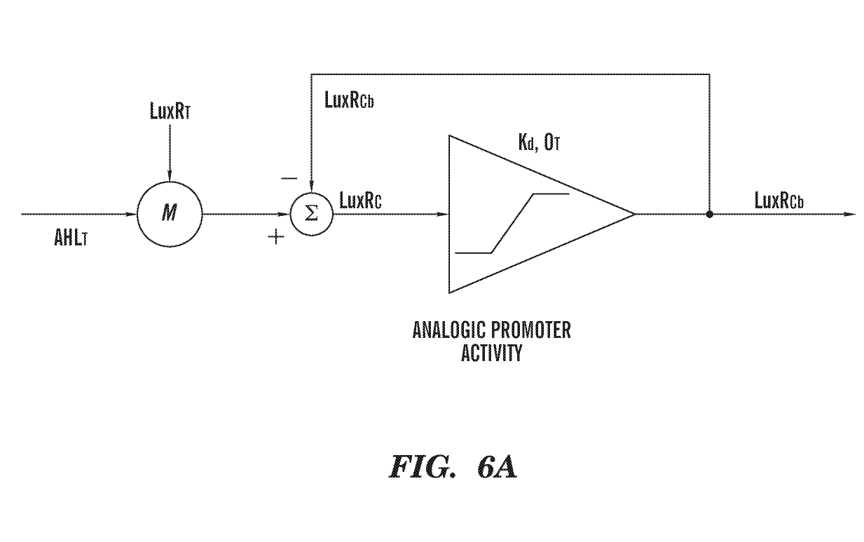

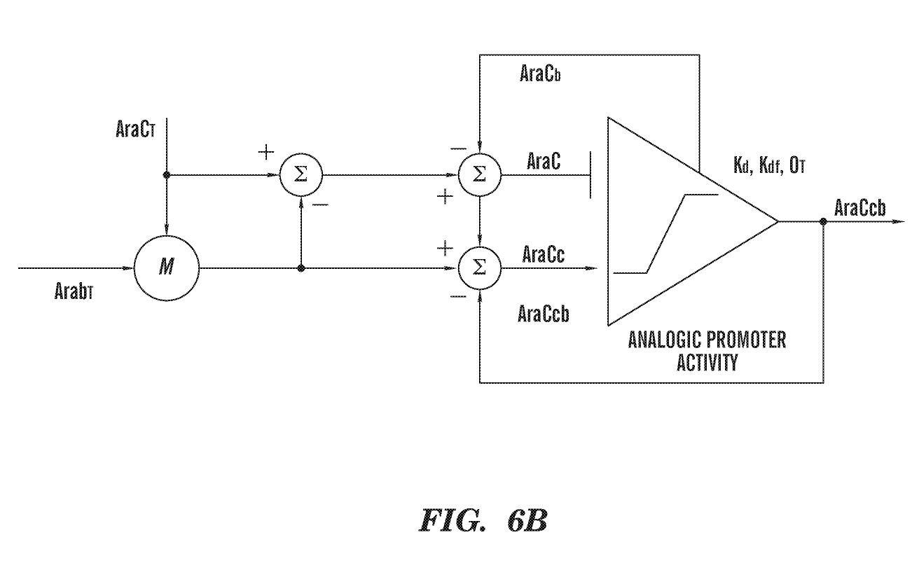

FIGS. 6A-6B show schematic diagrams for the models of promoter activity for LuxR and AraC, including the binding reaction which forms the complex between the inducer and the transcription factor. In the models described herein, the expression of the output protein is proportional to the bound transcription factor complex (LuxR_{Cb} and AraC_{Cb}).

FIGS. 6A-6B also show the effect of local negative feedback (the loops that subtract from the adders in FIGS. 6A-6B) that is ubiquitous in chemical binding (Eq. 24): when a free molecule binds to another, it gets used up such that less free molecule is available to bind, lowering its level. The ‘analogic’ promoter in FIGS. 6A-6B models the linear as well as saturating behavior seen at DNA promoters as described by Equations 17-24. Note that AraC has a repressory effect when it is not bound to the inducer but has an activatory effect when it is bound to the inducer in FIG. 6B.

### Modeling of Degradation Rates in the Presence of Binding Site

In the models described herein, as in others, free and DNA-bound transcription factor degrade at different rates⁸. Generally DNA can protect a transcription factor from degradation, thereby decreasing its degradation rate. The degradation process for a transcription factor can be described by the following reactions^{9,10}:

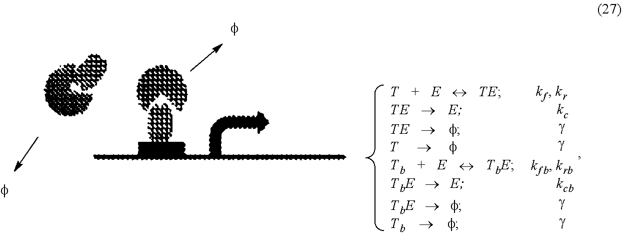

where T is the concentration of free transcription factor; T_{b} is the concentration of transcription factor bound to DNA; E is the concentration of free protein-degrading enzyme; k_{f} and k_{fb} are the forward reaction rates of the binding of free transcription factor and DNA-bound transcription factor to the protein-degrading enzyme, respectively; kᵣ and k_{rb} are the reverse reaction rates of the binding of free transcription factor and DNA-bound transcription factor to the protein-degrading enzyme, respectively; k_{c} and k_{cb} are the forward reaction rates of enzyme function and release for the enzyme-free-transcription-factor complex and the enzyme-DNA-bound-transcription-factor-complex, respectively; and γ is the dilution rate of total transcription factor due to cell growth. We assume that the degradation rate is not directly affected by the binding of inducers to transcription factors.

The set of ordinary differential equations which model the degradation process is:

$$\begin{matrix}\frac{d TE}{d t} = {k}_{f} \cdot T \cdot E - {k}_{r} \cdot TE - {k}_{c} \cdot TE - γ \cdot TE & ( 28.1 ) \\ \frac{d T}{d t} = - {k}_{f} \cdot T \cdot E + {k}_{r} \cdot TE - γ \cdot T & ( 28.2 ) \\ \frac{d {T}_{b} E}{d t} = {k}_{fb} \cdot {T}_{b} \cdot E - {k}_{rb} \cdot {T}_{b} E - {k}_{cb} \cdot {T}_{b} E - γ \cdot {T}_{b} E & ( 28.3 ) \\ \frac{d {T}_{b}}{d t} = - {k}_{fb} \cdot {T}_{b} \cdot E + {k}_{rb} \cdot {T}_{b} E - γ \cdot {T}_{b} & ( 28.4 )\end{matrix}$$

In steady state dTE/dt=0, dT_{b}E/dt=0, which leads to:

$$\begin{matrix}TE = \frac{T \cdot E}{K} ; where K = \frac{{k}_{r} + {k}_{c} + γ}{{k}_{f}} & ( 29.1 ) \\ {T}_{b} E = \frac{{T}_{b} \cdot E}{{K}_{b}} ; where {K}_{b} = \frac{{k}_{rb} + {k}_{cb} + γ}{{k}_{fb}} & ( 29.2 )\end{matrix}$$

The decay of free and bound transcription factor can be expressed by:

$$\begin{matrix}\begin{matrix}\frac{d T}{d t} = - {k}_{f} \cdot T \cdot E + {k}_{r} \cdot TE - γ \cdot T \\ = - ( {k}_{c} + γ ) \cdot TE = γ \cdot T\end{matrix} & ( 30.1 ) \\ \begin{matrix}\frac{d {T}_{b}}{d t} = - {k}_{fb} \cdot {T}_{b} \cdot E + {k}_{rb} \cdot {T}_{b} E - γ \cdot {T}_{b} \\ = - ( {k}_{cb} + γ ) \cdot {T}_{b} E = γ \cdot {T}_{b}\end{matrix} & ( 30.2 )\end{matrix}$$

Substituting Eq. 29 into Eq. 30, we get:

$$\begin{matrix}\frac{d T}{d t} = - \frac{( {k}_{c} + γ )}{K} \cdot T \cdot E - γ \cdot T & ( 31.1 ) \\ \frac{d {T}_{b}}{d t} = - \frac{( {k}_{cb} + γ )}{{K}_{b}} \cdot {T}_{b} \cdot E - γ \cdot {T}_{b} & ( 31.2 )\end{matrix}$$

The sum of free protein-degrading enzyme E and bound enzyme to the transcription factors (TE and T_{b}E) is equal to the total enzyme concentration (E_{T}):

E_{T}=E+TE+T_{b}E (32)

Substituting Eq. 29.1 and Eq. 29.2 into Eq. 32, we can express the concentration of free protein-degrading enzyme as:

$$E = \frac{{E}_{T}}{1 + \frac{T}{K} + \frac{{T}_{b}}{{K}_{b}}} \qquad ( 33 )$$

In the general case where there are multiple protein species that are degraded by enzyme E, the concentration of free protein-degrading enzyme can be described as:

$$E = \frac{{E}_{T}}{1 + {\sum }_{i}^{ } \frac{{T}_{i}}{{K}_{i}} + {\sum }_{j}^{ } \frac{{T}_{bj}}{{K}_{bj}}} \qquad ( 34 )$$

Where i pertains to different free proteins and transcription factors, and j is different bound transcription factors to DNA. In this model, the degradation of free transcription factors or proteins is significantly faster than the degradation of bound transcription factors to DNA such that most protein-degrading enzyme is typically free or associated with bound transcription factors. Therefore, if we assume that T/Kᵢ<<T_{bi}/K_{bi} the free protein-degrading enzyme concentration can be expressed by:

$$E = \frac{{E}_{T}}{1 + {\sum }_{j}^{ } \frac{{T}_{bj}}{{K}_{bj}}} \qquad ( 35 )$$

Substituting the general form of the free protein-degrading enzyme concentration (Eq. 35) into Eq. 31, the general decay of free and bound transcription factors can be modeled as:

$$\begin{matrix}\frac{d {T}_{i}}{d t} = - {μ}_{i} \cdot {T}_{i} - γ \cdot {T}_{i} & ( 36.1 ) \\ \frac{d {T}_{bi}}{d t} = - {μ}_{bi} \cdot {T}_{bi} - γ \cdot {T}_{bi} , & ( 36.2 ) \\ where \text{:} & \\ {μ}_{i} = \frac{( {k}_{ci} + γ )}{K} \frac{{E}_{T}}{( 1 + {\sum }_{j}^{ } \frac{{T}_{bj}}{{K}_{bj}} )} & ( 37.1 ) \\ {μ}_{bi} = \frac{( {k}_{cbi} + γ )}{{K}_{bi}} \frac{{E}_{T}}{( 1 + {\sum }_{j}^{ } \frac{{T}_{bj}}{{K}_{bj}} )} & ( 37.2 )\end{matrix}$$

### Modeling Transcription Factor Expression in the Presence of Binding Sites

The steady-state mass action model assumes that there is a balance between the overall production rate and the degradation rate of the transcription factor’:

$$\frac{d {T}_{Ti}}{d t} = G - {μ}_{i} \cdot {T}_{i} - {μ}_{bi} \cdot {T}_{bi} = γ \cdot {T}_{i} - γ \cdot {T}_{bi} , \qquad ( 38 )$$

where G is the total production rate. The sum of the free and the bound forms of transcription factor to DNA is equal to the total transcription factor (T_{Ti}=Tᵢ+T_{bi}):

$$\frac{1}{{μ}_{i} + γ} \cdot \frac{d {T}_{Ti}}{d t} = \frac{G}{{μ}_{i} + γ} - {T}_{Ti} + {T}_{bi} \frac{{μ}_{i}}{{μ}_{i} + γ} \cdot ( 1 - \frac{{μ}_{bi}}{{μ}_{i}} ) \qquad ( 39 )$$

In steady state we get:

$${T}_{Ti} = \frac{G}{{μ}_{eff}} + {T}_{bi} \cdot {θ}_{i} \qquad ( 40 )$$

Where μ_{eff} is given by:

$${μ}_{eff} = {μ}_{i} + γ = {μ}_{0 i} ( \frac{1}{1 + {\sum }_{j} \frac{{T}_{bj}}{{K}_{bj}}} + \frac{γ}{{μ}_{oi}} ) \qquad ( 41 )$$

### Where

$${μ}_{oi} = \frac{( {k}_{c} + γ )}{K} \cdot {E}_{T} ,$$

and me “protection parameter”

$${θ}_{i} = \frac{{μ}_{i}}{{μ}_{i} + γ} ( 1 - \frac{{μ}_{bi}}{{μ}_{i}} ) .$$

The protection parameter generally varies in the range 0≦θᵢ≦1, with two extreme cases:
1. θ=0: this situation can occur when the degradation rate of the bound TF is equal to the degradation rate of the free TF (μ_{bi}=μᵢ) or when the dilution rate dominates over the degradation rate (γ>>μᵢ).
2. θ=1: this situation can occur when the degradation of the bound TF is very slow compared to the degradation of the free TF, and the dilution rate is negligible compared with the free TF degradation rate.

### Positive-Feedback Model

Positive-feedback loops are commonly used motifs in genetic circuits and depending on their context exhibit different behavior, including bi-stability in toggle-switch circuits¹¹ and hysteresis in digital memory devices¹². While positive feedback has many different forms, the simplest form of genetic positive feedback is the production of a transcriptional activator by its promoter (FIGS. 7A and 7C): when an inducer (AHL/Arab) binds to an input transcription factor (LuxR/AraC), the resulting complex can bind to a promoter (Pₗᵤₓ/P_{BAD}) to stimulate expression of output transcription factors. If these output transcription factors are identical to the input transcription factors (LuxR/AraC), then a positive-feedback loop is created. High values of θ increase the effect of positive feedback through reduced degradation.

A schematic diagram that represents LuxR positive feedback is shown in FIG. 7B, where the total production rate and the degradation rate are calculated from Eq. 17 and Eq. 41 and shown below:

$$\begin{matrix}G = g \cdot ( {LuxR}_{Cb} + Basal ) & ( 42.1 ) \\ {μ}_{eff} = {μ}_{0} ( \frac{γ}{{μ}_{0}} + \frac{1}{1 + \frac{{LuxR}_{cb}}{{K}_{b}}} ) & ( 42.2 )\end{matrix}$$

where g is the production rate for induced promoter expression and Basal is the basal level. Similarly, the schematic diagram for AraC positive feedback is shown in FIG. 7B, where the total production rate and the degradation rate are calculated according to Eq. 17, Eq. 22-26, and Eq. 41 and shown below:

$$\begin{matrix}G = g \cdot ( {AraC}_{Cb} + Basal ) & ( 43.1 ) \\ {μ}_{eff} = {μ}_{0} ( \frac{γ}{{μ}_{0}} + \frac{1}{1 + \frac{{AraC}_{cb} + {AraC}_{b}}{{K}_{b}}} ) & ( 43.2 )\end{matrix}$$

The modeling and experimental results are presented in FIGS. 10A-10H.

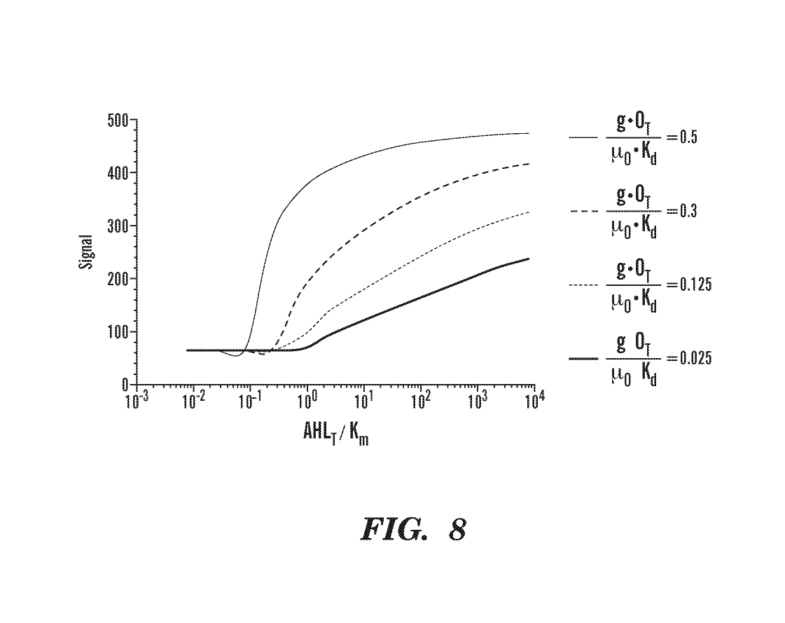

FIG. 8 shows the influence of increasing K_{d} (the dissociation of the AHL-LuxR complex to the promoter) on the positive-feedback signal. When K_{d} increases, the input dynamic range increases and the signal output decreases. To increase K_{d} but maintain signals at a high level, we constructed a positive-feedback-and-shunt (PF-Shunt) circuit: The shunt circuit helps maintain a low K_{d} while the positive feedback increases signal levels.

### Positive Feedback and Shunt Model (PF-Shunt)

The shunt circuit with positive feedback is depicted in FIG. 10A. The contribution of the shunt on the performance of the circuit can be summarized as follows:
1. Increasing the number of binding sites for transcription factors:
   I. For LuxR

$${μ}_{eff} = {μ}_{0} ( \frac{γ}{{μ}_{0}} + \frac{1}{1 + \frac{{LuxR}_{cb 1} + {LuxR}_{cb 2}}{{K}_{b}}} )$$

$${μ}_{eff} = {μ}_{0} ( \frac{γ}{{μ}_{0}} + \frac{1}{( 1 + \frac{{AraC}_{cb 1} + {AraC}_{cb 2} + {AraC}_{b 1} + {AraC}_{b 2}}{{K}_{b}} )} )$$

For AraC
II. For LuxR: LuxR_{CT}=LuxR_{C}+LuxR_{Cb1}+LuxR_{Cb2}
   For AraC: AraC_{CT}=AraC_{C}+AraC_{Cb1}+AraC_{Cb2}
      AraC_{T}−AraC_{CT}=AraC+AraC_{b1}+AraC_{b2}
III. For LuxR:

$${LuxR}_{T} = \frac{g}{{μ}_{eff}} + {LuxR}_{Cb 1} \cdot θ + {LuxR}_{Cb 2} \cdot θ$$

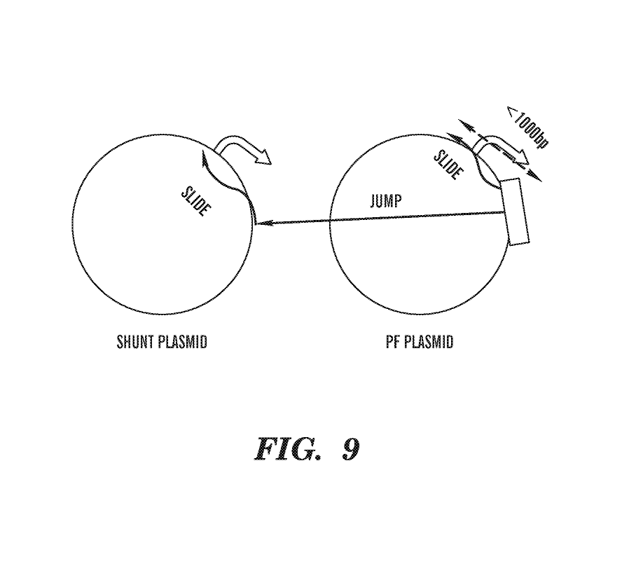

For AraC:

$${AraC}_{T} = \frac{g}{{μ}_{eff}} + {AraC}_{Cb 1} \cdot θ + {AraC}_{b 1} \cdot θ + {AraC}_{Cb 2} \cdot θ + {AraC}_{b 2} \cdot θ$$

where subscripts with “1” refer to the positive-feedback plasmid and subscripts with “2” refer to the shunt plasmid.
2. Increasing plasmid copy number and changing the diffusion time of the transcription factors: There are two ways that transcription factors search for their binding sites: the first is local and fast consisting of hops and slides on DNA, while the second is global and slow consisting of jumps¹³. FIG. 9 depicts these concepts. We assume that in the positive-feedback plasmid, the search is mainly local (the distance between the transcription factor production site and the promoter binding site is around 1 Kbp), while in the shunt plasmid, the search is global (the transcription factor needs to jump from the positive-feedback plasmid production site to the shunt-plasmid promoter binding site).

In the case that the plasmids are distributed uniform inside the cell, we can assume that the distance between the plasmid copy numbers Δx is approximately equal to (V/N)^{1/3}, where N is the total plasmid copy number and V is the cell volume. Since the jumping of transcription factors between the plasmids is described by a 3D diffusion process, we can express the jumping time as¹⁴:

$${τ}_{jump} = \frac{〈 Δ {x}^{2} 〉}{2 \cdot D} \to {τ}_{jump} = \frac{{( \frac{V}{N} )}^{2 / 3}}{2 \cdot D} \qquad ( 44 )$$

The forward reaction rate of TF binding to DNA is inversely proportional to the search time, such that:

K_{d1}=K₋₁₁·τ_{slide1} (45.1)

K_{d2}=K₋₁₂·(τ_{slide2}+τⱼᵤₘₚ). (45.2)

where K_{d1} and K_{d2} are the dissociation constants of the transcription factor for the PF plasmid and shunt plasmid respectively, K₋₁₁ and K₋₁₂ are proportional to the reverse reaction rates of the transcription factor binding to the promoter of the PF plasmid and shunt plasmid, respectively, and τ_{slide1} and τ_{slide2} are the sliding times of the transcription factor in the PF plasmid and shunt plasmid, respectively. If we assume that the sliding time is not dependent on the plasmid copy number, then dividing Eq. 45.1 by Eq. 45.2 yields:

$$\begin{matrix}\frac{{K}_{d 1}}{{K}_{d 2}} = \frac{ρ}{1 + \frac{β}{{N}^{2 / 3}}} & ( 4.61 ) \\ \frac{{τ}_{jump}}{{τ}_{slide 2}} = \frac{{V}^{2 / 3} \cdot {k}_{2}}{2 \cdot ln ( 2 ) \cdot D} \frac{1}{{N}^{2 / 3}} \to β = \frac{{V}^{2 / 3} \cdot {k}_{2}}{2 \cdot ln ( 2 ) \cdot D} & ( 4.62 ) \\ ρ = \frac{{K}_{- 11} \cdot {τ}_{slide 1}}{{K}_{- 12} \cdot {τ}_{slide 2}} , & ( 4.63 )\end{matrix}$$

where D is the diffusion coefficient, and (k₂=ln(2)/τ_{slide2}) is a rate constant that describes transcription-factor binding to the shunt-plasmid promoter.

We note two important points:

In our models, transcription-factor diffusion processes only influence the K_{d} of the shunt plasmid and not that of the PF plasmid. Therefore, K_{d1} is defined as the reference dissociation constant (when the distance between the TF gene and its cognate binding site on the same plasmid is less than 1 Kbp¹³ or the search type is local).

When we fit our model (FIGS. 10A-10H) to experimental data we found that ρ=1 indicating that sliding processes within DNA are similar between the plasmids and that it is the jumping across plasmids that leads to differences in K_{d} that vary with plasmid copy number.

The experimental and modeling results of the PF-shunt circuit for LuxR and AraC with different copy numbers are presented in FIGS. 1A-1E, FIGS. 2A-2E, and FIGS. 10A-10H. The fitting parameters are shown in Table 2.

### Modeling the P_{lacO} Promoter

Using transcriptional activators and repressors in multi-component circuits, we developed several synthetic analog gene circuits. The first circuit gives a wide-dynamic-range negative-slope logarithm (FIGS. 3A-3H) and the second circuit gives a power law (FIGS. 4E-4F). In both circuits, we used Lad and its cognate P_{laco} promoter. Herein, we present our model for the LacI-regulated promoter, P_{lacO}¹⁵. To do so, we capture the quantitative relationship between the inducer (IPTG) concentration and the free repressor (Lad) concentration. We can model the free Lad (LacI) and the IPTG-LacI complex (LacI_{C}) by a Hill function^{7,2}:

$${LacI}_{C} = {LacI}_{T} \frac{{( \frac{IPTG}{{K}_{m}} )}^{{h}_{1}}}{1 + {( \frac{IPTG}{{K}_{m}} )}^{{h}_{1}}} \qquad ( 47 )$$

Where LacI_{T} is the total Lad concentration, Kₘ is the dissociation constant between IPTG and LacI, and h₁ is the Hill coefficient which represents cooperativity between IPTG and Lad. The concentration of free Lad is expressed by:

LacI=LacI_{T}−LacI_{C} (48)

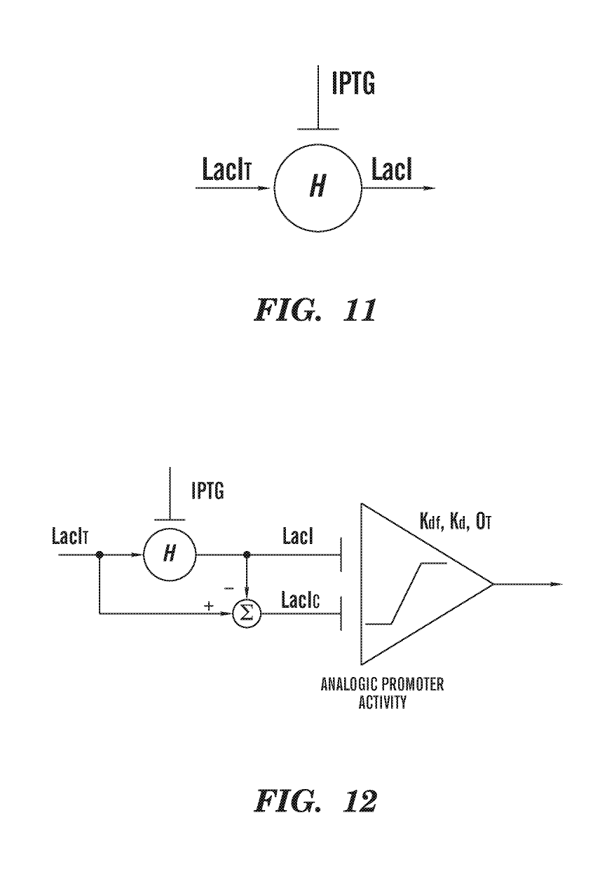

FIG. 11 shows the schematic diagram model of the binding reaction of IPTG and the LacI repressor.

We consider three possible binding states for the P_{lacO} promoter: (1) The promoter is empty with probability 1, (2) Free LacI repressor is bound to the promoter with probability LacI/K_{df}, and (3) IPTG-LacI complex (LacI_{C}) is bound to the promoter with probability LacI_{c}/K_{d}, where K_{df}<<K_{d}. The probability of the P_{lacO} promoter being in an open complex P is described by the following equation:

$$P = \frac{1}{1 + {( \frac{LacI}{{K}_{df}} )}^{ni} + {( \frac{{LacI}_{C}}{{K}_{d}} )}^{ni}} , \qquad ( 49 )$$

where ni represents the cooperativity between Lad and the promoter. In the work described herein, we used the P_{lacO} promoter in two networks:
A wide-dynamic-range negative-slope logarithm circuit (FIGS. 3A-3H): In this case, the IPTG concentration is high such that the majority of the Lad protein is unbound to DNA.
Power-law circuit (FIGS. 4E-4F): In this case, the P_{lacO} promoter is on a low copy plasmid and Lad is produced from a high-copy plasmid. The IPTG level varies in this circuit.
   In both cases, we can assume that the DNA-bound Lad is very small compared to the unbound LacI and also that the DNA-bound IPTG-LacI complex is small compared to the unbound IPTG-LacI complex. In this case, we assume a protection parameter θ=0 (Eq. 40). The schematic diagram for P_{lacO} in steady state is shown in FIG. 12.

### Modeling the WDR Negative-Logarithm Circuit

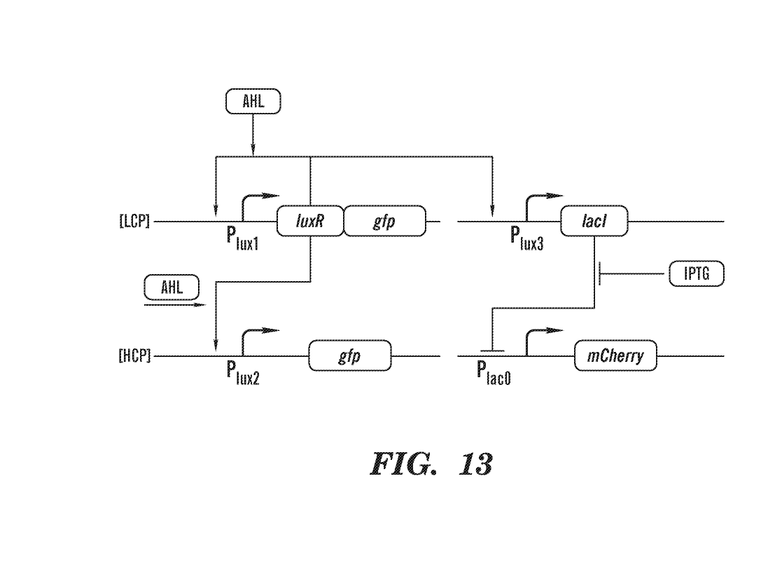

The genetic circuit of the wide-dynamic-range negative-slope is shown in FIG. 13. The circuit includes a two-stage cascade; the first stage is the PF-shunt LuxR circuit, which gives a wide-dynamic-range positive slope for expressing Lad, and the second stage is the control of the P_{lacO} promoter by LacI, which, due to its repressing action, yields a negative slope. FIG. 13 shows the network diagram of the genetic circuit.

The WDR PF-shunt subcircuit of FIG. 13 is shown in FIG. 14A. An analog schematic diagram that represents this subcircuit is shown in FIG. 14B and the modeling and experimental results that correspond to this subcircuit are shown in FIG. 3B and FIG. 14C.

The dissociation constant for binding of LuxR to the Pₗᵤₓ promoter is defined according to Eq. 47. We use

$$\frac{{K}_{d 1}}{{K}_{d 2}} = \frac{ρ}{1 + \frac{β}{{N}^{2 / 3}}} ,$$

where N is sum of the high and the low copy number and

$$\frac{{K}_{d 1}}{{K}_{d 3}} = \frac{ρ}{1 + \frac{β}{{N}^{2 / 3}}} ,$$

where N is low copy number. Subscripts ‘1’, ‘2’, and ‘3’ correspond to the Pₗᵤₓ₁, Pₗᵤₓ₂, and Pₗᵤₓ₃ promoters in FIG. 13. Since the number of DNA binding sites for the LuxR transcription factor at sites 1 and 3 are identical, we use values for O_{T3}=O_{T1}.

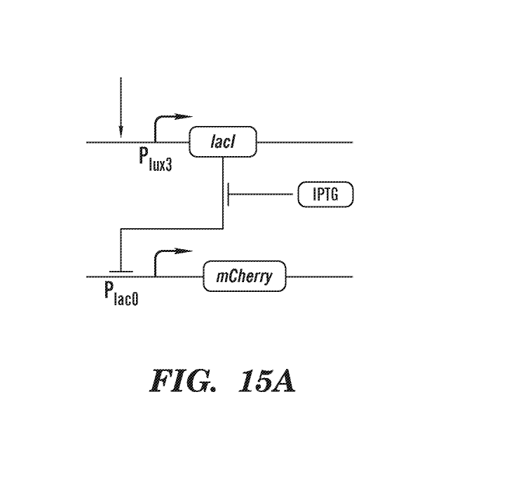

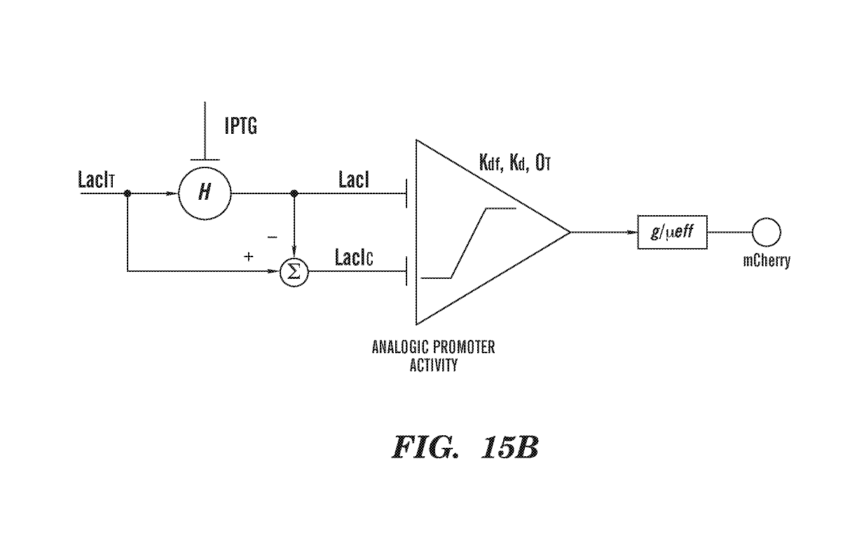

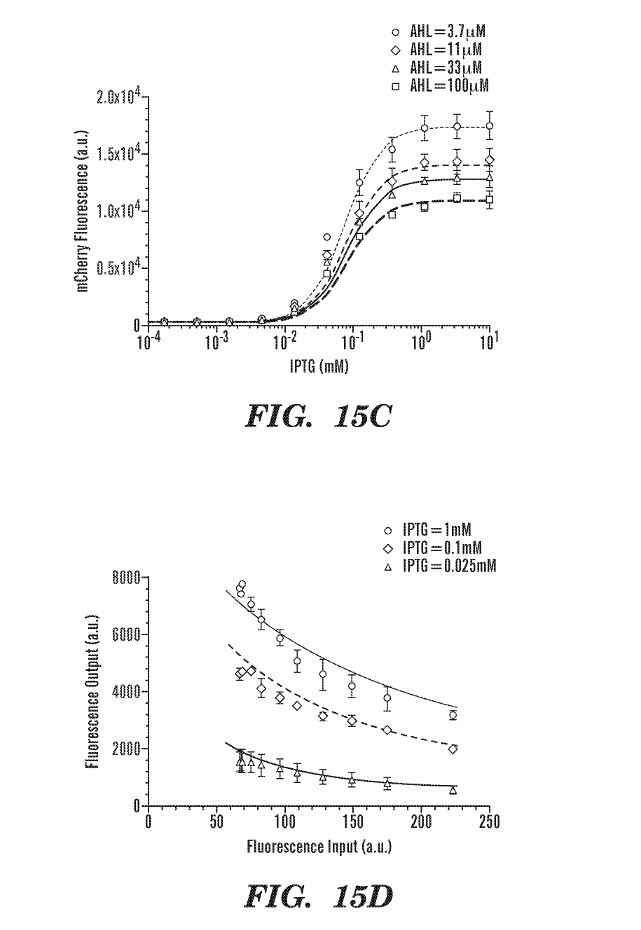

The experimental characterization and the modeling results of the P_{lacO} promoter are shown in FIGS. 15A-15D. The total production rate of Lad is calculated according to:

G=g·O_{T}·P, (50)

where g is the production rate, O_{T} is number of P_{lacO} binding sites, and P is the probability of the P_{lacO} promoter being in an open complex (Eq. 49). Since the output of the P_{lacO} promoter is the mCherry reporter protein, the degradation rate is calculated according to:

μ_{eff}=μ₀+γ (51)

Model parameters are listed in Table 2. We found that the ratio

$$\frac{{K}_{df}}{{K}_{d}} = 9 \times {10}^{- 4}$$

is consistent with published parameters¹⁶.

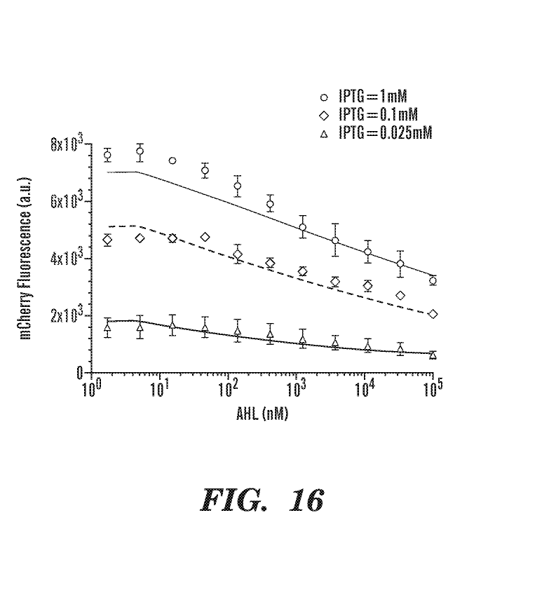

By combining the WDR PF-shunt subcircuit of FIGS. 14A-14C and the P_{lacO} module of FIG. 3D and FIGS. 15A-15D, we achieve a wide-dynamic-range negative-slope logarithm circuit as shown in FIG. 13. The experimental and modeling results of this overall wide-dynamic-range negative-slope circuit are presented in FIGS. 3A-3H and FIG. 16.

### Modeling the Power Law Circuit

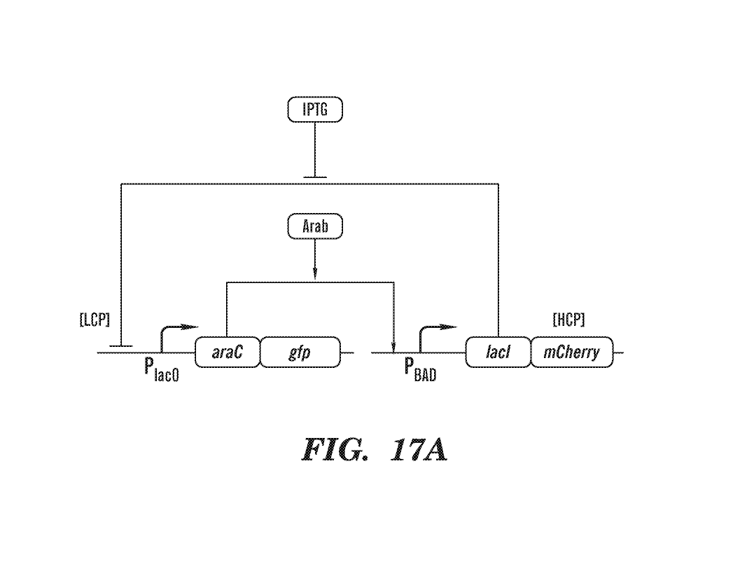

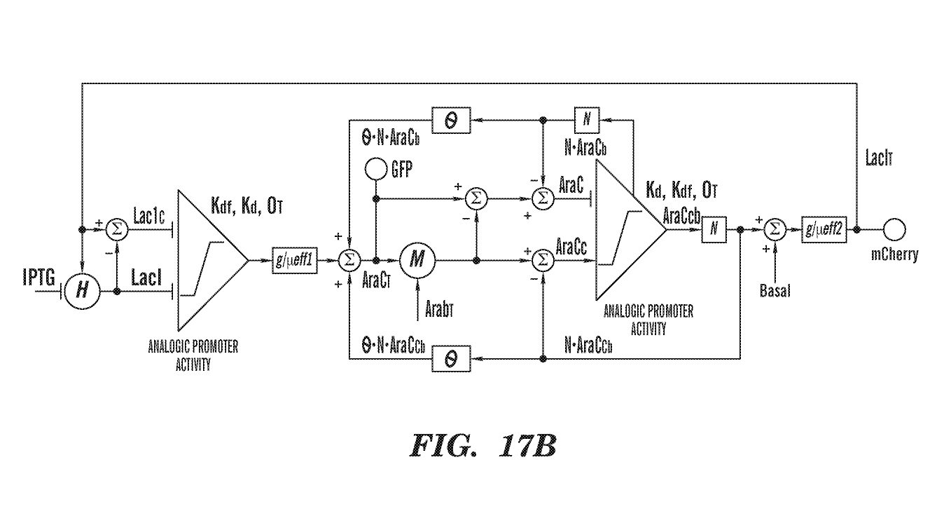

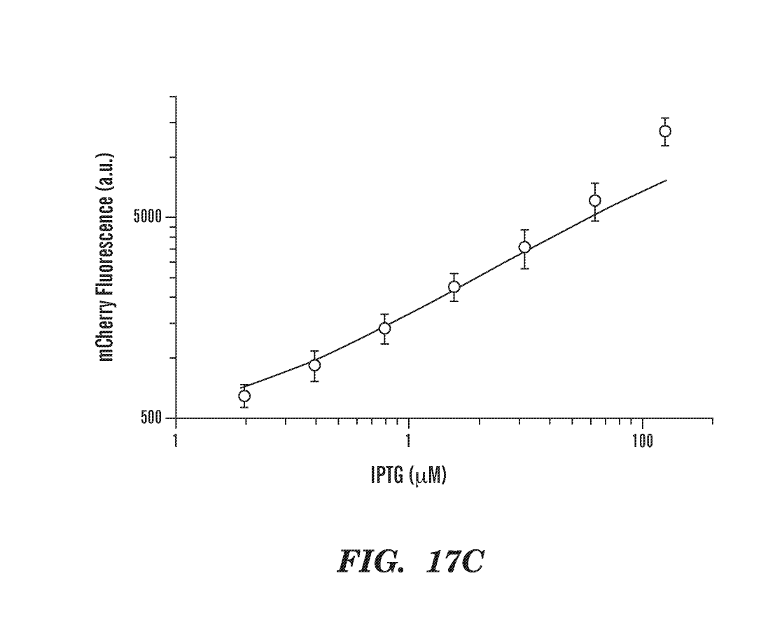

We used negative feedback to create a genetic power-law circuit (FIG. 4E and FIG. 17A). The circuit includes a two-stage cascade with negative feedback where the first stage is involves an AraC-P_{BAD} feedforward path and the second stage involves a LacI P_{lacO} feedback path. The analog schematic diagram of the power-law function circuit is presented in FIG. 17B, where:

$$\begin{matrix}{μ}_{eff 1} = {μ}_{0} ( \frac{γ}{{μ}_{0}} + \frac{1}{( 1 + \frac{{AraC}_{cb 1} + {AraC}_{cb 2} + {AraC}_{b 1} + {AraC}_{b 2}}{{K}_{b}} )} ) & ( 52.1 ) \\ {μ}_{eff 2} = {μ}_{0} + γ & ( 52.2 )\end{matrix}$$

N is the copy number of the high copy plasmid (HCP). The experimental and modeling results of the power-law circuit are shown in FIG. 4F and FIG. 17D.

### LuxR-Based Open Loop Circuits

We constructed four open loop circuits to test the effect of adding a shunt plasmid. The first circuit is shown in FIG. 18A, where the transcription factor and its promoter are on the same low-copy plasmid (LCP). The second circuit is shown in FIG. 18C, where the transcription factor is on a LCP and its promoter is on a different high-copy plasmid (HCP). In FIGS. 18B and 18D, we fused LuxR to GFP and repeated the LCP and HCP experiments of FIGS. 18A and 18C respectively.

The experimental and modeling results of the open-loop circuits are shown in FIGS. 19A-19C. In FIGS. 19A and 19B, the concentration of the inducer AHL was varied and the expression of mCherry or GFP was measured. Model parameters are shown in Table 2. In FIG. 19C, we tested GFP fluorescence of the circuit without any addition of AHL to demonstrate that high levels of LuxR expression (IPTG=10 mM) led to no repression of the P₁ promoter.

### AraC-Based Open Loop Circuits

We constructed two open loop circuits with AraC. The first circuit is shown in FIG. 20A, where the transcription factor is on a LCP and its promoter is on a different high-copy plasmid (HCP). The second circuit is shown in FIG. 20B, where we fused AraC to GFP. The experimental results and modeling fits are shown in FIG. 20C. Model parameters are shown in Table 2.

### Dummy Shunt Circuit

To test the specific effect of the shunt on linearization, we constructed a new circuit (FIG. 21A) which includes a “dummy” shunt for the AraC-GFP transcription factor that was based on the Pₗᵤₓ promoter. We compared these results to AraC-GFP positive feedback without a shunt. The experimental data is shown in FIG. 21B and demonstrates that the dummy shunt has negligible effects on the transfer function.

### Mathematical Models for Synthetic Analog Genetic Circuits

As described herein, we fit our experimental results to simple mathematical approximations which enable straightforward analog circuit design. These approximations are not based on physical parameters as discussed in also herein, and are useful in allowing quick design and insights into circuit behavior.

### Simple Mathematical Model for the WDR Positive-Logarithm Circuit

General genetic circuits including our wide-dynamic-range PF-shunt circuit can be empirically approximated by a simple Hill function⁸:

$$f ( {I}_{n} ) = a \cdot \frac{{( \frac{{I}_{n}}{b} )}^{n}}{1 + {( \frac{{I}_{n}}{b} )}^{n}} + d , \qquad ( 53 )$$

where Iₙ is the inducer concentration (AHL, Arab), n is the Hill coefficient, a is an amplification parameter, d is the basal level of expression and f( ) represents the output. The Hill function xⁿ/(1+xⁿ) can be re-written as:

$$\frac{{x}^{n}}{1 + {x}^{n}} = \frac{( {x}^{n} + 1 ) - 1}{1 + {x}^{n}} = 1 - {( 1 + {x}^{n} )}^{- 1} = 1 - {e}^{- l n ( 1 + {x}^{n} )} \qquad ( 54 )$$

For small values of ln(1+xⁿ), we get:

$$\frac{{x}^{n}}{1 + {x}^{n}} \approx 1 - ( 1 - ln ( 1 + {x}^{n} ) ) = ln ( 1 + {x}^{n} ) \qquad ( 55 )$$

Then, we approximate our PF-shunt output as:

$$f ( {I}_{n} ) = a \cdot ln ( 1 + {( \frac{{I}_{n}}{b} )}^{n} ) + d \qquad ( 56 )$$

For (Iₙ/b)ⁿ>1, we can approximate Eq. 56 as:

$$f ( {I}_{n} ) = a \cdot n \cdot ln ( \frac{{I}_{n}}{b} ) + d \qquad ( 57 )$$

In practice, a and n are represented by one parameter a′=an and n is set to 1 in all fits.

Because log-domain electronic circuits obey the exponential laws of Boltzmann thermodynamics like biochemical circuits do, highly accurate biochemical functions and Hill-function approximations thereof can be implemented by analog circuits that only use a single transistor or a handful of transistors^{1,20}. Therefore, the ln(1+x) function is a good approximation for describing the input-output behavior of electronic circuits as well.

### Simple Mathematical Model for the WDR Negative-Logarithm Circuit

The wide-dynamic-range negative-slope circuit includes two stages:
(1) A wide-dynamic-range positive-slope circuit fit to as

$${a}_{1} \cdot ln ( 1 + \frac{AHL}{{b}_{1}} ) + d \qquad ( Eq . 56 )$$

shown in FIG. 24A.
(2) The output of P_{lacO} promoter can be approximated by a Hill function:

$$f ( {LacI}_{T} ) = {a}_{2} \cdot \frac{1}{1 + \frac{{LacI}_{T}}{{b}_{2}}} \qquad ( 58 )$$

According to the approximation of Eq. 55, P_{lacO} promoter activity is then well-fit by:

$$\begin{matrix}\frac{1}{1 + x} = {e}^{- l n ( 1 + x )} ≅ 1 - ln ( 1 + x ) & ( 59.1 ) \\ f ( {lacI}_{T} ) = {d}_{2} - {a}_{2} \cdot ln ( 1 + \frac{{LacI}_{T}}{{b}_{2}} ) & ( 59.2 )\end{matrix}$$

The fitting results for P_{lacO} promoter activity are shown in FIG. 24B. Substituting Eq. 56 in Eq.59 we find that the output of our two-stage cascade can be fit by:

$$f ( AHL ) = {d}_{2} - {a}_{2} \cdot ln ( 1 + \frac{{a}_{1}}{{b}_{2}} \cdot ln ( 1 + \frac{AHL}{{b}_{1}} ) + \frac{{a}_{1}}{{b}_{2}} ) \qquad ( 60 )$$

The fitting results are shown in FIG. 24C. Since we expressed Lad in a LCP and IPTG is high (the dissociation constant of the IPTG-LacI complex binding to DNA is large), then the ratio a₁/b₂<1. Using the approximation ln(1+z) z (for z<<1), we can approximate Eq. 60 by an equation of the form:

$$f ( AHL ) = {d}_{2} - c \cdot ln ( 1 + \frac{AHL}{{b}_{1}} ) \qquad ( 61 )$$

For 1<<AHL/b₁, we get a negative-slope logarithm function:

$$f ( AHL ) = {d}_{2} - c \cdot ln ( \frac{AHL}{{b}_{1}} ) \qquad ( 62 )$$

External tuning of the multi-stage analog circuits described herein via inducers is not essential in the frameworks described herein, which is an advantage for the scalability of our circuits in situations where an inducer may be not be available. For example, FIGS. 24E-24F show that the WDR negative-logarithm function can be achieved without the need for external tuning of Lad repression with the inducer IPTG: We tagged LacI with a C-terminal ssrA-based degradation tag (TSAANDENYALVA²³) and expressed it with a weaker RBS (RBS3, Table 4) (FIG. 24E) to tune expression rather than using an inducer, and obtained good experimental results (FIG. 24F).

### Simple Mathematical Model for the Log-Linear Adder Circuit

The log-linear adder circuit can be fit by the simple expression, indicating a sum of log-transformed inputs:

$$f ( AHL , Arab ) = {a}_{1} ln ( \frac{AHL}{{b}_{1}} ) + {a}_{2} ln ( \frac{Arab}{{b}_{2}} ) \qquad ( 63 )$$

### Simple Mathematical Model for the Ratiometer Circuit

The ratiometer can be fit by the simple mathematical expression, indicating a difference between log-transformed inputs:

$$f ( AHL , Arab ) = Const - {a}_{1} ln ( \frac{AHL}{{b}_{1}} ) + {a}_{2} ln ( \frac{Arab}{{b}_{2}} ) \qquad ( 64.1 )$$

In the case that a₁=a₂=a:

$$f ( AHL , Arab ) = Const + a ln ( \frac{Arab}{AHL} \cdot \frac{{b}_{1}}{{b}_{2}} ) \qquad ( 64.2 )$$

### Simple Mathematical Model for the Power Law Circuit

In FIG. 17A, we presented a power-law genetic circuit and derived a detailed biochemical model that captures its behavior. Here, we derive a simple mathematical model of its operation.

From FIG. 17A,

$${AraC}_{T} = \frac{{G}_{1}}{1 + \frac{{LacI}_{T}}{{K}_{{d}_{f}}} ( \frac{1}{1 + {( \frac{IPTG}{{K}_{m}} )}^{{h}_{1}}} )} ,$$

from the LCP. Here, G₁ represents maximal production from the P_{lacO} promoter. Similarly, from the HCP,

$${LacI}_{T} = \frac{{G}_{2}}{1 + \frac{{K}_{d}}{Ara {C}_{T}}}$$

where G₂ represents maximal production from the P_{BAD} promoter. These two equations need to be consistent as per the negative-feedback loop of FIG. 17A. Hence, if we substitute the AraC_{T} term from the first equation into the second equation and solve for the LacI_{T} term, we get:

$${LacI}_{T} = \frac{\begin{matrix}- {K}_{df} ( 1 + {( \frac{IPTG}{{K}_{m}} )}^{{h}_{1}} ) ( 1 + \frac{{G}_{1}}{{K}_{d}} ) + \\ \sqrt{\begin{matrix}{( {K}_{df} ( 1 + {( \frac{IPTG}{{K}_{m}} )}^{{h}_{1}} ) ( 1 + \frac{{G}_{1}}{{K}_{d}} ) )}^{2} + \\ 4 \frac{{G}_{2} {G}_{1} {K}_{df}}{{K}_{d}} ( 1 + {( \frac{IPTG}{{K}_{m}} )}^{{h}_{1}} )\end{matrix}}\end{matrix}}{2} \qquad ( 65 )$$

According to Eq. 46.1, for the LacI production from the HCP we get:

$$\begin{matrix}{K}_{d} \to {K}_{d} \cdot {N}_{HCP} \cdot ( 1 + \frac{β}{{( {N}_{HCP} + {N}_{LCP} )}^{2 / 3}} ) & ( 66.1 ) \\ {G}_{2} \to {N}_{HCP} {G}_{2} & ( 66.2 )\end{matrix}$$

Similarly, from Eq. 46.1, for the AraC production from the LCP we get:

$${K}_{df} \to {K}_{df} ( 1 + \frac{β}{{( {N}_{HCP} + {N}_{LCP} )}^{2 / 3}} ) \qquad ( 67 )$$

For large N_{HCP} we get:

$${LacI}_{T} = \frac{\sqrt{4 \frac{{G}_{2} {G}_{1} {K}_{df}}{{K}_{d}} ( 1 + {( \frac{IPTG}{{K}_{m}} )}^{{h}_{1}} )}}{2} \qquad ( 68 )$$

In the range where

$${( \frac{IPTG}{{K}_{m}} )}^{{h}_{1}} >> 1 \to {LacI}_{T} ∝ {( \frac{IPTG}{{K}_{m}} )}^{{h}_{1} / 2}$$

Thus, we have a power-law circuit as confirmed by the measurements of FIGS. 17A-17C and as shown by FIG. 27.

### Mixed Analog-Digital Circuits

Analog functions can be integrated with digital control as a powerful mixed-signal strategy for tuning dynamic circuit behavior. To demonstrate such functionality, we built a positive-logarithm circuit that could be toggled by the presence or absence of an input inducer (FIG. 28A). This toggling was achieved by using a hybrid promoter (P_{lacO/ara}) repressed by Lad and activated by AraC, as the output of the AraC-based positive-logarithm circuit. In the absence of IPTG, the output of the circuit was OFF with respect to the arabinose input; whereas in the presence of IPTG, the output of the circuit was a wide-dynamic-range positive logarithm on the arabinose input (FIG. 28B). We found that the arabinose-to-GFP transfer function was well-fit by a simple mathematical function of the form ln(1+x), in the presence of IPTG (when the switch is “ON”).

The same circuit can implement a negative-logarithm circuit with AHL as its input that can be digitally toggled by the presence or absence of arabinose. As shown in FIG. 28C, this circuit implements a negative logarithm in the presence of arabinose whereas it is shut OFF in the absence of arabinose. This circuit requires no addition of external IPTG to function, similar to the circuit in FIG. 24E. Thus, it demonstrates that complex mixed-signal functions can be implemented and scaled without the need for additional external inducer inputs.

### A Double-Promoter PF-Shunt Circuit

We constructed a new wide-dynamic-range PF-shunt circuit with two identical promoters on the shunt HCP. The circuit is shown in FIG. 29A. The PF LCP has a single P_{BAD} promoter and the shunt HCP has two identical P_{BAD} promoters. The output of the PF LCP with this double-promoter shunt circuit is a wide-dynamic-range positive logarithm with higher gain than the PF LCP with a single promoter shunt HCP circuit (FIG. 29B). These results indicate that the input-to-output gain of our circuits can be tuned. We found that the arabinose-to-mCherry transfer function is well fit by a simple mathematical function of the form ln(1+x).

### Dynamic Measurements of Analog Genetic Circuits

Time-course experiments were performed on our AHL wide-dynamic-range circuit positive-logarithm circuit described herein (the circuit of FIG. 2B). E. coli strains were picked from LB agar plates and grown overnight at 37° C. and 300 rpm in 3 mL of LB medium with appropriate antibiotics and inducers (carbenicillin (50 μg/ml), kanamycin (30 μg/ml) and AHL 3OC6HSL). Overnight cultures were diluted 1:100 into 3 mL of LB medium with added antibiotics and were then incubated at 37° C. and 300 rpm for 20 minutes. 200 μl of culture was then moved into a 96-well plate, combined with inducers, and incubated in a VWR microplate shaker at 37° C. and 700 rpm.

Once the diluted cultures grew to an OD600 of ˜0.5 (˜3 hours), 20 μl of culture was moved into a new 96-well plate containing 200 μl of media, antibiotics, and inducers and then incubated in a VWR microplate shaker at 37° C. and 700 rpm.

At OD600 ˜0.5, 50 μl of culture was moved to a 96-well plate with 200 μl of PBS and taken to a FACS machine for measurement. In addition, 20 μl of culture was moved into a new 96-well plate containing 200 μl of media, antibiotics, and inducers and then incubated in a VWR microplate shaker at 37° C. and 700 rpm. This iterative dilution, growth, and measurement process was repeated over 10 hours.

The experimental results corresponding to different times are shown in FIG. 30. The GFP output of the PF-shunt circuit is a wide-dynamic-range positive logarithm and well-fit by a simple mathematical function of the form ln(1+x) at 5 hours, 7.5 hours, and 10 hours.

### Sensitivity Analysis

Herein, we explore the effects of our circuit motifs described herein on sensitivity. If we change the input signal Iₙ to Iₙ+ΔIₙ and measure the response Δf in the output signal f, then the sensitivity is defined as²⁴:

$$S = \frac{Δ f / 〈 f 〉}{Δ {I}_{n} / 〈 {I}_{n} 〉} \qquad ( 69 )$$

where < > denotes the stationary values of Iₙ and f.

We calculate the sensitivity for input-output transfer curves that fit a log-linear function and for input-output transfer curves that fit a Hill function:

If the input-output transfer curve does not saturate and fits a log-linear function (Eq. 56); for example, in our PF-and-shunt circuits, then:

$$\begin{matrix}a . f = a \cdot ln ( 1 + \frac{{I}_{n}}{b} ) + d & \\ b . Δ f = a \cdot \frac{Δ {I}_{n}}{( 1 + \frac{〈 {I}_{n} 〉}{b} ) \cdot b} & ( 70.1 ) \\ c . \frac{Δ f}{〈 f 〉} = \frac{\frac{Δ {I}_{n}}{〈 {I}_{n} 〉} \cdot \frac{〈 {I}_{n} 〉}{b}}{( 1 + \frac{〈 {I}_{n} 〉}{b} ) \cdot ( ln ( 1 + \frac{〈 {I}_{n} 〉}{b} ) + \frac{d}{a} )} & ( 70.2 )\end{matrix}$$

d. In the limit that Δ→0, the sensitivity, defined in Equation (69), is given by:

$$e . S = \frac{〈 {I}_{n} 〉}{b + 〈 {I}_{ n} 〉} \cdot \frac{1}{ln ( 1 + \frac{〈 {I}_{n} 〉}{b} ) + \frac{d}{a}} \qquad ( 70.3 )$$

If the input-output transfer curve saturates and fits a Hill function (Eq. 53), for example, in circuits with strong positive feedback and in circuits with open-loop motifs, then:

$$\begin{matrix}f . f = a \cdot \frac{{I}_{n}^{n}}{{I}_{n}^{n} + {b}^{n}} + d & \\ g . Δ f = a \cdot n \frac{{〈 {I}_{n} 〉}^{n - 1}}{{〈 {I}_{n} 〉}^{n} + {b}^{n}} \cdot \frac{{b}^{n}}{{〈 {I}_{n} 〉}^{n} + {b}^{n}} Δ {I}_{n} & ( 71.1 ) \\ h . Δ f = n \frac{{b}^{n}}{{〈 {I}_{n} 〉}^{n} + {b}^{n}} \cdot a \frac{{〈 {I}_{n} 〉}^{n}}{{〈 {I}_{n} 〉}^{n} + {b}^{n}} \cdot \frac{Δ {I}_{n}}{〈 {I}_{n} 〉} & ( 71.2 ) \\ i . In the limit that Δ \to 0 , the sensitivity is given by \text{:} & \\ j . S = n ( \frac{〈 f 〉 - d}{〈 f 〉} ) ( 1 - \frac{〈 f 〉 - d}{a} ) & ( 71.3 )\end{matrix}$$

FIGS. 31A-31E show the sensitivity for our analog PF-shunt circuits versus various controls. For the AraC-based circuits, our analog motifs (PF LCP with a HCP shunt; PF LCP with a double-promoter HCP shunt) showed peak sensitivities comparable to circuits with positive-feedback only (FIG. 31A) or with open-loop operation (FIG. 31B). Notably, across much of the input range, our analog motifs had higher sensitivities than the other motifs. For the LuxR-based circuits, our analog PF-shunt motif (PF LCP with a HCP shunt) had comparable or higher sensitivities than circuits with positive feedback only (FIG. 31C) or with open-loop operation (FIG. 31E). Thus, our analog motifs compare favorably in relation to other commonly used circuit motifs in synthetic biology.

In FIG. 2D, we describe a circuit motif that can be toggled between analog and digital behaviors by the addition of a CopyControl (CC) reagent to change the copy number of a variable-copy plasmid (VCP) containing a LuxR-based positive-feedback loop. As shown in FIG. 31D, the peak sensitivity of this circuit when operated with strong positive feedback that leads to digital behavior (CC ON) exceeds that of the circuit when operated with graded positive feedback that yields analog behavior (CC OFF) by a factor of ˜2.6. However, the sensitivity of the circuit that exhibits digital behavior is significantly lower than the sensitivity of the circuit that exhibits analog behavior for over two orders of magnitude. The sensitivity of the digital circuit is also significantly lower than the sensitivity of an analog circuit with a PF LCP and a HCP shunt for over two orders of magnitude, and here the peak sensitivity is only lower by a factor of 1.5. Thus, as may be expected from the nature of their input-output curves, digital and analog behavior provide complementary advantages: better sensitivity over a narrow dynamic range (digital), or better sensitivity over a wide dynamic range (analog). Both circuits are useful depending on the application, in both biological and electronic design.

As described in Madar et al. and illustrated in FIG. 32A, we define the output dynamic range (ODR) as the difference between the 90% and 10% of the maximal output (a) and the input dynamic range (IDR) as the ratio of the input concentrations required for 90% and 10% of the maximal output²⁵. This definition allows us to define the parameter a in Eq. 70.3, which is the slope of the relationship between the output f and log(Iₙ):

$$a = \frac{0.8 \cdot α}{log ( IDR )} \qquad ( 72 )$$

Rewriting Eq. 70.3 by substituting in Eq. 72, the sensitivity of our analog circuits can be defined as:

$$S = \frac{〈 {I}_{n} 〉 / b}{1 + 〈 {I}_{n} 〉 / b} \cdot \frac{1}{ln ( 1 + 〈 {I}_{n} 〉 / b ) + 1.25 \cdot \frac{Basal}{α} \cdot log ( IDR )} , \qquad ( 73 )$$

where d in Eq. 70.3, is defined as the basal level (Basal) of the transfer function.

Based on Eq. 73, the sensitivity is influenced by the IDR and the ratio between the basal level and the maximum output, a. FIGS. 33A-33B show the tradeoff between sensitivity and IDR for different values of the basal level and maximum output. As seen in FIG. 33A, for low basal-to-maximum-output ratios, the influence of the IDR on the sensitivity is very small, whereas for high basal-to-maximum output ratios, increasing the IDR decreases the sensitivity. This relationship can explain the enhanced sensitivities of the AraC-based circuits compared with the LuxR-based circuits in FIGS. 31A-31E, as the AraC-based circuits were observed to have lower basal levels than LuxR-based circuits⁷. This analysis also indicates that reducing the basal level (e.g., via the use of riboregulators²⁶) could enhance the sensitivity of future designs.

### Minimal Models for Linearization Via Positive Feedback

In this section, we describe minimal models for graded positive feedback without a shunt and for graded positive feedback with a shunt that are based only on biochemical reactions. These minimal models, while sacrificing some accuracy compared to our previously described complex biophysical models, nevertheless provide insight and intuition about the mechanism of linearization enabled by positive feedback. For example, they reveal that the use graded positive-feedback enables linearization and wide-dynamic-range operation on just a single plasmid if the K_{d} for biochemical binding of the transcription-factor complex to DNA is appropriate: The strength of the positive feedback, which depends on this K_{d}, must not be too strong to yield latching or reduced-dynamic-range analog operation; it must not be too weak to make the positive feedback ineffective at compensating for saturating effects. Indeed, our scheme for widening the log-linear dynamic range of operation via graded positive feedback is conceptually general and applies to both genetic and electronic circuits: expansive sin h-based linearization of compressive tan h-based functions in log-domain electronic circuits²⁷ is analogous to the use of expansive positive-feedback linearization of compressive biochemical binding functions in log-domain genetic circuits, and such circuits show an optimum as well.

The set of the biochemical reactions which describe graded positive feedback without a shunt can be described by:

Iₙ+T⇄T_{C} (79.1)

T_{C}+DNA_{LCP}⇄G_{LCP} (79.2)

G_{LCP}→G_{LCP}+T (79.3)

T→φ (79.4)

Eq. 79.1 describes the binding reaction of the inducer to the transcription factor. Eq. 79.2 describes the binding of the complex to the promoter. Eq. 79.3 describes the positive feedback loop and Eq. 79.4 describes the degradation of the transcription factor due to dilutive cell division. We define the input dynamic range (IDR) as the ratio of the input concentrations required for 90% and 10% of the maximal output²⁵ as shown in FIG. 32A.

A minimal set of biochemical equations for graded positive feedback involving a shunt are given by:

Iₙ+T⇄T_{C} (80.1)

T_{C}+DNA_{LCP}⇄G_{LCP} (80.2)

T_{C}+DNA_{HCP}⇄G_{HCP} (80.3)

G_{LCP}→G_{LCP}+T (80.4)

G_{HCP}→G_{HCP}+Signal (80.5)

T→φ (80.6)

Signal→φ (80.7)

Eq. 80.1 describes the binding of the inducer to the transcription factor. Eq. 80.2 and Eq. 80.3 describe the binding of the complex to the promoter on the LCP and HCP. For simplicity in the minimal model, we assume that the forward and reverse rates of binding to the LCP and HCP are equal. Eq. 80.4 describes the positive-feedback loop and Eq. 80.5 describes the expression of the signal by the shunt. The final two reactions describe the degradation of the transcription factor and the signal, which we assume is identical due to dilutive cell division. The simulation results are shown in FIG. 34B. By decreasing the probability of binding of the transcription factor to the promoter, or by adding shunt binding sites, we can generate graded positive feedback with wide input dynamic range.

FIGS. 34A-34B illustrate that graded positive feedback, whether accomplished by altering the K_{d} in Eqs. 79.1-79.4 or by altering the copy-number ratio in Eqs. 80.1-80.7, widens the log-linear dynamic range of operation. FIGS. 34C-34D show that the maximum input dynamic range (IDR) of operation in both of these cases occurs when the positive feedback is not too strong or too weak. The exact optimum will depend on the details of the biochemical models and these results correspond to our minimal models. The heat maps shown in FIGS. 34E-34G reveal how the IDR, PF, and shunt HCP signals change as the (K_{d}, HCP/LCP ratio) vector is varied. FIG. 34E visually echoes the findings of FIGS. 34C-34D, which also reveal that the IDR is maximized when the positive feedback is not too strong or too weak.

### Materials and Methods

All fluorescence intensities presented in the data described herein were smoothed using Matlab.

Strains and Plasmids.

All plasmids in this work were constructed using basic molecular cloning techniques (Supplementary Information). E. coli 10β (araD139 Δ(ara-leu)7697 fhuA lacX74 galK (φ80 Δ(lacZ)M15) mcrA galU recA1 endA1 nupG rpsL (StrR) Δ(mrr-hsdRMS-mcrBC)) or E. coli EPI300 (F− mcrA Δ(mrr-hsdRMS-mcrBC) Φ80dlacZΔM15 ΔlacX74 recA1 endA1 araD139 Δ(ara, leu)7697 galU galK λ-rpsL (StrR) nupG trfA tonA), where noted, were used as bacterial hosts for the circuits in FIGS. 1A-4F.

Circuit Characterization.

Overnight cultures of E. coli strains were grown from glycerol freezer stocks at 37° C. 300 rpm in 3 mL of Luria-Bertani (LB)-Miller medium (Fisher #BP1426-2), with appropriate antibiotics: carbenicillin (50 μg/ml), kanamycin (30 μg/ml), chloramphenicol (25 μg/ml). The inducers used were arabinose, isopropyl-β-D-1-thiogalactopyranoside, and AHL 3OC6HSL (Sigma-Aldrich #K3007-10MG). Where appropriate, COPYCONTROL²⁴ from Epicentre (Madison, Wis.) was added to overnight cultures at 1× active concentration. Overnight cultures were diluted 1:100 into 3 mL fresh LB and antibiotics and were incubated at 37° C. 300 rpm for 20 minutes. 200 μl of cultures were then moved into 96-well plates, combined with inducers, and then incubated for 4 hours and 20 minutes in a VWR microplate shaker shaking at 37° C. and 700 rpm, arriving at OD600 of ˜0.6-0.8.

Cells were then diluted 4-fold into a new 96-well plate containing fresh 1×PBS and immediately assayed using a BD LSRFORTESSA-HTS. At least 50,000 events were recorded for all data, which was then gated by forward scatter and side scatter using CYFLOGIC v.1.2.1 software (CyFlo, Turku, Finland). The geometric means of the gated fluorescence distributions were calculated by Matlab. Fluorescence values are based on geometric means of flow cytometry populations from three experiments and the error bars represent standard errors of the mean.

### Plasmid Construction

All the plasmids in this work were constructed using basic molecular cloning techniques¹⁹. New England Biolab's (Beverly, Mass.) restriction endonucleases, T4 DNA Ligase, and Taq Polymerase were used. PCRs were carried out with a BIO-RAD S1000™ Thermal Cycler With Dual 48/48 Fast Reaction Modules. Synthetic oligonucleotides were synthesized by Integrated DNA Technologies (Coralville, Iowa). As described in the Methods Summary, plasmids were transformed into E. coli 10β (araD139 Δ(ara-leu)7697 fhuA lacX74 galK (φ80 Δ(lacZ)M15) mcrA galU recA1 endA1 nupG rpsL (StrR) Δ(mrr-hsdRMS-mcrBC)), E. coli EPI300 (F− mcrA Δ(mrr-hsdRMS-mcrBC) φ80dlacZΔM15 ΔlacX74 recA1 endA1 araD139 Δ(ara, leu)7697 galU galK rpsL (StrR) nupG trfA tonA), or E. coli MG1655 Pro which contains integrated constitutive constructs for TetR and Lad proteins (FIGS. 18E and 19C)¹⁵, with a standard heat shock protocol¹⁹. Plasmids were isolated with QIAGEN QIAPREP SPIN MINIPREP KITS and modifications were confirmed by restriction digests and sequencing by Genewiz (Cambridge, Mass.).

All devices (promoter-RBS-gene-terminator) were initially assembled in the Lutz and Bujard expression vector pZE11G¹⁵ containing ampicillin resistance and the ColE1 origin of replication. Parts are defined as promoters, RBSs, genes, and terminators. Manipulation of different parts of the same type were carried out using the same restriction sites. For example, to change a gene in a device we used KpnI and XmaI. To assemble two devices together, we used a single restriction site flanking one device and used oligonucleotide primers and PCR to add that restriction site to the 5′ and 3′ ends of a second device. After assembling devices in the ampicillin-resistant ColE1 backbone, antibiotic-resistance genes were changed using AatII and SacI, and origin of replications were changed with SacI and AvrII. For gene fusions, oligonucleotide primers were designed to delete the stop codon in the C-terminus of the first gene as well as the start codon in the N-terminus of the second gene and to insert a 12-bp (Gly-Gly-Ser-Gly) linker between the two genes. The genes were amplified separately with appropriate primers using standard PCR techniques and the PCR products were assembled in a subsequent PCR reaction with the linker region serving as means of annealing the two templates. The variable copy plasmid (VFP) containing Pₗᵤₓ positive feedback was built by adding an AatII site to the 5′ end and a PacI site to the 3′ end of the Plux positive feedback device using PCR. This PCR product was cloned into the AatII and Pad sites of a pBAC/oriV vector¹⁷.

### Plate Reader/FACS Setup:

For each experiment, fluorescence readings were taken on a BioTek Synergy H1 Microplate reader using BioTek Gen5 software to determine the minimum and maximum expression level for cultures in each 96-well plate. GFP fluorescence was quantified by excitation at wavelength 484 nm and emission at wavelength 510 nm. mCherry fluorescence was quantified by excitation at wavelength 587 nm and emission at wavelength 610 nm. The gain of the plate reader was automatically sensed and adjusted by the machine.

Cultures containing the minimum and maximum fluorescence levels, as determined by the plate reader, were used to calibrate the FITC and PE-TexasRed filter voltages on a BD LSRFORTESSA-HTS in order to measure GFP and mCherry expression levels, respectively. The FACS voltages were adjusted using BD FACSDIVA software so that the maximum and minimum expression levels could be measured with the same voltage settings. Thus, consistent voltages were used across each entire experiment. The same voltages were used for subsequent repetitions of the same experiment. GFP was excited with a wavelength 488 nm laser and mCherry was excited with a wavelength 561 nm laser. Voltage compensation for FITC and PE-TexasRed was not necessary for any experiments.

TABLE 56
List of abbreviations used herein

| Symbol | Description |
|---|---|
| AHL | Free N-(β-Ketocaproyl)-L-homoserine lactone |
| | 3OC₆HSL concentration |
| AHL_{T} | Total AHL concentration |
| Arab | Free Arabinose concentration |
| Arab_{T} | Total Arab concentration |
| IPTG | Free Isopropyl-β-D-1-thiogalactopyranoside concentration |
| LuxR | Free LuxR concentration |
| LuxR_{C} | AHL-LuxR complex concentration |
| LuxR_{Cb} | Bound-promoter AHL-LuxR complex concentration |
| LuxR_{CT} | Total AHL-LuxR complex concentration |
| LuxR_{T} | Total LuxR concentration |
| AraC | Free AraC concentration |
| AraC_{C} | Arab-AraC complex concentration |
| AraC_{Cb} | bound-promoter Arab-AraC complex concentration |
| AraC_{CT} | Total Arab-AraC complex concentration |
| AraC_{T} | Total AraC concentration |
| LacI | Free LacI concentration |
| LacI_{C} | IPTG-LacI complex concentration |
| LacI_{T} | Total LacI concentration |
| Pₗᵤₓ | LuxR promoter |
| P_{BAD} | AraC promoter |
| P_{lacO} | LacI promoter |
| T | Free transcription factor concentration (LuxR, AraC, LacI) |
| T_{b} | Bound-promoter transcription factor concentration |
| T_{T} | Total transcription factor concentration (LuxR_{T}, AraC_{T}, LacI_{T}) |

TABLE 57
Parameter values for biochemical circuit models.

| Parameters | Pₗᵤₓ Promoter | P_{BAD} Promoter | P_{lacO} Promoter |
|---|---|---|---|
| Kₘ | 125 nM^{a} | 90 × 10³ nM^{a} | 1.4 mM^{a} |
| h₁ | 1.4 | 3 | 1.4-1.65^{c} |
| Kₙ | 400 | 1000 | |
| h₂ | 1.05 | 2.5 | |
| K_{d} | 800 | 140 | 1.76 × 10⁴ |
| K_{df} | | 140 × 9^{b} | 7 |
| g/μ₀ | 800 | 55 | 55 |
| g_{0/}μ₀ | 5 | 0.05 | |
| O_{T1} | 5 × 1 | 5 × 10 | 5 × 10 |
| N | 63 for HCP | 63 for HCP | |
| | 18 for MCP | 30 for MCP | |
| O_{T2} | O_{T1} × N | O_{T1} × N | |
| ρ | 1 | 1 | |
| β | 25 | 100 | |
| K_{b} | 30 | 1.5 × 10⁴ | |
| θ | 1 | 0.2 | |
| γ/μ₀ | 0.2 | 0.2 | |
| ni | | | 1 |

^{a}Parameter was set according to the literature
^{b}K_{d}/K_{df} was set according to the literature
^{c}For the wide-dynamic-range negative-slope circuit we obtained 1.65 for this parameter. In the negative-feedback circuit where mCherry is fused to the C-terminus of LacI we obtained 1.4.
The parameters: h₁, h₂, N, ρ, β, θ and γ/μ₀ are unitless.
The parameters: Kₙ, K_{d}, K_{df}, g/μ₀, g₀/μ₀, O_{T1}, O_{T2}, and K_{b} have the units of the measured signal.

TABLE 58
List of strains used herein

| Circuit | Schematic | Output | Input | Parameter | Plasmids |
|---|---|---|---|---|---|
| PF LCN | FIG. 2A | GFP | AHL | | pRD152 |
| PF LCN + Shunt MCP | FIG. 2A | GFP, mCherry | AHL | | pRD152, pRD318 |
| Positive WDR* | FIG. 2A | GFP, mCherry | AHL | | pRD152, pRD58 |
| PF LCN | FIG. 1B | GFP | Arab | | pRD123 |
| PF LCN + Shunt MCP | FIG. 1B | GFP, mCherry | Arab | | pRD123, pRD357 |
| Positive WDR* | FIG. 1B | GFP, mCherry | Arab | | pRD123, pRD131 |
| D/A** Positive WDR* | FIG. 2D | mCherry | AHL | CC(0,1x) | pJR378, pRD58 |
| Positive WDR DP*** | FIG. 29 | mCherry | Arab | | pRD123, pRD10 |
| Positive WDR-3Output | FIG. 3A | mCherry | AHL | | pJR570, pRD58 |
| Negative WDR | FIG. 3E | mCherry | AHL | IPTG | pRD289, pRD293 |
| Adder | FIG. 4A | mCherry | AHL, Arab | | pRD258, pRD238 |
| Ratiometer | FIG. 4C | mCherry | AHL, Arab | IPTG | pRD289, pRD362 |
| Power Law | FIG. 4E | mCherry | IPTG | Arab | pRD43, pRD114 |
| OL: LuxR | FIG. 18A | GFP | AHL | | pRD302 |
| OL + Shunt: LuxR | FIG. 18B | mCherry | AHL | | pRD171, pRD58 |
| OL: LuxR-GFP | FIG. 18C | mCherry | AHL | | pRD397 |
| OL + Shunt: LuxR-GFP | FIG. 18D | mCherry | AHL | | pRD331, pRD58 |
| OL + Shunt: AraC | FIG. 20A | mCherry | Arab | | pRD89, pRD131 |
| OL + Shunt: AraC-GFP | FIG. 20B | mCherry | Arab | | pRD43, pRD131 |
| | FIG. 1C | | | | |
| PF + Dummy Shunt | FIG. 21A | GFP | Arab | | pRD152, |
| | | | | | pRD58 |

*WDR: Wide Dynamic range
**D/A: Digital-to-Analog (in other words, digitally toggleable analog circuit behavior)
***WDR DP: Wide Dynamic Range with Double Promoter

TABLE 59
List of parts used herein

| Part Name | Description and Source |
|---|---|
| Pₗᵤₓ | Lux promoter, BBa_R00622²¹ |
| P_{BAD} | araBAD promoter⁶ |
| P_{lacO} | P_{LlacO-1} promoter¹⁵ |
| RBS1 | BBa_B0030 (ATTAAAGAGGAGAAA)²¹ (SEQ ID NO: 822) |
| RBS2 | BBa_B0034 (AAAGAGGAGAAA)²¹ (SEQ ID NO: 823) |
| RBS3 | BBa_B0029 (TTCACACAGGAAACC)²¹ (SEQ ID NO: 824) |
| TermT1 | Terminator T1¹⁵ |
| TermT0 | Terminator T0¹⁵ |
| LuxR | LuxR coding sequence (BBa_C0062)²¹, induced by AHL (3OC₆HSL) |
| AraC | AraC coding sequence⁶ |
| Lad | Lad coding sequencer¹⁵ |
| GFP | Enhanced Green Fluorescent Protein coding sequence²² |
| mCherry | Red Fluorescent Protein coding sequence²² |
| ColE1 | High-copy number origin of replication¹⁵ |
| p15A | Medium-copy number origin of replication¹⁵ |
| pSC101 | Low-copy number origin of replication¹⁵ |

### REFERENCES

1 Sprinzak, D. et al. Cis-interactions between Notch and Delta generate mutually exclusive signalling states. Nature 465, 86-90, doi:10.1038/nature08959 (2010).
2 Gardner, T. S., Cantor, C. R. & Collins, J. J. Construction of a genetic toggle switch in Escherichia coli. Nature 403, 339-342, doi:10.1038/35002131 (2000).
3 Ajo-Franklin, C. M. et al. Rational design of memory in eukaryotic cells. Genes Dev 21, 2271-2276, doi:21/18/2271 [pii] 10.1101/gad.1586107 (2007).
4 Ham, T. S., Lee, S. K., Keasling, J. D. & Arkin, A. P. A tightly regulated inducible expression system utilizing the fim inversion recombination switch. Biotechnol Bioeng 94, 1-4, doi:10.1002/bit.20916 (2006).
5 Friedland, A. E. et al. Synthetic gene networks that count. Science 324, 1199-1202, doi:324/5931/1199 [pii] 10.1126/science. 1172005 (2009).
6 Rinaudo, K. et al. A universal RNAi-based logic evaluator that operates in mammalian cells. Nat Biotechnol 25, 795-801, doi:nbt1307 [pii] 10.1038/nbt1307 (2007).
7 Win, M. N. & Smolke, C. D. Higher-order cellular information processing with synthetic RNA devices. Science 322, 456-460, doi:322/5900/456 [pii] 10.1126/science. 1160311 (2008).
8 Tamsir, A., Tabor, J. J. & Voigt, C. A. Robust multicellular computing using genetically encoded NOR gates and chemical ‘wires’. Nature, doi:nature09565 [pii] 10.1038/nature09565 (2010).
9 Regot, S. et al. Distributed biological computation with multicellular engineered networks. Nature 469, 207-211, doi:10.1038/nature09679 (2011).
10 Anderson, J. C., Voigt, C. A. & Arkin, A. P. Environmental signal integration by a modular AND gate. Mol Syst Biol 3, 133, doi:msb4100173 [pii] 10.1038/msb4100173 (2007).
11 Auslander, S., Auslander, D., Muller, M., Wieland, M. & Fussenegger, M. Programmable single-cell mammalian biocomputers. Nature advance online publication, doi:http://www.nature.com/nature/journal/vaop/ncurrent/abs/nature11149.html—supplementary-information (2012).
12 Xie, Z., Wroblewska, L., Prochazka, L., Weiss, R. & Benenson, Y. Multi-input RNAi-based logic circuit for identification of specific cancer cells. Science 333, 1307-1311, doi:10.1126/science.1205527 (2011).
13 Nissim, L. & Bar-Ziv, R. H. A tunable dual-promoter integrator for targeting of cancer cells. Mol Syst Biol 6, 444, doi:10.1038/msb.2010.99 (2010).
14 Tabor, J. J. et al. A synthetic genetic edge detection program. Cell 137, 1272-1281, doi:S0092-8674(09)00509-1 [pii] 10.1016/j.cell.2009.04.048 (2009).
15 Canton, B., Labno, A. & Endy, D. Refinement and standardization of synthetic biological parts and devices. Nat Biotechnol 26, 787-793, doi:nbt1413 [pii] 10.1038/nbt1413 (2008).
16 Cardinale, S. & Arkin, A. P. Contextualizing context for synthetic biology—identifying causes of failure of synthetic biological systems. Biotechnology Journal 7, 856-866, doi:10.1002/biot.201200085 (2012).
17 Giorgetti, L. et al. Noncooperative Interactions between Transcription Factors and Clustered DNA Binding Sites Enable Graded Transcriptional Responses to Environmental Inputs. Molecular Cell 37, 418-428, doi:10.1016/j.molcel.2010.01.016 (2010).
18 Chen, Y. Y., Galloway, K. E. & Smolke, C. D. Synthetic biology: advancing biological frontiers by building synthetic systems. Genome Biol 13, 240, doi:10.1186/gb-2012-13-2-240 (2012).
19 Clark, B. & Hausser, M. Neural Coding: Hybrid Analog and Digital Signalling in Axons. Current biology: CB 16, R585-R588 (2006).
20 Sarpeshkar, R. Ultra Low Power Bioelectronics: Fundamentals, Biomedical Applications, and Bio-Inspired Systems. (Cambridge University Press, 2010).
21 Sarpeshkar, R. Analog versus digital: extrapolating from electronics to neurobiology. Neural Comput. 10, 1601-1638, doi:10.1162/089976698300017052 (1998).
22 Ferrell, J. E. Signaling Motifs and Weber's Law. Molecular Cell 36, 724-727 (2009).
23 Tavakoli, M. & Sarpeshkar, R. A sin h resistor and its application to tan h linearization. Solid-State Circuits, IEEE Journal of 40, 536-543, doi:10.1109/jssc.2004.841015 (2005).
24 Wild, J., Hradecna, Z. & Szybalski, W. Conditionally Amplifiable BACs: Switching From Single-Copy to High-Copy Vectors and Genomic Clones. Genome research 12, 1434-1444, doi:10.1101/gr.130502 (2002).
25 Qian, L. & Winfree, E. Scaling up digital circuit computation with DNA strand displacement cascades. Science 332, 1196-1201, doi:10.1126/science.1200520 (2011).
26 Prindle, A. et al. A sensing array of radically coupled genetic ‘biopixels’. Nature 481, 39-44, doi:http://www.nature.com/nature/journal/v481/n7379/abs/nature10722.html—supplementary-information (2012).
27 van der Meer, J. R. & Belkin, S. Where microbiology meets microengineering: design and applications of reporter bacteria. Nat Rev Micro 8, 511-522 (2010).
28 Burger, A., Walczak, A. M. & Wolynes, P. G. Abduction and asylum in the lives of transcription factors. Proceedings of the National Academy of Sciences 107, 4016-4021, doi:10.1073/pnas.0915138107 (2010).
29 Holtz, W. J. & Keasling, J. D. Engineering Static and Dynamic Control of Synthetic Pathways. Cell 140, 19-23 (2010).
30 Tolonen, A. C. et al. Proteome-wide systems analysis of a cellulosic biofuel-producing microbe. Mol Syst Biol 7, doi:http://www.nature.com/msb/journal/v7/n1/suppinfo/msb2010116_S1.html (2011).
31 Ellis, T., Wang, X. & Collins, J J Diversity-based, model-guided construction of synthetic gene networks with predicted functions. Nat Biotechnol 27, 465-471, doi:nbt.1536 [pii] 10.1038/nbt.1536 (2009).
32 Stricker, J. et al. A fast, robust and tunable synthetic gene oscillator. Nature 456, 516-519, doi:nature07389 [pii] 10.1038/nature07389 (2008).
33 Elowitz, M. B. & Leibler, S. A synthetic oscillatory network of transcriptional regulators. Nature 403, 335-338, doi:10.1038/35002125 (2000).
34 McMillen, D., Kopell, N., Hasty, J. & Collins, J J Synchronizing genetic relaxation oscillators by intercell signaling. Proceedings of the National Academy of Sciences 99, 679-684, doi:10.1073/pnas.022642299 (2002).
35 Madar, D., Dekel, E., Bren, A. & Alon, U. Negative auto-regulation increases the input dynamic-range of the arabinose system of Escherichia coli. BMC Syst Biol 5, 111, doi:10.1186/1752-0509-5-111 (2011).
36 Nevozhay, D., Adams, R. M., Murphy, K. F., Josić, K. & Balazsi, G. Negative autoregulation linearizes the dose-response and suppresses the heterogeneity of gene expression. Proc Natl Acad Sci USA 106, 5123-5128, doi:10.1073/pnas.0809901106 (2009).
37 Shen-Orr, S. S., Milo, R., Mangan, S. & Alon, U. Network motifs in the transcriptional regulation network of Escherichia coli. Nat Genet 31, 64-68, doi:10.1038/ng881 ng881 [pii] (2002).
38 You, L., Cox, R. S., Weiss, R. & Arnold, F. H. Programmed population control by cell-cell communication and regulated killing Nature 428, 868-871 (2004).
39 Bacchus, W. et al. Synthetic two-way communication between mammalian cells. Nat Biotech 30, 991-996, doi:http://www.nature.com/nbt/journal/v30/n10/abs/nbt.2351.html—supplementary-information (2012).
40 Isaacs, F. J. et al. Engineered riboregulators enable post-transcriptional control of gene expression. Nat Biotechnol 22, 841-847, doi:10.1038/nbt986 nbt986 [pii] (2004).
41 Khalil, A. et al. A Synthetic Biology Framework for Programming Eukaryotic Transcription Functions. Cell 150, 647-658 (2012).
42 Dueber, J. E., Yeh, B. J., Chak, K. & Lim, W. A. Reprogramming control of an allosteric signaling switch through modular recombination. Science 301, 1904-1908, doi:10.1126/science.1085945 301/5641/1904 [pii] (2003).
43 Hahnloser, R. H. R., Sarpeshkar, R., Mahowald, M. A., Douglas, R. J. & Seung, H. S. Digital selection and analogue amplification coexist in a cortex-inspired silicon circuit. Nature 405, 947-951, doi:http://www.nature.com/nature/journal/v405/n6789/suppinfo/405947a0_S1.html (2000).
44 Lu, T. K., Khalil, A. S. & Collins, J J Next-generation synthetic gene networks. Nat Biotechnol 27, 1139-1150, doi:nbt.1591 [pii] 10.1038/nbt.1591 (2009).
45 Hill, T L. Cooperativity Theory in Biochemistry (Springer, New York, 1985).
46 Ackers, G. K. Johnson, A. D. & Shea, M. A. Quantitative model for gene regulation by lambda phage repressor. Proc Natl Acad Sci 79, 1129-1133, (1982)
47 Bintu, L. et al. Transcriptional regulation by numbers: models. Curr Opin Genet Dev 15, 116-124, (2005).
48 Pesci, E. C. Pearson, J. P. Seed, P. C. & Iglewski, B. H. Regulation of las and rhl quorum sensing in Pseudomonas aeruginosa. J Bacteriol 179, 3127-3132, (1997).
49 Lee, N. L. Gielow, W. O. & Wallace, R. G. Mechanism of araC autoregulation and the domains of two overlapping promoters, Pc and PBAD, in the L-arabinose regulatory region of Escherichia coli. Proc Natl Acad Sci 78, 752-756, (1981).
50 Tamsir, A. Tabor, J. J. & Voigt, C. A. Robust multicellular computing using genetically encoded NOR gates and chemical ‘wires’. Nature 469, 212-215, (2010).
51 Burger, A. Walczak, A. M. & Wolynes, P. G. Abduction and asylum in the lives of transcription factors. Proc Natl Acad Sci 107, 4016-4021, (2010).
52 Wilkinson, D. J. Stochastic Modelling for Systems Biology, (Chapman & Hall/CRC Mathematical & Computational Biology, 2006)
53 Cookson, N. A. et al. Queueing up for enzymatic processing: correlated signaling through coupled degradation, Mol Syst Biol 7, 561, (2011)
54 Gardner, T. S. Cantor, C. R. & Collins, J. J. Construction of a genetic toggle switch in Escherichia coli. Nature 403, 339-342, (2000).
55 CM. Ajo-Franklin et al. Rational design of memory in eukaryotic cells. Genes Dev. 21, 2271-2276, (2007)
56 Wunderlich, Z. & Mirny, L. A. Spatial effects on the speed and reliability of protein-DNA search, Nucleic Acids Res 36, 3570-3580 (2008)
57 Gardiner, C. Handbook of stochastic methods: For physics, chemistry and the natural sciences, (Springer Verlag, Berlin, 1996)
58 Lutz, R. & Bujard, H. Independent and tight regulation of transcriptional units in Escherichia coli via the LacR/O, the TetR/O and AraC/I1-I2 regulatory elements. Nucleic Acids Res 25, 1203-1210, (1997).
59 Ceroni, F. Furini, S. Giordano, & E. Cavalcanti, S. Rational design of modular circuits for gene transcription: A test of the bottom-up approach. Journal Biol Eng 4, 14, (2010).
60 Wild, J. Hradecna, Z. & Szybalski, W. Conditionally Amplifiable BACs: Switching From Single-Copy to High-Copy Vectors and Genomic Clones. Genome Res 12, 1434, (2002).
61 Sambrook, J. Fritsch, & E. F. Maniatis, T. Molecular Cloning: A Laboratory Manual, (Cold Spring Harbor Laboratory Press, Plainview, N.Y., edn. 2, 1989).
62 Danial, R., Woo, S. S., Turicchia, L., & Sarpeshkar, R. Analog Transistor Models of Bacterial Genetic Circuits, Proceedings of the IEEE Symposium on Biological Circuits and Systems, 333-336, (2011).
63 Andersen J B, Sternberg C, Poulsen L K, Bjorn S P, Givskov M, & Molin S: New unstable variants of green fluorescent protein for studies of transient gene expression in bacteria, Appl. Environ Microbiol, 64 (6), 2240-2246 (1998)
64 T. Shibata and K. Fujimoto, Noisy signal amplification in ultrasensitive signal transduction, Proc. Natl. Acd. Sci. U.S.A. vol. 102, pp. 331-336, 2005.
65 Daniel Madar, Erez Dekel, Anat Bren and Uri Alon Negative auto-regulation increases the input dynamic-range of the arabinose system of Escherichia coli, BMC Systems Biology, 5:111 (2011)
66 Isaacs F J, Dwyer D J, Ding C, Pervouchine D D, Cantor C R and Collins J J. Engineered riboregulators enable post-transcriptional control of gene expression. Nature Biotechnology 22: 841-847 (2004).
67 Tavakoli, M. & Sarpeshkar, R. A sin h resistor and its application to tan h linearization. Solid-State Circuits, IEEE Journal of 40, 536-543, doi:10.1109/jssc.2004.841015 (2005).

2. A graded positive-feedback molecular circuit comprising
a. an input association block comprising molecular species Mᵢₙ, and Mₒᵤₜ′ as inputs and that outputs molecular species C, wherein the input association block may have an adjustable input association strength; and
b. a control block comprising one or more of an association, attenuation, transformation, or degradation block, wherein the output C of the input block is converted to a molecular species C′ as an output, wherein the association, attenuation, transformation and degradation strengths of the respective association, attenuation, transformation or degradation blocks may have adjustable strengths; and
c. an output transformation block comprising molecular species C′ of the control block as an input that is converted to Mₒᵤₜ as an output, wherein the output transformation strength may be adjusted; and
d. a feedback block comprising one or more of an association, attenuation, transformation, or degradation block, wherein the molecular species Mₒᵤₜ of the output transformation block is converted to Mₒᵤₜ′ as an output, and wherein the association, attenuation, transformation, and degradation strengths of the respective association, attenuation, transformation, and degradation blocks may be adjusted;
and wherein signs of the functional derivatives of the blocks in the feedback circuit are configured such that small changes in at least one molecular species in the feedback loop, for example, C, return as further changes in C that increase the initial change in C, thus creating a positive-feedback loop.

3-23. (canceled)
